(19) United States
(12) Patent Application Publication
(10) Pub. No.: US 2017/0046729 A1
(43) Pub. Date: Feb. 16, 2017

(54) INTERNET-BASED AFFILIATE-REFERRAL DRIVEN CONSUMER-TRANSACTION REWARDING SYSTEM NETWORK AND METHODS SUPPORTED BY THE SAME

(71) Applicant: LOCALLYSELECTED.COM, LLC, Bridgeport, CT (US)

(72) Inventor: Conal Breslin, Bridgeport, CT (US)

(21) Appl. No.: 15/216,962

(22) Filed: Jul. 22, 2016

Related U.S. Application Data
(63) Continuation of application No. PCT/US2015/012961, filed on Jan. 26, 2015.
(60) Provisional application No. 61/931,138, filed on Jan. 24, 2014.

(51) Int. Cl. G06Q 30/02; G06Q 30/06

(52) U.S. Cl. CPC G06Q 30/0214; G06Q 30/0631

(57) ABSTRACT

The present disclosure provides, among other things, a new and improved method of and a system network for supporting the payment of monetary amounts (i.e. consumer rewards) to financial gift-card accounts held by consumers registered on the system network, as a financial reward for referring specific service providers and/or merchants affiliated with the system network to perform specific jobs listed on the system network on behalf of other consumers registered on the system network, and also holding gift card accounts so as to drive consumer transactions on the system network with the consumer rewards paid by network affiliates to consumers who refer or recommend another consumer the services and/or goods of such network affiliates to drive the local economy which the system network supports, while overcoming the shortcomings and drawbacks of prior art apparatus and methodologies.

### CROSS-REFERENCE TO RELATED APPLICATIONS

This patent application is a continuation of and claims the benefit of priority to International Application No. PCT/US2015/012961, filed Jan. 26, 2015, which claims the benefit of priority to U.S. Provisional Patent Application Ser. No. 61/931,138, filed Jan. 24, 2014. The content of each of the aforementioned patent applications are incorporated herein in its entirety by reference for any purpose whatsoever.

### BACKGROUND OF INVENTION

Field of Invention

The present invention relates to new and improved methods of and apparatus for supporting and rewarding consumer product and service transactions carried out over an enterprise-level Internet-based system network providing powerful information and financial services to consumers, merchants and service providers alike to help strengthen and grow local economies.

Brief Description of the State of Knowledge in the Art

In today's marketplace, the consumer is presented with an enormous amount of information but no real way of sorting out the good from the bad. When the consumer is looking for a product they do not have a true review system available to them. An example of this is Angie's List where an advertiser can boost his ratings by paying for premier placement. Angie's List will then send him out 20 or 30 postcards which he passes on to his customers, the happy ones of course, who then write a review and post it back to Angie's List. This results in our service provider having 30 great recent reviews from customers but, of course, these are not real reviews because they have been cherry picked.

Another problem is that a consumer can deliberately write a negative review. There is also the problem that more often than not people who complain a lot are more inclined to write a review. Very often, a good job is taken or granted but get very annoyed and make a point of complaining when the job does not ones expectations. A service provider may have only 3 reviews and one of them may be from a consumer who invariably complains about everyone. In a case like this one bad review could unfairly damage the service provider. The fact that people generally do not give reviews without being requested to do so also means that a lot of the reviews which are available are out of date and not to be relied upon.

Today's advertisers often spend a lot of money on Google and other platforms but they get a very poor return on their investment. It is very easy for a business to spend $1000 on Google Adwords and not get one sale from it. The inefficiency of this advertising system is very costly to the business and, of course, this cost is passed on to the consumer. All the inefficiencies in systems such as Google and Bing are driving up the costs of goods and services to the consumer, who is powerless to do anything about it.

There is no search engine available to the consumer which mimics a “word of mouth system,” where people can ask questions of a trusted group and make informed decisions based on the reviews presented to them.

Also, manufacturers, brands and service providers pay money to agents to advertise and build demand for products and services. Money flows from businesses to agents in effort to influence consumers to make purchases and consume products. While some methods and systems exist for rewarding consumers who refer product manufacturers and service providers to other consumers, they are vulnerable to exploitation and gaming and are generally incapable of scaling to meet the demands of local economies to make them essentially non-feasible, and non-sustainable.

Thus, there is a great need in the art for a new and improved system, methods and apparatus for enabling consumers, service providers and merchants, to communicate and move information to support decision making and service processes relating to consumer transactions, while overcoming the shortcomings and drawbacks of prior art apparatus and methodologies.

### SUMMARY AND OBJECTS OF THE PRESENT INVENTION

Accordingly, a primary object of the present invention is to provide a new and improved method of and a system network for supporting the payment of monetary amounts (i.e. consumer rewards) to financial gift-card accounts held by consumers registered on the system network, as a financial reward for referring specific service providers and/or merchants affiliated with the system network to perform specific jobs listed on the system network on behalf of other consumers registered on the system network, and also holding gift card accounts so as to drive consumer transactions on the system network with the consumer rewards paid by network affiliates to consumers who refer or recommend another consumer the services and/or goods of such network affiliates to drive the local economy which the system network supports, while overcoming the shortcomings and drawbacks of prior art apparatus and methodologies.

Another object of the present invention is to provide an Internet-based affiliate-referral driven consumer transaction rewarding system network, wherein each new consumer registers with the system network and opens a new consumer rewards gift card account maintained at a sponsoring financial institution, whereafter (i) the consumer earns consumer rewards credit that is issued to the consumer's consumer rewards gift card account as a reward for either (i) posting one or more jobs on the system network, (ii) referring specific jobs to registered affiliates on the system which are then completed by the referred affiliates and reviewed by the served consumer, and/or (ii) purchasing a product or service from an affiliate registered on the system network; and wherein the consumer can purchase goods and/or services from an affiliate registered on the system network using monetary value held in the consumer's consumer reward gift card account.

Another object of the present invention is to provide an Internet-based affiliate-referral driven consumer transaction rewarding system network, wherein consumers can conduct searches on the system network to find affiliates who have been classified in a particular category of services/goods, and in response to each search query, the network servers return: (i) a list of registered affiliates that meet the consumer's search criteria, (ii) a business profile for each affiliate business/merchant, and (iii) a list of reviews, made by a selected number of the most recent consumers (indexed by date of service/purchase);

Another object of the present invention is to provide an Internet-based affiliate-referral driven consumer transaction rewarding system network, wherein at this stage of the search process, the user/consumer is provided with several options: (1) read the displayed affiliate profiles; (2) refer a displayed affiliate to a particular job—by selecting the “refer now” button on the client system user interface, which job may be the user's job or someone else's job); (3) conduct another search query against affiliate directory; where, in response thereto, the consumer reviews the displayed reviews, makes a decision on the displayed reviews, and contacts one or more of the listed affiliates via messaging.

Another object of the present invention is to provide an Internet-based affiliate-referral driven consumer transaction rewarding system network, wherein ultimately, the consumer selects a referred affiliate, and if and when a transaction is completed, then (a) the consumer who received services/goods (job) writes and posts a review, and (b) the affiliate providing the services confirms that the job was completed; (c) thereafter, the affiliate transfer reward credits from the affiliate's Consumer Reward Gift Card (CRGC) payment account to (i) the referring consumer's CRGC account, (ii) the served consumer's CRGC account, and (iii) the network's CRGC account.

Another object of the present invention is to provide an Internet-based affiliate-referral driven consumer transaction rewarding system network, wherein a consumer earns consumer rewards gift card credit on the network, in any one of the following events, namely, (i) the consumer is rewarded as a job adder; (ii) the consumer is rewarded as a job referrer; and (iii) the consumer is rewarded as a consumer goods and/or services purchaser on the system network.

Another object of the present invention is to provide an Internet-based affiliate-referral driven consumer transaction rewarding system network, wherein as a job adder, (i) the consumer x adds a job to the database of the system network—requesting service by a network affiliate registered with the system network, for the benefit of the consumer x, wherein the job is ultimately to ne completed by a network affiliate registered with the system network.

Another object of the present invention is to provide an Internet-based affiliate-referral driven consumer transaction rewarding system network, wherein as a job adder, a consumer x adds a job to the database of the system network—requesting service by a network affiliate registered with the system network, for the benefit of the consumer y (where x is not y), and the job is ultimately completed by a network affiliate registered with the system network.

Another object of the present invention is to provide an Internet-based affiliate-referral driven consumer transaction rewarding system network, wherein as a job referrer, a consumer z refers (i.e. by selecting the “refer now” button on the client system), an affiliate registered on the system network, to a job which the consumer has actually used upon which the consumer relies on the referral and the consumer transaction is consummated/completed and the consumer waitress and posts a review on the system network.

Another object of the present invention is to provide an Internet-based affiliate-referral driven consumer transaction rewarding system network, wherein as a consumer purchaser, a consumer y purchases a product/service from an affiliate registered on the system network, and then writes and posts a product/service experience review on the system network.

Another object of the present invention is to provide an Internet-based affiliate-referral driven consumer transaction rewarding system network, wherein a consumer is not permitted to push his/her own referral (i.e. job+affiliate+review record) to another consumer considering an affiliate's goods/services; rather, the affiliate referral made by consumer x (who selecting the “refer now” button on a client system) goes into the referral pools, and only another consumer y performing a search against the affiliate directory can thereafter move consumer x's job referral out of the referral pool and display the same to the consumer seeking an affiliate referral for a particular job.

Another object of the present invention is to provide an Internet-based affiliate-referral driven consumer transaction rewarding system network, wherein consumers can use earned consumer rewards credit card (CRG) monetary value to pay for consumer services or goods purchased from affiliates on the system network.

Another object of the present invention is to provide an Internet-based affiliate-referral driven consumer transaction rewarding system network, wherein the consumer holding a consumer rewards gift card (CRGC) account is issued a mag-stripe card encoded with user information recorded thereon, so that the card can be read by using a mag-stripe reader interfaced to a client system at a network affiliate.

Another object of the present invention is to provide an Internet-based affiliate-referral driven consumer transaction rewarding system network, wherein each network affiliate can use a mobile client application to generate a purchase transaction receipt for a consumer customer, and to then read a QRS barcode displayed on the consumer's mobile client application so as to access the consumer's CRGC account and use stored credit value to pay for the consumer's purchase transaction.

Another object of the present invention is to provide an Internet-based affiliate-referral driven consumer transaction rewarding system network, wherein each network affiliate can use a mobile client application to read an RFID-tag to authorize access to the consumer's CRGC account and deduct credit value contained therein to pay for the consumer's purchase transaction at the affiliate's place of business.

Another object of the present invention is to provide an Internet-based affiliate-referral driven consumer transaction rewarding system network, wherein the client system used by each consumer allows the consumer to set limits on the amount of credit to be automatically maintained on the consumer's consumer reward gift card (CRGC) account through the automated transfer of funds from an account owned/held by the consumer at a designated financial institution, into the consumer's CRGC account maintained at the sponsoring financial institution on the system network.

Another object of the present invention is to provide an Internet-based affiliate-referral driven consumer transaction rewarding system network, wherein the client system used by each consumer allows the consumer to transfer CRGC credits to spouses and other family members who are registered users and CRGC account holders on the system network.

Another object of the present invention is to provide an Internet-based affiliate-referral driven consumer transaction rewarding system network, wherein the client system used by each consumer allows the consumer to (i) review the balance of his or her CRGC account, (ii) make donations to local charities registered with the system network, (iii) add credit value to consumer reward gift card account (CRGC) account using a financial institution linked to the consumer's credit card or debit card account, and (iv) transfer consumer reward credit to a spouse or family member who also holds a consumer reward gift card (CRGC) account on the system network.

Another object of the present invention is to provide an Internet-based affiliate-referral driven consumer transaction rewarding system network, wherein the client system used by each consumer allows the consumer to use earned consumer rewards credit to pay for such services/products from any affiliate in the system network by (i) reading a mag-stripe encoded consumer rewards credit card, or (ii) using a mobile client application to generate and display a QRS code which is read by the a QRS code reader interfaced with the affiliate's client system deployed on the system network.

Another object of the present invention is to provide an Internet-based system for paying for a consumer purchase transaction with an affiliate service provider or merchant registered on an affiliate-referral driven consumer transaction rewarding system network, using credit value available within a consumer's consumer rewards gift card (CRGC) account.

Another object of the present invention is to provide such an Internet-based system, wherein (a) the consumer purchases products or services at a store or space (e.g. restaurant) of an affiliate service provider/merchant, registered on the system network, and the affiliate generates and displays a sales transaction invoice at the point of sale or purchase, in the form of a QRS code on a display screen; (b) the affiliate service provider uses the affiliate's mobile client system to scan a QRS bar code displayed on the consumer client machine identifying its consumer reward gift card (CRGC) account for payment; (c) the affiliate's mobile client system displays a proposed payment transaction screen for the consumer transaction, requesting the consumer's approval to make payment from the identified CRGC account(d) upon the consumer providing approval for payment, the system network processes the payment and sends notification messages to the consumer and the affiliate service provider, which updates the system database, while payment processing is carried out transparently; and (e) the consumer receives the payment confirmation on its mobile client system, and confirms the consumer transaction on the network and its associated payment transaction using the mobile client system.

Another object of the present invention is to provide an Internet-based affiliate-referral driven consumer transaction rewarding system network on which registered consumers can earn consumer reward gift card credits in different ways, namely: (i) when a consumer x adds a job to the network—requesting service by a network affiliate; (ii) when a consumer y purchases a product/service from an affiliate on the network, and then writes and posts a product/service review on the network; and (iii) when a consumer z refers an affiliate to a job, upon which a consumer transaction is consummated/completed, where consumer z has actually used the affiliate being referred.

Another object of the present invention is to provide an Internet-based affiliate-referral driven consumer transaction rewarding system network, wherein a consumer cannot push his/her own job referral to another consumer considering an affiliate's goods/services; rather, the job-affiliate referral made by consumer x (who selects the “refer now” button) goes into the referral pool, and only another consumer y can thereafter move the consumer x's job-affiliate referral out of the referral pool into the review queue—to be seen by consumers seeking referrals from consumers who have (i) used the referred affiliate's services in connection with completed jobs similar to the posted job, and posted their review's of the affiliate's products/services.

Another object of the present invention is to provide an Internet-based affiliate-referral driven consumer transaction rewarding system network, wherein the client system used by each consumer allows the consumer to manage the job-affiliate records maintained within the database of the affiliate-referral driven consumer transaction rewarding system network.

Another object of the present invention is to provide an Internet-based method of registering a consumer on an affiliate-referral driven consumer transaction rewarding system network using one of the following methods: (i) downloading a mobile web client application or mobile native client application supporting a registration module; (ii) visiting a web site and registering using GUI screens supported at the web site; (iii) receiving an SMS or email message requesting the consumer to register through a web-based GUI screen; (iv) purchasing goods or services at an network affiliate and registering through one of the affiliate's client system systems; where upon registering with the system network, the consumer receives a consumer reward gift card (CRGC) account having a user name and password; wherein the initial value on the consumer's consumer rewards gift card (CRGC) account is zero, unless one or more affiliates charge it with a predesignated value amount as promotion for joining the system network.

Another object of the present invention is to provide an Internet-based affiliate-referral driven consumer transaction rewarding system network, wherein a Contacts Search Module allows each consumer to search within a Job Category for network affiliates used by one or more of his personal contacts (i.e. the Contacts on his own phone or smartphone).

Another object of the present invention is to provide an Internet-based affiliate-referral driven consumer transaction rewarding system network, wherein consumer profiles will not be available to be seen by the general public, and reviews will use the username chosen by the consumer.

Another object of the present invention is to provide an Internet-based affiliate-referral driven consumer transaction rewarding system network, wherein consumer household accounts are supported so that where everyone in the household has their own account for use of the system network by underage family participants.

Another object of the present invention is to provide an Internet-based affiliate-referral driven system network, wherein when the job is added from the affiliate directory thereof, there is no refer now button, and instead, the job is automatically added to the referral pool, and one or more of the 3 displayed affiliates are referred for the job.

Another object of the present invention is to provide an Internet-based affiliate-referral driven system network, wherein each affiliate referral is registered to the consumer who is adding the job and he is sending a text message to the affiliate(s) asking them to contact him.

Another object of the present invention is to provide an Internet-based affiliate-referral driven consumer transaction rewarding system network, which supports referral pools where a refer now button is used to add and refer jobs to the referral pools, and also an affiliate directory system, where during searches, up to 3 affiliates are displayed and automatically referred to an affiliate for each job using text messaging, to drive customer leads and commerce.

Another object of the present invention is to provide an Internet-based affiliate-referral driven consumer transaction rewarding system network, wherein after each purchase with consumer reward gift card credit, a consumer reward gift card (CRGC) credit reward is issued to the consumer so as to encourage the consumer to use their consumer reward gift card (CFGC) account.

Another object of the present invention is to provide an Internet-based affiliate-referral driven consumer transaction rewarding system network, wherein update a job module allows an affiliate to update the status of a job assigned to the affiliate by the consumer to be completed.

Another object of the present invention is to provide an Internet-based affiliate-referral driven consumer transaction rewarding system network, wherein a rewards issued module provides each affiliate with the details of consumer reward gift card (CRGC) credit which has been awarded/issued to consumers through the system network.

Another object of the present invention is to provide an Internet-based affiliate-referral driven consumer transaction rewarding system network, wherein show my reviews module lists the reviews which each affiliate has received from consumers over the system network.

Another object of the present invention is to provide an Internet-based affiliate-referral driven consumer transaction rewarding system network, wherein an add a job for consumer module allows the affiliate to add a job for a consumer so that the job completed will be recorded for purposes of awarding CRGC credit to consumers, but the job will not be added to the Referral Pools. This facility will be useful in restaurants when after dinner is completed, and during checkout at the restaurant, the affiliate restaurant owner will enter the job (i.e. dining experience) into the system network so that the job and consumer reward gift card (CRGC) credit will be issued to the consumer after writing and posting a review about their consumer experience at the affiliate restaurant.

Another object of the present invention is to provide an Internet-based affiliate-referral driven consumer transaction rewarding system network, wherein the Add Jobs Module, the Refer Jobs Module, the Jobs Added By Me Module, Jobs Referred by Me Module are supported by highly advanced contacts-based, group-based and job-category based filtering processes which provide the user with greater control over who is presented job and referral related information so that those with experience to recommend and refer are filtered out and proposed as candidates to consumer considering affiliate for job related services and products on the system network of the present invention.

The system network and related methods of the present invention create many advantages and benefits to local economies.

The system network of the present invention provides a true review system which can be trusted by the consumer. Every consumer registered with the system network is asked to review the network affiliate on completion of a job. This is a condition of receiving their reward but the reward does not in any way depend on whether the review is good or bad. Once the review is completed the system will pay out the reward.

The system network requires a consumer review before issuing the reward, consumer reviews are always current and a large selection of reviews are available for each network affiliate. This ensures that the consumer always has a balanced view of the service provider. Because of the large volume of reviews, a service provider who is not performing well will be noticed as such.

Reviews cannot be skewed. Great measures have been undertaken to avoid review skewing. For example, when a consumer refers a job from the Referral Pools in favor of a network affiliate they have used, the review which they have given for this affiliate is removed from the list of the last 10 reviews shown to the consumer who needs the job done. This is to prevent any consumer from unfairly influencing the outcome for their own profit, or in an effort to damage or boost the Affiliate concerned. The system network of the present invention also has the ability to cross reference a negative review with other reviews given by the same consumer and so will detect if a pattern of negative reviews from a particular reviewer is emerging. This is a protection for the service provider.

The system network of the present invention overcomes the inefficiencies of conventional advertising systems. The system retains energy that under conventional advertisement systems is lost. This energy is retained as reward credits and redirected to the source that pays for advertisement which is the consumer and as such makes the system network of the present invention more efficient than conventional advertisement.

With the system network of the present invention, marketing dollars are spent more efficiently and directed at the local business area. It represents a new way of efficiently focusing marketing dollars spent by merchants and those who provide products and services to consumers and other businesses in a local area.

The present invention provides incentives for all potential consumers to refer service providers, whom they personally have used, to a locally focused community for use by other consumers, and to add jobs they become aware of to the system network.

The system network of the present invention is the first referral system that is expandable globally, but focused locally.

The system network of the present invention empowers the consumer. The consumer is rewarded for sharing his information by adding jobs, which need to be serviced, to the system. The experiences of consumers are central to the system network and they are also rewarded for making these experiences available to other consumers in the form of reviews and referrals.

Affiliate service providers are encouraged to work together in the Local Economy since the rewards issued by one are redeemable by all. Every consumer in the system is asked to review the network affiliate on completion of a job. This is a condition of receiving their reward but the reward does not in any way depend on whether the review is good or bad. Once the review is completed, the system network will pay out the reward. Because writing and posting a review is required before issuing a consumer reward, reviews are always current and a large selection of reviews are available for each network affiliate. This ensures that the consumer always has a balanced view of the service provider.

Financial energy is retained within the network reward credits are redirected to the source that pays for advertisement which is the consumer in the present invention, and as such, makes the system network of the present invention more efficient than conventional advertising systems. In the system network of the present invention, marketing dollars are spent more efficiently and directed at the local business area which will eventually benefit the consumer, since advertising costs have to be recouped by the service provider in the marketplace.

In the system network of the present invention, there is no risk for the service provider in that they only pay the reward when they have been paid for a job. By referring service providers and adding jobs, consumers receive incentive rewards, which are redeemable by all service providers in the system and which service providers in turn, can redeem for cash through the system network of the present invention. In this way rewards are an incentive bridge from one service provider to another and, thus, create a more collaborative and cooperative marketing system to benefit all service providers in the system network.

The system network introduces a new way of efficiently focusing marketing dollars spent by providers (e.g., of goods and/or services) in a local area. The system network is the first referral platform that is expandable globally, but focused locally. It provides incentives for potential consumers to refer providers, whom they personally have used, to a locally focused community for use by other consumers, and to add jobs they become aware of to the system network.

By adding jobs and referring providers, consumers receive incentive CRGC credits which are redeemable by any affiliate provider and which the affiliates, in turn, can redeem for cash via the system network. In the preferred embodiments, financial gift card credits serve as an incentive bridge from one service provider to another and, thus, create a more collaborative and cooperative marketing platform that benefits service providers affiliated with the system network.

The system network includes two mutually dependent communities: (i) a community of providers whose services and goods have been used by, and who may be referred to the system network by, satisfied consumers; and (ii) a community of consumers who have used and referred the services of a provider and who may use such services in the future. Also, it understood that providers can also be consumers, and enjoy the benefits of this group on system network.

These and other objects will become apparent hereinafter and in the Claims to Invention.

### BRIEF DESCRIPTION OF THE DRAWINGS

The accompanying figures and/or appendices illustrate various exemplary embodiments in accordance with the present disclosure.

FIG. 1 is a schematic diagram illustrating a network architecture of the Internet-based affiliate-referral driven consumer transaction rewarding system network of the present invention;

FIG. 1A is a schematic representation illustrating the system architecture of the Internet-based affiliate-referral driven consumer transaction rewarding system network of the present invention;

FIG. 1B is a schematic representation illustrating the mechanism by which affiliate consumer reward gift card (CRGC) payment accounts maintained at the sponsoring financial institution are loaded with financial credit value from the affiliates' financial accounts maintained within computer system networks of affiliate financial institutions, by way of debit/credit card payment networks and/or ACH payment settlement system networks, whereas consumer reward gift card (CRGC) accounts maintained at the sponsoring financial institution are reloaded with credit value from the computer system network of a designated financial institution;

FIG. 1C is a schematic representation of the system architecture of an exemplary server system deployed on the system network of the present invention and supporting the many services offered by system network servers of the present invention;

FIG. 2 is a schematic representation of the system architecture of an exemplary mobile client system (e.g. device) that is deployed on the system network of the present invention and supporting the many services offered by system network servers of the present invention;

FIG. 3 is schematic representation providing a data schema for the object-oriented system-engineered (OOSE) software component of the system network of the present invention, executing on the client-server architecture specified in great detail throughout the present patent specification;

FIGS. 3A and 3B, taken together, provide a schematic representation of a set of object-oriented software modules, containing classes (written in an object-oriented programming language) supporting the system network of the present invention;

FIG. 4 is a schematic representation of POS-based client systems used by affiliates and consumers on the Internet-based affiliate-referral driven consumer transaction rewarding system network of the present invention;

FIG. 5 is a schematic illustration for the service architecture of the Internet-based affiliate-referral driven consumer transaction rewarding system network of the present invention;

FIG. 6A is a schematic representation illustrating some primary data structures maintained within the system database including the job listings structure, the affiliate directory structure with affiliate profiles, the consumer directory structure with consumer profiles and reviews, the job referrals structure, and the job referral pools structure supporting the system network of the present invention;

FIG. 6B is a schematic representation illustrating some more primary data structures maintained within the system database including (i) the my contacts structure and the my groups structure which are associated with the consumer directory structure, and (ii) the affiliate contacts structure and the affiliate group structure of FIG. 6A which are associated with the affiliate directory structure of FIG. 6A, all of which support the system network of the present invention

FIG. 7 is a schematic representation of the primary data structures supported within the system database, including affiliate directory structure, the jobs listing structure, the referral pools structure, the my contacts structure, the my groups structure, the affiliate contacts structure and the affiliate groups structure, illustrating the various data elements maintained within each such structure;

FIG. 8A is an exemplary consumer service map for the consumer—side of the system network of the present invention;

FIG. 8B is an exemplary affiliate service map for the affiliate—side of the system network of the present invention;

FIG. 9 is a schematic illustration describing exemplary dataflow paths for the system network of the present invention;

FIG. 10A is a flow chart describing some exemplary consumer-services supported on the system network;

FIG. 10B is a flow chart describing some exemplary consumer-services supported on the system network;

FIG. 11A is a table representation describing several ways in which a consumer may register with the system network of the present invention and open a consumer rewards gift card (CRGC) account therewith, for use by the consumer user on the system network;

FIG. 11B is a table representation describing several ways in which a consumer may search the affiliate directory with the system network of the present invention, for use by the consumer user on the system network;

FIG. 11C is a table representation describing different events when consumer rewards gift card credit is earned and issued over the system network;

FIG. 11D is a table representation describing different ways consumers can use available credit in their consumer rewards gift card (CRGC) accounts to pay for purchases from affiliates over the system network;

FIG. 11E is a table representation describing different ways how consumers can manage their consumer rewards gift card (CRGC) accounts on the system network of the present invention;

FIG. 12A is a table representation describing various affiliates services including (i) affiliates registering with the system network, (ii) affiliates managing their consumer reward payment accounts on the system network, (iii) affiliates managing their profile and points of access on the system network, and (iv) affiliates managing the referral pool on the system network;

FIG. 13A is a schematic representation illustrating a primary process supported on the system network of the present invention, wherein a consumer earns consumer reward gift card (CRGC) dollars as a reward for referring an affiliate who completes a job posted on the affiliate-referral driven consumer transaction rewarding system network of the present invention;

FIG. 13B is a schematic representation illustrating a primary process supported on the system network of the present invention, wherein a consumer uses consumer rewards gift card (CRGC) credit value to pay for a purchase transaction over the affiliate-referral driven consumer-transaction rewarding system network of the present invention;

FIG. 14 is a schematic representation illustrating the recycling of consumer rewards gift card (CRGC) credit value (“financial energy”) between consumer reward gift card (CRGC) payment accounts held by affiliates and consumer reward gift card (CRGC) accounts held by consumers and external financial institutions of the consumers, within the system network of the present invention;

FIG. 15 is a schematic representation of the job-affiliate referral pools structure employed within the affiliate-referral driven consumer-transaction rewarding system network of the present invention;

FIG. 16 is a schematic representation of apparatus for managing job-affiliate referrals records in the affiliate-referral driven consumer-transaction rewarding system network of the present invention;

FIG. 17 is a flow chart describing the primary steps carried out the method of registering a consumer on the system network of the present invention, involving assigning of a consumer reward gift card (CRGC) account to the registered consumer for use on the system network;

FIG. 18 is table setting forth descriptions of primary workflow locations where consumers can search for affiliates listed in the affiliate directory;

FIG. 18A is a graphical user interface (GUI) screen generated by the login module of the system network and displayed on the display screen of a mobile client system on the system network of the present invention;

FIG. 18B is a graphical user interface (GUI) screen generated by the registration module of the system network and displayed on the display screen of a mobile client system;

FIG. 18C is a graphical user interface (GUI) displayed on the display screen of a mobile client system on the system network, and generated by the login module of the system network;

FIG. 19 is a graphical user interface (GUI) displayed on the display screen of a mobile client system on the system network, and generated by the home module of the system network;

FIG. 20 is a schematic representation of a use case model illustrating a consumer accessing the affiliate directory of the system network, and using the services supported thereby including the search module, the favorites module, and messaging module;

FIG. 21 is schematic representation of a multi-layer service model for delivering affiliate and other directory services, supported on the system network of the present invention;

FIG. 22A is a graphical user interface (GUI) screen generated by the search module of the system network and displayed on the display screen of a mobile client system on the system network, wherein interface objects are displayed for both the affiliate directory and the consumer directory, for access by registered consumers when using the system network of the present invention;

FIG. 22B is a graphical user interface (GUI) screen generated by the search module of the system network and displayed on the display screen of a mobile client system on the system network, wherein interface objects are displayed for service categories such as, for example, but not limited to home services, hair & beauty, gardening, pets, restaurants & dining, automotive, travel, medical and financial;

FIG. 22C is a graphical user interface (GUI) screen generated by the search module of the system network and displayed on the display screen of a mobile client system on the system network, wherein the displayed GUI screen indicates that the consumer selected the interface object for home services, and navigated through display screens to display the interface for “tree services” for a specific area code, where subcategories are displayed, specifically, cabling, fertilizing, pest control, stump grinding, and tree removal;

FIG. 22D is a graphical user interface (GUI) screen generated by the search module of the system network and displayed on the display screen of a mobile client system on the system network, wherein the consumer selects the interface object for a specific service (i.e. subcategory), the system network automatically accesses the system database and serves and displays to the consumer, a predetermined number (e.g. three) service providers (e.g. affiliates) for the selected service in the specified area code, and wherein, the customer can elect to “refer a job” to one, more or all of the listed service providers;

FIG. 22E is a graphical user interface (GUI) screen generated by the search module of the system network and displayed on the display screen of a mobile client system on the system network, wherein the displayed GUI displays the vendor/service provider profile detail screen, and the consumer has the option of adding the service provider to the consumer's favorites list;

FIG. 22F is a graphical user interface (GUI) screen generated by the search module of the system network and displayed on the display screen of a mobile client system on the system network, wherein the displayed GUI screen displays the “add a job” and “refer job to” display screen, in response to the consumer selecting the interface object for “add a job” shown in FIG. 22D;

FIG. 22G is a graphical user interface (GUI) screen generated by the search module of the system network and displayed on the display screen of a mobile client system on the system network, wherein the displayed GUI screen presents a message confirming that the consumer user that added job has been referred to the three selected service providers (e.g. Celtic Tree Service, Mike's Trees and Declan's Trees), and advising the consumer user that they will receive a message about this referral, and that if one of these referred network affiliates is hired for this specific job, then they will receive a predetermined amount of consumer reward gift card (CRGC) credit value paid by the affiliate who has completed the performance of the referred job;

FIG. 22G-1 is a graphical user interface (GUI) screen generated by the search module of the system network and displayed on the display screen of a mobile client system on the system network, where in response to selecting the “Post” interface object in FIG. 22G, the displayed GUI screen presents a set of enabled social channels of the referring consumer, as shown, to which the job referral event will be sent upon (i) selecting desired social networks and (ii) then selecting the “post” interface object displayed on the lower portion of the GUI display screen;

FIG. 22H is a graphical user interface (GUI) screen generated by the search module of the system network and displayed on the display screen of a mobile client system associated with the consumer whose a job has been referred to affiliates selected by the referring consumer using the display screen shown in FIG. 22F, wherein the displayed GUI screen presents a message to the consumer informing that a consumer reward gift card credit will be issued to the consumer in the event that a consumer viewing the referral in the affiliate directory listing hires the affiliate who completes the job;

FIG. 22I is a graphical user interface (GUI) screen generated by the search module (and supporting modules) of the system network, and displayed on the display screen of a mobile client system associated with each affiliate who has received a job referral by a referring consumer (using the display screen shown in FIG. 22F), wherein the displayed GUI screen presents a message to the consumer informing that the affiliate has been referred the job and is being considered therefor, and that a message has been sent to the consumer requesting job performance, with a link to the affiliate's profile and past job reviews by consumers who have used the affiliate on their jobs in the specified category;

FIG. 22J is a graphical user interface (GUI) screen generated by the search module of the system network and displayed on the display screen of a mobile client system on the system network, where in response to the consumer user selecting the corresponding interface object in the GUI display screen shown in FIG. 22B, the restaurant category screen is displayed and the consumer enters the town “Westport” and selects “Ethnic”;

FIG. 22K is a graphical user interface (GUI) screen generated by the search module of the system network and displayed on the display screen of a mobile client system on the system network, wherein “Irish” subcategory screen is selected;

FIG. 22L is a graphical user interface (GUI) screen generated by the search module of the system network and displayed on the display screen of a mobile client system on the system network, wherein the system network displays three restaurants to the consumer located in the chosen town for the chosen “ethnic/restaurant” category, and where the “view details” interface objects are displayed near each restaurant selection so that the consumer can easily view the affiliate profile for each restaurant selection;

FIG. 22M is a graphical user interface (GUI) screen generated by the search module of the system network and displayed on the display screen of a mobile client system on the system network, wherein the system network displays the affiliate profile for the restaurant “Murphy's Restaurant” selected from the display screen shown in FIG. 22L, and wherein (i) “add to favorites” interface object is provided at the top of the affiliate profile screen, (ii) an embedded video player for watching a video advertisement on Murphy's restaurant is located in the middle of the display screen, and (iii) Google maps directions interface object is provided at the bottom of the display screen;

FIG. 22M-1 is a graphical user interface (GUI) screen generated by the search module of the system network and displayed on the display screen of a mobile client system on the system network, wherein the system network displays the affiliate profile for the restaurant “Murphy's Restaurant” selected from the display screen shown in FIG. 22L, and wherein the GUI-based keyboard is displayed for character data entry into the messaging screen supported by the messaging module of the system network;

FIG. 23 is a graphical user interface (GUI) screen generated by the search module of the system network and displayed on the display screen of a mobile client system on the system network, wherein interface objects are displayed for both the affiliate directory and the consumer directory, for access by registered consumers when using the system network of the present invention, and wherein the consumer selects the “consumer directory” interface object to generate the GUI screen shown in FIG. 23-1;

FIG. 23-1 is a graphical user interface (GUI) screen generated by the search module and consumer directory module of the system network and displayed on the display screen of a mobile client system on the system network, wherein when the consumer user selects the consumer directory interface object from the GUI screen shown in FIG. 22A, the system network displays the interface objects for the following (i) update my system network profile, (ii) post to my social networks, (iii) post to my employment network, and (iv) post my personal networks;

FIG. 23A is a graphical user interface (GUI) screen generated by the search module and consumer directory module of the system network and displayed on the display screen of a mobile client system on the system network, wherein when the consumer user selects the update my system network profile interface object from the GUI screen shown in FIG. 23, the system network displays the interface objects for updating the user's consumer profile on the system network;

FIG. 23B is a graphical user interface (GUI) screen generated by the search module and consumer directory module of the system network and displayed on the display screen of a mobile client system on the system network, wherein when the consumer user selects the post my social networks object from the GUI screen shown in FIG. 22A, the system network displays the interface objects for configuring and authenticating the consumer social networks for the posting of messages and others events generated on the system network of the present invention;

FIG. 23B-1 and FIG. 23B-2 are graphical user interface (GUI) screens generated by the search module and the consumer directory module of the system network and displayed on the display screen of a mobile client system on the system network, wherein when the consumer user selects the post to my social networks interface object from the GUI screen shown in FIG. 23, the system network displays the interface objects for updating the user's configuration and authentication settings for his or her social networks (e.g. Facebook, Google+, Vine, Twitter, Pinterest, Meetup, Instagram, Tumblr, and LinkedIn, etc.) registered on the system network;

FIG. 23C is a graphical user interface (GUI) screen generated by the search module of the system network and displayed on the display screen of a mobile client system on the system network, wherein when the consumer/user selects the post to my employment networks interface object from the GUI screen shown in FIG. 23, the system network displays the interface objects for updating the user's configuration and authentication settings for his or her employment networks (e.g. monster.com, indeed.com, careerbuilder.com, etc.) registered on the system network;

FIG. 23D is a graphical user interface (GUI) displayed on the display screen of a mobile client system on the system network, and generated by the search module and consumer directory module of the system network, when the consumer user selects the post to my personal networks interface object from the GUI screen shown in FIG. 23, wherein the system network displays the interface objects for updating the user's configuration and authentication settings for his or her personal networks (e.g. match.com, eharmony.com, chemistry.com, okcupid.com, perfectmatch, zoosk.com, etc.) registered on the system network;

FIGS. 23E and 23F is a series of graphical user interfaces (GUI) screen generated by the search module and the consumer directory module of the system network and displayed on the display screen of a mobile client system on the system network, as shown in FIG. 23, wherein when the consumer user selects the my contacts interface object from the GUI screen shown in FIG. 23, and the system network displays in FIG. 23F, the interface objects for a number of contact related functions supported by the system network;

FIG. 23G is a graphical user interface (GUI) screen generated by the search module and the consumer directory module of the system network and displayed on the display screen of a mobile client system on the system network, wherein when the consumer user selects the synch my contacts interface object from the GUI screen shown in FIG. 23G, and the system network displays the GUI screen shown in FIG. 23G allowing the consumer to update contact synchronization settings;

FIG. 23H is a graphical user interface (GUI) screen generated by the search module and the consumer directory module of the system network and displayed on the display screen of a mobile client system on the system network, wherein when the consumer user selects the find affiliates from my contacts interface object from the GUI screen shown in FIG. 23H, and the system network displays the GUI screen shown in FIG. 23H presenting an list of automatically retrieved and presented affiliates who are listed in a job category and have been used by the consumer, or one or more of the consumer's personal contacts, determined using the programmed data processing apparatus and logic illustrated in FIGS. 6A, 6B, and 16;

FIG. 23I is a graphical user interface (GUI) screen generated by the search module and the consumer directory module of the system network and displayed on the display screen of a mobile client system on the system network, wherein when the consumer user selects the find jobs from my contacts interface object from the GUI screen shown in FIG. 23HI, and the system network displays the GUI screen shown in FIG. 23I presenting an list of automatically retrieved and presented jobs which have been served by affiliates for the consumer performing the search, or consumers who are listed in the consumer's contacts, determined using the programmed data processing apparatus and logic illustrated in FIGS. 6A, 6B, and 16;

FIG. 23J is a graphical user interface (GUI) shown in FIG. 23, wherein the consumer user selects the my groups interface object from the GUI screen shown to automatically display the GUI screen shown in FIG. 23K, presenting interface objects for (i) searching my groups, (ii) join a (consumer-based) group (e.g. DYI enthusiasts group, gardeners group, etc), (iii) finding affiliates from my groups, and (iv) finding jobs from my groups;

FIG. 23K is a graphical user interface (GUI) screen generated by the search module and the consumer directory module of the system network and displayed on the display screen of a mobile client system on the system network, wherein when the consumer user selects the search my groups interface object from the GUI screen shown in FIG. 23K, and the system network displays the GUI screen shown in FIG. 23K presenting the names of all of the consumer groups which the consumer has joined, and the dates of joining the same;

FIG. 23L is a graphical user interface (GUI) screen generated by the search module and the consumer directory module of the system network and displayed on the display screen of a mobile client system on the system network, wherein when the consumer user selects join a group interface object from the GUI screen shown in FIG. 23K, and the system network displays the GUI screen shown in FIG. 23L presenting the names of all of the consumer groups which the consumer (i) can join by simply checking the group and then selecting join the checked group interface object, and likewise, (ii) can un-join by simply un-checking the group and then then-join group interface object;

FIG. 23M is a graphical user interface (GUI) screen generated by the search module and the consumer directory module of the system network and displayed on the display screen of a mobile client system on the system network, wherein when the consumer user selects the find affiliates from interface object from the GUI screen shown in FIG. 23M, and the system network displays the GUI screen shown in FIG. 23M presenting the names of all affiliates who are listed in a job category and have been used by the consumer or one or more of the consumer's contacts, determined using the programmed data processing apparatus and logic illustrated in FIGS. 6A, 6B, and 16;

FIG. 23N is a graphical user interface (GUI) screen generated by the search module and the consumer directory module of the system network and displayed on the display screen of a mobile client system on the system network, wherein when the consumer user selects the find jobs from interface object from the GUI screen shown in FIG. 23M, and the system network displays the GUI screen shown in FIG. 23M presenting the names of all jobs which have been served by affiliates for the consumer during the search, or consumers who are listed in the consumer's contacts, determined using the programmed data processing apparatus and logic illustrated in FIGS. 6A, 6B, and 16;

FIG. 24A is a graphical user interface (GUI) screen generated by the search module of the system network and displayed on the display screen of a mobile client system on the system network, wherein the displayed GUI screen shows the display screen of FIG. 23, and illustrating that such a client system, running a native or mobile client web client application, can be used to access and search the affiliate directory supported on the system network of the present invention;

FIG. 24B is a schematic representation of a desktop-size or tablet-size GUI screen, wherein a wide suite of consumer and affiliate services can be accessed and delivered over the system network, from a web-based GUI-generating widget embedded in a web page on the WWW being browsed by a client system, whereby upon selecting the server-side or client-side widget (e.g. Applet), the user is provided a GUI interface to system network configured to display and access (i) the profile of a specific affiliate, (ii) conduct a search on the affiliate directory, and/or (iii) access and use (i.e. the Add Jobs And Refer Jobs To Affiliates functions) using the Referral Pools facility of the system network of the present invention;

FIG. 25 is a schematic representation illustrating that a wide suite of consumer and affiliate services can be accessed and delivered over the system network of the present invention by scanning a URL-encoded QRS code symbol using a mobile smartphone client running a native or mobile client application, establishing a network connection and session with servers on the system network;

FIG. 26 is a schematic representation illustrating a primary process supported on the system network of the present invention, wherein a consumer earns consumer reward gift card (CRGC) dollars as a reward for referring an affiliate who completes a job posted on the affiliate-referral driven consumer transaction rewarding system network of the present invention;

FIG. 27A is a graphical user interface (GUI) screen generated by the my favorites module of the system network and displayed on the display screen of a mobile client system on the system network, wherein the displayed GUI screen shows the my favorites list of the consumer user comprising a list of service providers and/or merchants and vendors who have been added from the search module by selecting the “add favorites” interface object, and where the consumer can refer a job to any of the listed affiliates by selecting the “refer a job to” interface object (i.e. button) which has been selected for “Celtic Tree Service” in the example shown in FIG. 27A;

FIG. 27B is a graphical user interface (GUI) screen generated by the my favorites module of the system network and displayed on the display screen of a mobile client system on the system network, wherein the displayed GUI screen the vendor/affiliate details screen for the Celtic Tree Service, and wherein the read reviews interface object is shown an available for selection to display the reviews of the affiliate by its past customers, and the integrating messaging module is shown for use by the consumer to send messages to affiliates, using a virtual keyboard supported by an interface object for entry of message information content;

FIG. 27C is a graphical user interface (GUI) screen generated by the my favorites module of the system network and displayed on the display screen of a mobile client system on the system network, presents a message in response to the message sent from the GUI screen shown in FIG. 27B, confirming that the consumer's message to the affiliate service provider has been transmitted through the system network to the destination affiliate;

FIG. 27D is a graphical user interface (GUI) screen generated by the my favorites module of the system network and displayed on the display screen of a mobile client system on the system network associated with a consumer, wherein the displayed GUI screen presents the “add a job” and “refer job to” interface objects display screen, in response to the consumer selecting the interface object for “add a job” shown in FIG. 27A;

FIG. 27E is a graphical user interface (GUI) screen generated by the my favorites module of the system network and displayed on the display screen of a mobile client system on the system network associated with the consumer whose job needs to be performed, wherein the displayed GUI screen presents a message in response to the operations performed using the GUI screen shown in FIG. 27D, confirming that “Add A Job” and “Refer A Job” events have occurred using the GUI screen shown in FIG. 27D, and containing details regarding the job referral made using the Referral Pools feature and functionality supported on the system network of the present invention;

FIG. 27F is a graphical user interface (GUI) screen generated by the messaging module of the system network and displayed on the display screen of a mobile client system on the system network associated with the affiliate who has received the job referral, wherein the displayed GUI screen presents a message in response to the operations performed using the GUI screen shown in FIG. 27D, confirming with the affiliate that (i) the affiliate (e.g. Celtic Tree Service) has been referred to a consumer for a specific job (e.g. Job No. 256—Clean Up After Storm—Tree Services) and (ii) that the consumer, who is seeking to have its job performed, has received a link to the referred affiliate profile and reviews and is now being considered for the specified job by the consumer;

FIG. 27G is a graphical user interface (GUI) screen generated by the my messages module of the system network and displayed on the display screen of a mobile client system on the system network associated with the consumer whose job has been referred to one or more affiliate service providers, wherein the displayed GUI screen presents a message in response to the operations performed using the GUI screen shown in FIG. 27D, confirming with the consumer that (i) the consumer's job has been referred to a particular affiliate service provider (e.g. Celtic Tree Service) and (ii) the consumer can consider the reviews and profile of the referred affiliate at the link (URL) provided in the message body;

FIG. 27H is a graphical user interface (GUI) screen generated by the my messages module of the system network and displayed on the display screen of a mobile client system on the system network associated with the consumer whose job has been completed an affiliate service provider, wherein the displayed GUI screen presents a message confirming with the consumer that (i) the consumer's job has been completed by a particular affiliate service provider (e.g. Celtic Tree Service) and (ii) after the consumer writes and posts a review on the affiliate who completed the job, the consumer and job referrer will be paid consumer reward gift card (CRGC) credit from the CRGC Payment Account of the affiliate service provider/merchant who completed the job;

FIG. 27I is a graphical user interface (GUI) screen generated by the my reviews module of the system network and displayed on the display screen of a mobile client system on the system network associated with the consumer whose job has been completed an affiliate service provider, and wherein the displayed GUI screen shows the review which the consumer wrote for the affiliate who completed the consumer's job, and it is ready for submission to the system database upon selection of the “submit” interface object (i.e. button);

FIG. 28 is a schematic representation of a use case model illustrating a consumer accessing the jobs directory of the system network illustrated in FIGS. 6A and 6B, and using the services supported thereby;

FIG. 29 is schematic representation of a multi-layer service model for delivering job listing services, supported on the system network of the present invention;

FIG. 30 is a schematic representation of the job-affiliate referral pools structure employed within the affiliate-referral driven consumer-transaction rewarding system network of the present invention;

FIG. 31 is a schematic representation of apparatus for managing job-affiliate referrals records in the affiliate-referral driven consumer-transaction rewarding system network of the present invention;

FIG. 32A is a graphical user interface (GUI) screen generated by the referral pools module of the system network and displayed on the display screen of a mobile client system on the system network associated with a consumer searching for an affiliate referral within the Referral Pools structure, wherein the displayed GUI screen presents the consumer with several options, namely, (i) adding a job to the job listings maintained by the system network, (ii) review the jobs that have been added by the consumer (i.e. jobs added by me), (iii) refer jobs to a particular affiliate service provider based on the consumer's past experiences therewith, and (iv) review jobs that have been referred by the consumer (i.e. jobs referred by me);

FIGS. 32B and 32C is series of graphical user interface (GUI) screens generated by the referral pools module of the system network and displayed on the display screen of a mobile client system on the system network associated with a consumer searching for an affiliate referral within the Referral Pools structure, where, in response to selecting the “add a job” interface object in the GUI screen of FIG. 32B, the displayed GUI screen states that the consumer would like to “add a job”, and also either (A) Refer My Job To An Affiliate In This Job Category Who Has Been Used By One Of My Personal Contacts; If No Result, Then Search The Contacts Of My Personal Contacts, (B) Allow The Job To Be Seen Only By The Groups I Choose In Next Screen, or (C) Allow The Job To Be Seen By Anyone Who Has Used An Affiliate Listed In The Job Category Of The Job, which are effectively data filters that operate on the job-affiliate data records associated with the Referral Pools structure schematically represented in FIGS. 15 and 16, and supported within the system RDBMS illustrated in FIGS. 6A and 6B;

FIGS. 32D-1 and 32D-2 is a series of graphical user interface (GUI) screens generated by the referral pools module of the system network and displayed on the display screen of a mobile client system on the system network associated with a consumer, where in FIG. 32D-1 the user selects Option A (data filter) from the GUI screen of FIG. 32C;

FIG. 32D-3 is a graphical user interface (GUI) screen generated by the referral pools module of the system network and displayed on the display screen of a mobile client system on the system network associated with a consumer, where upon selecting the continue interface object in FIG. 32D-2, the client system displays a GUI screen presenting an “add a job” interface object, wherein the system network automatically generates a job number for each new job (e.g. Job No. 502 being assigned for the exemplary system user);

FIG. 32E is a graphical user interface (GUI) screen generated by the referral pools module of the system network and displayed on the display screen of a mobile client system on the system network associated with the a consumer whose jobs need to be performed, wherein the displayed “Refer A Job” GUI displays the search results which comprises all of the affiliates listed in the affiliate directory structure of FIGS. 6A and 6B who satisfy the A-type search criteria;

FIG. 32F is a graphical user interface (GUI) screen generated by the affiliate's messaging module on the system network and displayed on the display screen of a mobile client system on the system network associated with the affiliate who has been referred a particular job on the system network, wherein the displayed GUI presents a message confirming that the affiliate has been referred a particular job, and that the referring consumer is reviewing the affiliate's profile and job reviews;

FIG. 32G is a graphical user interface (GUI) screen generated by the my messages module on the system network and displayed on the display screen of a mobile client system on the system network associated with the consumer who has a particular job to be performed by a registered service provider affiliate with the system network, wherein the displayed GUI presents a message confirming that the consumer's job has been referred to a particular affiliate service provider and providing a link or URL to the affiliate's profile;

32H is a graphical user interface (GUI) screen generated by the my messages module of the system network and displayed on the display screen of a mobile client system on the system network associated with the consumer whose job has been completed by an affiliate service provider, wherein the displayed GUI screen presents a message confirming with the consumer that (i) the consumer's job has been completed by a particular affiliate service provider (e.g. Celtic Tree Service), (ii) a particular amount paid, and (iii) after the consumer writes and posts a review on the affiliate who completed the job, the consumer and job referrer will be paid a consumer reward gift card (CRGC) credit from the CRGC Payment Account of the affiliate service provider/merchant who completed the referred job;

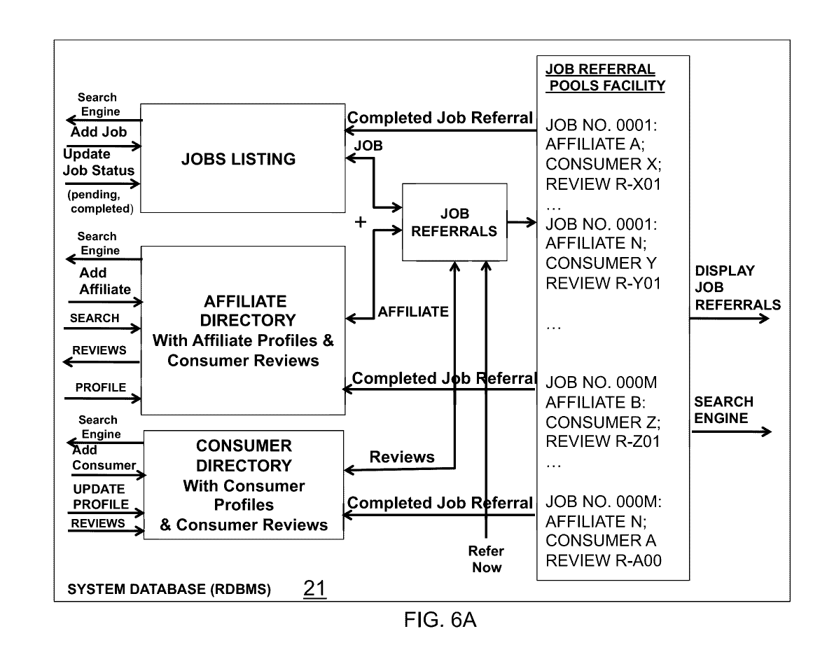

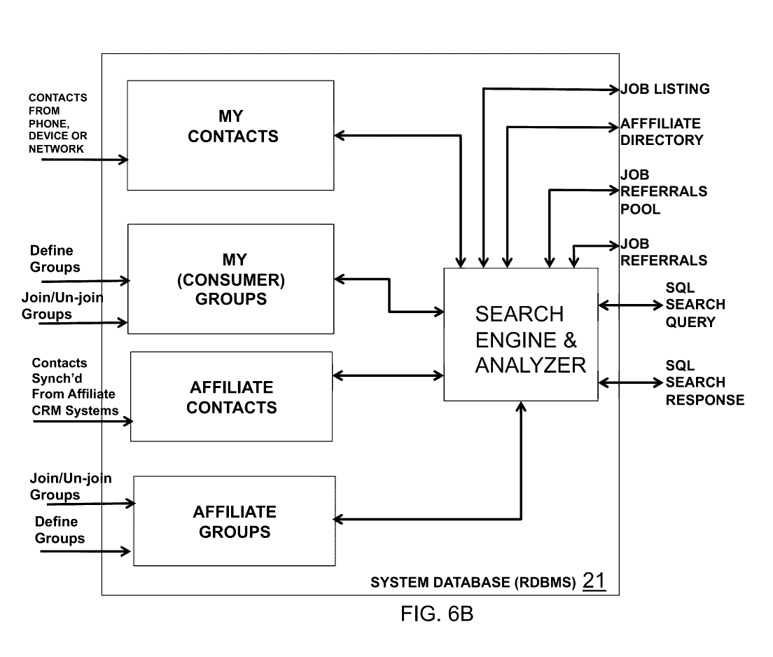

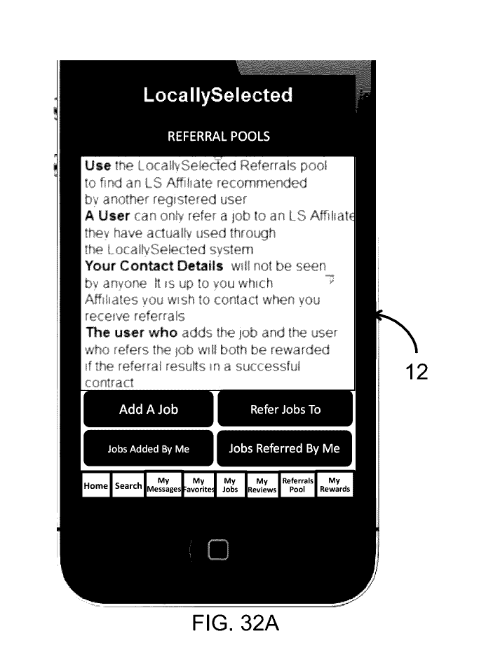

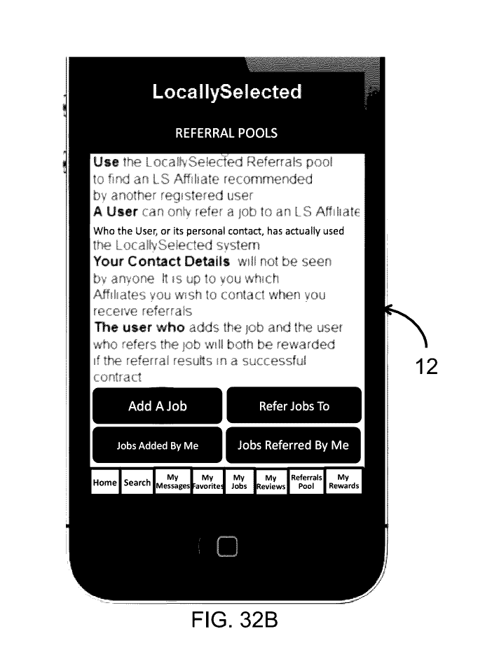

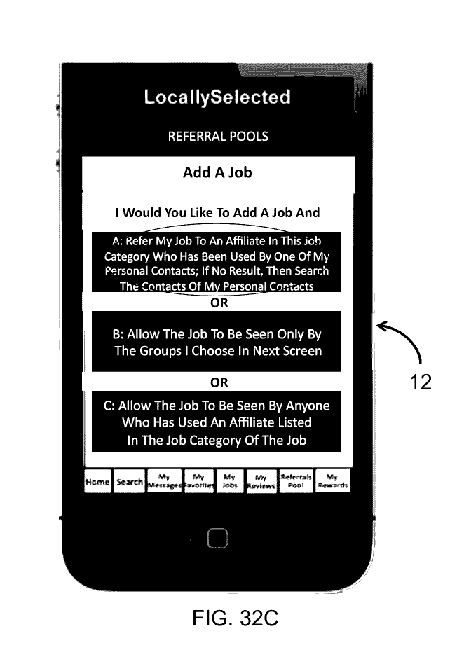

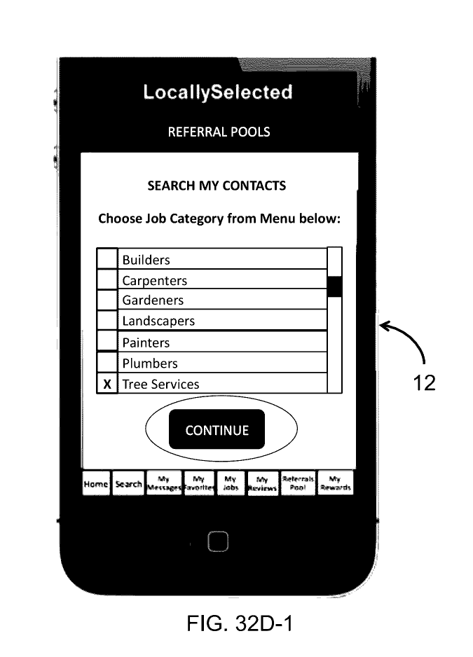

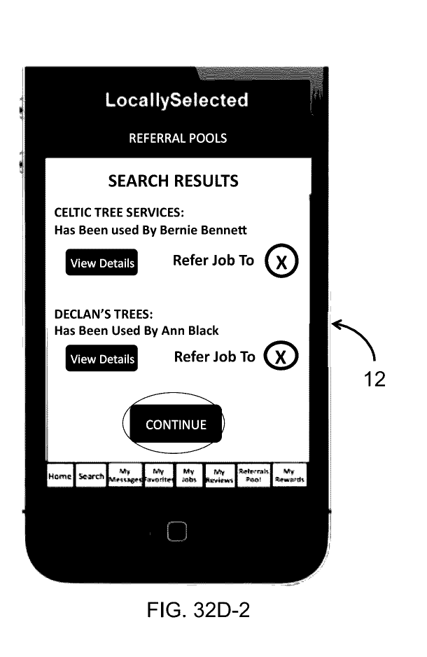

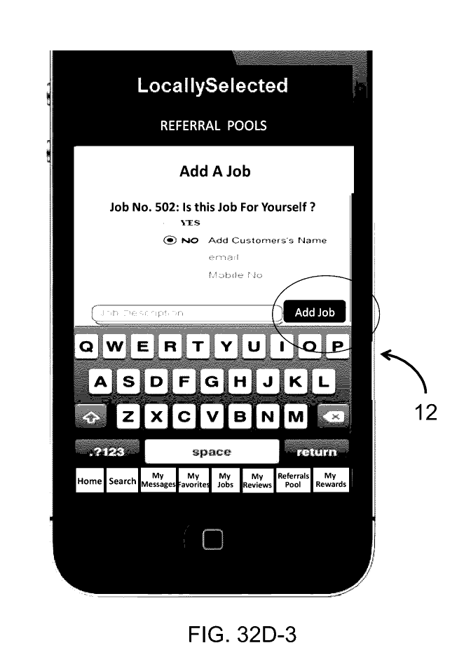

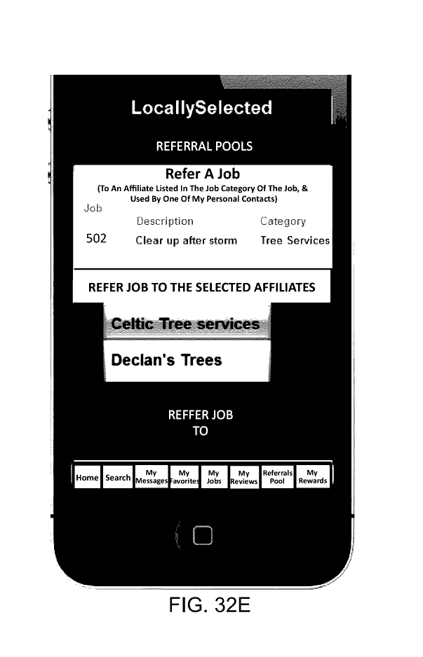

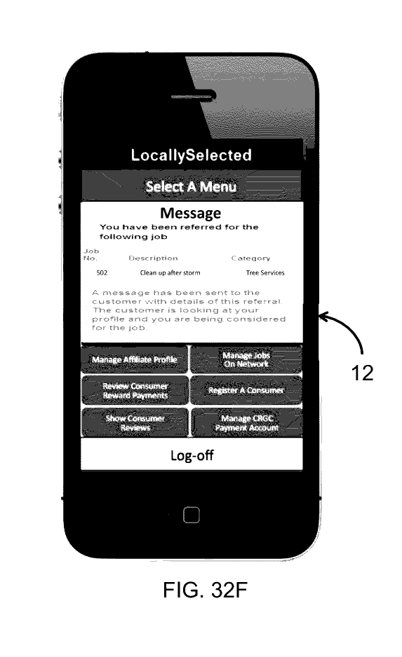

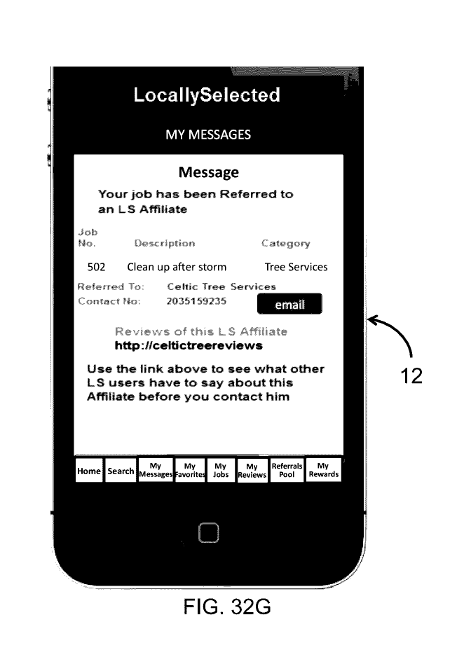

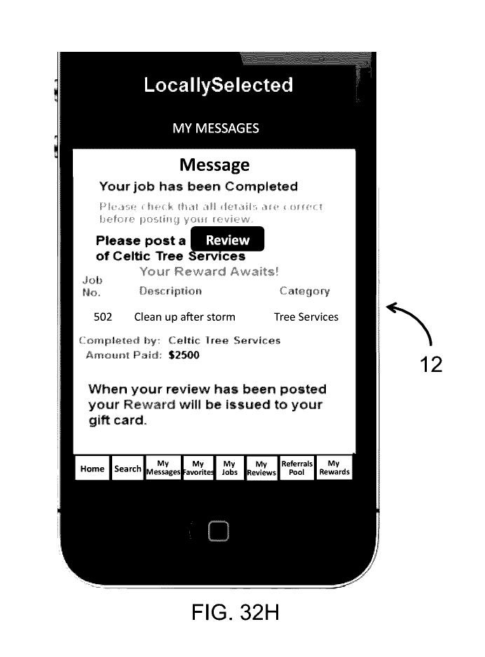

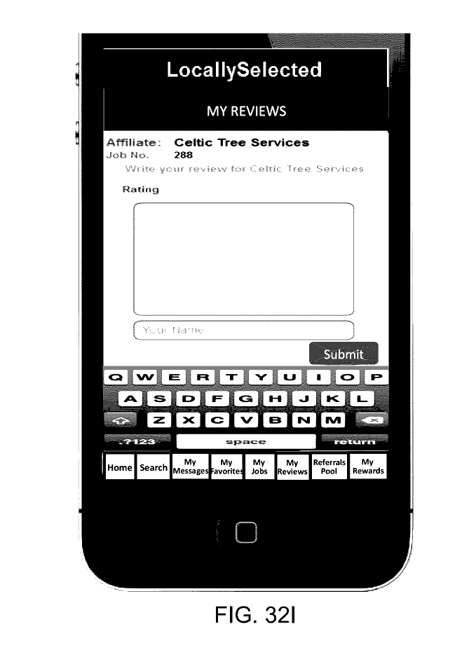

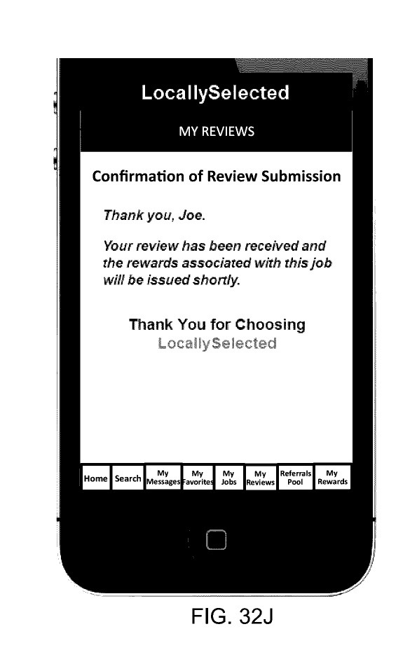

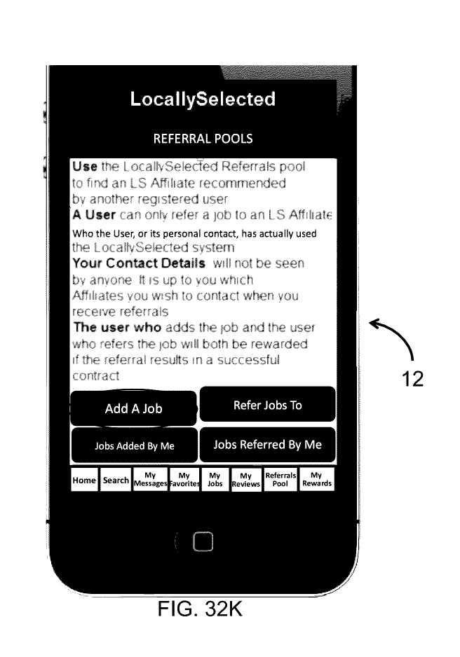

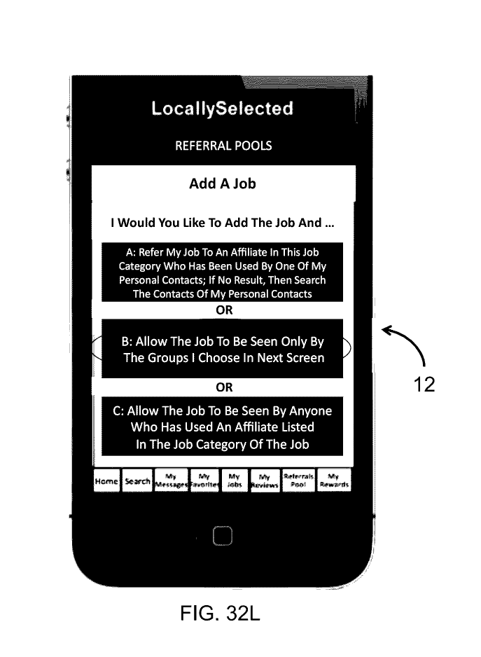

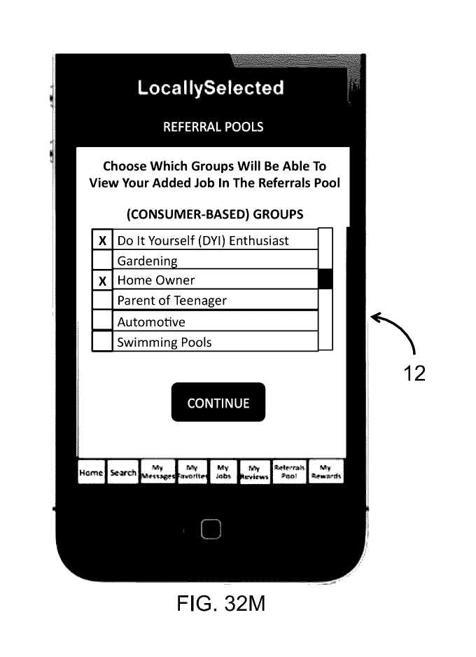

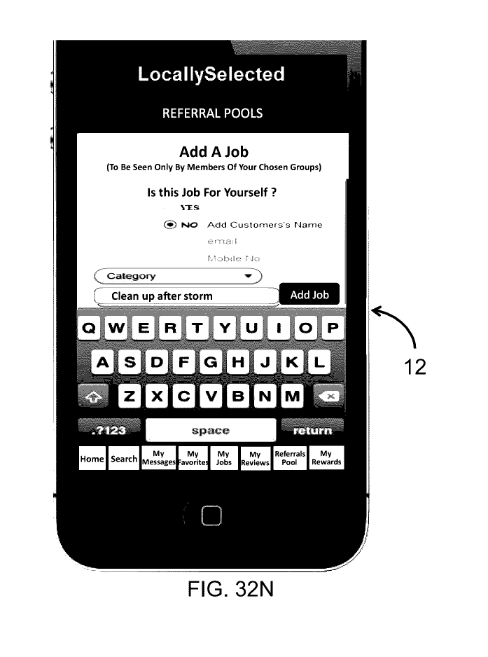

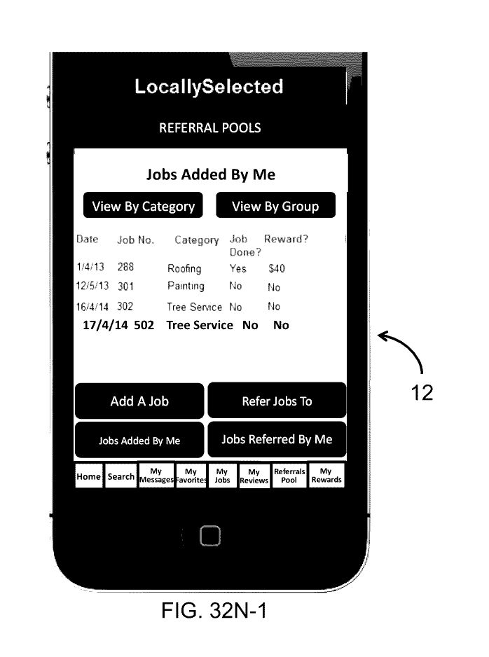

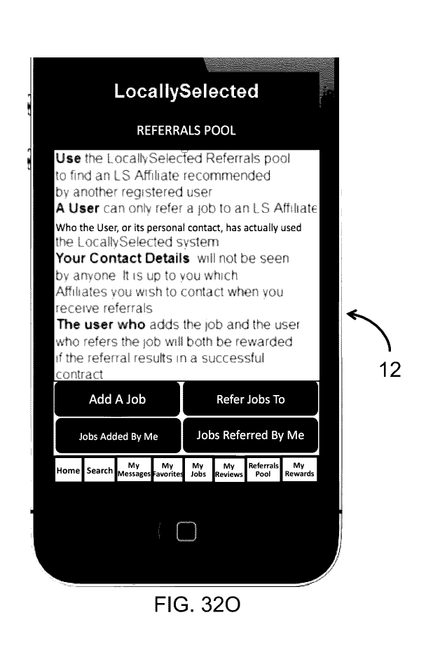

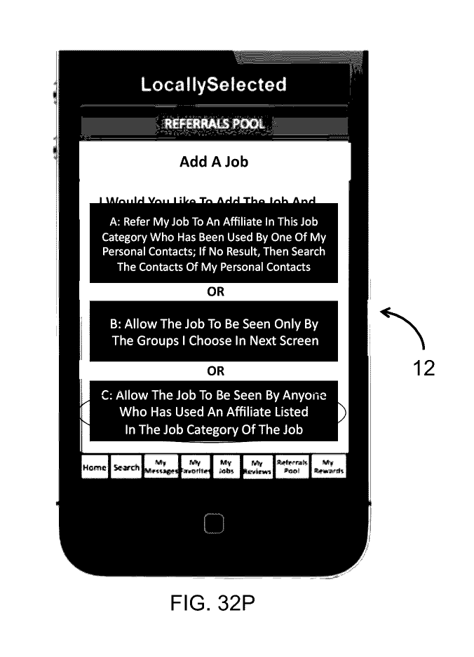

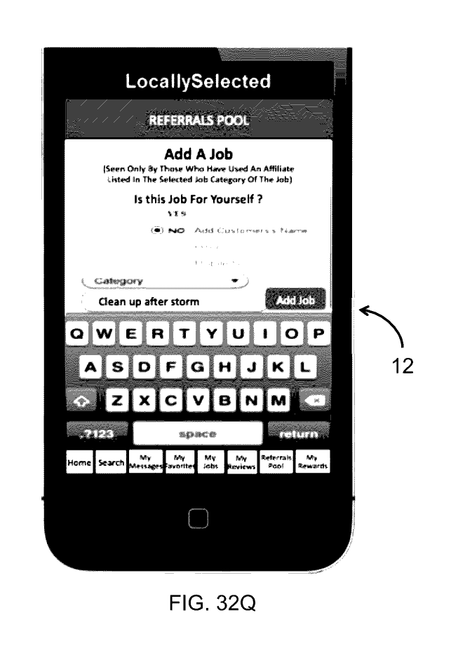

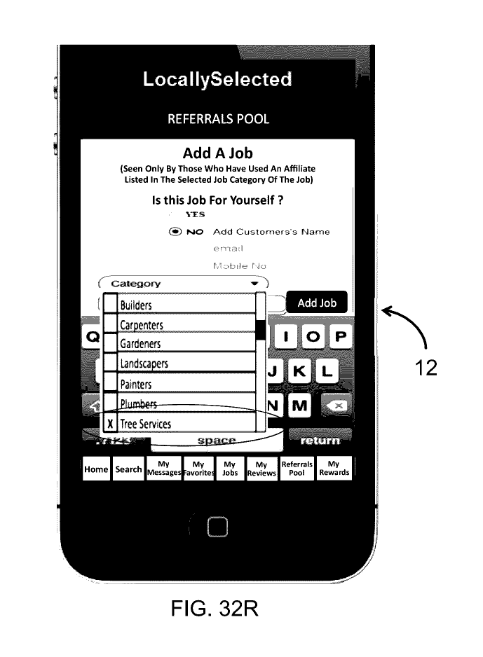

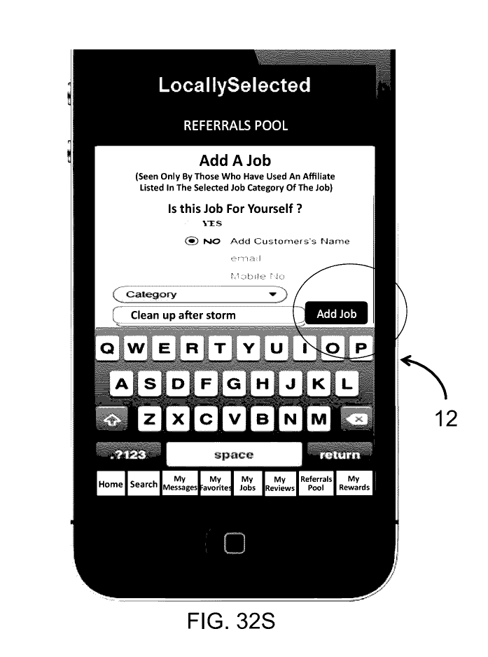

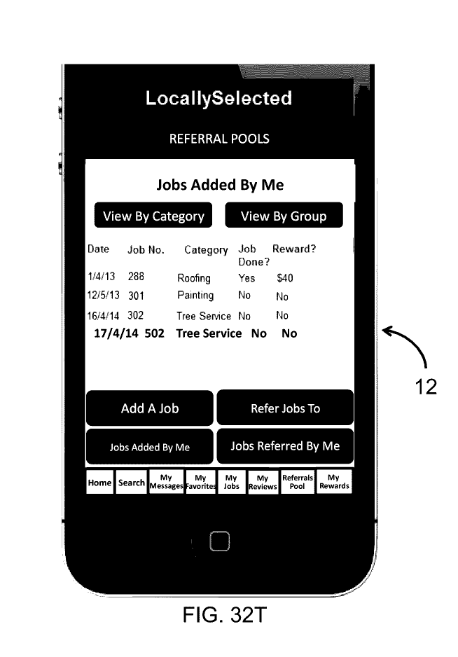

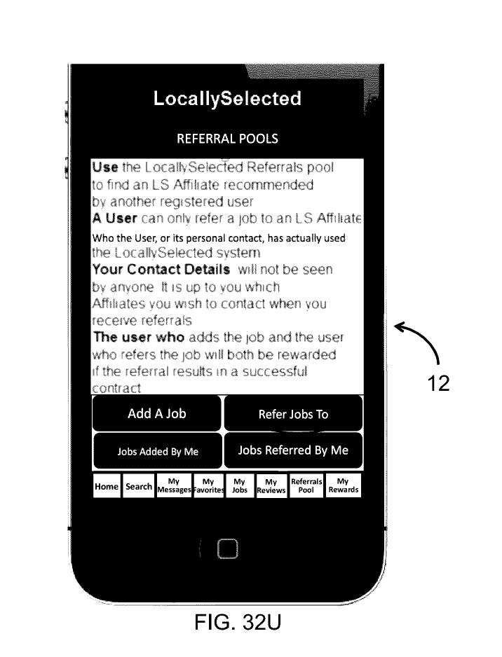

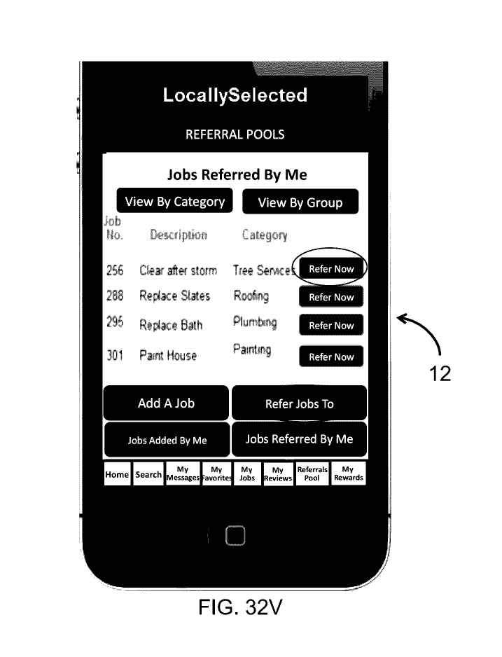

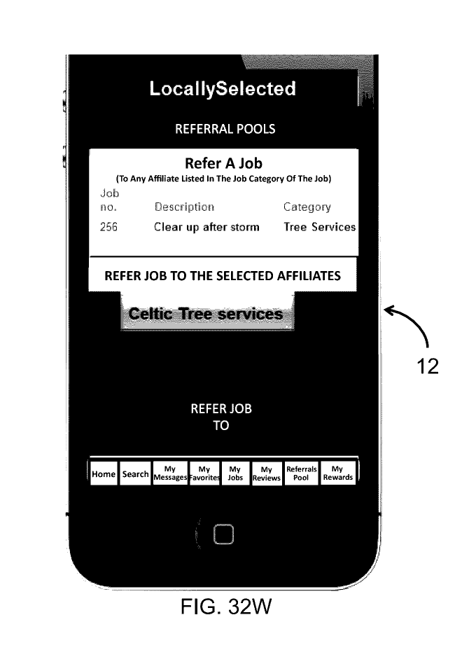

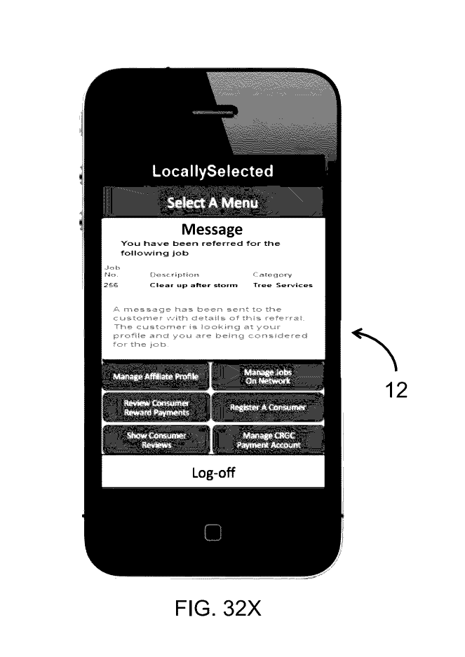

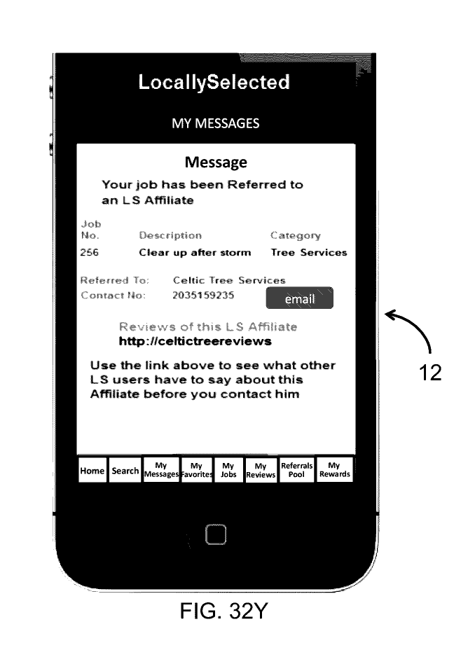

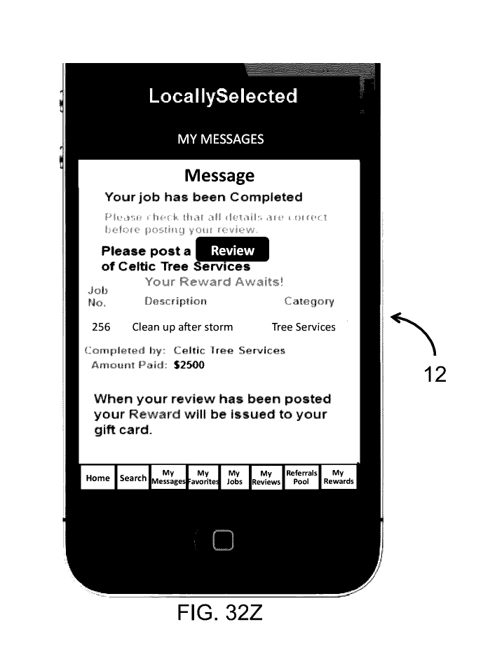

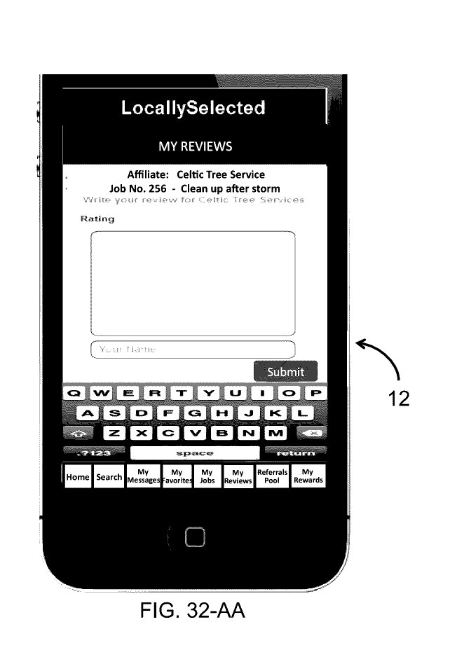

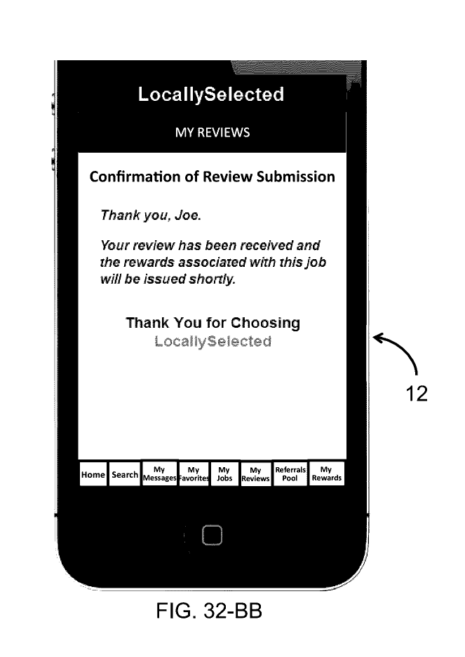

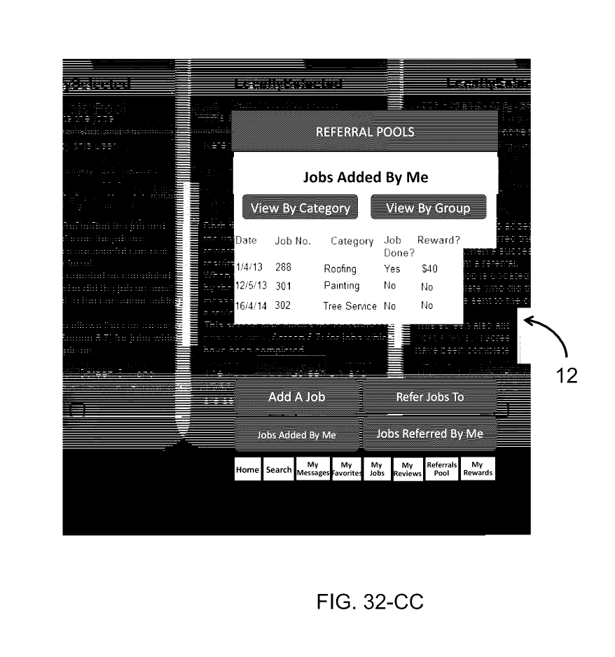

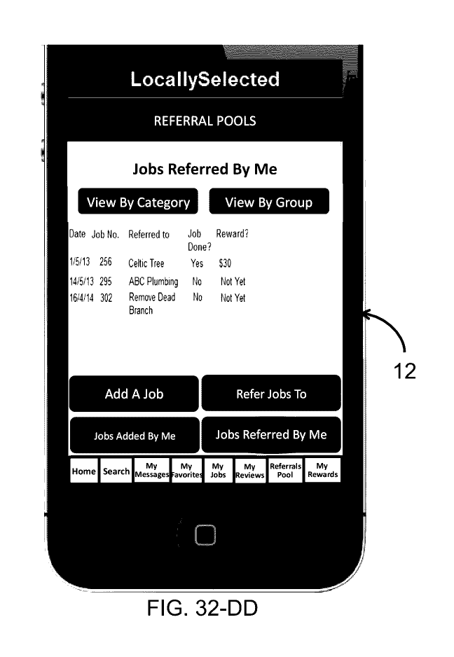

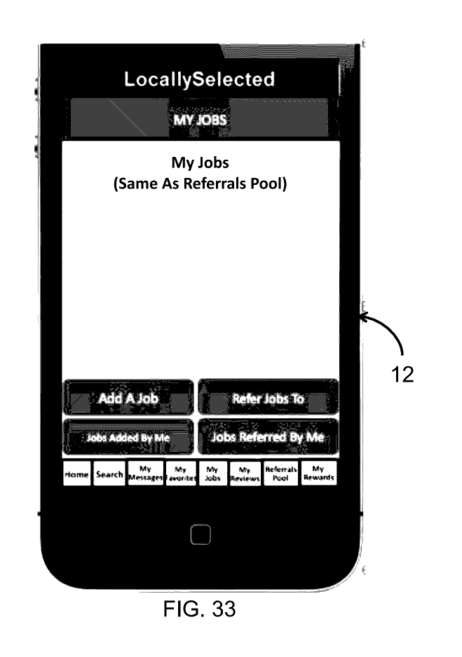

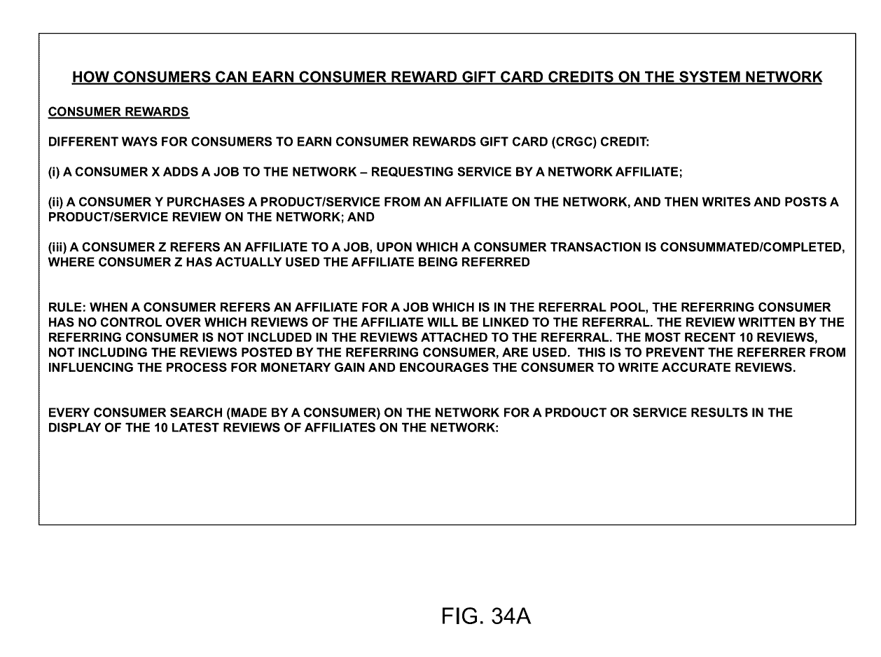

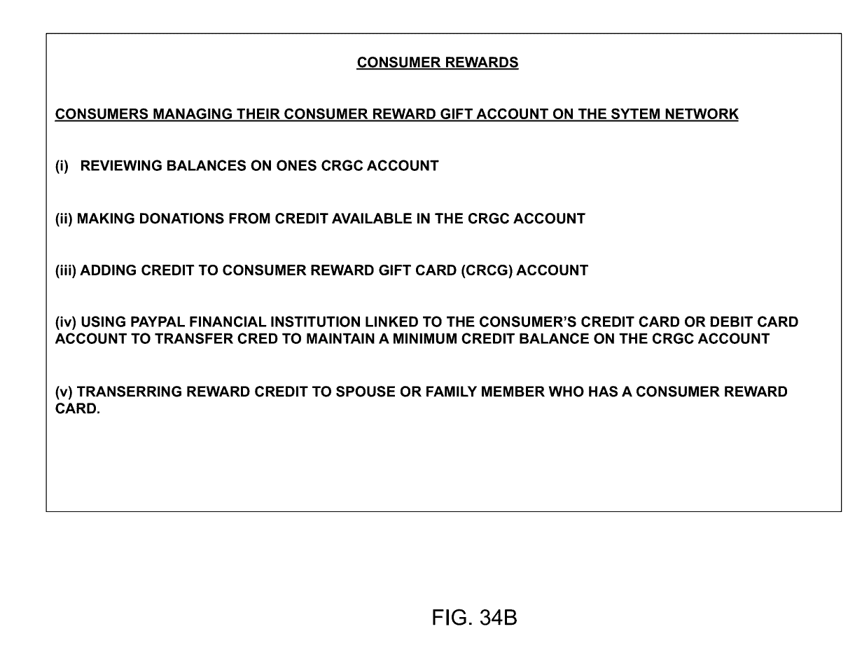

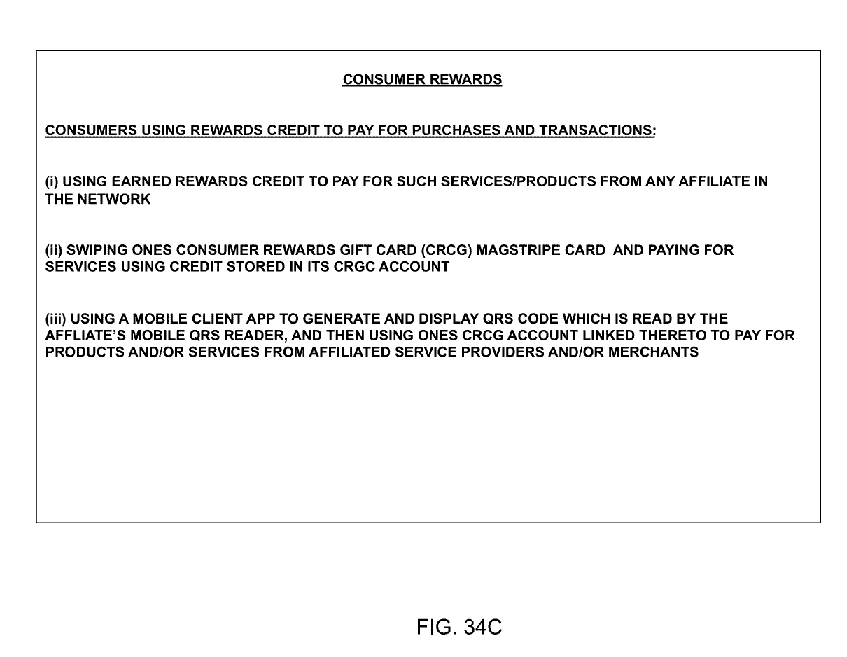

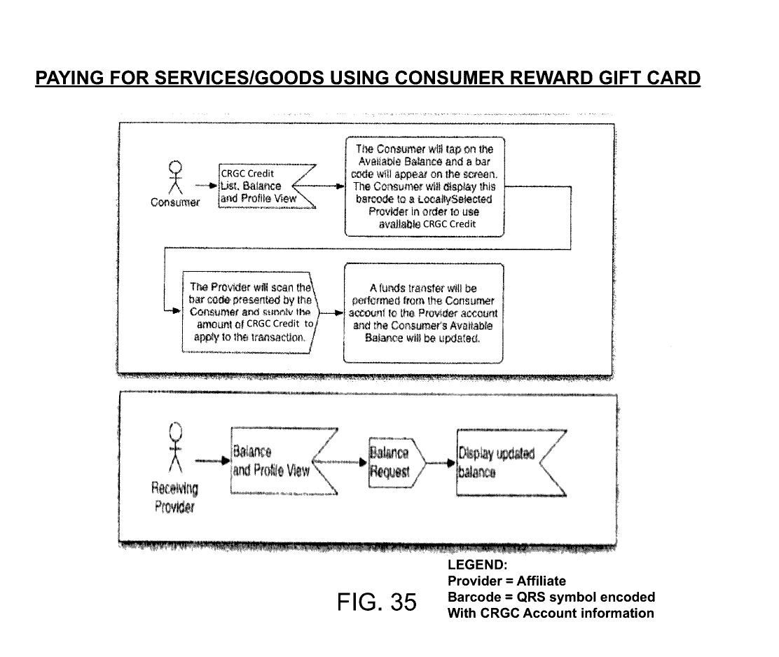

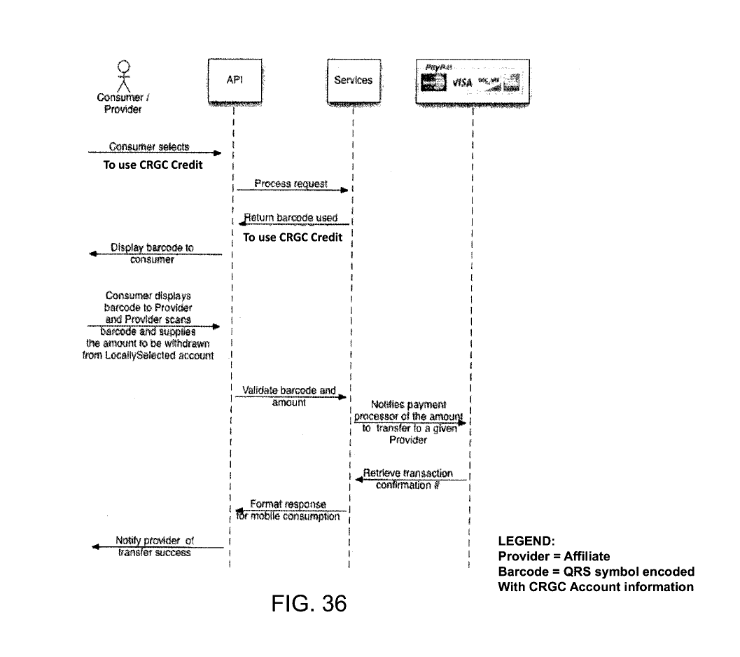

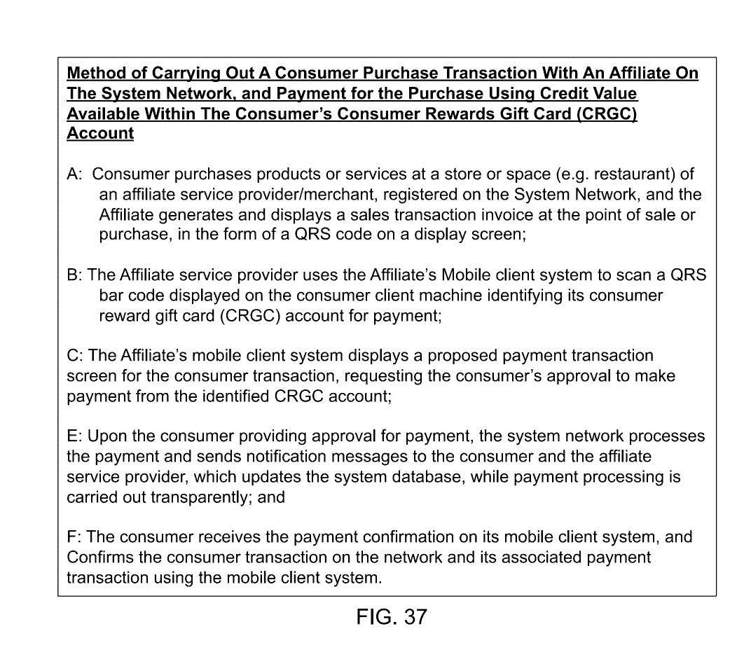

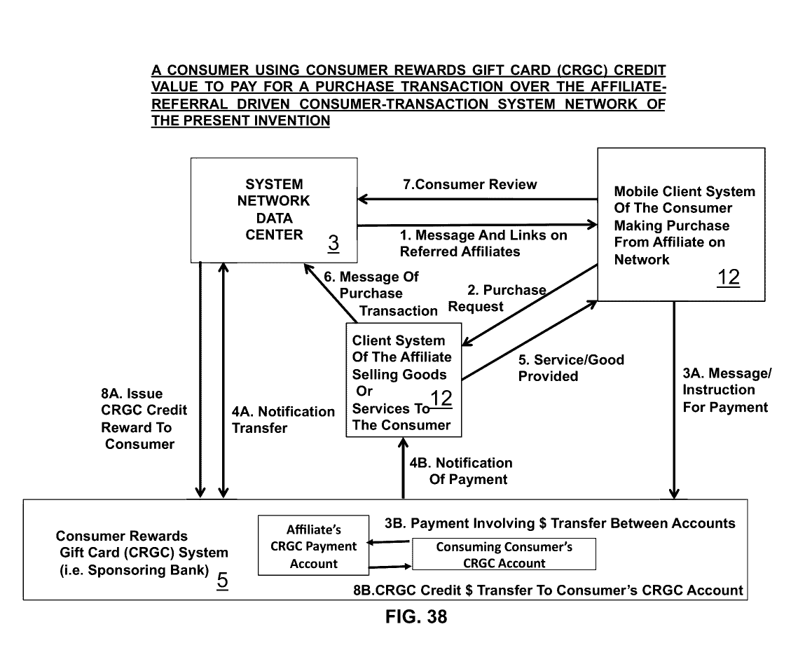

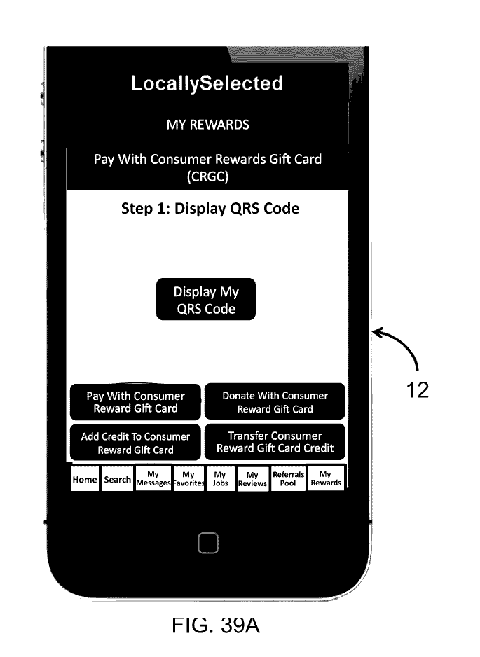

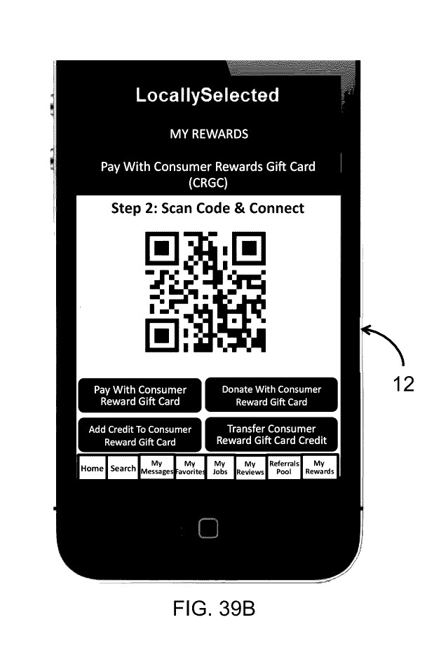

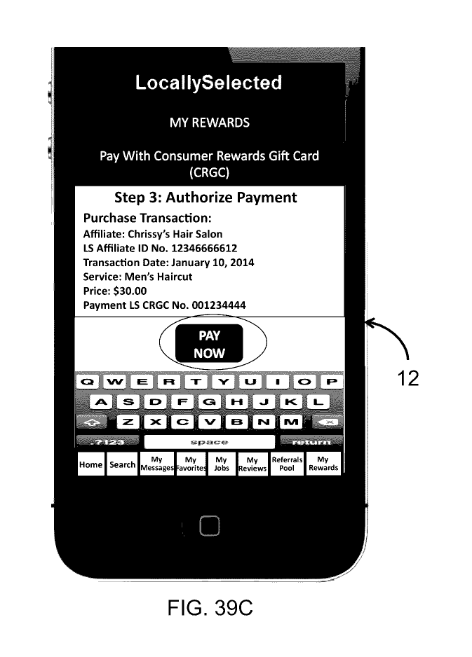

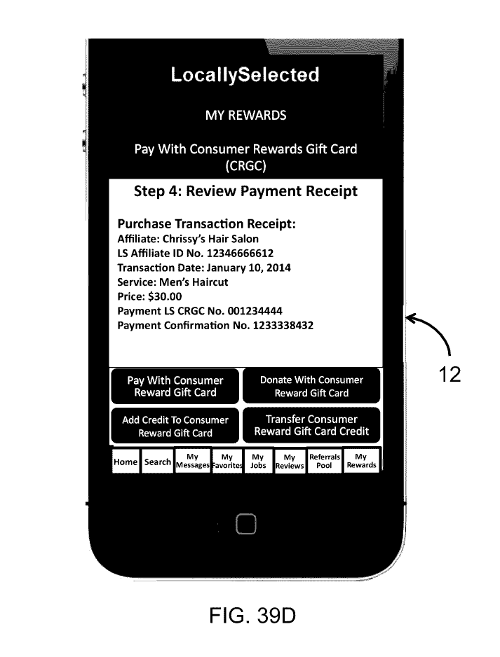

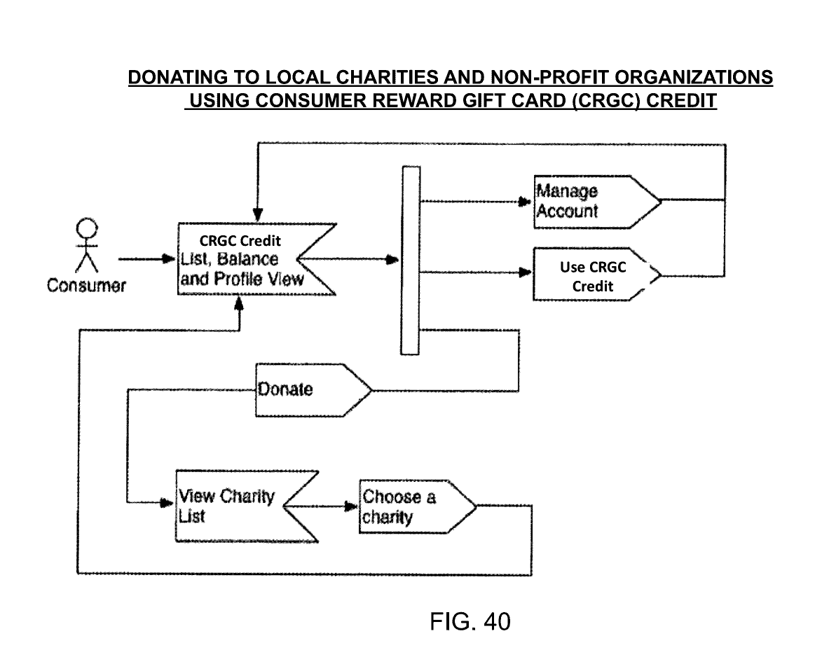

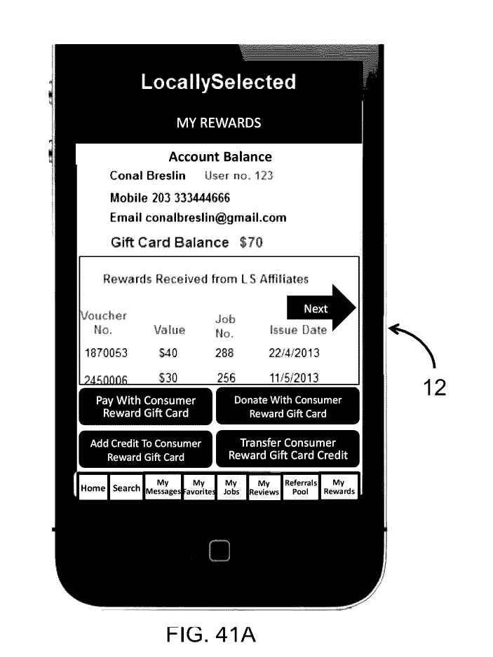

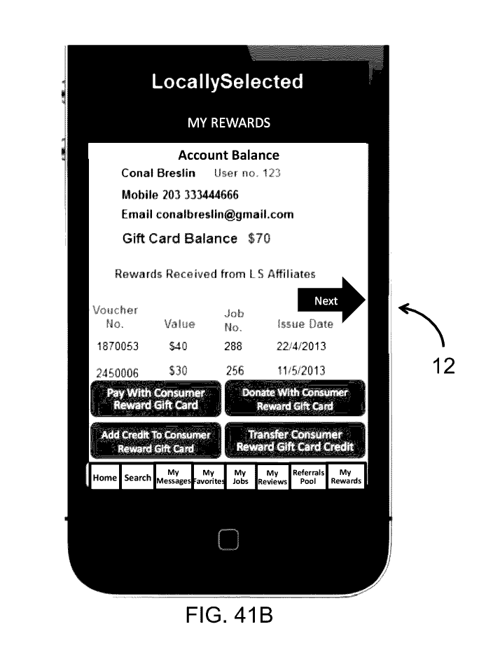

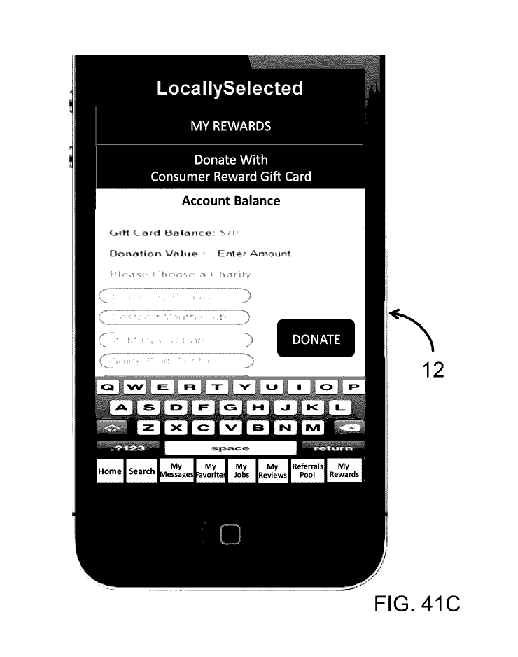

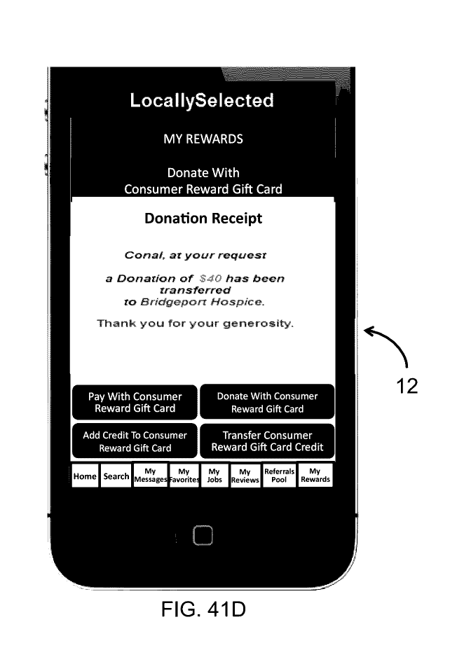

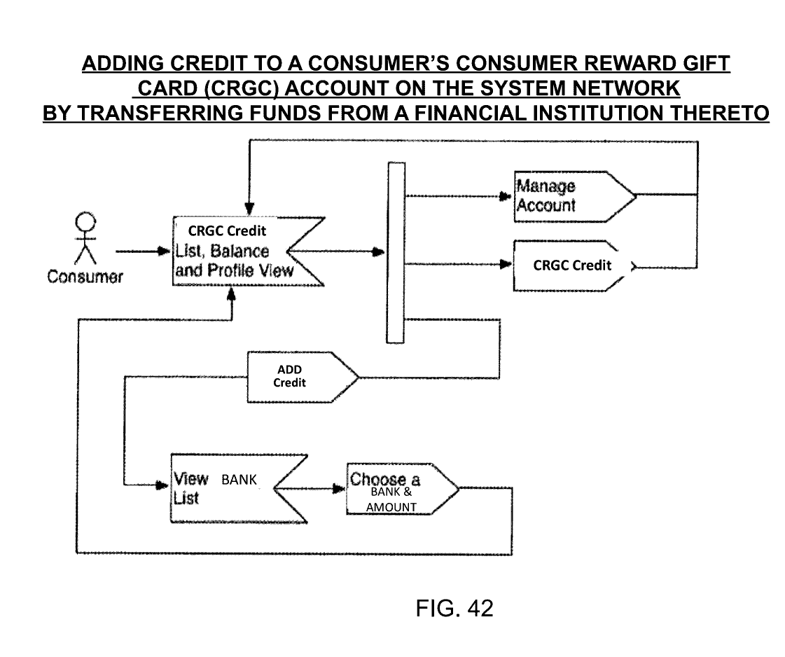

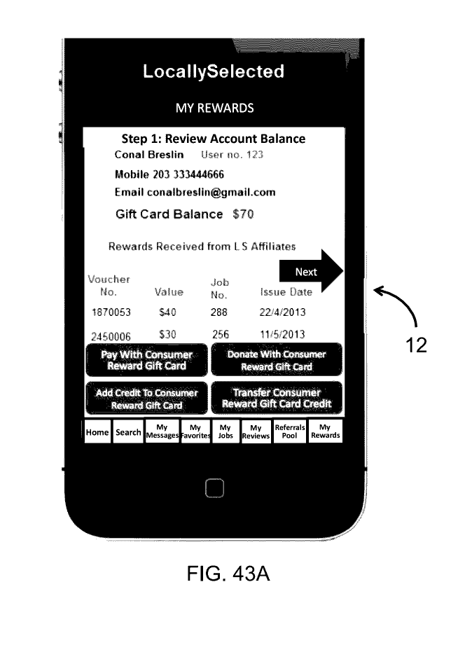

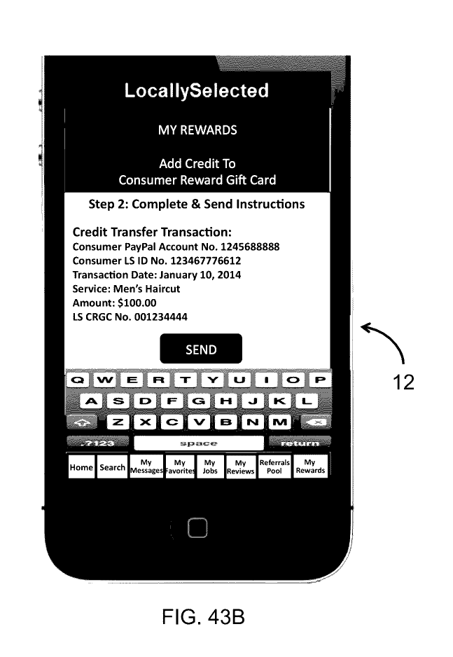

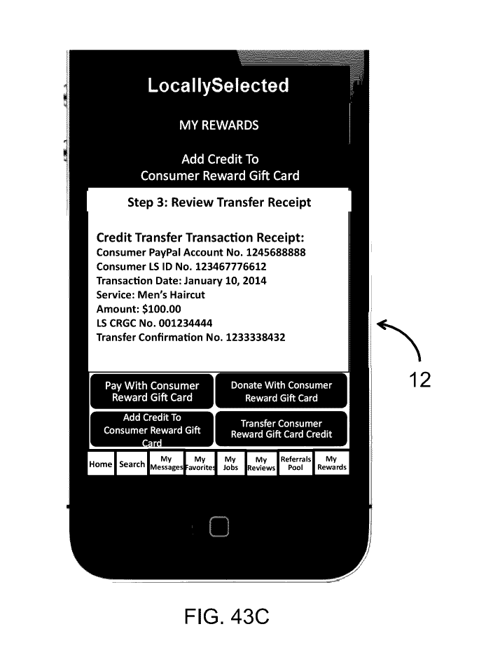

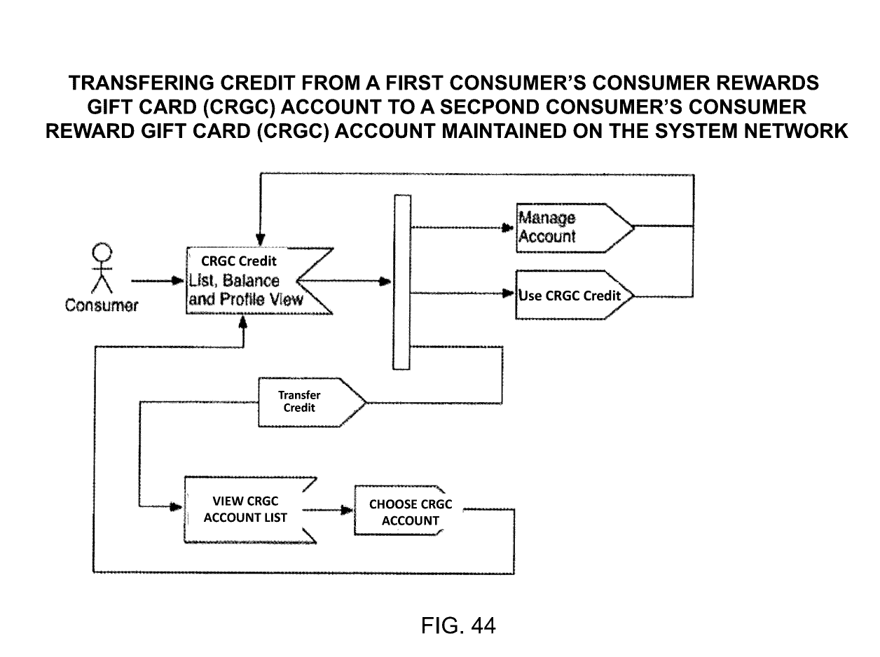

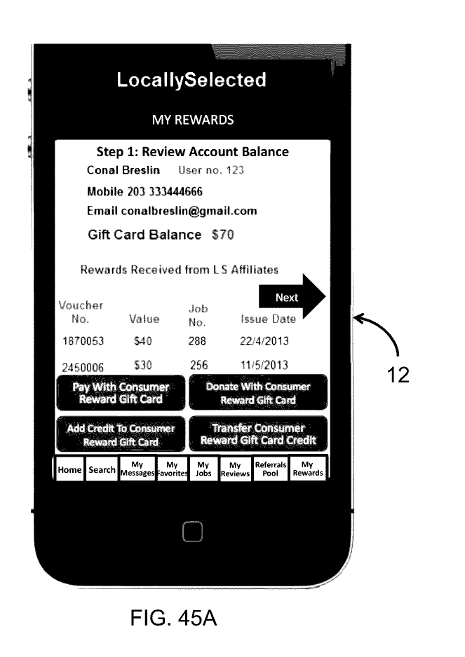

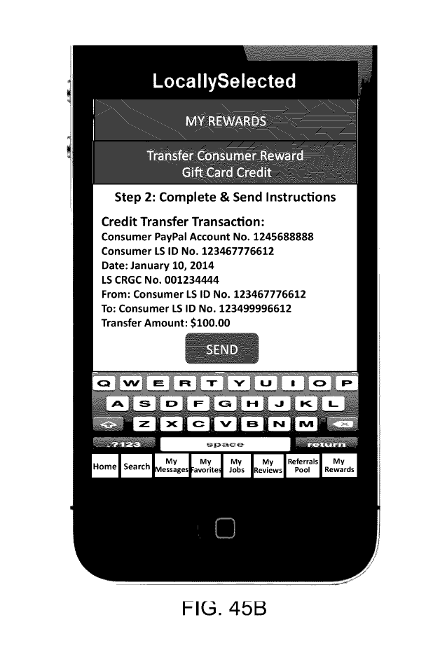

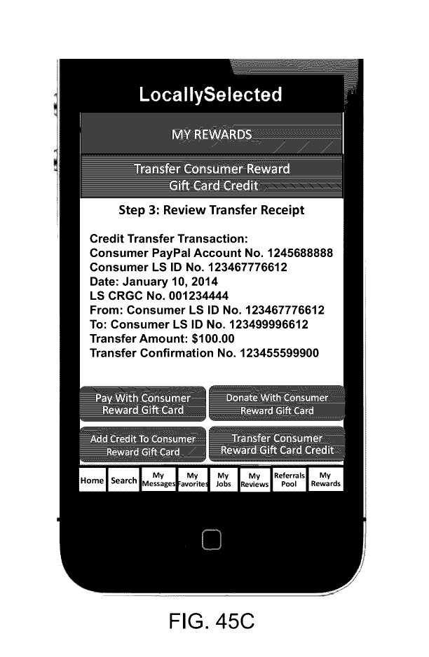

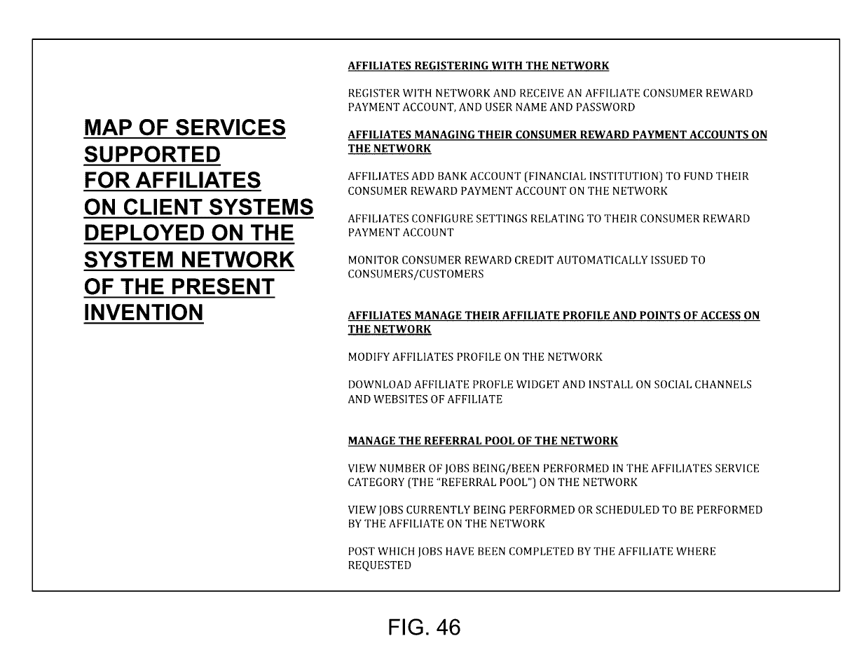

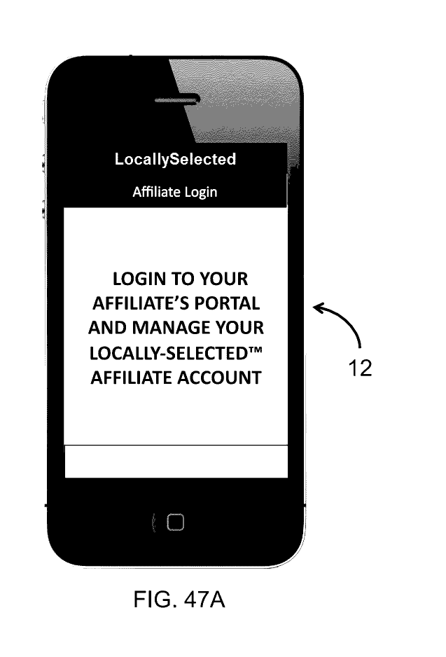

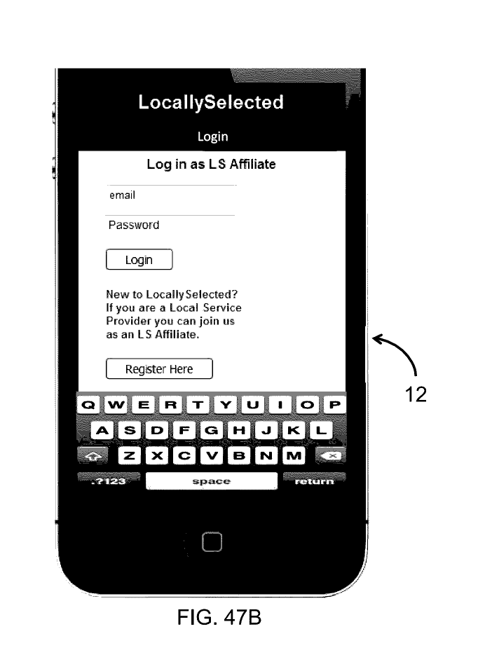

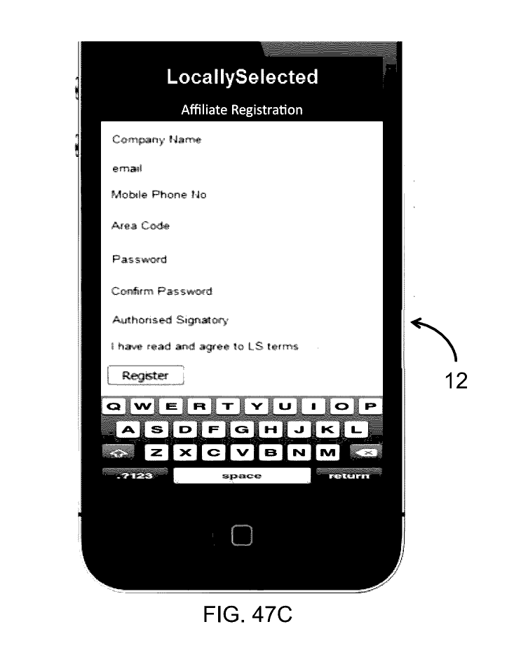

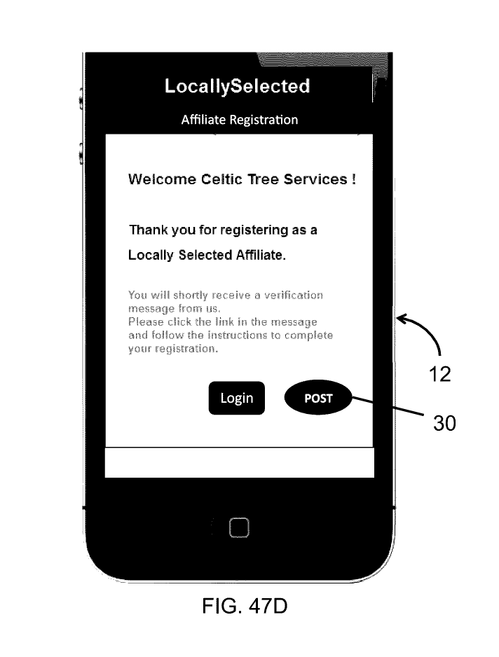

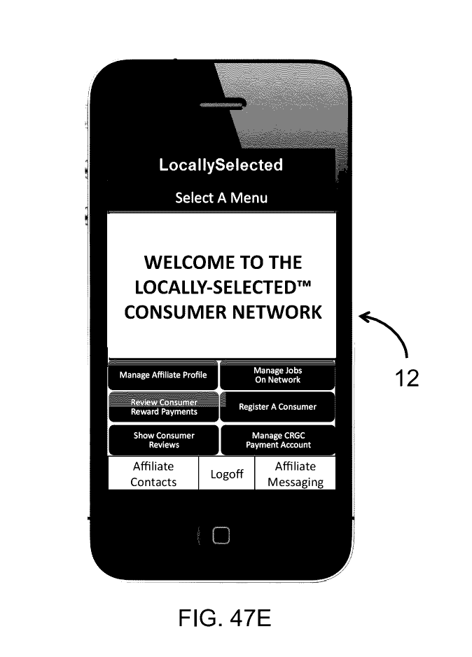

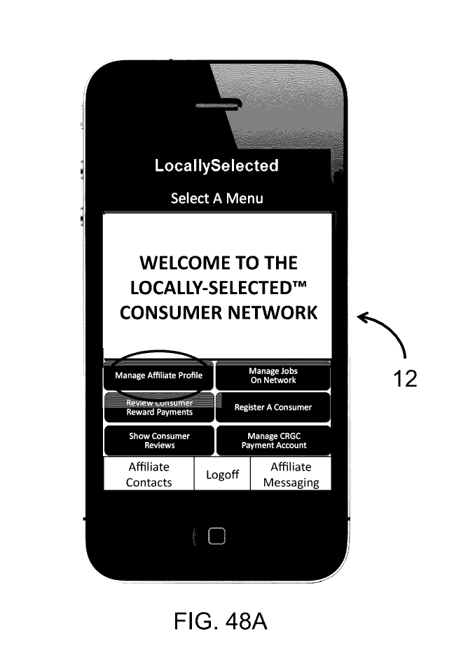

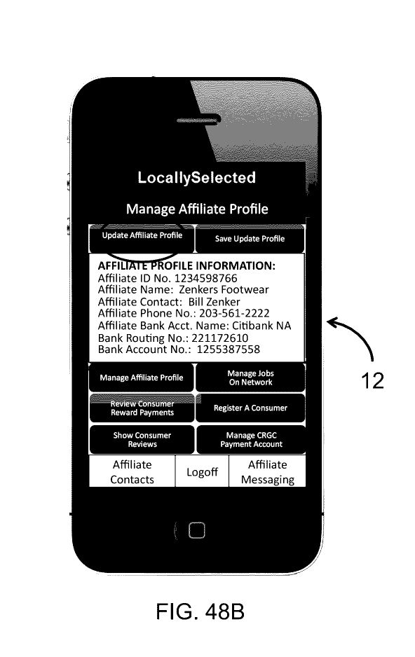

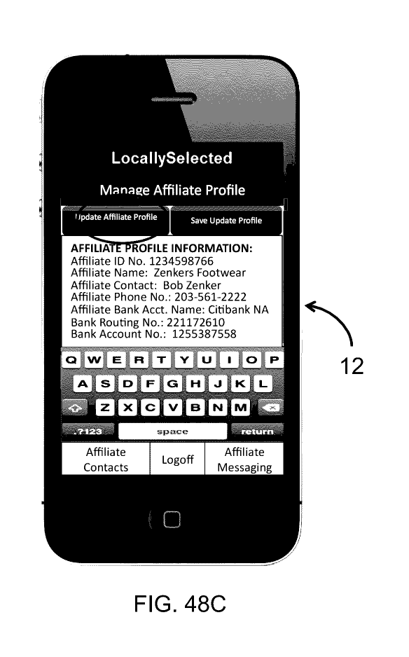

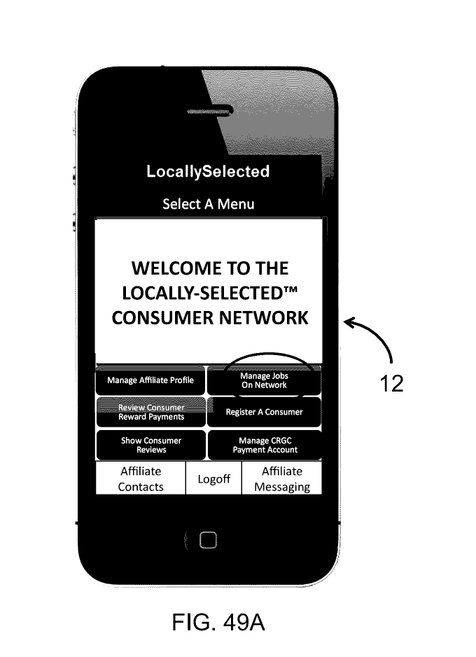

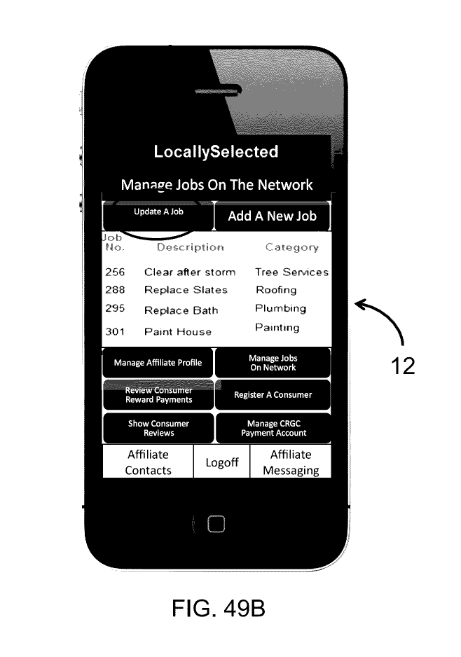

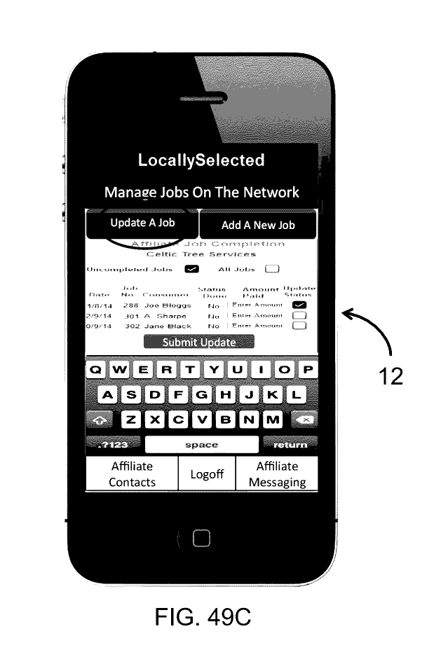

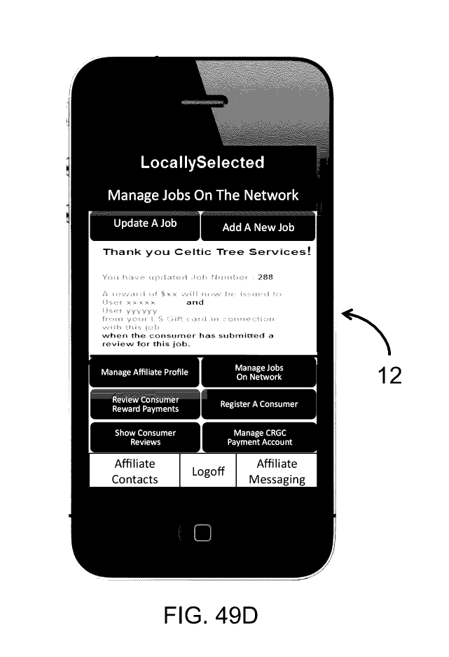

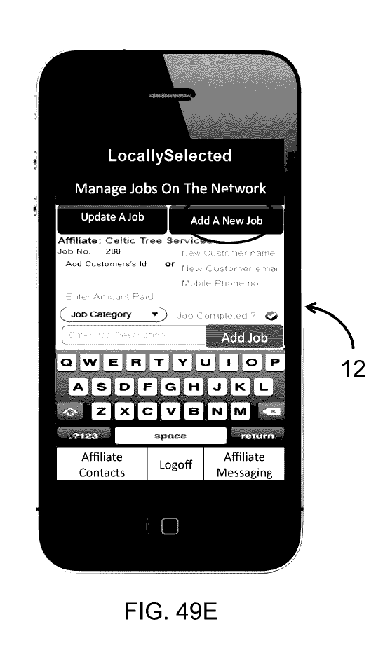

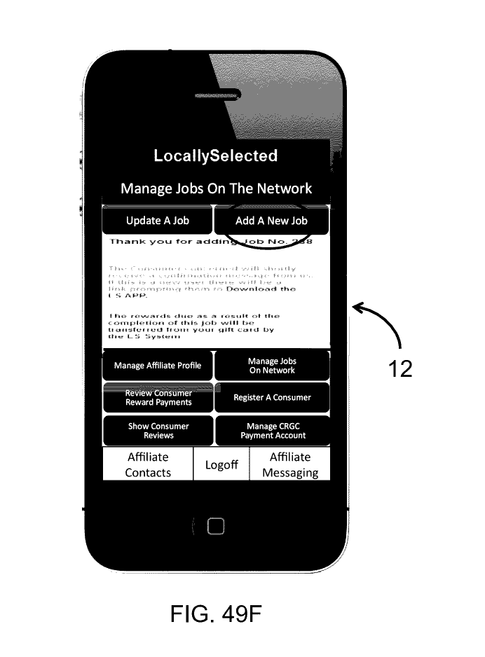

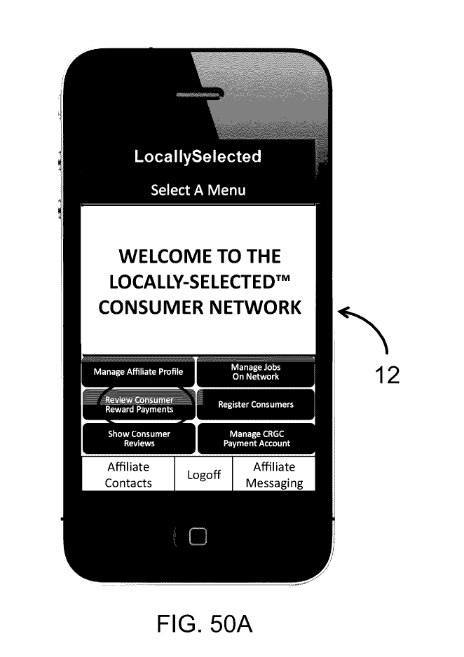

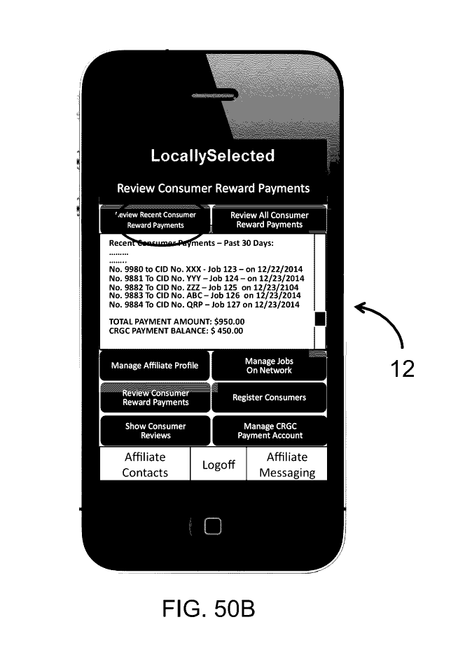

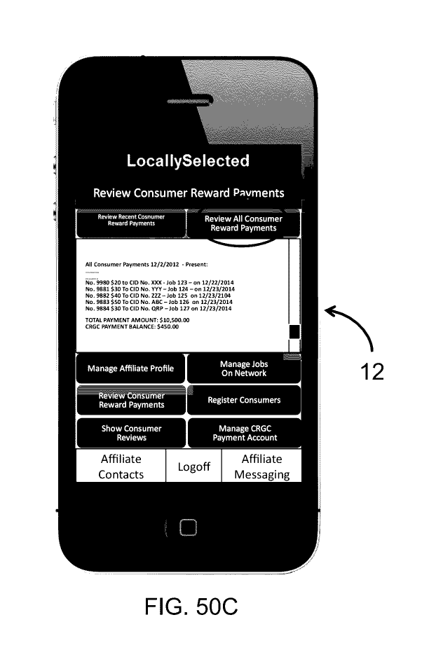

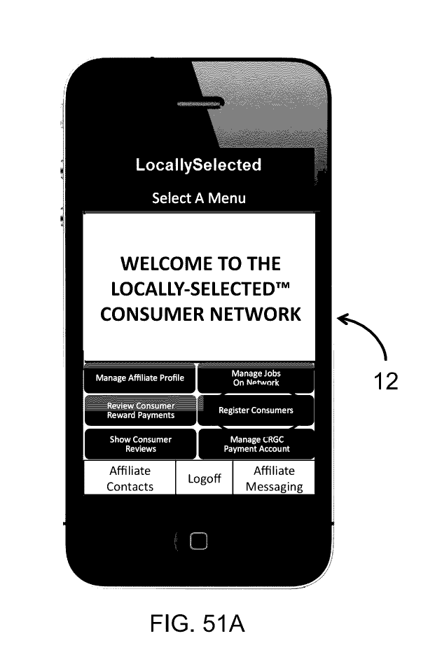

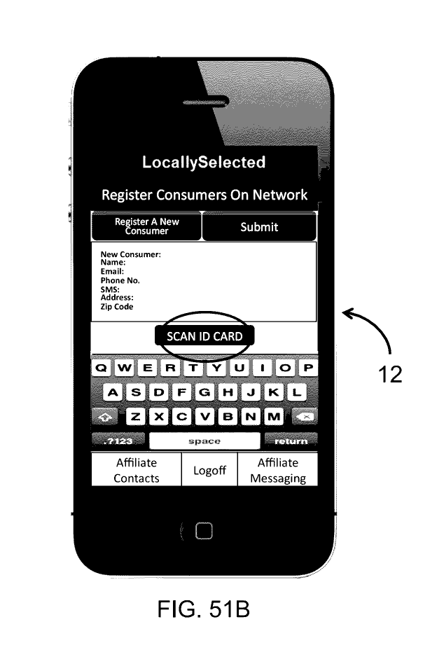

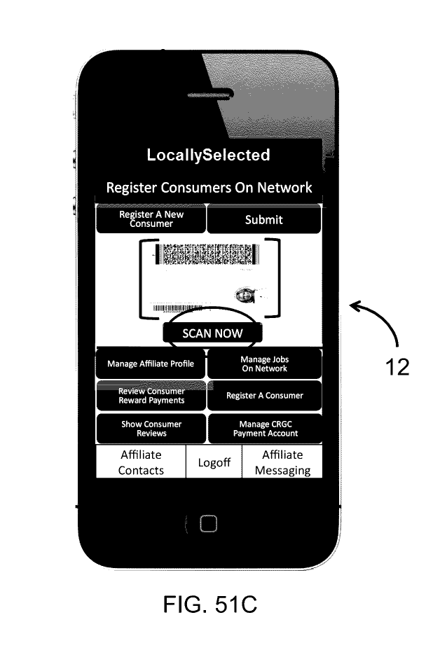

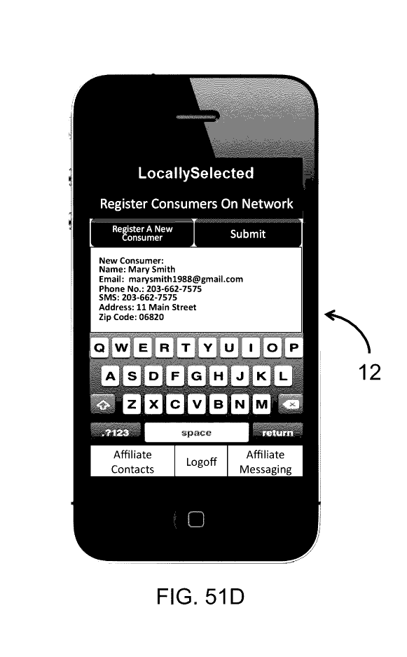

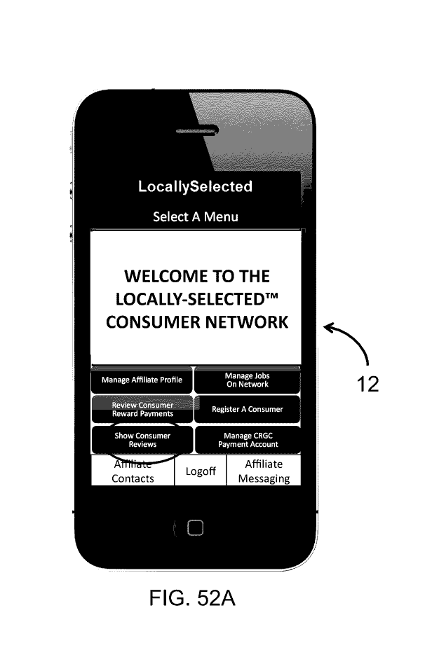

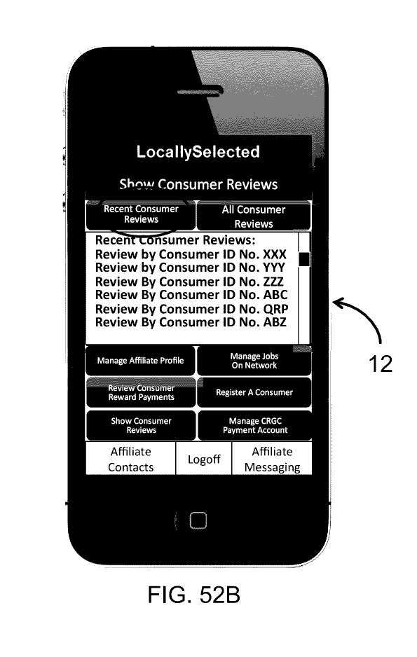

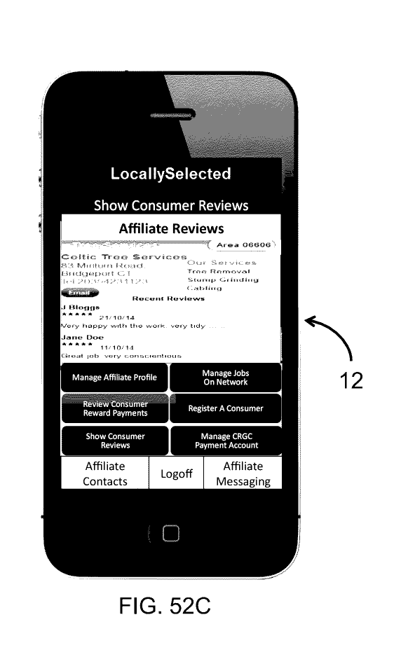

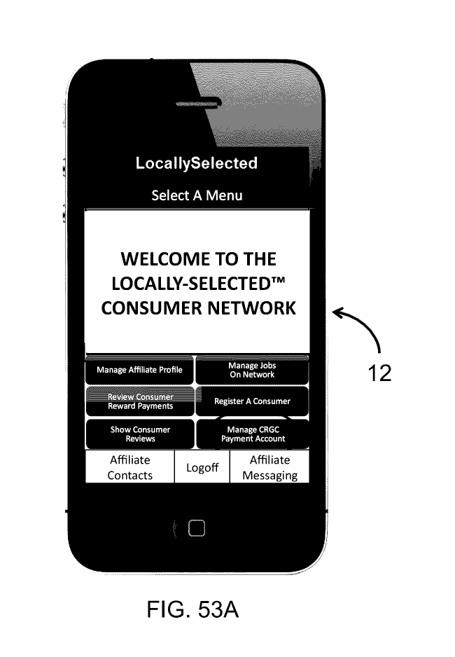

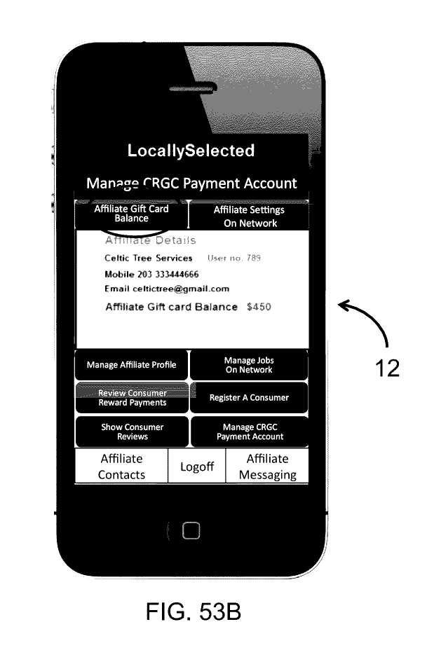

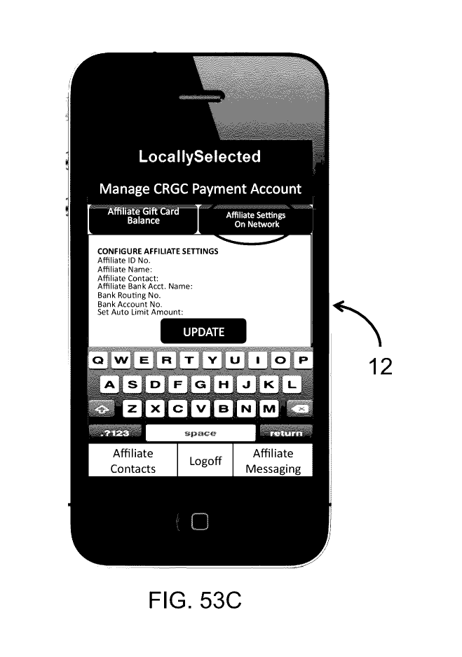

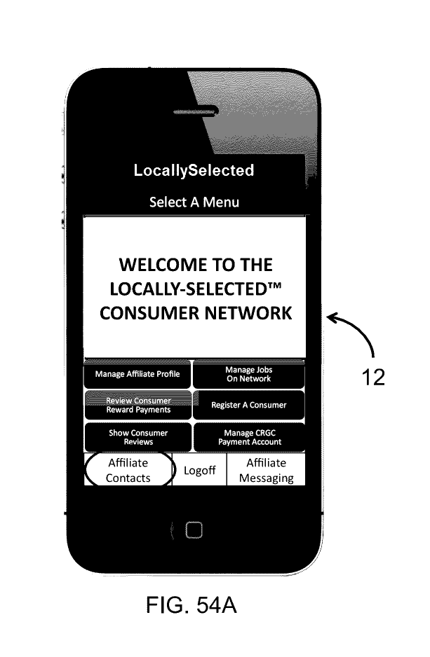

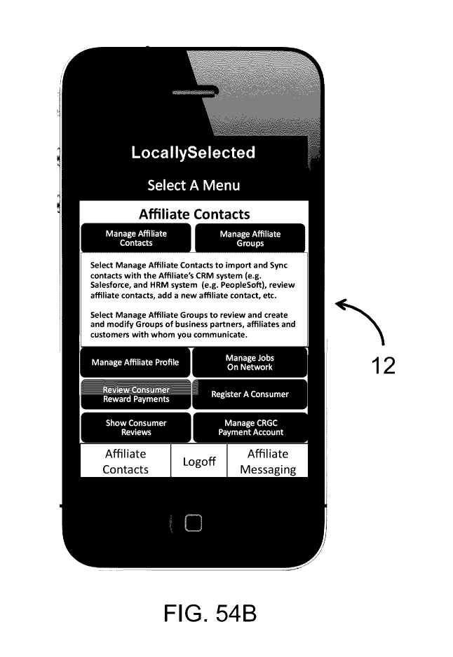

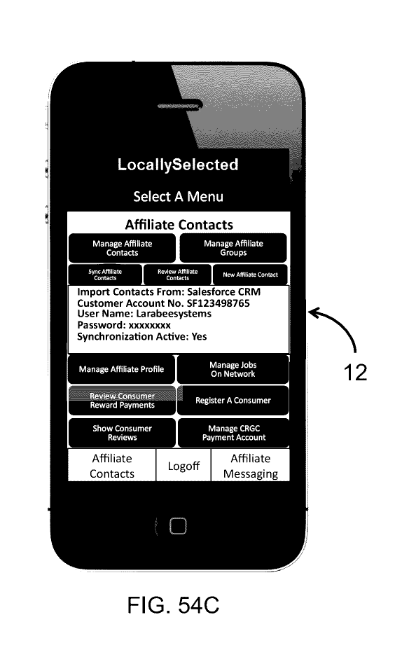

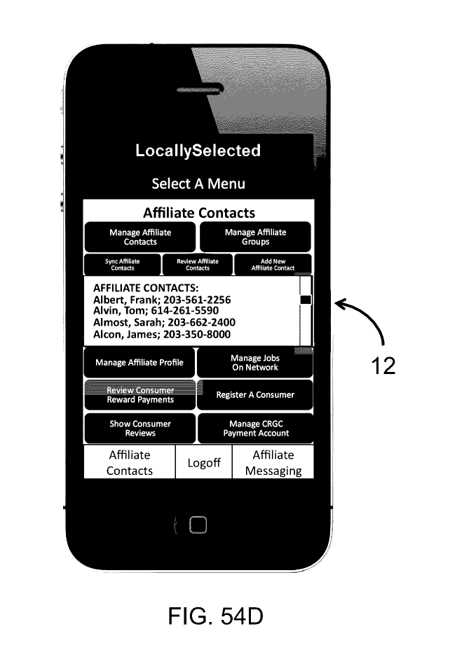

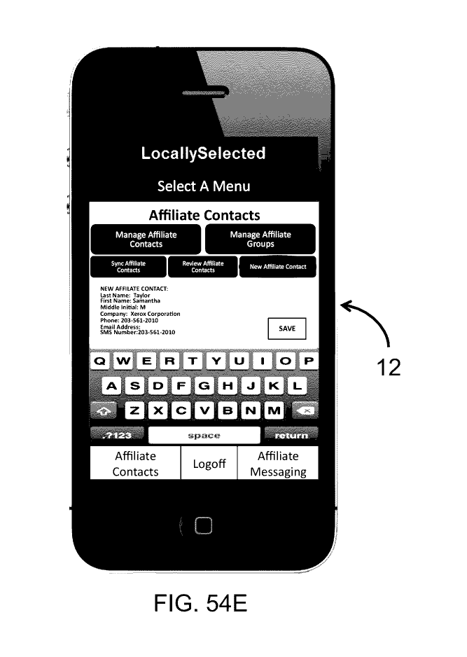

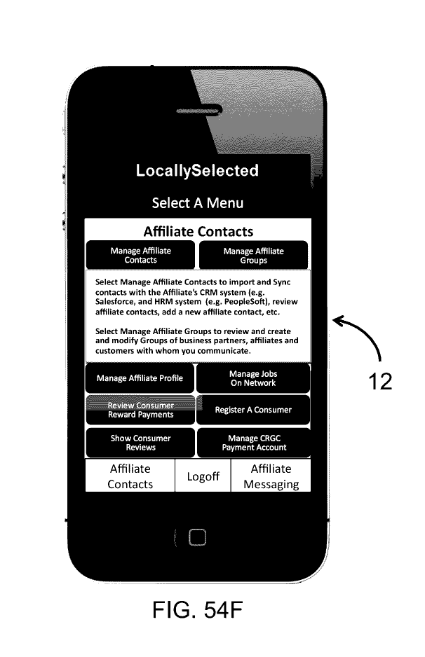

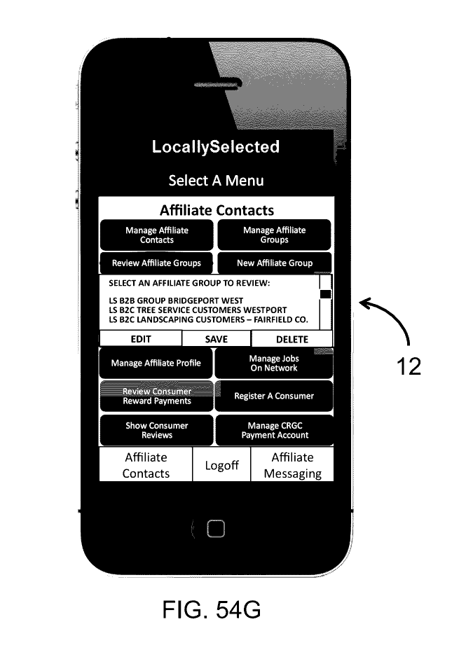

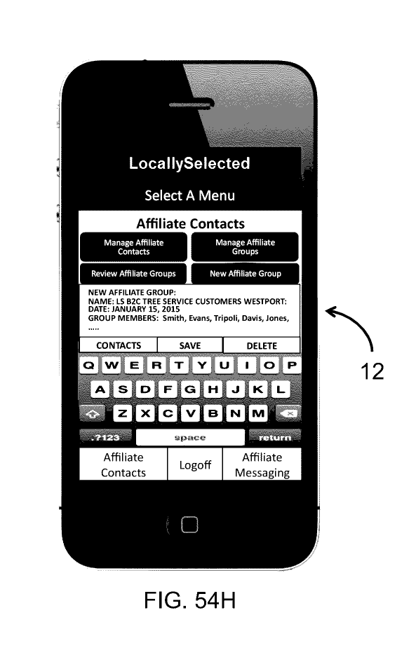

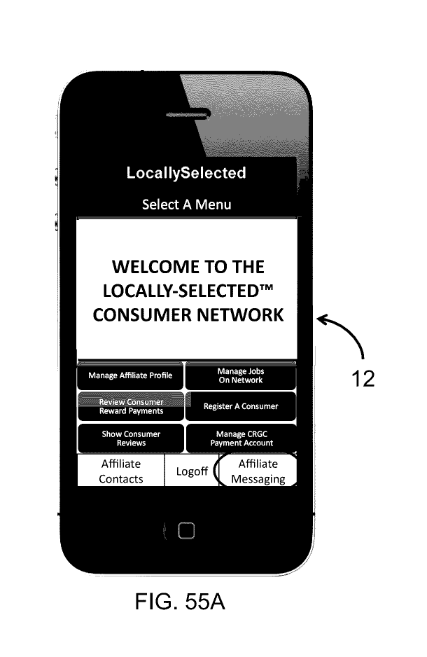

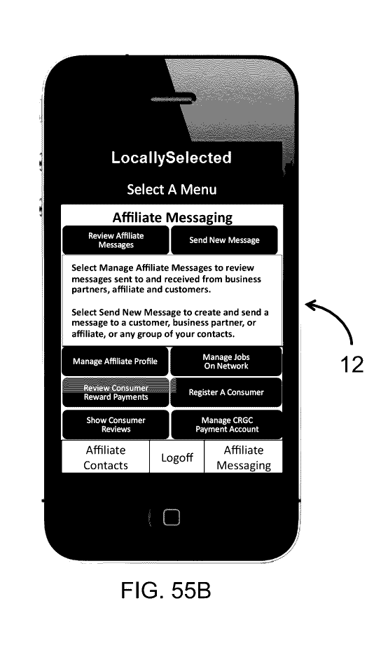

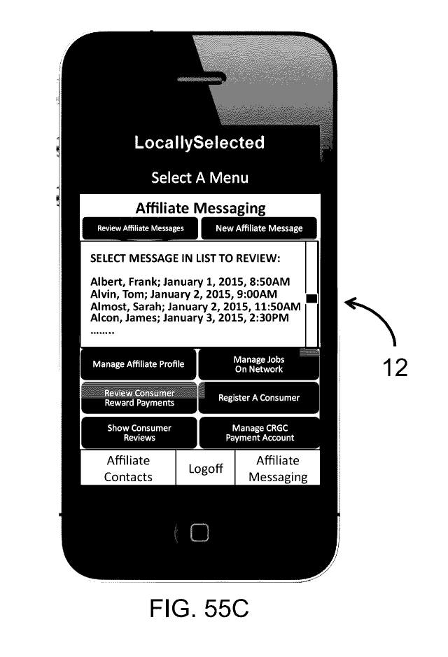

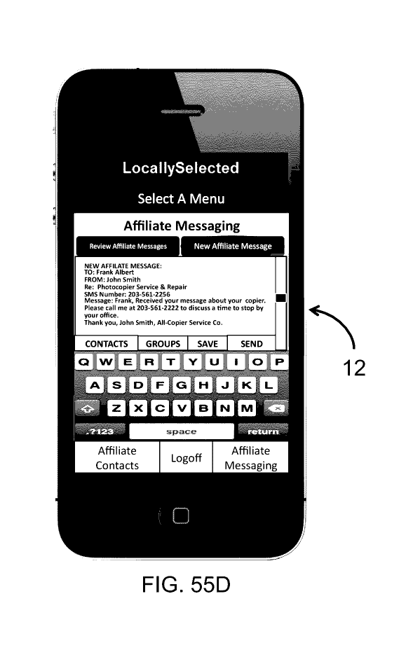

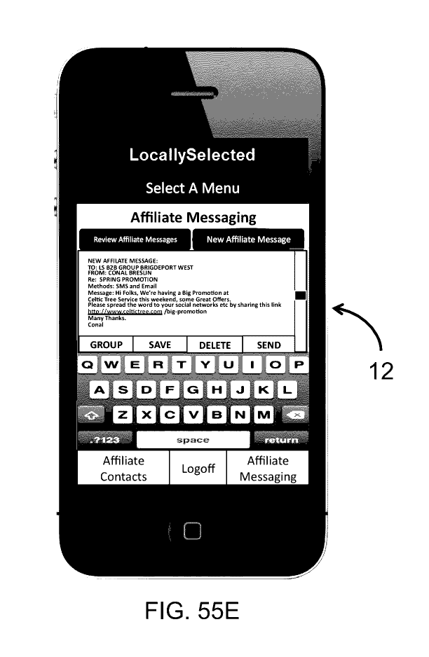

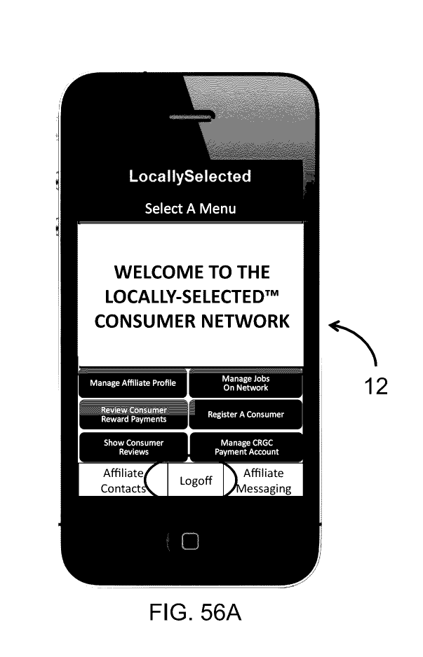

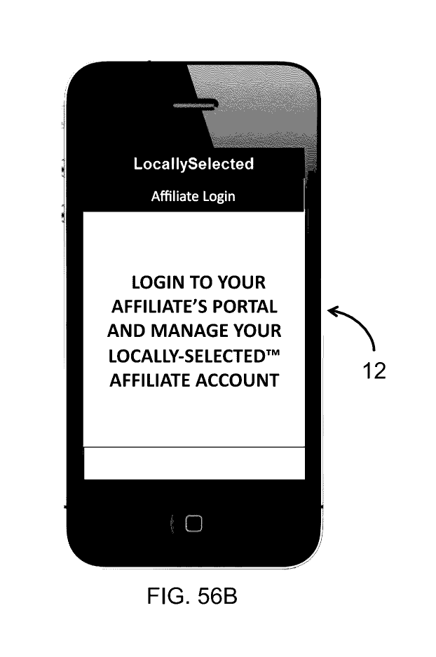

FIG. 32I is a graphical user interface (GUI) screen generated by the my reviews module of the system network and displayed on the display screen of a mobile client system on the system network associated with the consumer whose job has been completed an affiliate service provider, wherein the displayed GUI screen indicates that where the consumer has composed a review of an affiliate who has completed the consumer's job, and that the consumer is ready for submission to the system database upon selection of the “submit” interface object (i.e. button), where upon the consumer posting the consumer review, the review record will be added to the affiliate directory, the jobs listing, and the consumer directory, illustrated in FIG. 6;

FIG. 32J is a graphical user interface (GUI) screen generated by the my reviews module of the system network and displayed on the display screen of a mobile client system on the system network associated with the consumer whose job has been completed an affiliate service provider, wherein the GUI screen confirms that the consumer has posted a review of the affiliate who completed the consumer's job, and submitted the same to the system database;

FIG. 32K is a graphical user interface (GUI) screen generated by the my referral pools module of the system network and displayed on the display screen of a mobile client system on the system network associated with the consumer who wants to add a job and make some job referrals to affiliate service providers or merchants, wherein the displayed GUI screen displays interface objects for (i) adding a new job to the jobs listing on the system network, which new job may be for the consumer adding the new job, or for another entity with whom the consumer is affiliated in some manner, (ii) reviewing jobs added by me, (iii) referring jobs to an affiliate, and (iv) reviewing jobs referred by me, wherein the consumer user will select Option B in “Add A Job” data filter menu shown in FIG. 32P;

FIG. 32L is a graphical user interface (GUI) screen generated by the referral pools module of the system network and displayed on the display screen of a mobile client system on the system network associated with a consumer searching for an affiliate referral within the Referral Pools structure, where, in response to selecting the “add a job” interface object in the GUI screen of FIG. 32K, the displayed GUI screen states that the consumer would like top add a job, and also either (A) Refer My Job To An Affiliate In This Job Category Who Has Been Used By One Of My Personal Contacts; If No Result, Then Search The Contacts Of My Personal Contacts, (B) Allow The Job To Be Seen Only By The Groups I Choose In Next Screen, or (C) Allow The Job To Be Seen By Anyone Who Has Used An Affiliate Listed In The Job Category Of The Job.

FIG. 32M is a graphical user interface (GUI) screen generated by the referral pools module of the system network and displayed on the display screen of a mobile client system on the system network associated with a consumer searching for an affiliate referral within the Referral Pools structure, where, in response to selecting the B-type data filter option interface object in the GUI screen of FIG. 32L, the system network serves the client system a GUI screen setting forth interface objects that allow the consumer to choose which Groups the consumer wishes to view the job to be added in the referral pools facility supported on the system network of the present invention;

FIG. 32N is a graphical user interface (GUI) screen generated by the referral pools module of the system network and displayed on the display screen of a mobile client system on the system network associated with a consumer, wherein the GUI screen displays an “add a job” interface object, wherein the system network automatically generates a job number for each new job (e.g. Job No. 502 being assigned for the exemplary system user);

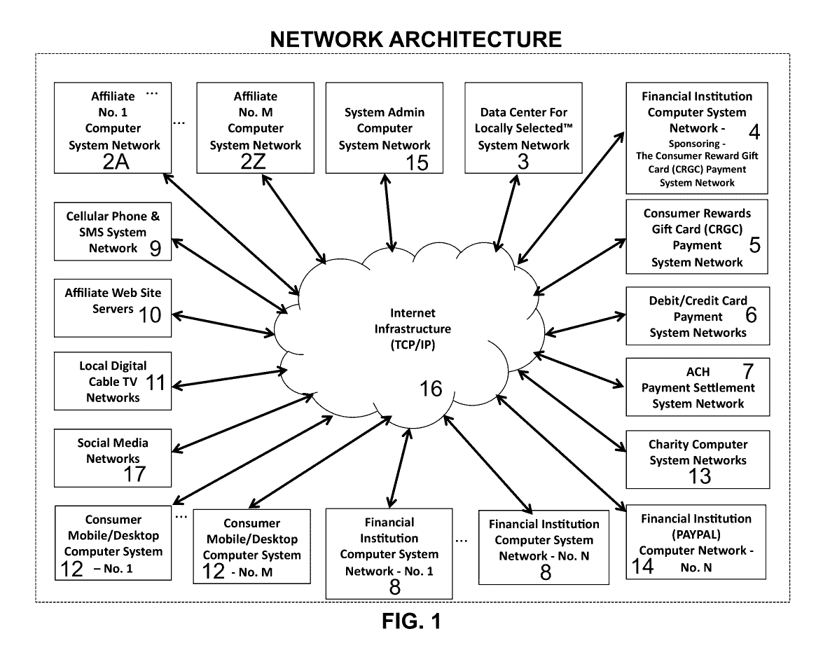

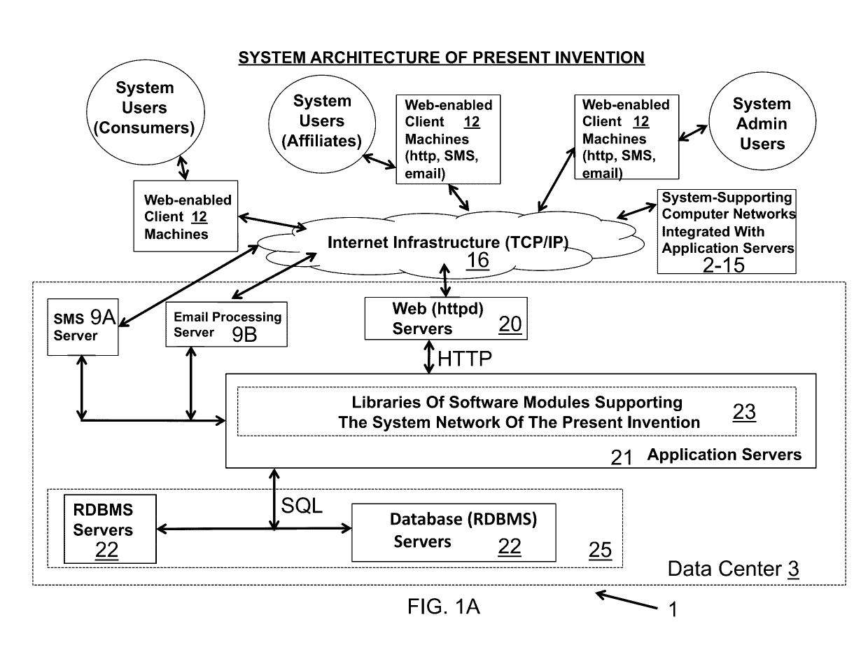

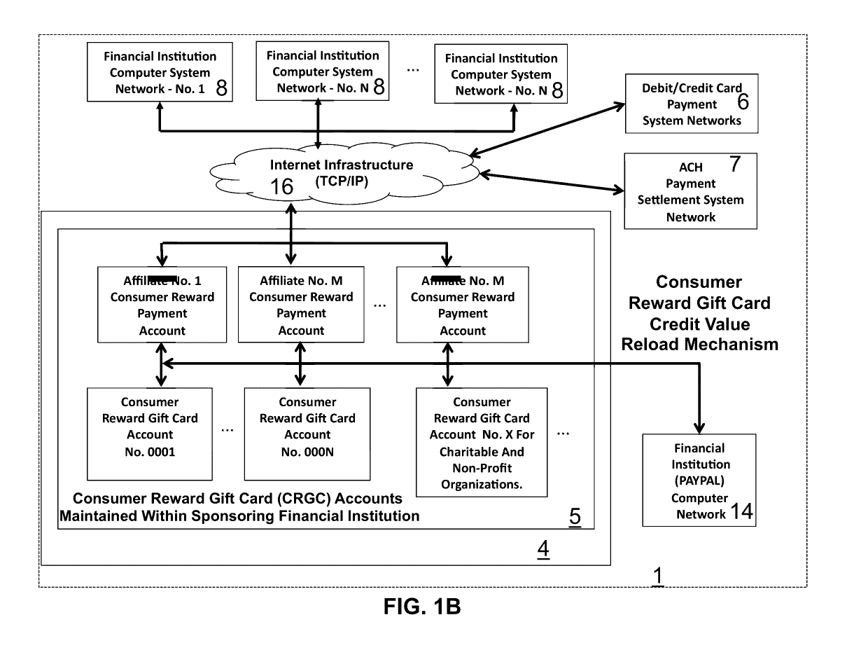

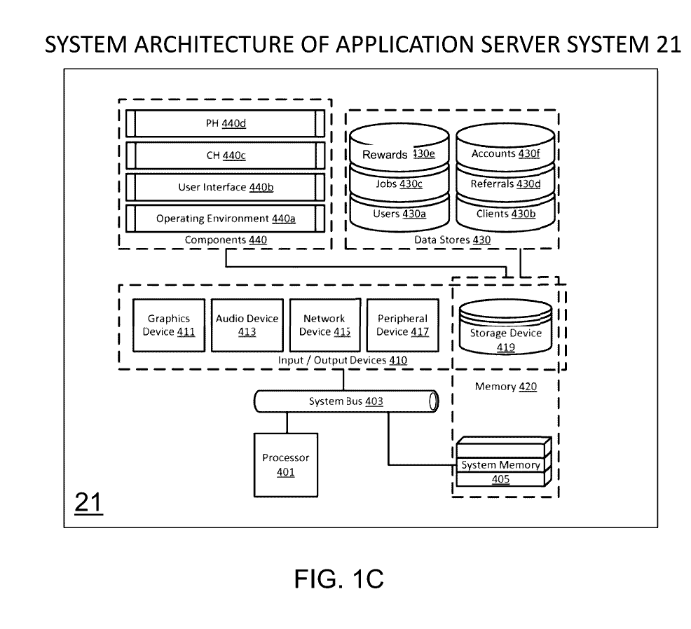

FIG. 32N-1 is a graphical user interface (GUI) screen generated by the referral pools module of the system network and displayed on the display screen of a mobile client system on the system network associated with a consumer, wherein the GUI screen displays an “jobs added by me” interface object, wherein the user can view all jobs that have been added to the Referral Pool specified by option-B, and viewable by any member of the Group with which the added job was tagged or indexed during the add a job operation performed in FIG. 32N, and where the user can view the recently added Job No. 502 presented in the jobs added by me displays space, with all other jobs to which the user is entitled to view on the system network, with the option of sorting and viewing the list of jobs by job category or by consumer group, using pull-down menus shown in FIG. 32N-1;

FIG. 32O is a graphical user interface (GUI) screen generated by the my referral pools module of the system network and displayed on the display screen of a mobile client system on the system network associated with the consumer who wants to add a job and make some job referrals to affiliate service providers or merchants, wherein the displayed GUI screen displays interface objects for (i) adding a new job to the jobs listing on the system network, which new job may be for the consumer adding the new job, or for another entity with whom the consumer is affiliated in some manner, (ii) reviewing jobs added by me, (iii) referring jobs to an affiliate, and (iv) reviewing jobs referred by me, wherein the consumer user will select option B in Add A Job data filter menu shown in FIG. 32P;

FIG. 32P is a graphical user interface (GUI) screen generated by the referral pools module of the system network and displayed on the display screen of a mobile client system on the system network associated with a consumer searching for an affiliate referral within the Referral Pools structure, where, in response to selecting the “add a job” interface object in the GUI screen of FIG. 32O, the displayed GUI screen states that the consumer would like top add a job, and also either (A) Refer My Job To An Affiliate In This Job Category Who Has Been Used By One Of My Personal Contacts; If No Result, Then Search The Contacts Of My Personal Contacts, (B) Allow The Job To Be Seen Only By The Groups I Choose In Next Screen, or (C) Allow The Job To Be Seen By Anyone Who Has Used An Affiliate Listed In The Job Category Of The Job;

FIGS. 32Q, 32R, and 32S is a series of graphical user interface (GUI) screens generated by the referral pools module of the system network and displayed on the display screen of a mobile client system on the system network associated with a consumer, wherein the GUI screen displays an “add a job” interface object for adding a new job to the referral pools (along with one or more qualified affiliates) and a “pull-down menu” interface object for selecting the Job Category from a job category list maintained by the system administrator, wherein the system network automatically generates a job number for each new job (e.g. Job No. 502 being assigned for the exemplary system user).

FIG. 32S is a graphical user interface (GUI) screen generated by the my referral pools module of the system network and displayed on the display screen of a mobile client system on the system network associated with the consumer who wants to add a job to the referral pools, wherein the displayed GUI screen displays interface objects for entering a description of the job, and the name and email address of the person for whom the job is to be performed if it is not the user, and also the job category which is selected from the pull-down menu in FIG. 32R;

FIG. 32T is a graphical user interface (GUI) screen generated by the referral pools module of the system network and displayed on the display screen of a mobile client system on the system network associated with a consumer, wherein the GUI screen displays an “jobs added by me” interface object, wherein the user can view all jobs that have been added to the Referral pool B, and viewable by any member of the Group with which the added job was tagged or indexed during the add a job operation performed in FIG. 32N, and where the user can view the recently added Job No. 502 presented in the “jobs added by me” display space, with all other jobs to which the user is entitled to view on the system network, with the option of sorting and viewing the list of jobs by job category or by consumer group, using pull-down menus shown in FIG. 32T;

FIG. 32U is a graphical user interface (GUI) screen generated by the referral pools module of the system network and displayed on the display screen of a mobile client system on the system network associated with a consumer who wants to “refer jobs to” affiliate service providers or merchants, by selecting the “refer jobs to” interface object in the GUI screen shown in FIG. 32U, which automatically generated the jobs referred by me GUI screen shown in FIG. 32V, where all jobs viewable by the user (by virtue of job origination, group membership or contacts) are displayed in this GUI screen and available for selection and referring to one or more qualified affiliates using the GUI screen shown in FIG. 32W;

FIG. 32W is a graphical user interface (GUI) screen generated by the referral pools module of the system network and displayed on the display screen of a mobile client system on the system network associated with the consumer whose jobs need to be referred, wherein the displayed “Refer A Job” GUI of FIG. 32W is configured, for example, to harness the search power of the search engine in FIGS. 6A and 6B to conduct an automated search of the users “my contacts” directory, and affiliate directory, and jobs listing, and referral pools, to determine who in the user, and anyone in his or her contact list has used an affiliate listed in the job category, to which the user can consider referring the selected job in referral pools;

FIG. 32X is a graphical user interface (GUI) screen generated by the message module of the system network and displayed on the display screen of a mobile client system on the system network associated with the affiliate who has been referred to a particular job, wherein the displayed GUI presents a message confirming that the affiliate has been referred a particular job, and that the referring consumer is reviewing the affiliate's profile and job reviews;

FIG. 32Y is a graphical user interface (GUI) screen generated by the my messages module on the system network and displayed on the display screen of a mobile client system on the system network associated with the consumer who has a particular job to be performed by a registered service provider affiliate with the system network, wherein the displayed GUI presents a message confirming that the consumer's job has been referred to a particular affiliate service provider and providing a link or URL to the affiliate's profile;

32Z is a graphical user interface (GUI) screen generated by the my messages module of the system network and displayed on the display screen of a mobile client system on the system network associated with the consumer whose job has been completed an affiliate service provider, wherein the displayed GUI screen presents a message confirming with the consumer that (i) the consumer's job has been completed by a particular affiliate service provider (e.g. Celtic Tree Service), (ii) a particular amount paid, and (iii) after the consumer writes and posts a review on the affiliate who completed the job, the consumer and job referrer will be paid a consumer reward gift card (CRGC) credit from the CRGC Payment Account of the affiliate service provider/merchant who completed the referred job;

FIG. 32-AA is a graphical user interface (GUI) screen generated by the my reviews module of the system network and displayed on the display screen of a mobile client system on the system network associated with the consumer whose job has been completed an affiliate service provider, wherein the displayed GUI screen indicates that where the consumer has composed a review of an affiliate who has completed the consumer's job, and that the consumer is ready for submission to the system database upon selection of the “submit” interface object (i.e. button), where upon the consumer posting the consumer review, the review record will be added to the affiliate directory, the jobs listing, and the consumer directory, illustrated in FIGS. 6A and 6B, which is merely a schematic representation of these three data structures which are otherwise implemented in the RDBMS of the system network database;

FIG. 32-BB is a graphical user interface (GUI) screen generated by the my reviews module of the system network and displayed on the display screen of a mobile client system on the system network associated with the consumer whose job has been completed an affiliate service provider, wherein the GUI screen confirms that the consumer has posted a review of the affiliate who completed the consumer's job, and submitted the same to the system database;

FIG. 32-CC is a graphical user interface (GUI) screen generated by the referral pools module of the system network and displayed on the display screen of a mobile client system on the system network associated with the consumer who wants to add a job and seek some referrals for an affiliate service provider, wherein the displayed “jobs added by me” GUI screen presents a list of jobs added by the user (i.e. jobs added by me), indicating, for each listed job, (i) a date of job entry into the system network, (ii) a job number assigned to each job by the system network, (iii) job category (e.g. roofing, painting, tree service etc), (iv) status of job (e.g. completed/done, pending, in-progress, not yet started), (v) whether or not consumer reward has been consumer reward issued, wherein this list of jobs added by the user can be sorted and viewed by job category, consumer group, as well as date;

FIG. 32-DD is a graphical user interface (GUI) generated by the my referral pools module of the system network and displayed on the display screen of a mobile client system on the system network associated with the consumer who has made some previous job referrals on the system network referrals, wherein the displayed “jobs referred by me” GUI screen presents a list of jobs that the user has referred to affiliates over the past year or so, wherein each job referred listed comprises the following information items (i) a date of job entry into the system network, (ii) a job number assigned to each job by the system network, (iii) the name of the affiliate to which the job was referred, (iv) status of the job (e.g. completed/done, pending, in-progress, not yet started), and (v) whether or not consumer reward has been issued for each listed job referral, wherein this list of job-affiliate referrals made by the user can be sorted and viewed by job category, consumer group, as well as date;

FIG. 33 is a graphical user interface (GUI) screen generated by the my jobs module of the system network and displayed on the display screen of a mobile client system on the system network associated with a consumer interested in managing all of the jobs that he or she had added and referred to the system network, via searching the affiliate directory, within my favorites, and while using the referral pools facility, wherein the displayed GUI screen presents the consumer with the same functions supported in the referral pools module and facility;

FIG. 34A is a table containing descriptions of how consumers can earn consumer reward gift card (CRGC) credits on the system network, including (i) by a consumer x adding a job to the system network and/or requesting service by a network affiliate; (ii) by a consumer y purchasing a product/service from an affiliate on the system network, and then writing and posting a product/service review on the system network; and (iii) by a consumer z referring an affiliate to a job, upon which a consumer transaction is consummated/completed, and where consumer z has actually used the affiliate being referred;

FIG. 34B is a table describing a primary suite of services supported on the system network relating to managing a registered user's consumer rewards gift card (CRGC) account including (i) consumers managing their consumer reward gift credit card on the system network, (ii) reviewing balances, making donations, (iii) adding credit to consumer reward gift card account, (iv) using, for example, the PayPal financial institution linked to the consumer's credit card or debit card account, and (v) transferring reward credit to spouse or family member who has a consumer reward card;

FIG. 34C is a table describing a primary suite of services supported on the system network relating to using rewards credit to pay for purchases and transactions, by way of a number of suggested techniques;

FIG. 35 is a schematic representation of work flow process that can be used in paying for services/goods purchased from service providers and/or merchants registered with the system network using ones consumer reward gift card (CRGC) account maintained on the system network;

FIG. 36 is schematic representation of a multi-layer service model for the barcode-driven consumer reward credit based payment service that is supported on the system network of the present invention;

FIG. 37 is a flow chart representation describing the primary steps involved in carrying out the method of supporting a consumer purchase transaction between a consumer and an affiliate on the system network, and making payment for the purchase using credit value available within the consumer's consumer rewards gift card (CRGC) account;

FIG. 38 is a schematic representation of the system network of the present invention supporting the process, whereby a consumer uses available consumer rewards gift card (CRGC) credit value to pay for a purchase of goods and/or services over the affiliate-referral driven consumer-transaction rewarding system network of the present invention;

FIG. 39A is a graphical user interface (GUI) screen generated by the my rewards module of the system network and displayed on the display screen of a mobile client system on the system network associated with the consumer who wants to manage their consumer reward credits, wherein the displayed GUI screen presents interfaces objects supporting the following modules, (i) pay with consumer reward gift card (CRGC) credit available on the system network, (ii) add credit to consumer reward gift card, (iii) donate (to charities and non-profits) with consumer reward gift card credit, and (iv) transfer consumer reward gift card credit, and wherein the consumer has selected and enabled the “pay with consumer rewards gift card (CRGC)” function to pay for goods and/or services with CRGC credit earned and maintained on the system network causing the “Display My QRS Code” interface object to be displayed to the consumer;

FIG. 39B is a graphical user interface (GUI) screen generated by the my rewards module of the system network and displayed on the display screen of a mobile client system on the system network associated with the consumer who wants to manage their consumer reward credits, where in response to selecting the “Display My QRS Code” interface object from the GUI screen shown in FIG. 39A, the GUI screen presents (i) the four function-enabling interface objects shown in FIG. 39A, and also (ii) the consumer's encoded QRS Code to be scanned by the client system of an affiliate to whom the consumer wishes to transfer a payment from its CRGC account to the affiliate's CRGC payment account, illustrated in FIG. 38;

FIG. 39C is a graphical user interface (GUI) screen generated by the my rewards module of the system network and displayed on the display screen of a mobile client system on the system network associated with the consumer who wants to manage their consumer reward credits, where in response to scanning the QRS Code” interface object from the GUI screen shown in FIG. 39A, the client system of the affiliate scanning the QRS Code operably connects through the system network with the CRGC payment system, establishes a payment transaction session therewith, and once ready to enable a transfer of CRGC credit from the consumer's CRGC account to the affiliate's CRGC payment account, the payment servers send an encrypted message to the consumer's client system, enabling the “pay now” interface object display on the display GUI screen shown in FIG. 38C, inviting the consume to select it and select, approve and authorize the payment to execute during the session;

FIG. 39D is a graphical user interface (GUI) screen generated by the my rewards module of the system network and displayed on the display screen of a mobile client system on the system network associated with the consumer who wants to manage their consumer reward credits, where in response to the consumer selecting the “pay now” interface object presented in the GUI screen shown in FIG. 39C, the payment transaction is executed, credit transfers occur as illustrated in FIG. 38, and the payment system sends a notification to the data center of the system network therewith that payment has been made, and the system network then notifies the consumer's client system and displays the “Review Payment Receipt” message illustrated in FIG. 39D;

FIG. 40 is a schematic representation of work flow process that can be used in making payments to charities and non-profit organizations, registered with the system network using ones consumer reward gift card (CRGC) account maintained on the system network;

FIGS. 41A, 41B, 41C and 41D is a series of graphical user interface (GUI) screens generated by the my rewards module of the system network and displayed on the display screen of a mobile client system on the system network associated with the consumer who wants to donate some of their consumer reward credits (i.e. money) to a charity or non-profit organization registered on the system network and having their own CRCG account, as illustrated in FIG. 1B, where after reviewing available balances in FIGS. 41A and 41B and selecting the “donate” interface object in FIG. 41C, the donation transaction is executed, whereupon the consumer selected amount of CRGC credit donation is transferred from the consumer's CRGC account to the charitable or non-profit organization's CRGC account, illustrated in FIG. 1B, and in response thereto, a donation receipt is displayed on the consumer's GUI screen as shown in FIG. 41D, to complete this donation transaction;

FIG. 42 is a schematic representation of work flow process that can be used in add credit value one's consumer reward gift card (CRGC) account maintained on the system network;

FIGS. 43A, 43B, and 43C is series of graphical user interface (GUI) screens generated by the my rewards module of the system network and displayed on the display screen of a mobile client system on the system network associated with the consumer who wants to add monetary credit from an external bank to their consumer reward gift card (CRGC) account maintained on the system network, as illustrated in FIG. 1B, where after reviewing available balances in FIG. 43A and selecting the “send” interface object in FIG. 43B, the credit transfer transaction is executed, whereupon the consumer specified CRGC credit amount is transferred from the consumer's selected bank to his or her CRGC account, illustrated in FIG. 1B, and in response thereto, a transfer receipt is displayed on the consumer's GUI screen as shown in FIG. 43C, to complete this transaction;

FIG. 44 is a schematic representation of work flow process that can be used in transfer credit value from one's consumer reward gift card (CRGC) account to another CRGC account maintained on the system network;

FIGS. 45A, 45B, and 45C is series of graphical user interface (GUI) screens generated by the my rewards module of the system network and displayed on the display screen of a mobile client system on the system network associated with the consumer who wants to transfer credit from their consumer reward gift card (CRGC) account to another's CRGC account maintained on the system network, as illustrated in FIG. 1B, where after reviewing available balances in FIG. 45A and selecting the “send” interface object in FIG. 45B, the credit transfer transaction is executed, whereupon the consumer specified CRGC credit amount is transferred from the consumer's selected bank to his or her CRGC account, illustrated in FIG. 1B, and in response thereto, a transfer receipt is displayed on the consumer's GUI screen as shown in FIG. 45C, to complete this transaction;

FIG. 46 is a map of primary affiliate services supported on the client system of affiliates (e.g. service providers, vendors and merchants) deployed on the system network of the present invention;

FIG. 47A is a graphical user interface (GUI) screen generated by the affiliate login module of the system network and displayed on the display screen of a mobile client system on the system network associated with an affiliate (or one of its principals or employees wants to needs to manage the affiliate's profile, consumer reward gift card payment account, or other services on the system network), wherein the displayed GUI screen presents an interface object (i.e. Affiliate Login) which, when selected, initiates the login process on the system network;

FIG. 47B is a graphical user interface (GUI) screen generated by the affiliate login module of the system network and displayed on the display screen of a mobile client system on the system network associated with an affiliate, wherein the displayed GUI screen presents interface objects for logging into the system network, or alternatively, registering with the system network if the user is not registered and does not have a user account on the system network;

FIG. 47C is a graphical user interface (GUI) screen generated by the affiliate registration module of the system network and displayed on the display screen of a mobile client system on the system network associated with an affiliate, wherein the displayed GUI screen presents interface objects for registering with the system network;

FIG. 47D is a graphical user interface (GUI) screen generated by the affiliate registration module of the system network and displayed on the display screen of a mobile client system on the system network associated with an affiliate, wherein the displayed GUI screen presents a confirmation that the user has successfully registered with the system network;

FIG. 47E is a graphical user interface (GUI) screen generated by the home (select a menu) module of the system network and displayed on the display screen of a mobile client system on the system network associated with an affiliate, wherein the displayed GUI screen presents the six primary service modules supported on the affiliate side of the system network, namely (i) manage affiliate profile, (ii) review consumer reward payments, (iii) manage jobs on network, (iv) register a consumer (i.e. customer), and (vi) manage consumer reward gift card (CRGC) payment account using any client system deployed on the system network of the present invention;

FIG. 48A is a graphical user interface (GUI) screen generated by the home (select a menu) module of the system network and displayed on the display screen of a mobile client system on the system network associated with an affiliate, wherein the displayed GUI screen presents the six primary service modules supported on the affiliate side of the system network, and the consumer selects the “manage affiliate profile” module;

FIG. 48B is a graphical user interface (GUI) screen generated by the manage affiliate profile module of the system network and displayed on the display screen of a mobile client system on the system network associated with an affiliate, wherein the displayed GUI screen presents the affiliate profile information management screen which allows the affiliate to update profile information as required, via virtual keyboard which is enabled upon touching the screen, as illustrated in FIG. 48C, and when information has been changed, selecting the “save update profile” interface object (e.g. button) automatically saves the information updates to persistent memory in the database system of the system network;

FIG. 48C is a graphical user interface (GUI) screen generated by the manage affiliate profile module of the system network and displayed on the display screen of a mobile client system on the system network associated with an affiliate, wherein a virtual keyboard is enabled upon touching the screen, for entering profile information updates;

FIG. 49A is a graphical user interface (GUI) screen generated by the home (select a menu) module of the system network and displayed on the display screen of a mobile client system on the system network associated with an affiliate, wherein the displayed GUI screen presents the six primary service modules supported on the affiliate side of the system network, and the consumer selects the “manage jobs on network” module;

FIG. 49B is a graphical user interface (GUI) screen generated by the manage jobs on network module of the system network and displayed on the display screen of a mobile client system on the system network associated with an affiliate, wherein the “update a job” interface object is selected to present the GUI screen shown in FIG. 49C;

FIG. 49C is a graphical user interface (GUI) screen generated by the manage jobs on network module of the system network and displayed on the display screen of a mobile client system on the system network associated with an affiliate, wherein the displayed GUI screen presents the Update A Job screen which allows the affiliate to update job information as required, via a virtual keyboard shown which is enabled upon touching the screen, and when information has been changed, selecting the “submit update” interface object (e.g. button) automatically saves the information updates to persistent memory in the database system of the system network;

FIG. 49D is a graphical user interface (GUI) screen generated by the manage jobs on network module of the system network and displayed on the display screen of a mobile client system on the system network associated with an affiliate, wherein the displayed GUI screen presents the confirmation message sent to the affiliate for completing the referred job, and notifying the same that the system network will automatically issue consumer rewards credit to the referring consumer, the consumer who posted the job to the referral pool, and the system administrator;

FIG. 49E is a graphical user interface (GUI) screen generated by the manage jobs on network module of the system network and displayed on the display screen of a mobile client system on the system network associated with an affiliate, wherein the affiliate selected an add a new job GUI screen, so that the affiliate can add a job for a consumer who did not contact him through the system network, where upon adding the job, the system automatically generates a job number for the added job, and if the job is for a new user, then contact details for the person are added by the affiliate and the system network will generate a new user/consumer profile for that customer, and then the system will send a message requiring the new user to (i) download client application software (for native client system software application enablement on the client system) or a URL for access to the web-based responsive-design website providing a web-based interface and services to the web-enabled client system used by the new system user, and (ii) activate its new consumer reward gift card (CRGC) account with the CRGC payment system within the system network of the present invention, and thereafter, the affiliate adds all of the customer and job related information required including job amount so that the correct consumer reward can be calculated and issued by the system network (i.e. CRGC payment system) to the customer upon completion of the job;

FIG. 49F is a graphical user interface (GUI) screen generated by the manage jobs on network module of the system network and displayed on the display screen of a mobile client system on the system network associated with an affiliate, wherein the displayed GUI screen presents the confirmation message confirming that the new job has been successfully added to the system network for the customer/consumer;

FIG. 50A is a graphical user interface (GUI) screen generated by the home (select a menu) module of the system network and displayed on the display screen of a mobile client system on the system network associated with an affiliate, wherein the displayed GUI screen presents the six primary service modules supported on the affiliate side of the system network, and the consumer selects the “review consumer rewards” module;

FIG. 50B is a graphical user interface (GUI) screens generated by the review consumer rewards module of the system network and displayed on the display screen of a mobile client system on the system network associated with an affiliate, wherein the “review recent consumer reward payments” interface object is selected to present a list of consumer reward gift card credits (e.g. measured in $) which have been recently issued (e.g. over the past 30 days) by the affiliate;

FIG. 50C is a graphical user interface (GUI) screens generated by the review consumer rewards module of the system network and displayed on the display screen of a mobile client system on the system network associated with an affiliate, wherein the “review all consumer reward payments” interface object is selected to present a list of all consumer reward gift card credits (e.g. measured in $) which have been issued by the affiliate from the first date of the CRGC payment account opening to the present moment;

FIG. 51A is a graphical user interface (GUI) screens generated by the home (select a menu) module of the system network and displayed on the display screen of a mobile client system on the system network associated with an affiliate, wherein the displayed GUI screen presents the six primary service modules supported on the affiliate side of the system network, and the consumer selects the “register consumers” module;

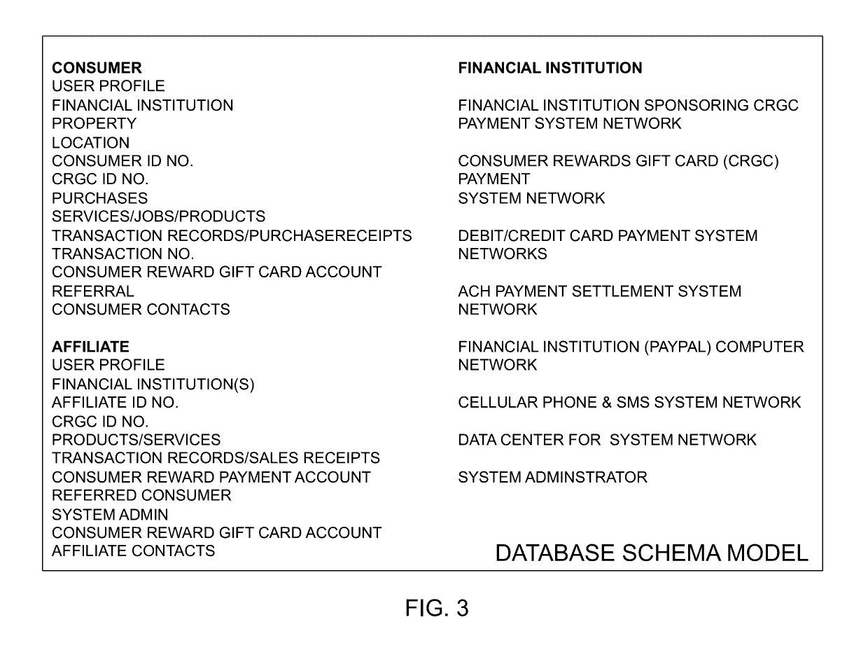

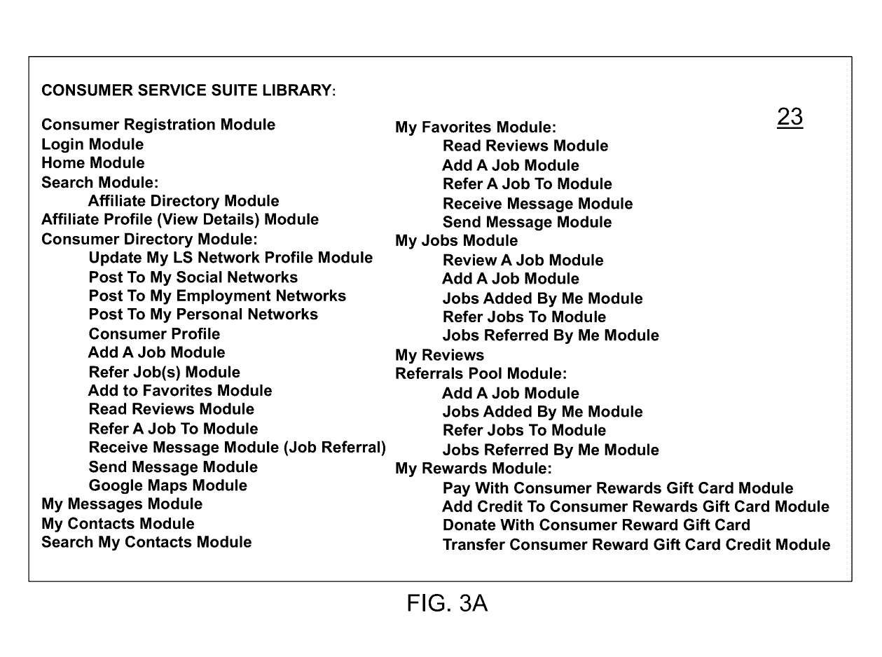

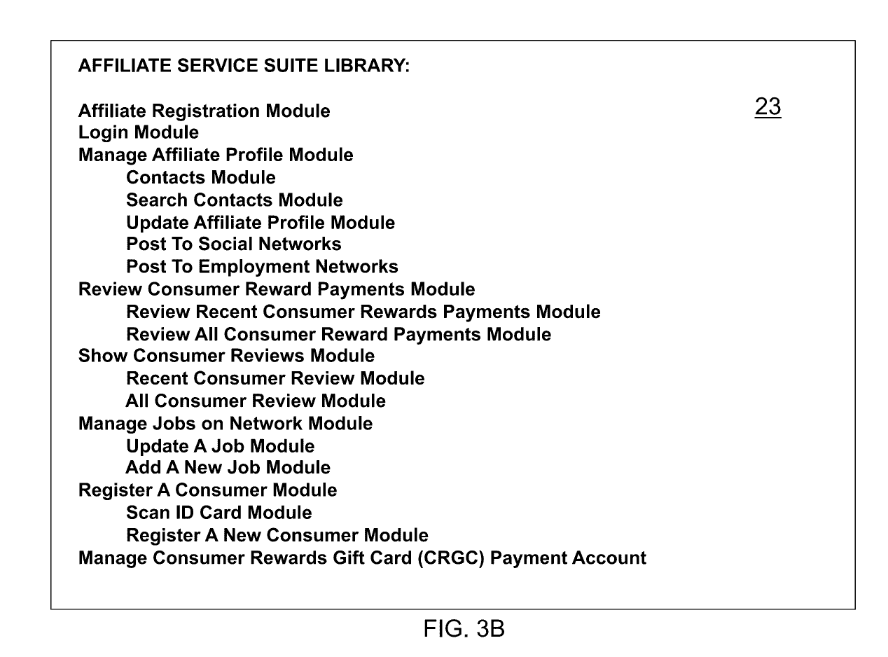

FIGS. 51B through 51D is a series of graphical user interface (GUI) screens generated by the register consumers module of the system network and displayed on the display screen of a mobile client system on the system network associated with an affiliate, wherein the “register consumers” interface object is selected to present an interface for entering consumer profile information minimally required to register a new consumer to the system network, using either (i) the integrated bar code scanner which scans the new consumer's ID barcode on an ID card (e.g. driver's license or other card) to capture the user's name, address and other available information as shown in FIGS. 51B-1, and (ii) a virtual keyboard for manually key-entering profile information into the form, and thereafter using GUI screen shown in FIG. 51B-3, the affiliate selects the “submit” interface object to store the user profile information in persistent memory storage devices on the system network, and complete user registration;

FIG. 52A is a graphical user interface (GUI) screens generated by the home (select a menu) module of the system network and displayed on the display screen of a mobile client system on the system network associated with an affiliate, wherein the displayed GUI screen presents the six primary service modules supported on the affiliate side of the system network, and the consumer selects the “show consumer reviews” module;

FIG. 52B is a graphical user interface (GUI) screen generated by the show consumer reviews module of the system network and displayed on the display screen of a mobile client system on the system network associated with an affiliate, wherein the review “recent consumer reviews” interface object is selected to present a list of consumer reviews of affiliates which have been recently posted (e.g. over the past 30 days) by particular consumers regarding the quality and manner in which jobs were performed by the affiliate;

FIG. 52C is a graphical user interface (GUI) screen generated by the show consumer reviews module of the system network and displayed on the display screen of a mobile client system on the system network associated with an affiliate, wherein an “affiliate review(s)” (i.e. consumer review of an affiliate) is presented on the GUI screen, showing the name, address and contact information of the affiliate and typically a written review of the affiliate's performance in carrying out the specified job, with words of recommendation or condemnation provided;

FIG. 53A is a graphical user interface (GUI) screens generated by the home (select a menu) module of the system network and displayed on the display screen of a mobile client system on the system network associated with an affiliate, wherein the displayed GUI screen presents the six primary service modules supported on the affiliate side of the system network, and the consumer selects the “manage CRGC payment account” module;

FIG. 53B is a graphical user interface (GUI) screen generated by the manage CRGC payment account module of the system network and displayed on the display screen of a mobile client system on the system network associated with an affiliate, wherein the review and affiliate (consumer reward)gift card credit balance interface object is selected to present affiliate details regarding the balance of CRGC payment credit available in the affiliate's CRGC payment account within the CRGC payment system on the system network;

FIG. 53C is a graphical user interface (GUI) screen generated by the manage CRGC payment account module of the system network and displayed on the display screen of a mobile client system on the system network associated with an affiliate, wherein a configuration of “affiliate settings on network” interface object is presented on the GUI screen, showing the affiliate configuration settings including affiliate ID No., Affiliate Name, Affiliate Contact, Affiliate bank account information, bank routing number, bank account number, set auto limit amount (determining how much money needs to be transferred to maintain a specific predetermined credit limit in the affiliate's CRGC payment amount account;

FIG. 54A is a graphical user interface (GUI) screen generated by the select a menu module (i.e. affiliate home module) of the system network and displayed on the display screen of a mobile client system on the system network associated with an affiliate, wherein the “affiliate contacts module” interface object is being selected from the GUI screen, so that affiliate contacts and group management functions can be performed in GUI screens shown in FIGS. 54B and 54C;

FIG. 54B is a graphical user interface (GUI) screen generated by the affiliate contact module of the system network and displayed on the display screen of a mobile client system on the system network associated with an affiliate, wherein interface objects for the manage affiliate contacts module and the manage affiliate groups are displayed, and wherein the manage affiliate contacts module is selected for affiliate contact management purposes (e.g. import and sync contacts with the affiliate's CRM system such as PeopleSoft, review affiliate contacts, add a new affiliate contact, etc);

FIG. 54C is a graphical user interface (GUI) screen generated by the affiliate contacts module of the system network and displayed on the display screen of a mobile client system on the system network associated with an affiliate, wherein interface object for the manage affiliate contacts module is selected causing the sync affiliate contacts module, the review affiliate contacts module and the add new affiliate contact module to be displayed, and wherein the sync affiliate contacts module is selected for importing contact files from and synchronizing contact files within the affiliate's contacts directory on the system network, with contact files maintained within the affiliate's enterprise-level CRM system, such as PeopleSoft);

FIG. 54D is a graphical user interface (GUI) screen generated by the affiliate contacts module of the system network and displayed on the display screen of a mobile client system on the system network associated with an affiliate, wherein interface object for the manage affiliate contacts module is selected causing the sync affiliate contacts module, the review affiliate contacts module and the add new affiliate contact module to be displayed, and wherein the review affiliate contacts module is selected for reviewing affiliate contacts;

FIG. 54E is a graphical user interface (GUI) screen generated by the affiliate contacts module of the system network and displayed on the display screen of a mobile client system on the system network associated with an affiliate, wherein interface object for the manage affiliate contacts module is selected causing the sync affiliate contacts module, the review affiliate contacts module and the add new affiliate contact module to be displayed, and wherein the add a new affiliate contact module is selected for adding a new affiliate contact;

FIG. 54F is a graphical user interface (GUI) screen generated by the affiliate contacts module of the system network and displayed on the display screen of a mobile client system on the system network associated with an affiliate, wherein interface objects for the manage affiliate contacts module and the manage affiliate groups are displayed, and wherein the manage affiliate groups module is selected for affiliate groups management purposes (e.g. review current affiliate groups created and supported on the system network, and adding a new affiliate group);

FIG. 54G is a graphical user interface (GUI) screen generated by the affiliate contacts module of the system network and displayed on the display screen of a mobile client system on the system network associated with an affiliate, wherein the interface object for the review affiliate groups module has been selected, causing a list of affiliate groups to be displayed to which the user belong, along with a menu of tools allowing the user to edit the affiliate groups, save them, and even delete them as desired by the affiliate user;

FIG. 54H is a graphical user interface (GUI) screen generated by the affiliate contacts module of the system network and displayed on the display screen of a mobile client system on the system network associated with an affiliate, wherein the interface object for the create new affiliate groups module has been selected, causing a new affiliate group form to be displayed, along with a menu of tools allowing the user to create a new group of affiliates from the user's contacts, and thereafter the save the new affiliate group, and even delete the new group before it is saved, as might be desired by the affiliate user;

FIG. 55A is a graphical user interface (GUI) screen generated by the select a menu module (i.e. affiliate home module) of the system network and displayed on the display screen of a mobile client system on the system network associated with an affiliate, wherein the “affiliate messaging module” interface object is being selected from the GUI screen, so that affiliate messaging functions can be performed in GUI screens shown in FIGS. 55B through 55E;

FIG. 55B is a graphical user interface (GUI) screen generated by the affiliate messaging module of the system network and displayed on the display screen of a mobile client system on the system network associated with an affiliate, wherein interface objects for the review affiliate messages module and the send new message are displayed;

FIG. 55C is a graphical user interface (GUI) screen generated by the affiliate messaging module of the system network and displayed on the display screen of a mobile client system on the system network associated with an affiliate, wherein interface object for the review affiliate messages module is selected causing a list of incoming messages to be reviewed by the user by selecting the message to be reviewed in the display space provided in the GUI screen;

FIG. 55D is a graphical user interface (GUI) screen generated by the affiliate messaging module of the system network and displayed on the display screen of a mobile client system on the system network associated with an affiliate, wherein interface object for the new affiliate message module is selected causing a new message interface to be displayed allowing the user affiliate to create a new message for a single contact, using a on-screen virtual keyboard, along with a set of tools allowing the user to select from his or her list of contacts, list of affiliate groups, save the message, and send the message;

FIG. 54E is a graphical user interface (GUI) screen generated by the affiliate messaging module of the system network and displayed on the display screen of a mobile client system on the system network associated with an affiliate, wherein interface object for the new affiliate message module is selected causing a new message interface to be displayed allowing the user affiliate to create a new message for a affiliate selected by the user (e.g. LS B2B GROUP BRIDGEPORT WEST), using a on-screen virtual keyboard, along with a set of tools allowing the user to select from his or her list of contacts, list of affiliate groups, save the message, and send the message; and

FIG. 56A and FIG. 56B is a series of graphical user interface (GUI) screens generated by the select a menu module (i.e. affiliate home module) of the system network and displayed on the display screen of a mobile client system on the system network associated with an affiliate, wherein the “logoff” interface object is being selected from the GUI screen, so that the client system logs off the system network, and displaying the GUI screen shown in FIG. 56B, ready for logging back into the system network upon selecting the interface object labeled “affiliate login”.

### BRIEF DESCRIPTION OF THE PREFERRED EMBODIMENTS OF THE PRESENT INVENTION

Referring to the accompanying Drawings, like structures and elements shown throughout the figures thereof shall be indicated with like reference numerals.

### Overview on Uses and Benefits of the Internet-Based Affiliate-Referral Driven Consumer Transaction Supporting System Network of the Present Invention

The system network system of the present invention is designed to help consumers in many unique ways: (1) the consumer can search their personal phone contacts to find network affiliates (including service providers and merchants) that people close to them have also used; (2) the consumer can direct rewards towards their friends by using the phone contact feature; (3) the consumer will receive a monetary reward for completing a search that leads to a contract between the consumer and the affiliate service provider; (4) the consumer will receive monetary reward (e.g. consumer reward gift card CRGC credit) for assisting with a search that lead to a contract between a consumer and affiliate service provider; (5) the consumer can post promotions of affiliates service providers that they have used, to their social networks (e.g. the consumer who posts receiving a 20% discount from Celtic Tree Service for work completed in January, has a opportunity to profit from the post if it drives a future job referral which is ultimately completed; (6) the consumer will feel a sense of empowerment as he recognizes that his information need not be sold by a third party (e.g. the consumer will come to realize that the system network is a platform for the community to exchanged information, and the system network will be perceived as the search engine designed for the community where the consumer can deliver their own information and profit from it; (7) the consumer will benefit from being able to get access to the 10 most recent reviews of each affiliate their are considering, with the understanding that every time an affiliate issues a reward, the consumer must review the service for which the consumer reward is being given; (8) the system network of the present invention is a true reviewed system in that affiliates have no control over who writes a review and affiliates are reviewed on every job because there is economic incentive for doing so.

The system network system of the present invention is designed to help network affiliates (e.g. service providers, merchants and branded product manufacturers) in many unique ways as well: (1) the affiliate will benefit by working as a group to advertise there profile on the affiliate directory; (2) affiliates can get instance access to every consumer who will down load and use the client system application software used in the system network of the present invention; (3) affiliates will benefit from consumers posting the affiliate special offers on the consumer social media which will benefit both the Affiliate and the consumer; (4) affiliates will benefit from affiliate posting special offers to their B2B groups which in many cases would be a duplicate of business network international, and the system network platform of the present invention can help manage the referrals between these groups; (5) affiliates benefit in that if they are part of the referral program, then there is no monthly charge. Affiliates pay their fee only after they get a contract and are paid for a job, and there is no risk to the affiliate unlike conventional advertising where they pay first and pray that someone will call; (6) affiliates benefit by building a customer base that they can post their promotions on there social networks where both parties; (7) affiliates benefits by rewarding his costumers for delivering there own information instead of a third party; and (8) affiliates benefit by sending rewards to consumer who then spend it back with another affiliate.

By design, the system network of the present invention is designed to be readily integrated with conventional social networks, personal networks, e-commerce sites, employment networks, and elsewhere along the fabric of the WWW, in various ways, to support the goals and objectives of the system of the present invention, and also to enhance to conventional social networks, personal networks, employment networks, and numerous other services offered across the WWW.

### Specification of the Network Architecture of the System Network of the Present Invention

FIG. 1 illustrates the network architecture of the Internet-based affiliate-referral driven consumer transaction rewarding system network of the present invention 1 for the case where the system of the present invention is implemented as a stand-alone platform designed to work independent from but alongside of one or more computer networks deployed on the Internet.

As shown in FIG. 1, the Internet-based affiliate-referral driven consumer transaction rewarding system network of the present invention 1 comprises: (i) a plurality of affiliate computer system networks 2A through 2Z, each having web-based client machines, web servers, object-oriented application software servers, and database servers operably connected to the infrastructure of the Internet 16, (ii) a data center 3 supporting the system network of the present invention, comprising web servers, object-oriented application software servers, and database servers operably connected to the infrastructure of the Internet 16, (iii) computer system network 4 of the financial institution sponsoring the consumer reward gift card (CRGC) payment system network 5 supporting the affiliate-referral driven consumer transaction rewarding system network 1, (iv) debit/credit card payments system networks 6 operably connected to the infrastructure of the Internet, for processing and settling credit and/or debit card transactions over the system network 1, (v) ACH payment settlement system network 7 operably connected to the infrastructure of the Internet 16, (vi) a plurality of computer system networks 8 for financial institutions associated with the affiliates (e.g. affiliated service providers and merchants registered with the system network 1), (viii) cellular phone and SMS system networks 9 operably connected to the infrastructure of the Internet 16, (vii) affiliate web site servers 10 operably connected to the infrastructure of the Internet, (ix) local digital cable TV networks 11 operably connected to the infrastructure of the Internet 16, (xi) social media site and networks (e.g. Facebook social network, Google+, LinkedIn, etc.) 17 operably connected to the infrastructure of the Internet 16, (xiii) consumer mobile/desktop computer systems 12 operably connected to the infrastructure of the Internet 16, (xiv) charitable and non-profit organization computer system networks 13 operably connected to the infrastructure of the Internet 16, (xv) financial institution (e.g. PayPal) computer system network 14 operably connected to the infrastructure of the Internet, (xvi) an ACH payment settlement system network 7 operably connected to the infrastructure of the Internet 16, and (xvii) system admin computer system network 15 operably connected to the infrastructure of the Internet 16.

As shown in FIG. 1A, the Internet-based system network of the present invention is shown comprising various system components, including an cellular phone and SMS messaging systems 9, and one or more industrial-strength data centers 3, and each data center 3 comprising: a cluster of communication servers 20 for supporting http and other TCP/IP based communication protocols on the Internet; cluster of application server systems 21; a cluster of email processing servers 9B; and a cluster of RDBMS servers 22, and interfaced around the TCP/IP infrastructure of the Internet 16 well known in the art. As shown, the system network architecture further comprises; a plurality of Web-enabled client machines 12 (e.g. desktop computers, mobile computers such as iPad, and other Internet-enabled computing devices with graphics display capabilities, etc) running native client system software applications and mobile web-browser applications supported by modules 23, identified in FIGS. 3A and 3B, supporting client-side and server-side processes on the system network of the present invention.

In general, regardless of the method of implementation employed in any particular embodiment, the system network of the present invention will be in almost all instances realized as an industrial-strength, carrier-class Internet-based network of object-oriented system design, deployed over a global data packet-switched communication network comprising numerous computing systems and networking components, as shown. As such, the information network of the present invention is often referred to herein as the “system” or “system network”. The Internet-based system network can be implemented using any object-oriented integrated development environment (IDE) such as for example: the Java Platform, Enterprise Edition, or Java EE (formerly J2EE); Websphere IDE by IBM; Weblogic IDE by BEA; a non-Java IDE such as Microsoft's .NET IDE; or other suitably configured development and deployment environment well known in the art. Preferably, although not necessary, the entire system of the present invention would be designed according to object-oriented systems engineering (OOSE) methods using UML-based modeling tools such as ROSE by Rational Software, Inc. using an industry-standard Rational Unified Process (RUP) or Enterprise Unified Process (EUP), both well known in the art. Implementation programming languages can include C, Objective C, C″, Java, PHP, Python, Google's GO, and other computer programming languages known in the art.

### System Architecture of an Exemplary Application Server System Deployed on the System Network of the Present Invention

FIG. 1C illustrates the system architecture of an exemplary application server system component 21 deployed on the system network of the present invention and supporting the many services offered by the system network. In general, the application server system 21 facilitates the operation of the system network via a computer system (e.g., one or more cloud computing systems, grid computing systems, virtualized computer systems, mainframe computers, servers, clients, nodes, desktops, mobile devices such as smart phones, cellular phones, tablets, personal digital assistants (PDAs), and/or the like, embedded computers, dedicated computers, a system on a chip (SOC)). For example, the application server may receive, obtain, aggregate, process, generate, store, retrieve, send, delete, input, output, and/or the like data (including program data and program instructions); may execute program instructions; may communicate with computer systems, system networks, with nodes, with users, and/or the like.

In various embodiments, the application server system 21 may comprise a standalone computer system, a distributed computer system, a node in a computer network (i.e., a network of computer systems organized in a topology), a network of application server, and/or the like. It is to be understood that the application server and/or the various application server elements (e.g., processor, system bus, memory, input/output devices) may be organized in any number of ways (i.e., using any number and configuration of computer systems, computer networks, nodes, application server elements, and/or the like) to facilitate system network operation. Furthermore, it is to be understood that the various application server computer systems, application server computer networks, application server nodes, application server elements, and/or the like may communicate among each other in any number of ways to facilitate system network operation.

As used in this disclosure, the term “user” refers generally to people and/or computer systems that interact with the system network; the term “server” refers generally to a computer system, a program, and/or a combination thereof that handles requests and/or responds to requests from clients via a computer network; the term “client” refers generally to a computer system, a program, a user, and/or a combination thereof that generates requests and/or handles responses from servers via a computer network; the term “node” refers generally to a server, to a client, and/or to an intermediary computer system, program, and/or a combination thereof that facilitates transmission of and/or handling of requests and/or responses.

As shown in FIG. 1C, the application server system 21 comprises a processor 401 that executes program instructions (e.g., system network program instructions). In various embodiments, the processor may be a general purpose microprocessor (e.g., a central processing unit (CPU)), a dedicated microprocessor (e.g., a graphics processing unit (GPU), a physics processing unit (PPU), a digital signal processor (DSP), a network processor, and/or the like), an external processor, a plurality of processors (e.g., working in parallel, distributed, and/or the like), a microcontroller (e.g., for an embedded system), and/or the like. The processor may be implemented using integrated circuits (ICs), application-specific integrated circuits (ASICs), field-programmable gate arrays (FPGAs), and/or the like. In various implementations, the processor may comprise one or more cores, may include embedded elements (e.g., a coprocessor such as a math coprocessor, a cryptographic coprocessor, a physics coprocessor, and/or the like, registers, cache memory, software), may be synchronous (e.g., using a clock signal) or asynchronous (e.g., without a central clock), and/or the like. For example, the processor may be an AMD FX processor, an AMD Opteron processor, an AMD Geode LX processor, an Intel Core i7 processor, an Intel Xeon processor, an Intel Atom processor, an ARM Cortex processor, an IBM PowerPC processor, and/or the like.

The processor may be connected to system memory 405 via a system bus 403. The system bus may interconnect these and/or other elements of the application server via electrical, electronic, optical, wireless, and/or the like communication links (e.g., the system bus may be integrated into a motherboard that interconnects application server elements and provides power from a power supply). In various embodiments, the system bus may comprise one or more control buses, address buses, data buses, memory buses, peripheral buses, and/or the like. In various implementations, the system bus may be a parallel bus, a serial bus, a daisy chain design, a hub design, and/or the like. For example, the system bus may comprise a front-side bus, a back-side bus, AN/ID's HyperTransport, Intel's QuickPath Interconnect, a peripheral component interconnect (PCI) bus, an accelerated graphics port (AGP) bus, a PCI Express bus, a low pin count (LPC) bus, a universal serial bus (USB), and/or the like.

The system memory, in various embodiments, may comprise registers, cache memory (e.g., level one, level two, level three), read only memory (ROM) (e.g., BIOS, flash memory), random access memory (RAM) (e.g., static RAM (SRAM), dynamic RAM (DRAM), error-correcting code (ECC) memory), and/or the like. The system memory may be discreet, external, embedded, integrated into a CPU, and/or the like. The processor may access, read from, write to, store in, erase, modify, and/or the like, the system memory in accordance with program instructions (e.g., system network program instructions) executed by the processor. The system memory may facilitate accessing, storing, retrieving, modifying, deleting, and/or the like data (e.g., system network data) by the processor.

In various embodiments, input/output devices 410 may be connected to the processor and/or to the system memory, and/or to one another via the system bus. In some embodiments, the input/output devices may include one or more graphics devices 411. The processor may make use of the one or more graphic devices in accordance with program instructions (e.g., system network program instructions) executed by the processor.

In one implementation, a graphics device may be a video card that may obtain (e.g., via a connected video camera), process (e.g., render a frame), output (e.g., via a connected monitor, television, and/or the like), and/or the like graphical (e.g., multimedia, video, image, text) data (e.g., system network data). A video card may be connected to the system bus via an interface such as PCI, AGP, PCI Express, USB, PC Card, ExpressCard, and/or the like. A video card may use one or more graphics processing units (GPUs), for example, by utilizing AMD's CrossFireX and/or NVIDIA's SLI technologies. A video card may be connected via an interface (e.g., video graphics array (VGA), digital video interface (DVI), Mini-DVI, Micro-DVI, high-definition multimedia interface (HDMI), DisplayPort, Thunderbolt, composite video, S-Video, component video, and/or the like) to one or more displays (e.g., cathode ray tube (CRT), liquid crystal display (LCD), touchscreen, and/or the like) that display graphics. For example, a video card may be an AMD Radeon HD 6990, an ATI Mobility Radeon HD 5870, an AMD FirePro V9800P, an AMD Radeon E6760 MXM V3.0 Module, an NVIDIA GeForce GTX 590, an NVIDIA GeForce GTX 580M, an Intel HD Graphics 3000, and/or the like. In another implementation, a graphics device may be a video capture board that may obtain (e.g., via coaxial cable), process (e.g., overlay with other graphical data), capture, convert (e.g., between different formats, such as MPEG2 to H.264), and/or the like graphical data. A video capture board may be and/or include a TV tuner, may be compatible with a variety of broadcast signals (e.g., NTSC, PAL, ATSC, QAM) may be a part of a video card, and/or the like. For example, a video capture board may be an ATI All-in-Wonder HD, a Hauppauge ImpactVBR 01381, a Hauppauge WinTV-HVR-2250, a Hauppauge Colossus 01414, and/or the like. A graphics device may be discreet, external, embedded, integrated into a CPU, and/or the like. A graphics device may operate in combination with other graphics devices (e.g., in parallel) to provide improved capabilities, data throughput, color depth, and/or the like.

In some embodiments, the input/output devices may include one or more audio devices 413. The processor may make use of the one or more audio devices in accordance with program instructions (e.g., system network program instructions) executed by the processor. In one implementation, an audio device may be a sound card that may obtain (e.g., via a connected microphone), process, output (e.g., via connected speakers), and/or the like audio data (e.g., system network data). A sound card may be connected to the system bus via an interface such as PCI, PCI Express, USB, PC Card, ExpressCard, and/or the like. A sound card may be connected via an interface (e.g., tip sleeve (TS), tip ring sleeve (TRS), RCA, TOSLINK, optical) to one or more amplifiers, speakers (e.g., mono, stereo, surround sound), subwoofers, digital musical instruments, and/or the like. For example, a sound card may be an Intel AC′97 integrated codec chip, an Intel HD Audio integrated codec chip, a Creative Sound Blaster X-Fi Titanium HD, a Creative Sound Blaster X-Fi Go! Pro, a Creative Sound Blaster Recon 3D, a Turtle Beach Riviera, a Turtle Beach Amigo II, and/or the like. An audio device may be discreet, external, embedded, integrated into a motherboard, and/or the like. An audio device may operate in combination with other audio devices (e.g., in parallel) to provide improved capabilities, data throughput, audio quality, and/or the like.

In some embodiments, the input/output devices may include one or more network devices 415. The processor may make use of the one or more network devices in accordance with program instructions (e.g., system network program instructions) executed by the processor. In one implementation, a network device may be a network card that may obtain (e.g., via a Category 5 Ethernet cable), process, output (e.g., via a wireless antenna), and/or the like network data (e.g., system network data). A network card may be connected to the system bus via an interface such as PCI, PCI Express, USB, FireWire, PC Card, ExpressCard, and/or the like. A network card may be a wired network card (e.g., 10/100/1000, optical fiber), a wireless network card (e.g., Wi-Fi 802.11a/b/g/n/ac/ad, Bluetooth, Near Field Communication (NFC), TransferJet), a modem (e.g., dialup telephone-based, asymmetric digital subscriber line (ADSL), cable modem, power line modem, wireless modem based on cellular protocols such as high speed packet access (HSPA), evolution-data optimized (EV-DO), global system for mobile communications (GSM), worldwide interoperability for microwave access (WiMax), long term evolution (LTE), and/or the like, satellite modem, FM radio modem, radio-frequency identification (RFID) modem, infrared (IR) modem), and/or the like. For example, a network card may be an Intel EXPI9301CT, an Intel EXPI9402PT, a LINKSYS USB300M, a BUFFALO WLI-UC-G450, a Rosewill RNX-MiniN1, a TRENDnet TEW-623P1, a Rosewill RNX-N180UBE, an ASUS USB-BT211, a MOTOROLA SB6120, a U.S. Robotics USR5686G, a Zoom 5697-00-00F, a TRENDnet TPL-401E2K, a D-Link DHP-W306AV, a StarTech ET91000SC, a Broadcom BCM20791, a Broadcom InConcert BCM4330, a Broadcom BCM4360, an LG VL600, a Qualcomm MDM9600, a Toshiba TC35420 TransferJet device, and/or the like. A network device may be discreet, external, embedded, integrated into a motherboard, and/or the like. A network device may operate in combination with other network devices (e.g., in parallel) to provide improved data throughput, redundancy, and/or the like. For example, protocols such as link aggregation control protocol (LACP) based on IEEE 802.3AD-2000 or IEEE 802.1AX-2008 standards may be used. A network device may be used to connect to a local area network (LAN), a wide area network (WAN), a metropolitan area network (MAN), a personal area network, the Internet, an intranet, a Bluetooth network, an NFC network, a Wi-Fi network, a cellular network, and/or the like.

In some embodiments, the input/output devices may include one or more peripheral devices 417. The processor may make use of the one or more peripheral devices in accordance with program instructions (e.g., system network program instructions) executed by the processor. In various implementations, a peripheral device may be a digital camera, a video camera, a webcam, an electronically moveable pan tilt zoom (PTZ) camera, a monitor, a touchscreen display, active shutter 3D glasses, head-tracking 3D glasses, a remote control, an audio line-in, an audio line-out, a microphone, headphones, speakers, a subwoofer, a router, a hub, a switch, a firewall, an antenna, a keyboard, a mouse, a trackpad, a trackball, a digitizing tablet, a stylus, a joystick, a gamepad, a game controller, a force-feedback device, a laser, sensors (e.g., proximity sensor, rangefinder, ambient temperature sensor, ambient light sensor, humidity sensor, an accelerometer, a gyroscope, a motion sensor, an olfaction sensor, a biosensor, a chemical sensor, a magnetometer, a radar, a sonar, a location sensor such as global positioning system (GPS), Galileo, GLONASS, and/or the like), a printer, a fax, a scanner, a copier, a card reader, and/or the like. A peripheral device may be connected to the system bus via an interface such as PCI, PCI Express, USB, FireWire, VGA, DVI, Mini-DVI, Micro-DVI, HDMI, DisplayPort, Thunderbolt, composite video, S-Video, component video, PC Card, ExpressCard, serial port, parallel port, PS/2, TS, TRS, RCA, TOSLINK, network connection (e.g., wired such as Ethernet, optical fiber, and/or the like, wireless such as Wi-Fi, Bluetooth, NFC, cellular, and/or the like), a connector of another input/output device, and/or the like. A peripheral device may be discreet, external, embedded, integrated (e.g., into a processor, into a motherboard), and/or the like. A peripheral device may operate in combination with other peripheral devices (e.g., in parallel) to provide the application server with a variety of input, output and processing capabilities.

In some embodiments, the input/output devices may include one or more storage devices 419. The processor may access, read from, write to, store in, erase, modify, and/or the like a storage device in accordance with program instructions (e.g., system network program instructions) executed by the processor. A storage device may facilitate accessing, storing, retrieving, modifying, deleting, and/or the like data (e.g., system network data) by the processor. In one implementation, the processor may access data from the storage device directly via the system bus. In another implementation, the processor may access data from the storage device by instructing the storage device to transfer the data to the system memory and accessing the data from the system memory. In various embodiments, a storage device may be a hard disk drive (HDD), a solid-state drive (SSD), a floppy drive using diskettes, an optical disk drive (e.g., compact disk (CD-ROM) drive, CD-Recordable (CD-R) drive, CD-Rewriteable (CD-RW) drive, digital versatile disc (DVD-ROM) drive, DVD-R drive, DVD-RW drive, Blu-ray disk (BD) drive) using an optical medium, a magnetic tape drive using a magnetic tape, a memory card (e.g., a USB flash drive, a compact flash (CF) card, a secure digital extended capacity (SDXC) card), a network attached storage (NAS), a direct-attached storage (DAS), a storage area network (SAN), other processor-readable physical mediums, and/or the like. A storage device may be connected to the system bus via an interface such as PCI, PCI Express, USB, FireWire, PC Card, ExpressCard, integrated drive electronics (IDE), serial advanced technology attachment (SATA), external SATA (eSATA), small computer system interface (SCSI), serial attached SCSI (SAS), fibre channel (FC), network connection (e.g., wired such as Ethernet, optical fiber, and/or the like; wireless such as Wi-Fi, Bluetooth, NFC, cellular, and/or the like), and/or the like. A storage device may be discreet, external, embedded, integrated (e.g., into a motherboard, into another storage device), and/or the like. A storage device may operate in combination with other storage devices to provide improved capacity, data throughput, data redundancy, and/or the like. For example, protocols such as redundant array of independent disks (RAID) (e.g., RAID 0 (striping), RAID 1 (mirroring), RAID 5 (striping with distributed parity), hybrid RAID), just a bunch of drives (JBOD), and/or the like may be used. In another example, virtual and/or physical drives may be pooled to create a storage pool. In yet another example, an SSD cache may be used with a HDD to improve speed.

Together and/or separately the system memory 405 and the one or more storage devices 419 may be referred to as memory 420 (i.e., physical memory). The system network memory 420 contains processor-operable (e.g., accessible) system network data stores 430. Data stores 430 comprise data that may be used (e.g., by the system network) via the application server. Such data may be organized using one or more data formats such as a database (e.g., a relational database with database tables, an object-oriented database, a graph database, a hierarchical database), a flat file (e.g., organized into a tabular format), a binary file (e.g., a GIF file, an MPEG-4 file), a structured file (e.g., an HTML file, an XML file), a text file, and/or the like. Furthermore, data may be organized using one or more data structures such as an array, a queue, a stack, a set, a linked list, a map, a tree, a hash, a record, an object, a directed graph, and/or the like. In various embodiments, data stores may be organized in any number of ways (i.e., using any number and configuration of data formats, data structures, application server elements, and/or the like) to facilitate system network operation. For example, system network data stores may comprise data stores 430a-f implemented as one or more databases. A users data store 430a may be a collection of database tables that include fields such as UserID, UserName, UserPreferences, AssociatedAffiliates, and/or the like. A clients data store 430b may be a collection of database tables that include fields such as ClientID, ClientName, ClientDeviceType, ClientScreenResolution, and/or the like. A jobs data store 430c may be a collection of database tables that include fields such as JobID, JobDescription, JobCategory, Job SubCategory, JobAddedDateTime, JobConsumerID, JobAffiliateID, IsJobCompleted, and/or the like. A referrals data store 430d may be a collection of database tables that include fields such as ReferralID, ReferrerID, ReferralType, AssociatedJobID, AssociatedUserID, RewardAwardAmount, IsRewardEarned, and/or the like. A rewards data store 430e may be a collection of database tables that include fields such as RewardID, AssociatedConsumerID, AssociatedAffiliateID, AssociatedVendorID, AssociatedCharityID, RewardAmount, IsRewardUsed, and/or the like. An accounts data store 430f may be a collection of database tables that include fields such as AccountID, AssociatedUserID, AccountBalance, AccountPreferences, and/or the like. The application server may use data stores 430 to keep track of inputs, parameters, settings, variables, records, outputs, and/or the like.

The system network memory 420 contains processor-operable (e.g., executable) system network components 440. Components 440 comprise program components (including program instructions and any associated data stores) that are executed (e.g., by the system network) via the application server (i.e., via the processor) to transform system network inputs into system network outputs. It is to be understood that the various components and their subcomponents, capabilities, applications, and/or the like may be organized in any number of ways (i.e., using any number and configuration of components, subcomponents, capabilities, applications, application server elements, and/or the like) to facilitate system network operation. Furthermore, it is to be understood that the various components and their subcomponents, capabilities, applications, and/or the like may communicate among each other in any number of ways to facilitate system network operation. For example, the various components and their subcomponents, capabilities, applications, and/or the like may be combined, integrated, consolidated, split up, distributed, and/or the like in any number of ways to facilitate system network operation. In another example, a single or multiple instances of the various components and their subcomponents, capabilities, applications, and/or the like may be instantiated on each of a single application server node, across multiple application server nodes, and/or the like.

In various embodiments, program components may be developed using one or more programming languages, techniques, tools, and/or the like such as an assembly language, Ada, BASIC, C, C++, C#, COBOL, Fortran, Java, LabVIEW, Lisp, Mathematica, MATLAB, OCaml, PL/I, Smalltalk, Visual Basic for Applications (VBA), HTML, XML, CSS, JavaScript, JavaScript Object Notation (JSON), PHP, Perl, Ruby, Python, Asynchronous JavaScript and XML (AJAX), Simple Object Access Protocol (SOAP), SSL, ColdFusion, Microsoft .NET, Apache modules, Adobe Flash, Adobe AIR, Microsoft Silverlight, Windows PowerShell, batch files, Tcl, graphical user interface (GUI) toolkits, SQL, database adapters, web application programming interfaces (APIs), application server extensions, integrated development environments (IDEs), libraries (e.g., object libraries, class libraries, remote libraries), remote procedure calls (RPCs), Common Object Request Broker Architecture (CORBA), and/or the like.

In some embodiments, components 440 may include an operating environment component 440a. The operating environment component may facilitate operation of the system network via various subcomponents.

In some implementations, the operating environment component may include an operating system subcomponent. The operating system subcomponent may provide an abstraction layer that facilitates the use of, communication among, common services for, interaction with, security of, and/or the like of various application server elements, components, data stores, and/or the like.

In some embodiments, the operating system subcomponent may facilitate execution of program instructions (e.g., system network program instructions) by the processor by providing process management capabilities. For example, the operating system subcomponent may facilitate the use of multiple processors, the execution of multiple processes, multitasking, and/or the like.

In some embodiments, the operating system subcomponent may facilitate the use of memory by the system network. For example, the operating system subcomponent may allocate and/or free memory, facilitate memory addressing, provide memory segmentation and/or protection, provide virtual memory capability, facilitate caching, and/or the like. In another example, the operating system subcomponent may include a file system (e.g., File Allocation Table (FAT), New Technology File System (NTFS), Hierarchical File System Plus (HFS+), Universal Disk Format (UDF), Linear Tape File System (LTFS)) to facilitate storage, retrieval, deletion, aggregation, processing, generation, and/or the like of data.

In some embodiments, the operating system subcomponent may facilitate operation of and/or processing of data for and/or from input/output devices. For example, the operating system subcomponent may include one or more device drivers, interrupt handlers, file systems, and/or the like that allow interaction with input/output devices.

In some embodiments, the operating system subcomponent may facilitate operation of the application server as a node in a computer network by providing support for one or more communications protocols. For example, the operating system subcomponent may include support for the internet protocol suite (i.e., Transmission Control Protocol/Internet Protocol (TCP/IP)) of network protocols such as TCP, IP, User Datagram Protocol (UDP), Mobile IP, and/or the like. In another example, the operating system subcomponent may include support for security protocols (e.g., Wired Equivalent Privacy (WEP), Wi-Fi Protected Access (WPA), WPA2) for wireless computer networks. In yet another example, the operating system subcomponent may include support for virtual private networks (VPNs).

In some embodiments, the operating system subcomponent may facilitate security of the application server. For example, the operating system subcomponent may provide services such as authentication, authorization, audit, network intrusion-detection capabilities, firewall capabilities, antivirus capabilities, and/or the like. In some embodiments, the operating system subcomponent may facilitate user interaction with the system network by providing user interface elements that may be used by the system network to generate a user interface. In one implementation, such user interface elements may include widgets (e.g., windows, dialog boxes, scrollbars, menu bars, tabs, ribbons, menus, buttons, text boxes, checkboxes, combo boxes, drop-down lists, list boxes, radio buttons, sliders, spinners, grids, labels, progress indicators, icons, tooltips, and/or the like) that may be used to obtain input from and/or provide output to the user. For example, such widgets may be used via a widget toolkit such as Microsoft Foundation Classes (MFC), Apple Cocoa Touch, Java Swing, GTK+, Qt, Yahoo! User Interface Library (YUI), and/or the like. In another implementation, such user interface elements may include sounds (e.g., event notification sounds stored in MP3 file format), animations, vibrations, and/or the like that may be used to inform the user regarding occurrence of various events. For example, the operating system subcomponent may include a user interface such as Windows Aero, Mac OS X Aqua, GNOME Shell, KDE Plasma Workspaces (e.g., Plasma Desktop, Plasma Netbook, Plasma Contour, Plasma Mobile), and/or the like.

In various embodiments the operating system subcomponent may comprise a single-user operating system, a multi-user operating system, a single-tasking operating system, a multitasking operating system, a single-processor operating system, a multiprocessor operating system, a distributed operating system, an embedded operating system, a real-time operating system, and/or the like. For example, the operating system subcomponent may comprise an operating system such as UNIX, LINUX, IBM i, Sun Solaris, Microsoft Windows Server, Microsoft DOS, Microsoft Windows 7, Microsoft Windows 8, Apple Mac OS X, Apple iOS, Android, Symbian, Windows Phone 7, Windows Phone 8, Blackberry QNX, and/or the like.

In some implementations, the operating environment component may include a database subcomponent. The database subcomponent may facilitate system network capabilities such as storage, analysis, retrieval, access, modification, deletion, aggregation, generation, and/or the like of data (e.g., the use of data stores 430). The database subcomponent may make use of database languages (e.g., Structured Query Language (SQL), XQuery), stored procedures, triggers, APIs, and/or the like to provide these capabilities. In various embodiments the database subcomponent may comprise a cloud database, a data warehouse, a distributed database, an embedded database, a parallel database, a real-time database, and/or the like. For example, the database subcomponent may comprise a database such as Microsoft SQL Server, Microsoft Access, MySQL, IBM DB2, Oracle Database, and/or the like.

In some implementations, the operating environment component may include an information handling subcomponent. The information handling subcomponent may provide the system network with capabilities to serve, deliver, upload, obtain, present, download, and/or the like a variety of information. The information handling subcomponent may use protocols such as Hypertext Transfer Protocol (HTTP), Hypertext Transfer Protocol Secure (HTTPS), File Transfer Protocol (FTP), Telnet, Secure Shell (SSH), Transport Layer Security (TLS), Secure Sockets Layer (SSL), peer-to-peer (P2P) protocols (e.g., BitTorrent), and/or the like to handle communication of information such as web pages, files, multimedia content (e.g., streaming media), applications, and/or the like.

In some embodiments, the information handling subcomponent may facilitate the serving of information to users, system network components, nodes in a computer network, web browsers, and/or the like. For example, the information handling subcomponent may comprise a web server such as Apache HTTP Server, Microsoft Internet Information Services (IIS), Oracle WebLogic Server, Adobe Flash Media Server, Adobe Content Server, and/or the like. Furthermore, a web server may include extensions, plug-ins, add-ons, servlets, and/or the like. For example, these may include Apache modules, IIS extensions, Java servlets, and/or the like. In some implementations, the information handling subcomponent may communicate with the database subcomponent via standards such as Open Database Connectivity (ODBC), Java Database Connectivity (JDBC), ActiveX Data Objects for .NET (ADO.NET), and/or the like. For example, the information handling subcomponent may use such standards to store, analyze, retrieve, access, modify, delete, aggregate, generate, and/or the like data (e.g., data from data stores 430) via the database subcomponent.

In some embodiments, the information handling subcomponent may facilitate presentation of information obtained from users, system network components, nodes in a computer network, web servers, and/or the like. For example, the information handling subcomponent may comprise a web browser such as Microsoft Internet Explorer, Mozilla Firefox, Apple Safari, Google Chrome, Opera Mobile, Amazon Silk, Nintendo 3DS Internet Browser, and/or the like. Furthermore, a web browser may include extensions, plug-ins, add-ons, applets, and/or the like. For example, these may include Adobe Flash Player, Adobe Acrobat plug-in, Microsoft Silverlight plug-in, Microsoft Office plug-in, Java plug-in, and/or the like.

In some implementations, the operating environment component may include a messaging subcomponent. The messaging subcomponent may facilitate system network message communications capabilities. The messaging subcomponent may use protocols such as Simple Mail Transfer Protocol (SMTP), Internet Message Access Protocol (IMAP), Post Office Protocol (POP), Extensible Messaging and Presence Protocol (XMPP), Real-time Transport Protocol (RTP), Internet Relay Chat (IRC), Skype protocol, AOL's Open System for Communication in Realtime (OSCAR), Messaging Application Programming Interface (MAPI), Facebook API, a custom protocol, and/or the like to facilitate system network message communications. The messaging subcomponent may facilitate message communications such as email, instant messaging, Voice over IP (VoIP), video conferencing, Short Message Service (SMS), web chat, in-app messaging (e.g., alerts, notifications), and/or the like. For example, the messaging subcomponent may comprise Microsoft Exchange Server, Microsoft Outlook, Sendmail, IBM Lotus Domino, Gmail, AOL Instant Messenger (AIM), Yahoo Messenger, ICQ, Trillian, Skype, Google Talk, Apple FaceTime, Apple iChat, Facebook Chat, and/or the like.

In some implementations, the operating environment component may include a security subcomponent that facilitates system network security. In some embodiments, the security subcomponent may restrict access to the system network, to one or more services provided by the system network, to data associated with the system network (e.g., stored in data stores 430), to communication messages associated with the system network, and/or the like to authorized users. Access may be granted via a login screen, via an API that obtains authentication information, via an authentication token, and/or the like. For example, the user may obtain access by providing a username and/or a password (e.g., a string of characters, a picture password), a personal identification number (PIN), an identification card, a magnetic stripe card, a smart card, a biometric identifier (e.g., a finger print, a voice print, a retina scan, a face scan), a gesture (e.g., a swipe), a media access control (MAC) address, an IP address, and/or the like. Various security models such as access-control lists (ACLs), capability-based security, hierarchical protection domains, and/or the like may be used to control access. For example, the security subcomponent may facilitate digital rights management (DRM), network intrusion detection, firewall capabilities, and/or the like.

In some embodiments, the security subcomponent may use cryptographic techniques to secure information (e.g., by storing encrypted data), verify message authentication (e.g., via a digital signature), provide integrity checking (e.g., a checksum), and/or the like by facilitating encryption and/or decryption of data. Furthermore, steganographic techniques may be used instead of or in combination with cryptographic techniques. Cryptographic techniques used by the system network may include symmetric key cryptography using shared keys (e.g., using one or more block ciphers such as triple Data Encryption Standard (DES), Advanced Encryption Standard (AES); stream ciphers such as Rivest Cipher 4 (RC4), Rabbit), asymmetric key cryptography using a public key/private key pair (e.g., using algorithms such as Rivest-Shamir-Adleman (RSA), Digital Signature Algorithm (DSA)), cryptographic hash functions (e.g., using algorithms such as Message-Digest 5 (MD5), Secure Hash Algorithm 2 (SHA-2)), and/or the like. For example, the security subcomponent may comprise a cryptographic system such as Pretty Good Privacy (PGP).

In some implementations, the operating environment component may include a virtualization subcomponent that facilitates system network virtualization capabilities. In some embodiments, the virtualization subcomponent may provide support for platform virtualization (e.g., via a virtual machine). Platform virtualization types may include full virtualization, partial virtualization, paravirtualization, and/or the like. In some implementations, platform virtualization may be hardware-assisted (e.g., via support from the processor using technologies such as AMD-V, Intel VT-x, and/or the like). In some embodiments, the virtualization subcomponent may provide support for various other virtualized environments such as via operating-system level virtualization, desktop virtualization, workspace virtualization, mobile virtualization, application virtualization, database virtualization, and/or the like. In some embodiments, the virtualization subcomponent may provide support for various virtualized resources such as via memory virtualization, storage virtualization, data virtualization, network virtualization, and/or the like. For example, the virtualization subcomponent may comprise VMware software suite (e.g., VMware Server, VMware Workstation, VMware Player, VMware ESX, VMware ESXi, VMware ThinApp, VMware Infrastructure), Parallels software suite (e.g., Parallels Server, Parallels Workstation, Parallels Desktop, Parallels Mobile, Parallels Virtuozzo Containers), Oracle software suite (e.g., Oracle VM Server for SPARC, Oracle VM Server for x86, Oracle VM VirtualBox, Oracle Solaris 10, Oracle Solaris 11), Informatica Data Services, Wine, and/or the like.

In some embodiments, components 440 may include a user interface component 440b. The user interface component may facilitate user interaction with the system network by providing a user interface. In various implementations, the user interface component may include programmatic instructions to obtain input from and/or provide output to the user via physical controls (e.g., physical buttons, switches, knobs, wheels, dials), textual user interface, audio user interface, GUI, voice recognition, gesture recognition, touch and/or multi-touch user interface, messages, APIs, and/or the like. In some implementations, the user interface component may make use of the user interface elements provided by the operating system subcomponent of the operating environment component. For example, the user interface component may make use of the operating system subcomponent's user interface elements via a widget toolkit. In some implementations, the user interface component may make use of information presentation capabilities provided by the information handling subcomponent of the operating environment component. For example, the user interface component may make use of a web browser to provide a user interface via HTML5, Adobe Flash, Microsoft Silverlight, and/or the like.

In some embodiments, components 440 may include any of the components CH 440c, PH 440d described in more detail in preceding figures.

### Different Ways of Implementing the Client Machines and Devices on the System Network of the Present Invention

In one illustrative embodiment, the enterprise-level system network of the present invention is realized as a robust suite of hosted services delivered to Web-based client subsystems 12 using an application service provider (ASP) model. In this embodiment, the Web-enabled clients 12 can be realized using a web-browser application running on the operating system (OS) of a computing device (e.g. Linux, Application IOS, etc), to support online modes of system operation, only. However, it is understood that some or all of the services provided by the system network can be accessed using Java clients, or a native client application running on the operating system of a client computing device, to support both online and limited off-line modes of system operation. In such embodiments, the native application would have access to local memory (e.g. a local RDBMS) on the client device, accessible during off-line modes of operation to enable consumers to use certain or many of the system functions supported by the system network during off-line/off-network modes of operation. During such off-line modes of operation, supported by native application implemented client subsystems 12, the system users (e.g. consumers and affiliates) can perform local tasks within the GUI-based job-affiliate referral environment, with the understanding that when the client system, running the native application, goes back online, i.e. restores connectivity with the system network's data center 3, then synchronization between all clients and system servers will automatically occur.

### Specification of System Architecture of an Exemplary Mobile Client System Deployed on the System Network of the Present Invention

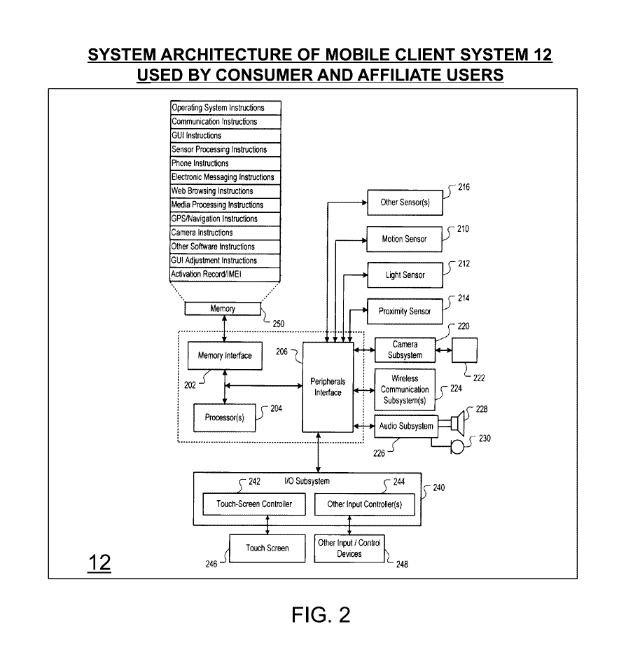

FIG. 2 is a schematic representation of the system architecture of an exemplary mobile client system (e.g. device) 12 that is deployed on the system network of the present invention and supporting the many services offered by system network servers of the present invention. As shown, the mobile device 12 can include a memory interface 202, one or more data processors, image processors and/or central processing units 204, and a peripherals interface 206. The memory interface 202, the one or more processors 204 and/or the peripherals interface 206 can be separate components or can be integrated in one or more integrated circuits. The various components in the mobile device can be coupled by one or more communication buses or signal lines. Sensors, devices, and subsystems can be coupled to the peripherals interface 206 to facilitate multiple functionalities. For example, a motion sensor 210, a light sensor 212, and a proximity sensor 214 can be coupled to the peripherals interface 206 to facilitate the orientation, lighting, and proximity functions. Other sensors 216 can also be connected to the peripherals interface 206, such as a positioning system (e.g., GPS receiver), a temperature sensor, a biometric sensor, a gyroscope, or other sensing device, to facilitate related functionalities. A camera subsystem 220 and an optical sensor 222, e.g., a charged coupled device (CCD) or a complementary metal-oxide semiconductor (CMOS) optical sensor, can be utilized to facilitate camera functions, such as recording photographs and video clips. Communication functions can be facilitated through one or more wireless communication subsystems 224, which can include radio frequency receivers and transmitters and/or optical (e.g., infrared) receivers and transmitters. The specific design and implementation of the communication subsystem 224 can depend on the communication network(s) over which the mobile device 12 is intended to operate. For example, a mobile device 100 may include communication subsystems 224 designed to operate over a GSM network, a GPRS network, an EDGE network, a Wi-Fi or WiMax network, and a Bluetooth™ network. In particular, the wireless communication subsystems 224 may include hosting protocols such that the device 100 may be configured as a base station for other wireless devices. An audio subsystem 226 can be coupled to a speaker 228 and a microphone 230 to facilitate voice-enabled functions, such as voice recognition, voice replication, digital recording, and telephony functions. The I/O subsystem 240 can include a touch screen controller 242 and/or other input controller(s) 244. The touch-screen controller 242 can be coupled to a touch screen 246. The touch screen 246 and touch screen controller 242 can, for example, detect contact and movement or break thereof using any of a plurality of touch sensitivity technologies, including but not limited to capacitive, resistive, infrared, and surface acoustic wave technologies, as well as other proximity sensor arrays or other elements for determining one or more points of contact with the touch screen 246. The other input controller(s) 244 can be coupled to other input/control devices 248, such as one or more buttons, rocker switches, thumb-wheel, infrared port, USB port, and/or a pointer device such as a stylus. The one or more buttons (not shown) can include an up/down button for volume control of the speaker 228 and/or the microphone 230. Such buttons and controls can be implemented as a hardware objects, or touch-screen graphical interface objects, touched and controlled by the system user. Additional features of device 8B, 8C can be found in U.S. Pat. No. 8,631,358 incorporated herein by reference in its entirety.

### Brief Overview of the Technical Operation of the System Network of the Illustrative Embodiment of the Present Invention

Having described the illustrative embodiment of the system network 1 in great detail, it will be helpful to provide a consist yet comprehensive review of the system network 1, bringing all together how the primary system network components, GUI screens, structures, graphical icons, information files in the information file storage and retrieval system 25, and the many functions and services supported by the system network 1 are delivered to client systems 12 deployed on the system network 1 and can used by hundreds of millions of system users representing individuals, families, social groups, companies, organizations and the like around the world.

As shown in the figure Drawings, the Internet-based affiliate-referral driven consumer transaction rewarding system network of the present invention 1 comprises:

a plurality of communication servers 20, operably connected to the infrastructure of the Internet 16, for supporting http and other TCP/IP based communication protocols on the system network 1;

a plurality of client systems 25 operably connected to the infrastructure of the Internet, and each the client subsystem 12 having a computing platform shown in FIG. 2 and a display screen for displaying graphical user interfaces (GUIs) associated with one or more programs executing on the computing platform, and supporting services for system users on the system network 1;

an information file storage and retrieval system 25 including (i) a relational database management system (RDBMS) 22 for organizing information files stored and managed on the system network, and (ii) information storage devices for storing the information files associated with the information maintained with the object-oriented GUI screens on client systems deployed on system network;

one or more object-oriented application servers 21 operably connected to the infrastructure of the Internet 16 and the RDBMS 22, for storing and executing modules of object-oriented code 23, and generating processes having a server-side and a client-side and supporting a graphical user interface (GUI) based environment available on the client-side and displayed on the client systems 12;

wherein each client subsystem 12 supports the client-side of the processes generated by the one or more modules of object-oriented code executing on the one or object-oriented application servers 21;

wherein the object-oriented application servers 21 and the modules 23 are configured so that each consumer and network affiliate can register as a system user on the system network, and automatically create and assign a system network user account to the system user upon completing registration on system network 1; and

wherein the system network user account is stored and maintained within the information storage devices of the distributed information file storage and retrieval system 25, shown in FIG. 1A, and thereafter, each system user can receive the many information-based services, described in great technical detail below, and delivered through the GUI screens displayed on the display screen of each client system deployed on the system network 1.

System Architecture for Loading Financial Credit Value from an Affiliate's Financial Account Maintained at an Affiliate Financial Institution, to the Affiliate's Consumer Reward Gift Card (CRGC) Payment Account Maintained within the Sponsoring Financial Institution of the System Network of the Present Invention

FIG. 1B illustrate a mechanism with the system network 1, by which affiliate consumer reward gift card (CRGC) payment accounts maintained at the sponsoring financial institution are loaded with financial credit value from the affiliates' financial accounts maintained within computer system networks of affiliate financial institutions, by way of debit/credit card payment networks 6 and/or ACH payment settlement system networks 7. At the same time, consumer reward gift card (CRGC) accounts maintained at the sponsoring financial institution 4 are reloaded with credit value from the computer system network 4 of a designated financial institution, so that there is a specified minimum amount of credit value in a consumer's CRGC account, or registered charity or non-profit organization, for making payments for various kinds of purchases on the system network of the present invention, as well as payments for donations to registered charities and non-profit organizations.

Specification Of Exemplary Database Schema For The System Database Employed In The System Network Of The Present Invention

FIG. 3 is schematic representation providing a data schema for the object-oriented system-engineered (OOSE) software component of the system network of the present invention, executing on the client-server architecture specified in great detail throughout the present patent specification;

### Specification of the Consumer Service and Affiliate Service Suite Library Employed on the Illustrative Embodiment of the System Network of the Present Invention

FIGS. 3A and 3B, taken together, provide a schematic representation of a set of object-oriented software modules, containing classes (written in an object-oriented programming language) supporting the system network of the present invention including (1) The Consumer Service Suite Library comprising the Consumer Registration Module, Login Module, Home Module, Search Module (comprising Affiliate Directory Module, Affiliate Profile (View Details) Module, Consumer Directory (comprising Update My System Network Profile Module, Post To My Social Networks, Post To My Employment Network, Post To My Personal Networks), Consumer Profile (comprising Add A Job Module, Refer Job(s) Module, Add to Favorites Module, Read Reviews Module, Refer A Job To Module, Receive Message Module (Job Referral), Send Message Module, Google Maps Module), My Messages Module, My Contacts Module, My Favorites Module (comprising Read Reviews Module, Add A Job Module, Refer A Job To Module, Receive Message Module, Send Message Module), My Jobs Module (comprising Review A Job Module, Add A Job Module, Jobs Added By Me Module, Refer Jobs To Module, Jobs Referred By Me Module), My Reviews, Referral Pools Module (comprising Add A Job Module, Jobs Added By Me Module, Refer Jobs To Module, Jobs Referred By Me Module), My Rewards Module (comprising Pay With Consumer Rewards Gift Card Module, Add Credit To Consumer Rewards Gift Card Module, Donate With Consumer Reward Gift Card, Transfer Consumer Reward Gift Card Credit Module); and (2) the Affiliate Service Suite Library comprising the Affiliate Registration Module, Login Module, Manage Affiliate Profile Module (comprising Update Affiliate Profile Module, Post To Social Networks, Post To Employment Network, Review Consumer Reward Payments Module, Review Recent Consumer Rewards Payments Module, Review All Consumer Reward Payments Module, Show Consumer Reviews Module, Recent Consumer Review Module, All Consumer Review Module), Manage Jobs on Network Module (comprising Update A Job Module, Add A New Job Module), Register A Consumer Module (comprising Scan ID Card Module and Register A New Consumer Module), and Manage Consumer Rewards Gift Card (CRGC) Payment Account.

### Specification of an Exemplary POS-Based Client System Used by Consumers and Affiliates Alike on the System Network of the Present Invention

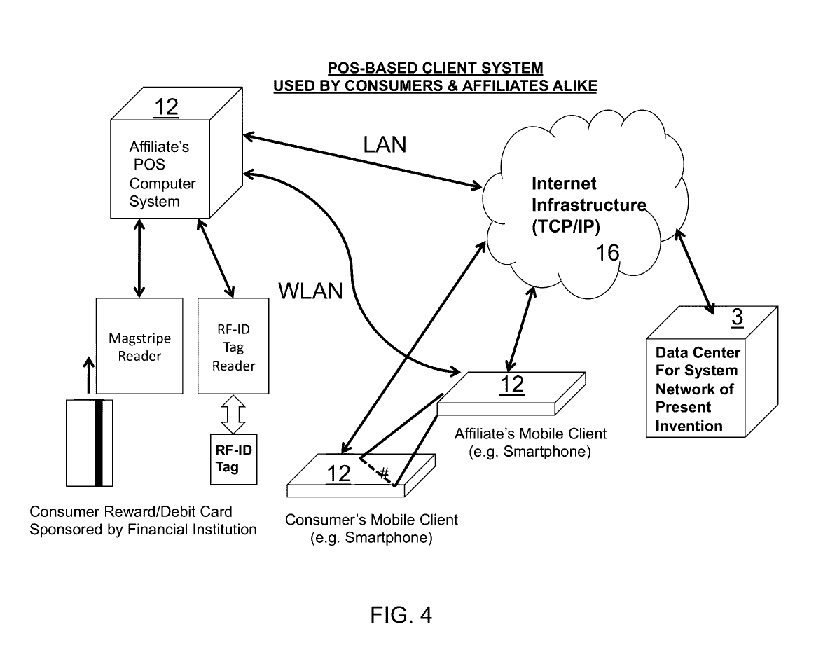

FIG. 4 is a schematic representation of POS-based client systems used by affiliates and consumers on the Internet-based affiliate-referral driven consumer transaction rewarding system network of the present invention, supporting (i) magstripe readers for reading encoded-encoded Consumer Reward Gift Cards, (ii) RF-ID tag readers for reading RFID-based tags with consumer identification and CRGC account information for supporting CGC transactions on the system network; and (iii) mobile barcode reading client computers (e.g. iPhone, iPad, Android Tablets, Phones etc) for reading QRS and other bar codes for enabling payment of consumer transactions using a CRGC Account supported on the system network of the present invention.

### Exemplary Service Architecture of the Internet-Based Affiliate-Referral Driven Consumer Transaction Supporting System Network of the Present Invention

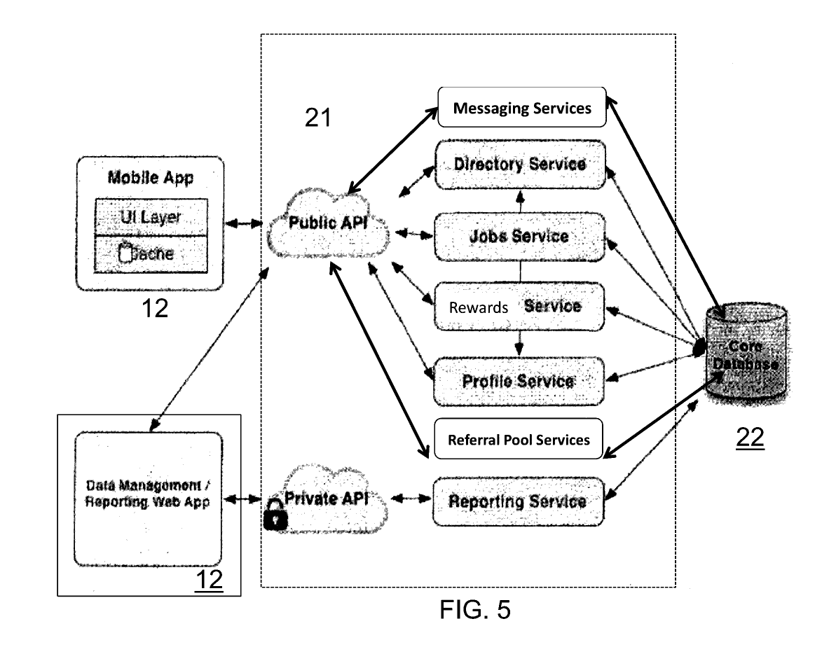

FIG. 5 provides a schematic illustration for the service architecture of the Internet-based affiliate-referral driven consumer transaction rewarding system network of the present invention, illustrating that the mobile client system can be interfaced with the core system database using a public API and a private API, and various services such as, for example, affiliate and client directory services, jobs references, referral pool services, profile services, consumer rewards services, messaging services, and reporting services.

Some Primary Data Structures Maintained within the System Database of the Illustrative Embodiment of the System Network of the Present Invention

FIG. 6A schematically illustrates some of the primary data structures maintained within the system database including the job listings structure, the affiliate directory structure with affiliate profiles, the consumer directory structure with consumer profiles and reviews, the job referrals structure, and the job referral pools structure supporting the system network of the present invention. FIG. 6B schematically illustrates some more primary data structures maintained within the system database including (i) the my contacts structure and the my groups structure which are associated with the consumer directory structure, and (ii) the affiliate contacts structure and the affiliate group structure of FIG. 6A which are associated with the affiliate directory structure of FIG. 6A, all of which support the system network of the present invention.

### Specification of the Primary Data Structures Supported in the System Database Employed on the System Network of the Present Invention

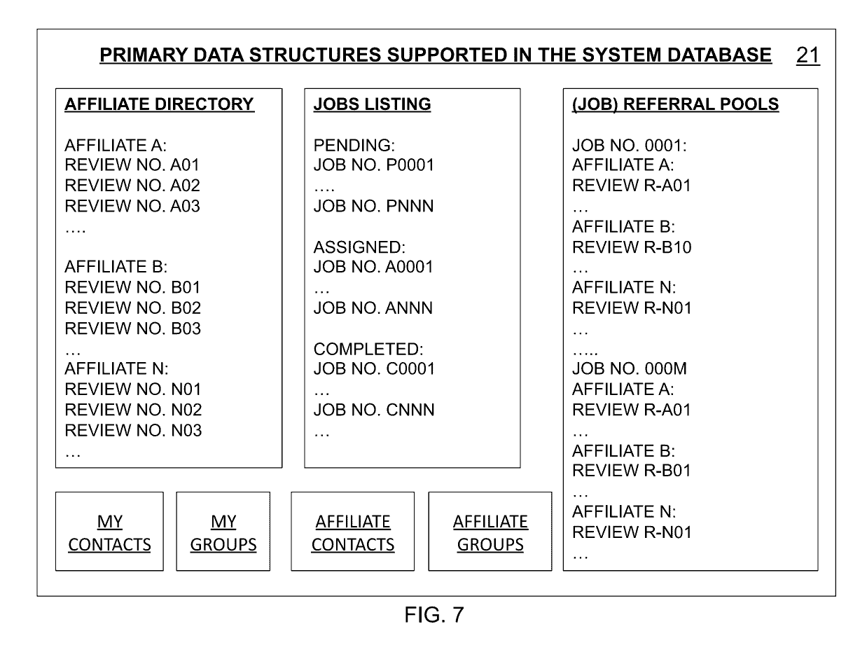

FIG. 7 provides a specification for the primary data structures supported within the system database, including affiliate directory structure, the jobs listing structure, the referral pools structure, the my contacts structure, the my groups structure, the affiliate contacts structure and the affiliate groups structure, illustrating the various data elements maintained within each such structure.

Notably, the Referral Pools structure of the present invention supports the formation and management of many different kinds of “job-affiliate referral pools” data structures within the RDBMS 22 of the system network 1, and each such data structure contains minimally added job records, and many data structures will also comprise added job records linked to affiliate referral records, and their affiliate profiles, and also consumer reviews of affiliate past job performance, as illustrated in FIGS. 6A and 6B, and 15 and 16.

### Exemplary Map for Consumer and Affiliate Application Interface Objects

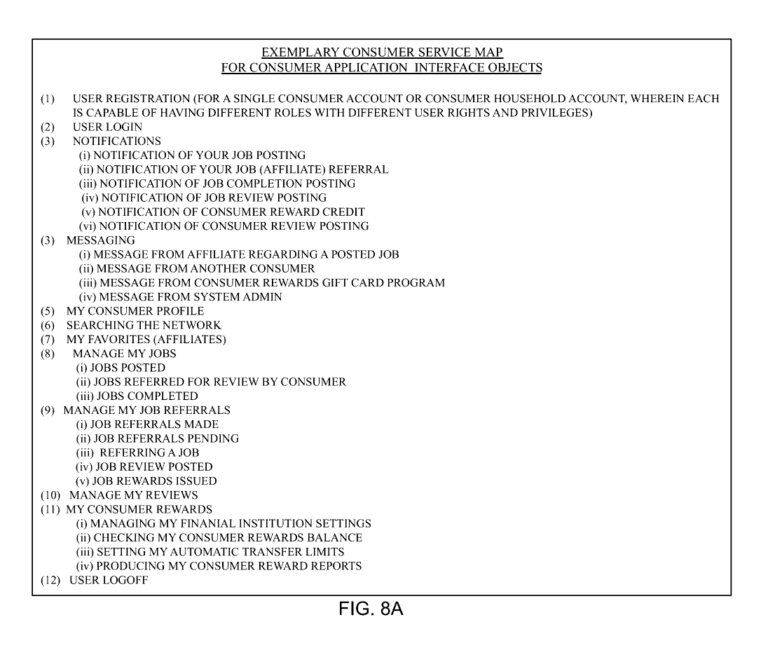

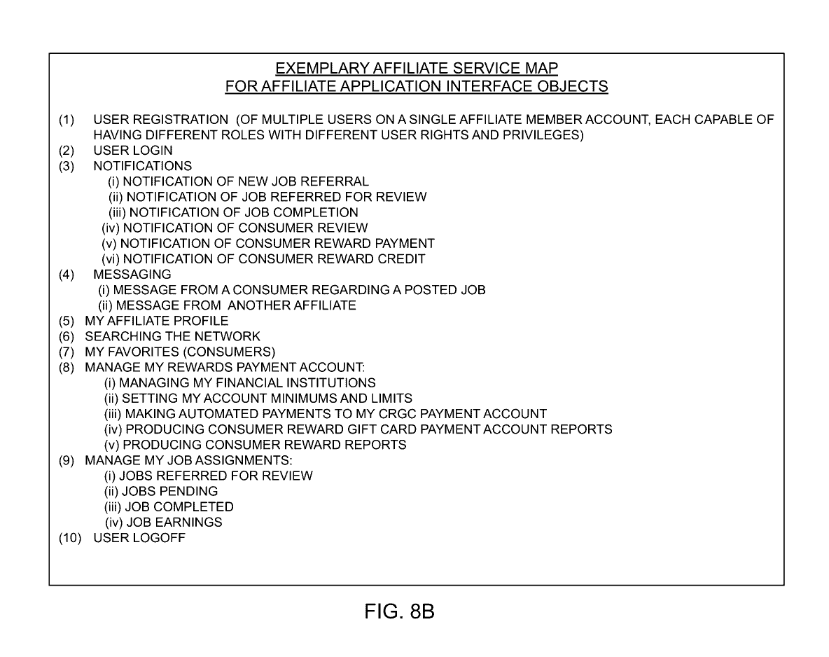

FIG. 8A provides an exemplary consumer service map for interface objects provided on the consumer—side of the system network of the present invention. FIG. 8B provides an exemplary affiliate service map for the interface objects provided on the affiliate—side of the system network of the present invention.

### Specification of Exemplary Consumer-Services Supported on the System Network of the Present Invention

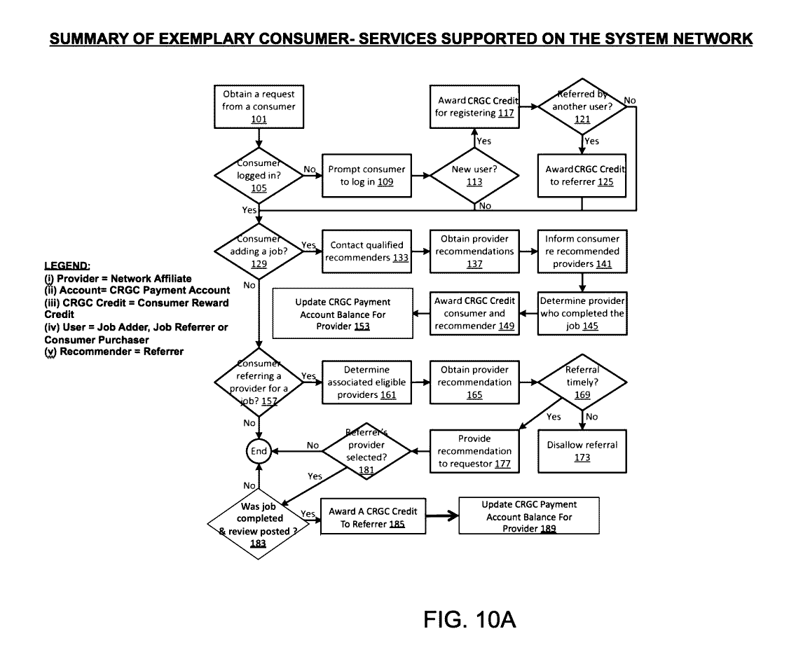

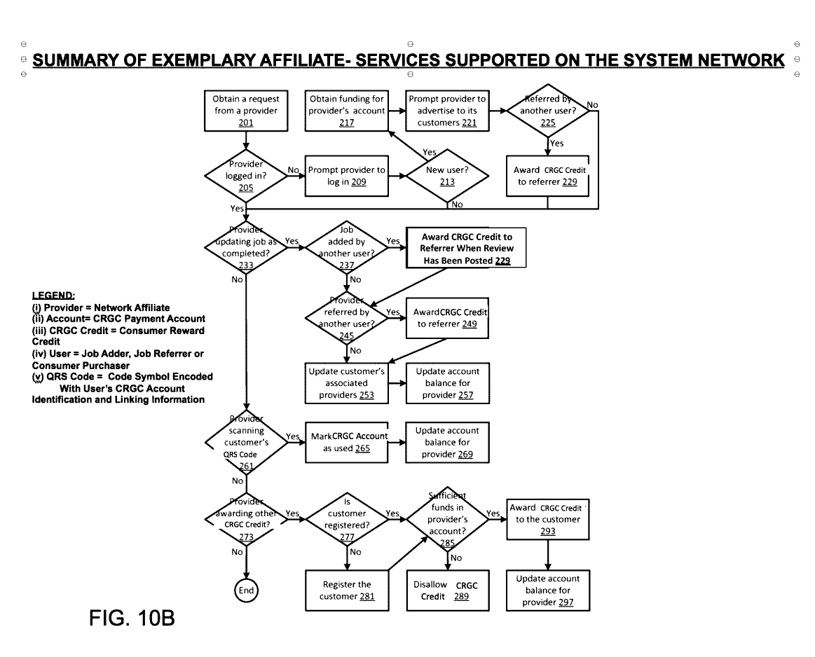

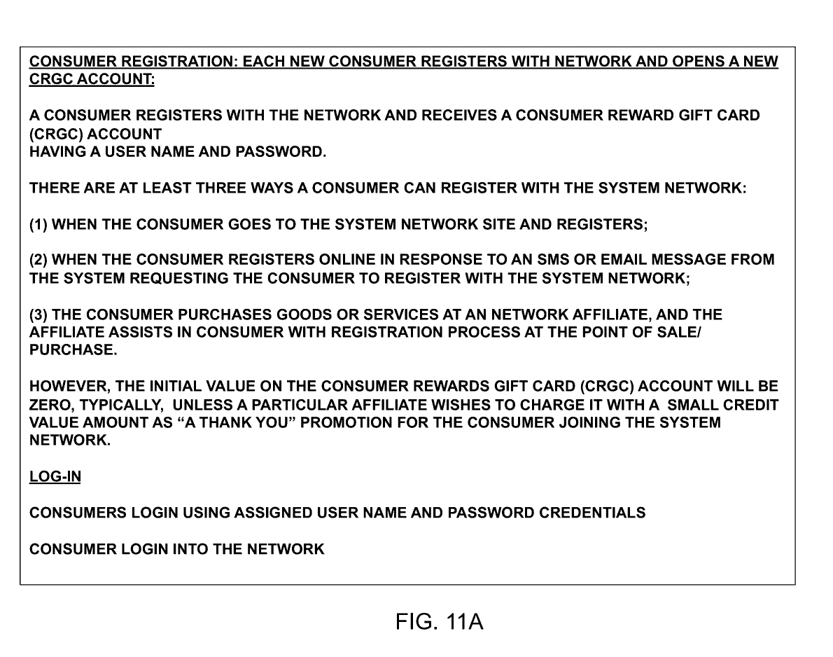

FIG. 10A is a flow chart describing some exemplary consumer-services supported on the system network. In FIG. 10A, a request from a consumer may be obtained at 101. In various implementations, the consumer may initiate the request via a client system software, via a website, and/or the like using the consumer's client system (e.g., a desktop, a laptop, a tablet, a smart phone).

A determination may be made at 105 whether the consumer is logged in. In one implementation, a cookie may be used to track whether the consumer is logged into the website. In another implementation, the client system software may track whether the user provided login information. If the consumer is not logged in, the system network may prompt the consumer to log in at 109. For example, the consumer may be prompted to provide a user name and a password, or to register.

A determination may be made at 113 whether the consumer is a newly registered user. In one embodiment, newly registered users may be asked to share their personal contacts info (e.g., contacts associated with a user's phone, contacts associated with a user's email account) with the system network. For example, a user may allow the client system software to obtain the user's contacts info (e.g., download contacts info stored on the user's phone, obtain contacts info from the user's email account) and/or to identify the user's friends who may be using the system network. Further, the user may utilize the client system software to send a message to the user's friends to invite them to join the system network.

If the consumer is a newly registered user, the system network may award the consumer CRGC credit for registering at 117. For example, the system network may reward newly registered users with a $10 welcome CRGC credit (e.g., paid for by a provider). In one embodiment, CRGC credits may be used by consumers to pay for goods and/or services at any of the affiliates associated with the system network. In another embodiment, consumers may donate their CRGC credits to charities. In one implementation, data regarding CRGC credits associated with a user may be stored in the CRGC credits data store 430e.

A determination may be made at 121 whether the consumer was referred by another user. If the consumer was referred by another user, the system network may award CRGC credit to the referrer at 125 for referring the consumer. In some implementations, users may be awarded CRGC credits for using the system network (e.g., a user may get a frequent user CRGC credit after a predetermined number of uses of the system network that result in a transaction, such as enrolling a new user, adding a job that is completed by a LSP provider, referring a provider that completes a job, and/or the like). For example, the referrer may be awarded a $20 frequent user CRGC credit if the referral is the tenth time that the referrer utilized the system network. In another example, the referrer may be awarded CRGC credit if the referral is the tenth time that the referrer utilized the system network, and the value of the CRGC credit may be based on a percentage of the dollar amount of business associated with the referrer's last ten uses of the system network.

A determination may be made at 129 whether the request is associated with the consumer adding a job (e.g., for the consumer or for another customer) to the system network. For example, the RequestType field of the request may be examined (e.g., via an XML parser) to make this determination. In one implementation, the job may be added to a list of jobs which the consumer added (e.g., stored in the jobs data store 430c).

If the request is associated with the consumer adding a job (e.g., via an add a job request), qualified recommenders may be contacted at 133. In one embodiment, qualified recommenders may be those users who utilized LSP providers for same or similar category and/or subcategory of job (e.g., tree services: tree removal). In another embodiment, qualified recommenders may have to be located and/or may have to have utilized providers in the customer's local area (e.g., same or nearby zip code, town, county, and/or the like). In yet another embodiment, the customer may specify that qualified recommenders should be those users who are friends with the customer on the system network. In one implementation, qualified recommenders may be contacted in a predetermined local area (e.g., in the same zip code for companies providing tree services, in the same town for restaurants). In another implementation, local area may vary based on the number of available qualified recommenders (e.g., local area may be adjusted until the number of available qualified recommenders exceeds a predetermined threshold). In various implementations, a qualified recommender may be contacted via a notification message from the client system software, via an email, via a message from the website, and/or the like. For example, a provider referral request may be sent to a qualified recommender stating that another user wishes to utilize a service that the qualified recommender used previously and/or asking the qualified recommender for a recommendation.

Affiliate referrals may be obtained at 137. In one embodiment, jobs for which a user is a qualified recommender may be listed for the user. The user may select a job for which to provide recommendation (e.g., by clicking a “Refer Now” button associated with the job) and recommend one or more providers (e.g., by selecting such providers via a GUI widget) for the selected job. In another embodiment, a user may respond to a provider referral request (e.g., by tapping a notification message) and recommend one or more providers for the associated job.

The system network may obtain a desired number of provider recommendations from qualified recommenders and inform the consumer regarding the referred affiliates at 141. In one implementation, the consumer may be informed (e.g., via a notification message from the client system software, via an email, via a message from the website) regarding provider recommendations as they are obtained from qualified recommenders. In another implementation, the consumer may be informed regarding provider recommendations once a predetermined number of recommendations (e.g., three recommendations) are obtained and/or once a predetermined period of time (e.g., three days) has elapsed. If the consumer posted the job on behalf of another customer, the customer may be informed regarding the referred affiliates instead of or in addition to the consumer. In one embodiment, the consumer may be provided with contact information (e.g., name, address, phone number, email address) of the referred affiliates. In another embodiment, the consumer may choose one or more of the referred affiliates (e.g., using checkboxes) and send (e.g., via the client system software) a message (e.g., requesting help with the job, asking for a quote) to each of the chosen providers.

The provider (i.e. affiliate) who completed the job may be determined at 145. In one embodiment, upon completion of the job, the affiliate and/or the customer may inform the system network that the job was completed (e.g., via a job performed request). In one implementation, the affiliate and the customer may utilize their clients (e.g., their smart phones) to inform the system network. For example, NFC capabilities of the clients may be utilized to inform the system network (e.g., via the client system software) that the customer's job was completed by the affiliate. In another example, the customer may indicate that the job was completed (e.g., via the website) and the affiliate may confirm (e.g., via the client system software). In one embodiment, information that the job was completed may include an identifier of the affiliate who completed the job. This information may be parsed (e.g., via an XML parser) to determine the affiliate who completed the job.

The system network may award the consumer who added the job and/or the recommender who recommended the affiliate who completed the job CRGC credits at 149. Accordingly, consumers may be rewarded for adding jobs to the system network and recommenders may be rewarded for recommending providers to facilitate the use of the system network. Furthermore, the consumer, the customer (e.g., if the consumer posted the job on behalf of another customer), the recommender, the affiliate, and/or the like may be awarded CRGC credits for using the system network (e.g., a user may get a frequent user CRGC credit after every tenth use of the system network that results in a transaction).

The account balance of the affiliate who completed the job may be updated at 153. In one embodiment, a provider may have to maintain an account (e.g., an escrow account) to pay for CRGC credits (e.g., for consumers who add jobs that the affiliate completes, for recommenders who recommend the affiliate for jobs that the affiliate completes). In one implementation, the values of the CRGC credits awarded to the consumer who added the job and/or to the recommender who recommended the affiliate for the job may be deducted from the affiliate's account. In another embodiment, the system network may have an account (e.g., an escrow account) to pay for CRGC credits (e.g., CRGC credits issued for using the system network). In one implementation, the values of the CRGC credits awarded for using the system network may be deducted from the system network's account. In some embodiments, the cost of awarding CRGC credit (e.g., CRGC credit for adding a job, CRGC credit for recommending a provider for a job, CRGC credit for using the system network) may be split between a provider and the system network in any agreed upon way, and account balances for the affiliate and the system network may be updated accordingly.

If the request is not associated with the consumer adding a job, a determination may be made at 157 whether the request is associated with the consumer referring a provider for a job (e.g., in response to a provider referral request). For example, the RequestType field of the request may be examined (e.g., via an XML parser) to make this determination. In one implementation, the job may be added to a list of jobs for which the consumer referred a provider (e.g., stored in the referrals data store 430d).

If the request is associated with the consumer referring a provider for a job, associated eligible affiliates for the consumer may be determined at 161. In one embodiment, eligible affiliates may be providers, in the same or similar category and/or subcategory as the job, which the consumer used previously. In another embodiment, eligible affiliates may have to be located in the local area associated with the job (e.g., same or nearby zip code, town, county, and/or the like). In yet another embodiment, eligible affiliates may have to have a predetermined (e.g., a minimum) account balance associated with their accounts to pay for CRGC credits.

Affiliate referrals may be obtained from the consumer at 165. In one implementation, the consumer may be presented (e.g., via a GUI widget of the client system software) with a list of eligible affiliates that the consumer may recommend, and the consumer may select (e.g., by tapping on the desired providers) one or more providers to recommend. In another implementation, the consumer may also be able to provide comments, ratings, reviews, and/or the like associated with the affiliates that the consumer is recommending. In yet another implementation, the consumer may be able to recommend a provider, but may not be able to include a review of the affiliate (e.g., to eliminate concern that the review may not be sincere due to the consumer's financial interest in having the affiliate chosen for the job).

A determination may be made at 169 whether the consumer's referral is timely. In one embodiment, a referral may be timely if the referral is one of a predetermined number of referrals obtained first (e.g., the referral is one of the first three referrals). In another embodiment, a referral may be timely until the job is certified as completed. In yet another embodiment, a referral may be timely until a specified time period (e.g., the referral is timely if the referral is obtained within three days after the job is posted). If the consumer's referral is not timely, the referral may be disallowed at 173.

If the referral is timely, the affiliate recommended by the consumer may be provided to the requestor (e.g., the consumer who added the job, the customer associated with the job) at 177. In one embodiment, the requestor may be provided with contact information (e.g., via the client system software, via the website) of the affiliate recommended by the consumer. In another embodiment, the requestor may be able to obtain additional information (e.g., video about the referred affiliate, other services offered by the referred affiliate, reviews of the referred affiliate by other system network users) regarding the referred affiliate via the system network (e.g., via the client system software, via the website).

A determination may be made whether the affiliate referred by the consumer was selected by the customer to do the job at 181 and whether the job was completed at 183. In one implementation, if the affiliate referred by the consumer was selected and the affiliate completed the job, the system network may be informed by the affiliate and/or by the customer that the job was completed (e.g., via a job performed request). For example, the affiliate field of the job performed request may be examined (e.g., via an XML parser) to determine the identity of the affiliate who completed the job.

The system network may award the consumer who referred the affiliate who completed the job CRGC credit at 185. Furthermore, the referring consumer, the customer, the affiliate, and/or the like may be awarded CRGC credits for using the system network (e.g., a user may get a frequent user CRGC credit after every tenth use of the system network that results in a completed transaction).

The account balance of the affiliate who completed the job may be updated at 189. In one implementation, the value of the CRGC credit awarded to the consumer who recommended the affiliate for the job may be deducted from the affiliate's account. Furthermore, the account balance of the system network may be updated. In one implementation, the values of the CRGC credits awarded for using the system network may be deducted from the system network administrator's account.

### Specification Of Exemplary Affiliate-Services Supported On The System Network Of The Present Invention

FIG. 10B is a flow chart describing some exemplary consumer-services supported on the system network. In particular, FIG. 10B describes a logic flow diagram illustrating a affiliate provider component in one embodiment of the system network. In FIG. 2, a request from a provider may be obtained at 201. In various implementations, the affiliate may initiate the request via a client system software, via a website, and/or the like using the affiliate's client system 12 (e.g., a desktop, a laptop, a tablet, a smart phone).

A determination may be made at 205 whether the affiliate is logged in. In one implementation, a cookie may be used to track whether the affiliate is logged into the website. In another implementation, the client system software may track whether the user provided login information. If the affiliate is not logged in, the system network may prompt the affiliate to log in at 209. For example, the affiliate may be prompted to provide a user name and a password, or to register.

A determination may be made at 213 whether the affiliate is a newly registered user. In one embodiment, newly registered providers may be asked to share their customer databases (e.g., a list of the affiliate's current customers and/or their contact info) with the system network. For example, the system network may determine which customers the affiliate shares with other affiliates (e.g., to split the cost of awarding CRGC credit to a consumer for joining the system network among affiliates who count the consumer as their customer).

If the affiliate is a newly registered user, funding for the affiliate's account and/or a fee may be obtained at 217. In one embodiment, the affiliate may have to fund an account (e.g., an escrow account) to pay for CRGC credits. In one implementation, the affiliate may have to fund the account via a periodic (e.g., monthly) deposit of a predetermined amount (e.g., specified by the affiliate, specified by the system network). In another implementation, the affiliate may have to add funds into the account if the account balance reaches a predetermined threshold (e.g., if the account balance falls below $1,000). In another embodiment, the affiliate may have to pay a fee to utilize the system network. In one implementation the affiliate may have to pay a one-time initial fee. In another implementation, the affiliate may have to pay a periodic fee (e.g., a monthly fee paid upfront in six month increments).

If the affiliate is a newly registered user, the affiliate may be prompted to advertise its use of the system network at 221. In one embodiment, the affiliate may be prompted to contact (e.g., via email in a format specified by the system network) existing and/or previous customers to explain how the system network operates, to request that the customers join the system network (e.g., by downloading the client system software and registering with the system network), to solicit the customers' recommendations on the system network, and/or the like. In another embodiment, the affiliate may be prompted to run ads (e.g., TV ads in a format specified by the system network) in the affiliate's local area. In some embodiments, the affiliate may have to have a predetermined (e.g., ten) number of qualified recommenders (e.g., existing and/or new system network users) to join the system network. Accordingly, the affiliate may contact (e.g., via a postcard) existing and/or previous customers to request that the customers join the system network to allow the affiliate to satisfy this condition.

A determination may be made at 225 whether the affiliate was referred by another user. If the affiliate was referred by another user, the system network may award CRGC credit to the referrer at 229 for referring the affiliate. Furthermore, the referrer may be awarded CRGC credit for using the system network (e.g., the referrer may get a frequent user CRGC credit after a predetermined number of uses of the system network that result in a transaction). For example, the referrer may be awarded a $20 frequent user CRGC credit if the referral is the tenth time that the referrer utilized the system network. In another example, the referrer may be awarded CRGC credit if the referral is the tenth time that the referrer utilized the system network, and the value of the CRGC credit may be based on a percentage of the dollar amount of business associated with the referrer's last ten uses of the system network. In various embodiments, CRGC credits may be used by providers to pay for goods and/or services at any of the other affiliates associated with the system network, to donate their CRGC credits to charities, to pay for LSP fees, to replenish the affiliate's LSP account, and/or the like.

A determination may be made at 233 whether the request is associated with the affiliate updating a job as completed. For example, the RequestType field of the request (e.g., a job performed request sent by the affiliate upon completion of the job) may be examined (e.g., via an XML parser) to make this determination.

If the request is associated with the affiliate updating a job as completed, a determination may be made at 237 whether the job was added by another user (e.g., based on data stored in the referrals data store 430d). If the job was added by another user, the system network may award such user CRGC credit at 241.

A determination may be made at 245 whether the affiliate was referred for the job by another user (e.g., based on data in the referrals data store 430d). If the affiliate was referred for the job by another user, the system network may award the referrer CRGC credit at 249.

Associated providers of the customer associated with the job may be updated at 253. In one embodiment, the customer's associated providers may be those providers (i.e. affiliates) that the customer utilized and/or for which the customer is a qualified recommender or referrer. In one implementation, if the affiliate completed a job for the customer, the affiliate may be associated with the customer.

The account balance of the affiliate may be updated at 257. In one implementation, the values of the CRGC credits awarded to the user who added the job and/or to the referrer who recommended the affiliate for the job may be deducted from the affiliate's account. Furthermore, the account balance of the system network may be updated. In one implementation, the values of the CRGC credits awarded for using the system network may be deducted from the system network's account.

If the request is not associated with the affiliate updating a job as completed, a determination may be made at 261 whether the request is associated with the affiliate scanning a customer's CRGC credit. For example, the RequestType field of the request may be examined (e.g., via an XML parser) to make this determination. In one embodiment, CRGC credits may be used by customers to pay for goods and/or services at any of the affiliates associated with the system network.

If the request is associated with the affiliate scanning a customer's CRGC credit, the CRGC credit may be marked as used at 265. In one embodiment, the system network may keep track of who paid for the CRGC credit, who was awarded the CRGC credit, who redeemed the CRGC credit, monetary amounts associated with the CRGC credit (how much was awarded, how much was spent, how much was donated), dates and/or times associated with the CRGC credit (e.g., when received, when spent), and/or the like to facilitate reporting features (e.g., reports on CRGC credit usage) of the system network.

The account balance of the affiliate may be updated at 269. In one implementation, the value of the CRGC credit redeemed by the customer may be debited against the affiliate's CRGC payment account.

If the request is not associated with the affiliate scanning a customer's CRGC credit, a determination may be made at 273 whether the request is associated with the affiliate awarding a customer CRGC credit for reasons other than referrals (e.g., for writing a review, for purchasing from the affiliate a specified number of times). For example, the RequestType field of the request may be examined (e.g., via an XML parser) to make this determination. In one embodiment, CRGC credits may be used by customers to pay for goods and/or services at any of the affiliates associated with the system network.

A determination may be made at 277 whether the customer is registered with the system network. If the customer is not registered, the affiliate and/or the customer may be prompted to register with the system network at 281. In one embodiment, a user may not be awarded CRGC credits (e.g., for referrals, for reasons other than referrals) unless the user is registered with the system network.

A determination may be made at 285 whether there are sufficient funds in the affiliate's account to pay for the CRGC credit (e.g., based on data in the accounts data store 430f). If there are insufficient funds, the CRGC credit award may be disallowed at 289. If there are sufficient funds, the CRGC credit may be awarded to the customer at 293. The account balance of the affiliate may be updated at 297. In one implementation, the value of the CRGC credit awarded to the customer may be deducted from the affiliate's account.

### Specification of Exemplary Dataflow Paths for the System Network of the Present Invention

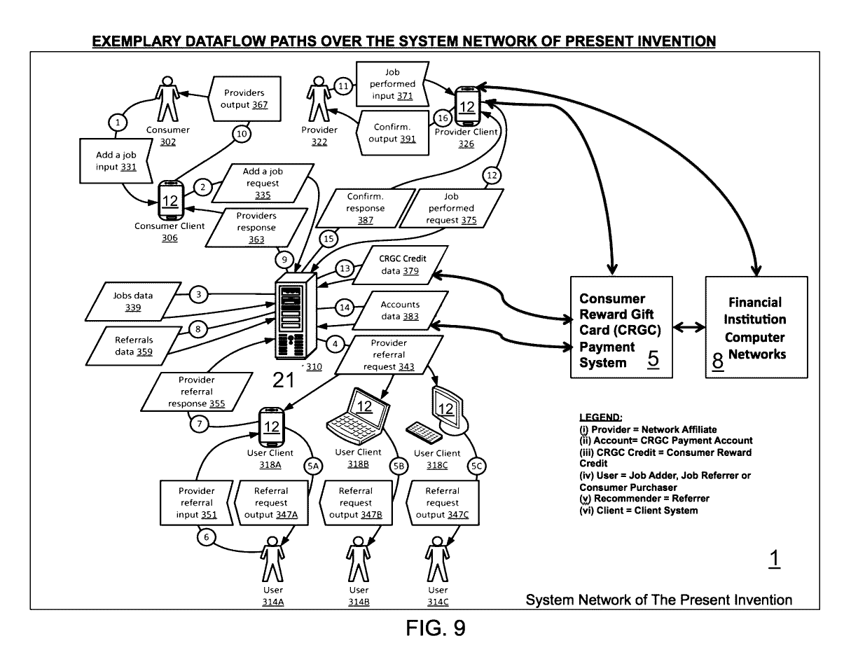

FIG. 9 is a schematic illustration describing exemplary dataflow paths for the system network of the present invention. FIG. 9 provides an example of how data may flow to, through, and/or from the system network. In FIG. 9, a consumer 302 may wish to add a job to the system network. The consumer may input information regarding the job 331 via the consumer's client system 306. For example, the consumer may type in information regarding the job via the client's touchscreen.

The consumer's client system may send an add a job request 335 to a system network 310. The add a job request may instruct the system network to add the job to a pool of jobs. For example, the add a job request may include data such as consumer identifier, contact details, job identifier, job description, job category, job subcategory, job location, job added date and/or time, and/or the like.

The system network may analyze jobs data 339. The system network may add the job to the pool of jobs, determine qualified recommenders for the job, set an expiration date for removing the job from the pool of jobs, and/or the like.

The system network may send a provider referral request 343 to qualified recommenders/referrers 314A-C via their respective clients 318A-C. The provider (i.e. affiliate) referral request may solicit provider recommendations from the qualified recommenders/referrers. For example, the affiliate referral request may include data such as referrer identifier, job description, job category, job subcategory, referrer's associated eligible affiliates, CRGC credit award value, and/or the like.

User 314A may input a provider referral 351 via the user's client 318A. For example, the user may select one or more associated eligible affiliates to recommend for the job. Furthermore, the user may input comments, ratings, reviews, and/or the like associated with the affiliates that the user is recommending. It is to be understood that any LSP user can be a consumer, a provider, or both a consumer and a provider.

The user's client system may send a provider referral response 355 to the system network. The provider (i.e. affiliate) referral response may include information regarding providers referred by the user for the job and may instruct the system network to add the referral to a list of referrals. For example the affiliate referral response may include data such as referrer identifier, referred affiliate identifier, comments about referred affiliate, job identifier, and/or the like.

The system network may analyze referrals data 359. The system network may determine whether the referral is timely, add the referral to the list of referrals, add the referred affiliate to a list of referred affiliates to send to the consumer, and/or the like. The system network may send a providers response 363 to the consumer's client system. The provider (i.e. affiliate)s response may include information regarding providers recommended by the referrers. For example, the affiliates response may include data such as consumer identifier, job identifier, referred affiliate identifier, comments about referred affiliate, description of referred affiliate, contact information of referred affiliate, and/or the like.

The consumer's client system may output information regarding referred affiliates 367 to the consumer. For example, the client system may display such information on the client's screen, may facilitate contacting one or more referred affiliates, and/or the like.

An affiliate provider 322 may indicate via job performed input 371 that the affiliate completed the job via the affiliate's client system 326. For example, the affiliate may utilize a GUI widget of a client system software to indicate that the affiliate completed the job.

The affiliate's client system may send a job performed request 375 to inform the system network that the affiliate completed the job. For example, the job performed request may include data such as job identifier, provider identifier, identifiers of CRGC credits redeemed, date and/or time when the job was marked as completed, and/or the like.

The system network may analyze CRGC credits data 379. The system network may determine who should be awarded CRGC credits for adding the job and/or for referring the affiliate who completed the job and/or for using the system network, values of CRGC credits that should be awarded, which CRGC credits were redeemed by the customer associated with the job and should be marked as used, and/or the like.

The system network may analyze accounts data 383. The system network may determine how to adjust account balances of the affiliate who completed the job and/or of the system network, whether the affiliate's account should be replenished, and/or the like.

The system network may send a confirmation response 387 to the affiliate's client system. The confirmation response may confirm that the job performed request was handled correctly. The affiliate's client system may display confirmation output 391 to the affiliate. For example, the client system may display a message thanking the affiliate for completing the job.

Each New Consumer Registers with Network and Opens a New Consumer Reward Gift Card (CRGC) Account Maintained on the System Network of the Present Invention

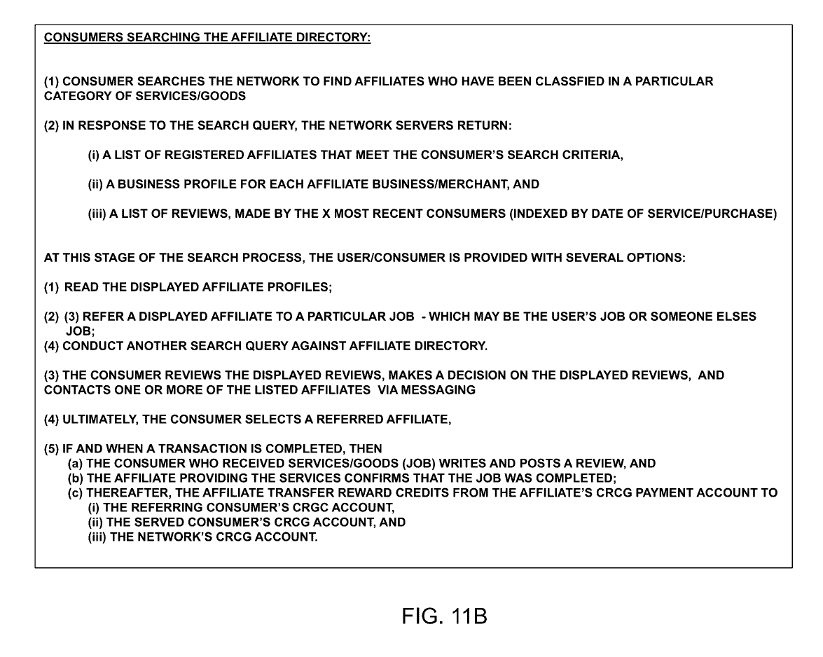

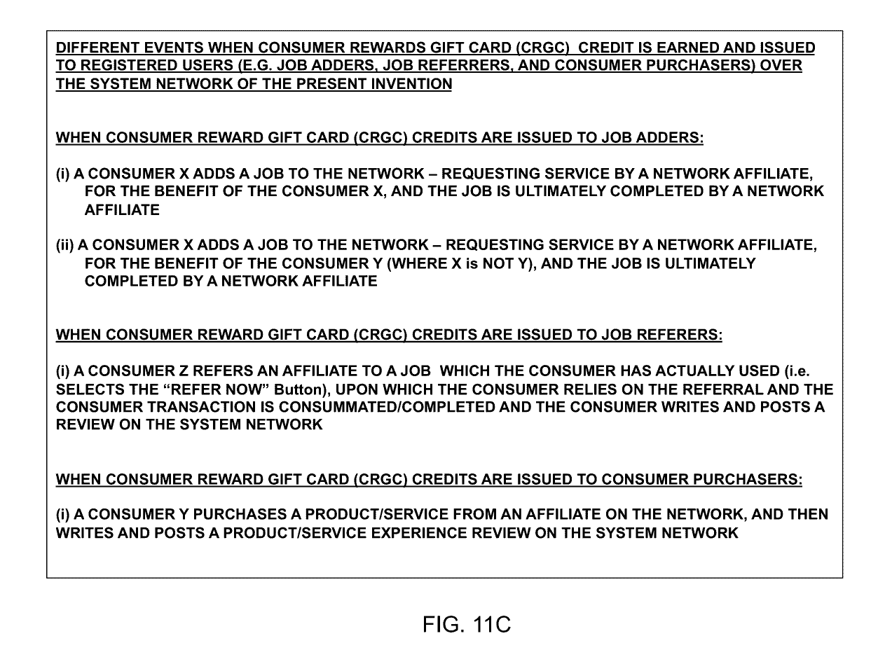

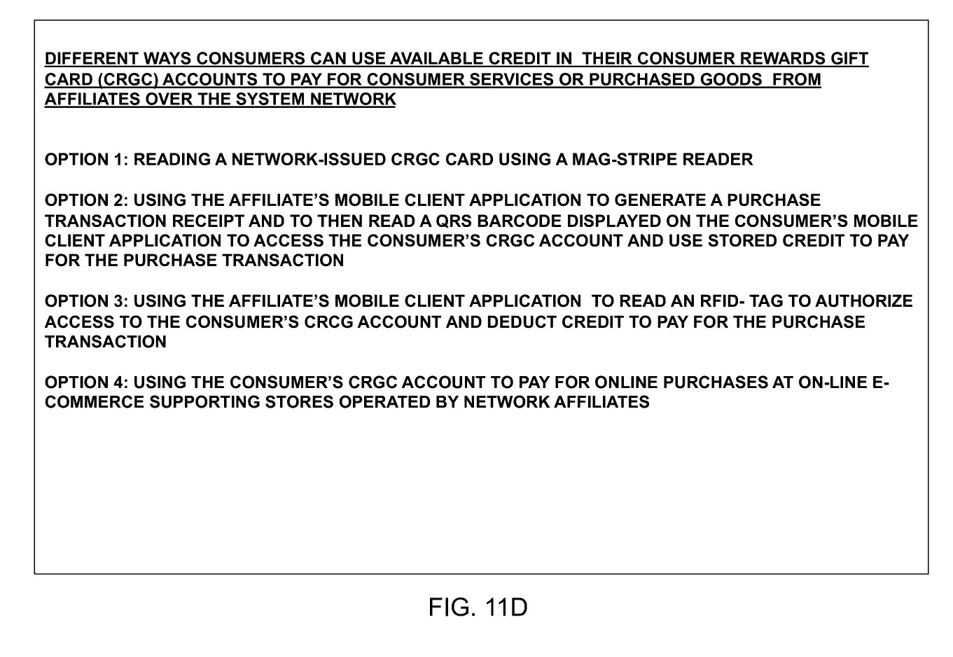

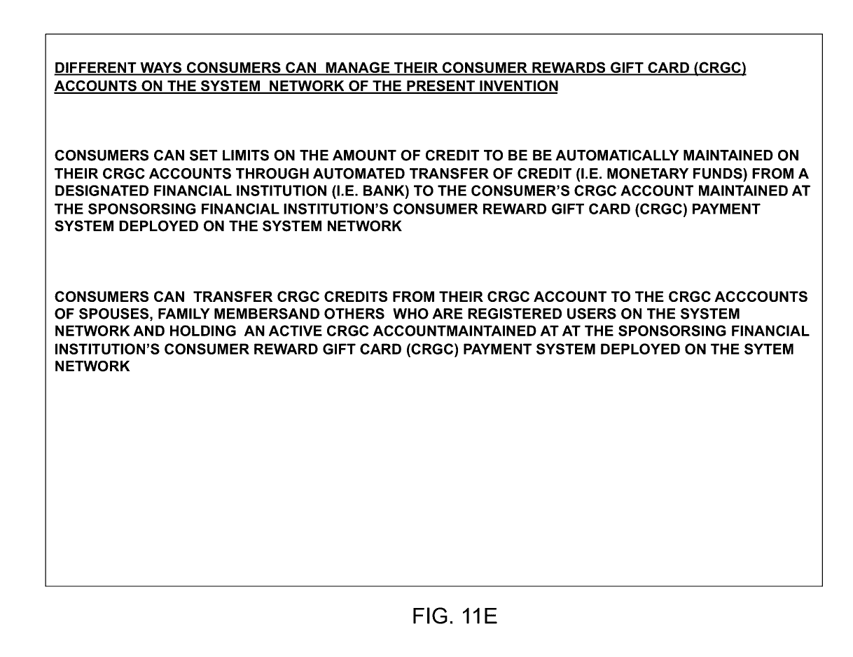

FIG. 11A describes several ways in which a consumer may register with the system network of the present invention and open a consumer rewards gift card (CRGC) account therewith, for use by the consumer user on the system network. Each consumer who registers with the system network automatically receives a consumer reward gift card (CRGC) account, having a user name and password. there are at least three ways a consumer can register with the system network: (1) when the consumer goes to the system network site and registers; (2) when the consumer registers online in response to an SMS or email message from the system requesting the consumer to register with the system network; and (3) the consumer purchases goods or services at an network affiliate, and the affiliate assists in consumer with registration process at the point of sale/purchase. however, the initial value on the consumer rewards gift card (CRGC) account will be zero, typically, unless a particular affiliate wishes to charge it with a small value amount as “a thank you” promotion for the consumer joining the network.

Consumer Services Supported while a Consumer is Searching the Affiliate Directory

FIG. 11B describes several ways in which a consumer may search the affiliate directory with the system network of the present invention, for use by the consumer user on the system network.

In general, a consumer searches the system network to find affiliates who have been classified in a particular category of services/goods. In response to the search query, the network servers return: (i) a list of registered affiliates that meet the consumer's search criteria; (ii) a business profile for each affiliate business/merchant; and (iii) a list of reviews, made by the x most recent consumers (indexed by date of service/purchase).

At this stage of the search process, the user/consumer is provided with several options: (1) read the displayed affiliate profiles; (2) refer a displayed affiliate to a particular job—which may be the user's job or someone else's job; (3) conduct another search query against affiliate directory; (4) the consumer reviews the displayed reviews, makes a decision on the displayed reviews, and contacts one or more of the listed affiliates via messaging; (5) ultimately, the consumer selects a referred affiliate; and (6) if and when a transaction is completed, then (a) the consumer who received services/goods (job) writes and posts a review; (b) the affiliate providing the services confirms that the job was completed; (c) thereafter, the affiliate transfers reward credits from the affiliate's CRGC payment account to (i) the referring consumer's CRGC account, (ii) the served consumer's CRGC account, and typically (iii) the network administrator's CRGC account to cover transaction fees on the system network.

Different Events when Consumer Rewards Gift Card (CRGC) Credit is Earned and Issued to Registered Users (e.g. Job Adders, Job Referrers, and Consumer Purchasers) Over the System Network of the Present Invention

FIG. 11C describes different events when consumer rewards gift card credit is earned and issued over the system network, including (i) when consumer reward gift card (CRGC) credits are issued to job adders (e.g. (1) consumer x adds a job to the system network—requesting service by a network affiliate, for the benefit of the consumer x, and the job is ultimately completed by a network affiliate, (2) a consumer x adds a job to the system network—requesting service by a network affiliate, for the benefit of the consumer y (where x is not y), and the job is ultimately completed by a network affiliate), (ii) when consumer reward gift card (CRGC) credits are issued to job referrers (e.g. a consumer z refers an affiliate to a job which the consumer has actually used (i.e. selects the “refer now” button), upon which the consumer relies on the referral and the consumer transaction is consummated/completed and the consumer waitress and posts a review on the system network), (iii) when consumer reward gift card (CRGC) credits are issued to consumer purchasers (e.g. a consumer y purchases a product/service from an affiliate on the network, and then writes and posts a product/service experience review on the system network).

Different Ways Consumers can Use Available Credit in their Consumer Rewards Gift Card (CRGC) Accounts to Pay for Consumer Services or Purchased Goods from Affiliates Over the System Network

FIG. 11D describes different ways consumers can use available credit in their consumer rewards gift card (CRGC) accounts to pay for purchases from affiliates over the system network, specifically: (i) option 1—reading a network-issued CRGC card using a mag-stripe reader; (ii) option 2—using the affiliate's mobile client application to generate a purchase transaction receipt and to then read a QRS barcode displayed on the consumer's mobile client application to access the consumer's CRGC account and use stored credit to pay for the purchase transaction; (iii) option 3—using the affiliate's mobile client application to read an RFID-tag to authorize access to the consumer's CRGC account and deduct credit to pay for the purchase transaction; and option 4:—using the consumer's CRGC account to pay for online purchases at on-line e-commerce supporting stores operated by network affiliates.

Various Ways how Consumers can Manage their Consumer Rewards Gift Card (CRGC) Accounts on the System Network of the Present Invention

FIG. 11E describes different ways how consumers can manage their consumer rewards gift card (CRGC) accounts on the system network of the present invention, including (i) setting limits on the amount of credit to be automatically maintained on their CRGC accounts through automated transfer of credit (i.e. monetary funds) from a designated financial institution (i.e. bank) to the consumer's CRGC account maintained at the sponsoring financial institution's consumer reward gift card (CRGC) payment system deployed on the system network, and (ii) transferring CRGC credits from their CRGC account to the CRGC accounts of spouses, family members and others who are registered users on the system network and holding an active CRGC account maintained at the sponsoring financial institution's consumer reward gift card (CRGC) payment system deployed on the system network

### A Listing of Primary Affiliates Services Supported on the System Network of the Present Invention

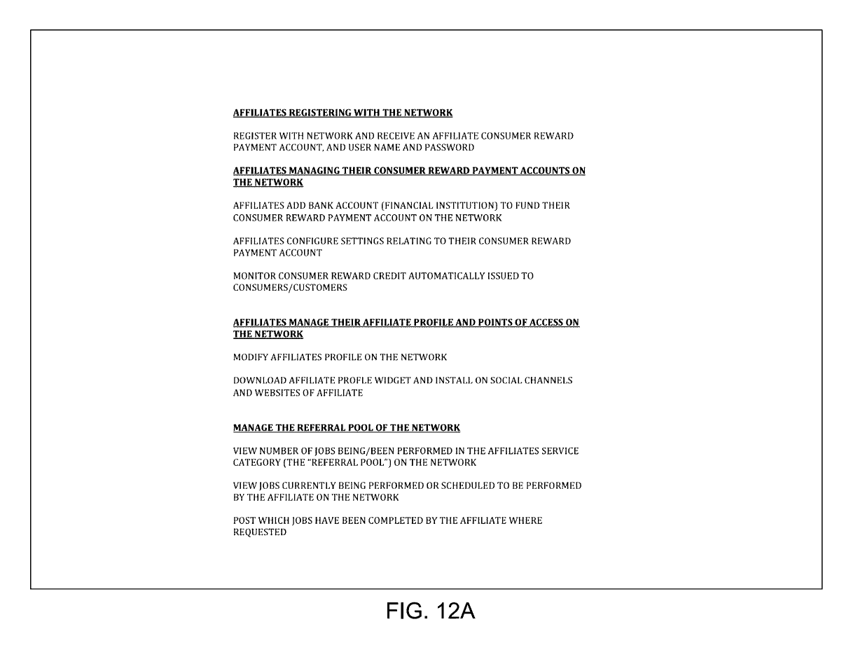

FIG. 12A describes various affiliates services including (i) affiliates registering with the system network, (ii) affiliates managing their consumer reward payment accounts on the system network, (iii) affiliates managing their profile and points of access on the system network, and (iv) affiliates managing the referral pool on the system network.

### System Allowing a Consumer to Earn Consumer Reward Gift Card (CRGC) Dollars as a Reward for Referring an Affiliate Who Completes a Job Posted on the Affiliate-Referral Driven Consumer Transaction Rewarding System Network of the Present Invention

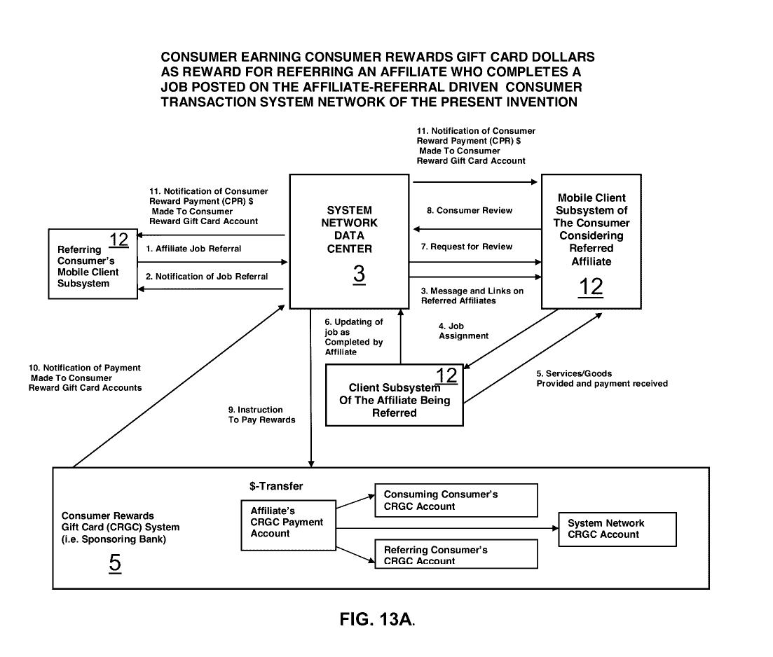

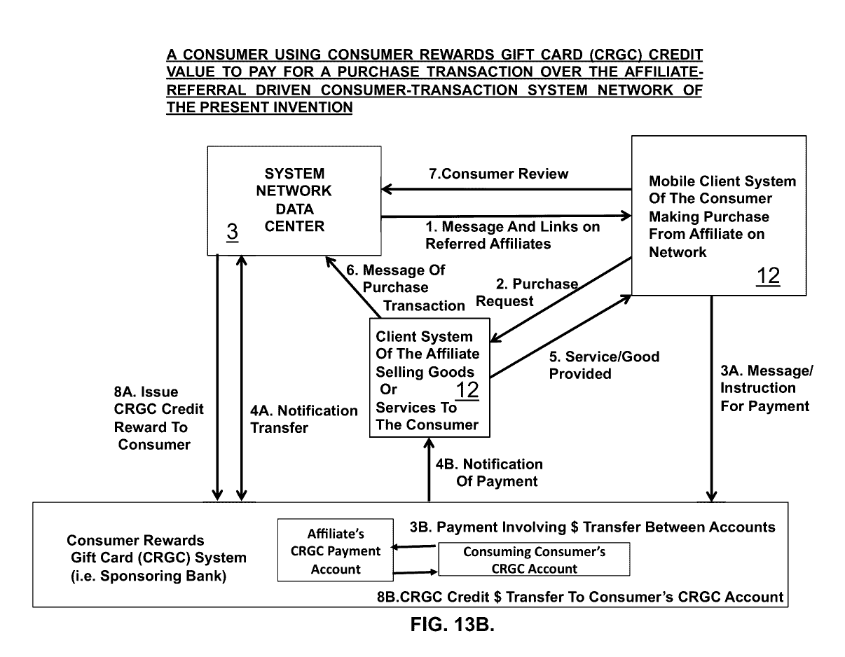

FIG. 13A is a schematic representation illustrating a primary process supported on the system network of the present invention. In the system network, a consumer earns consumer reward gift card (CRGC) dollars as a reward for referring an affiliate who completes a job posted on the affiliate-referral driven consumer transaction rewarding system network of the present invention.

In the illustrative embodiment, the process comprises the following steps: (a) the mobile client system of the referring consumer sends an affiliate job referral to the data center of the system network; (b) the data center of the system network sends a notification of job referral back to the referring consumer's mobile client system, as confirmation; (c) the data center of the system network sends a message and links on the referred affiliate(s) to the mobile client system of the consumer considering a referred affiliate to perform a service and/or from which to purchase goods; (d) the mobile client system of the consumer considering the referred affiliates sends a job assignment to the client system of the affiliate to who was referred, so they know they have been asked to perform the specified job; (e) the affiliate selected for the specified job performs the job services and/or provides specified goods or services, and the client system of the affiliate sends a message to the mobile client system of the consumer indicating that services have been rendered and/or goods provided and payment made by the consumer for the services/goods; (f) the data center of the system network sends a request for a consumer review to the mobile client system of the consumer whose job has been completed by the referred affiliate; (g) the mobile client system of the consumer whose referred job has been performed completely (and payment made by one of several methods) composes/writes a consumer review on the affiliate service provider/merchant who completed the specified job, and this consumer review is then sent from the mobile client system to the data center of the system network; (h) the data center of the system network sends instructions to the consumer rewards gift card payment system causing credit (money) in the affiliates CRGC payment account to be transferred to the CRGC account of the consumer referring the affiliate, the CRGC account of the consumer whose job has been performed by the affiliate, and the system network administrator's CRGC or like account; (i) the CRGC payment system sending a notification to the data center of the system network that payment has been transferred (made) to the consumer reward gift card (CRGC) accounts of the consumers and system network administrator; and (j) the data center of the system network sending a notification to the mobile client system of the affiliate service provider advising that a CRGC payment has been made to the consumer referring the affiliate to the completed job transaction, and the consumer whose referred job has been completed by the affiliate and reviewed by the consumer.

### A Consumer Using Consumer Rewards Gift Card (CRGC) Credit Value to Pay for a Purchase Transaction Over the Affiliate-Referral Driven Consumer-Transaction Rewarding System Network of the Present Invention

FIG. 13B schematically illustrates a primary process supported on the system network of the present invention, wherein a consumer uses consumer rewards gift card (CRGC) credit value to pay for a purchase transaction over the affiliate-referral driven consumer-transaction rewarding system network of the present invention. In the illustrative embodiment, the process comprises the steps whereby a consumer uses available consumer rewards gift card (CRGC) credit value to pay for a purchase of goods and/or services over the affiliate-referral driven consumer-transaction rewarding system network of the present invention. In the illustrative embodiment, the process comprises the steps of: (a) sending messages and links on referred affiliates from the data center of the system network to the mobile client system of the consumer making purchases from affiliates on the system network; (b) sending a purchase request from the mobile client system of the consumer making the purchase from affiliate on the system network; (c) sending a message and instructions for payment from the mobile client system of the consumer making purchase from the affiliate on the system network; (d) transfer of credit (i.e. funds) between the CRGC account of the consumer and the CRGC payment account of the affiliate service provider/merchant to make a payment for goods and/or services being purchased by the consumer from the affiliate; (e) notification of payment made within the sponsoring bank, sent from the consumer rewards gift card system; (f) notification of payment transfer within the sponsoring bank, sent from the consumer rewards gift card (CRGC) system to the data center of the system network; (g) the transfer of purchased goods and/or services from the client suite of the affiliate selling goods and/or services to the consumer; (h) sending a message of the completed purchase transaction from the client system of the affiliate to the data center of the system network; and (i) preparing and sending a consumer review of the completed purchase transaction involving the affiliate, from the mobile client system of the consumer who purchased the goods and/or services, to the data center of the system network.

Recycling Consumer Rewards Gift Card (CRGC) Credit Value (“Financial Energy”) within the System Network of the Present Invention

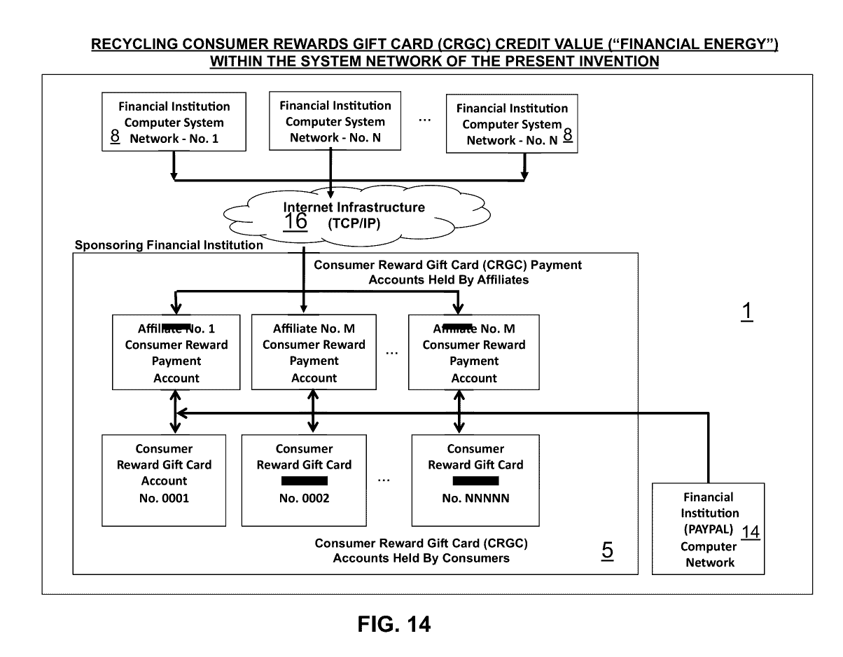

FIG. 14 illustrates the recycling of consumer rewards gift card (CRGC) credit value (e.g. “financial energy”) between consumer reward gift card (CRGC) payment accounts held by affiliates and consumer reward gift card (CRGC) accounts held by consumers and external financial institutions of the consumers, within the system network of the present invention. As shown, the group of financial institution computer system networks 12 are operably connected to the infrastructure of the Internet 16 (e.g. the cloud), whereas the consumer reward gift card (CRGC) payment accounts held by each affiliate (e.g. service provider) registered with the system network 1, on the sponsoring financial institution's CRGC payment system network 5, and the consumer's CRGC accounts are operably connected to the affiliate's CRGC payment accounts to facilitate the transfer of financial credits between consumers and affiliates so as to practice the consumer reward principles of the present invention.

Job-Affiliate Referral Pools Structure Employed within the Affiliate-Referral Driven Consumer-Transaction Rewarding System Network of the Present Invention

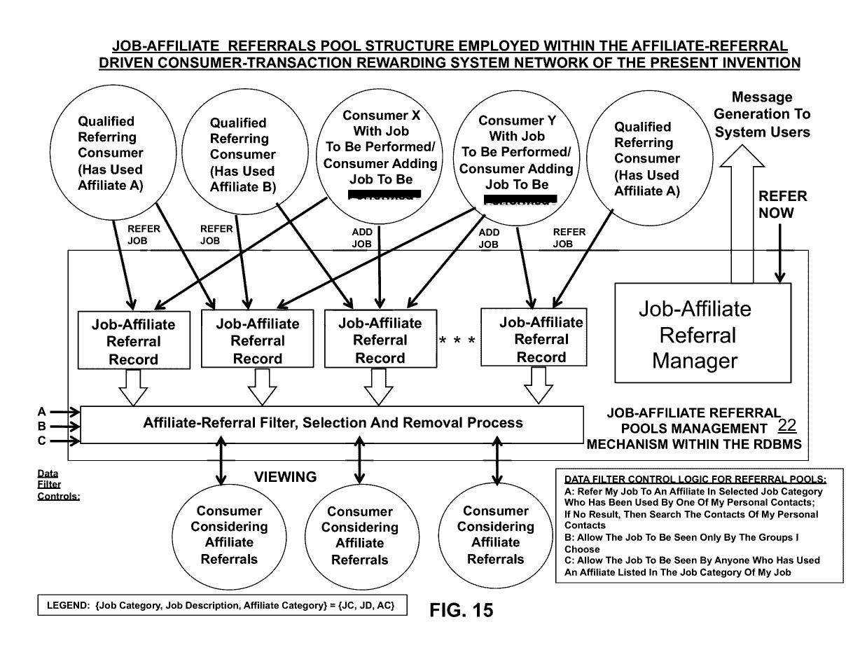

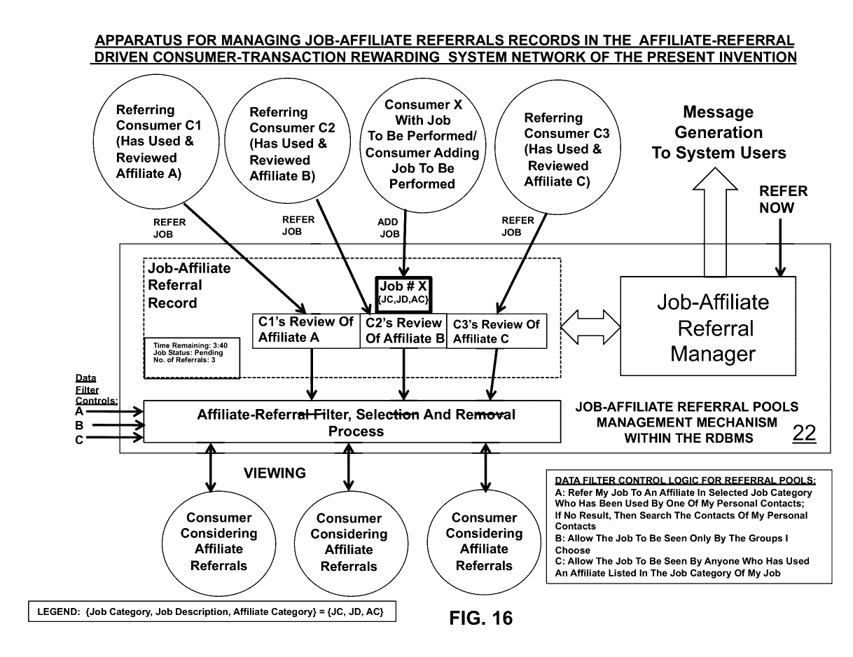

FIG. 15 schematically illustrates the job-affiliate referral pools structure employed within the affiliate-referral driven consumer-transaction rewarding system network of the present invention. As shown, a job-affiliate referral pools management mechanism within the RDBMS (the system database) comprises: record handling, storing and linking apparatus provided for assembling and storing job-affiliate referral records as job records are added to the referral pools, and then affiliate records and consumer review records are composited (i.e. linked together), and provided with viewing privileges (e.g. tags indicating which groups—defined with the consumer directory—can view particular job-affiliate referral records in the referral pools, when the user consumers use the “refer jobs to” module supported on client systems, deployed on the system network of the present invention, to see which jobs they are entitled to refer affiliates in effort to better serve consumer and help drive local commerce by maintaining financial incentives through consumer rewards gift card (CRGC) credits issued to consumers who help drive successful transactions. FIG. 16 illustrates in mechanism is greater technical detail, showing the structure of each job-affiliate referral record with the referrals pools, keeping in mind that this referral pool structure is conceptual, and in fact this structure is implemented within the RDBMS of the system network using programmed search logic applied in accordance with the principles of the present invention taught herein.

In the illustrative embodiment, the data filter control logic for the referral pools is characterized the three rules set forth above, and supplied as data filter control to the job-affiliate referral pools management mechanism within the RDBMS 22: (A) Refer My Job To An Affiliate In Selected Job Category Who Has Been Used By One Of My Personal Contacts; If No Result, Then Search The Contacts Of My Personal Contacts: (B) Allow The Job To Be Seen Only By The Groups I Choose; and (C) Allow The Job To Be Seen By Anyone Who Has Used An Affiliate Listed In The Job Category Of My Job. These rules are practiced in the GUI interfaces set forth in FIGS. 32C, 32L and 32P, for the three Options A, B and C, supported when a user wishes to add a job to the referrals pool supported within the RDBMS 22 on the system network of the present invention.

### Apparatus for Managing Job-Affiliate Referrals Records in the Affiliate-Referral Driven Consumer-Transaction System Network of the Present Invention

FIG. 16 schematically illustrates apparatus for managing job-affiliate referrals records in the affiliate-referral driven consumer-transaction rewarding system network of the present invention, as described above in connection with FIG. 15.

### Method of Registering a Consumer on the System Network and Assigning the Consumer a Consumer Reward Gift Card (CRGC) Account

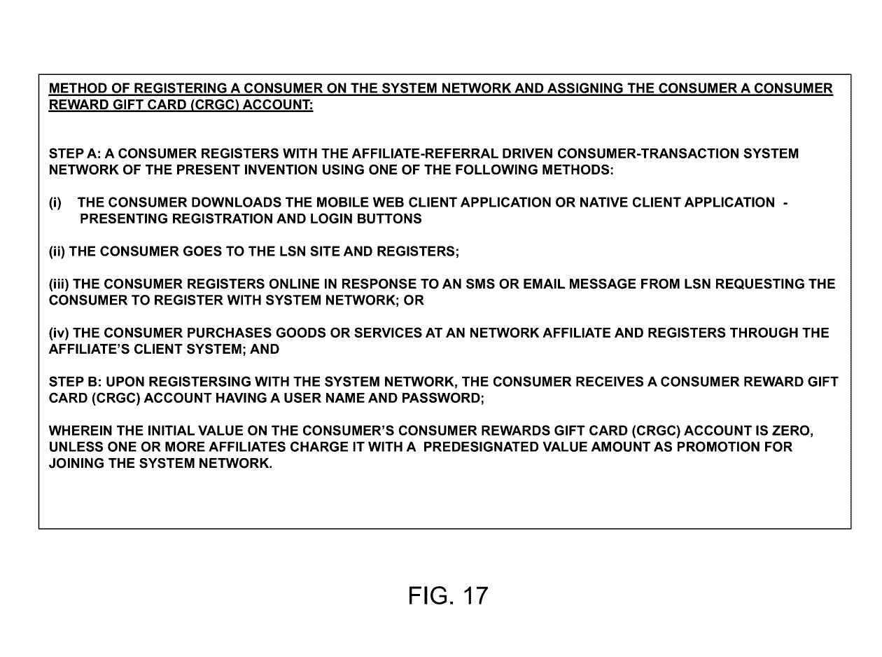

FIG. 17 describes the primary steps carried out the method of registering a consumer on the system network of the present invention, involving assigning of a consumer reward gift card (CRGC) account to the registered consumer for use on the system network. As shown in the illustrative embodiment, the method comprises the steps of: (a) a consumer registering with the affiliate-referral driven consumer-transaction rewarding system network of the present invention using one of the following methods, selected from the group consisting of (i) the consumer downloads the mobile web client application or native client application—presenting interface objects in the form of registration and login buttons, (ii) the consumer goes to the system network's web site and registers, (iii) the consumer registers online in response to an SMS or email message from system network requesting the consumer to register with system network; or (iv) the consumer purchases goods or services at an network affiliate and registers through the affiliate's client system; and (b) upon registering with the system network, the consumer receiving a consumer reward gift card (CRGC) account having a user name and password, wherein the initial value on the consumer's consumer rewards gift card (CRGC) account is zero, unless one or more affiliates charge it with a predesignated value amount as promotion for joining the system network.

### Consumers can Search for Affiliates Listed in the Affiliate Directory at Many Different Workflow Locations Supported on Client Systems Deployed on the System Network of the Present Invention

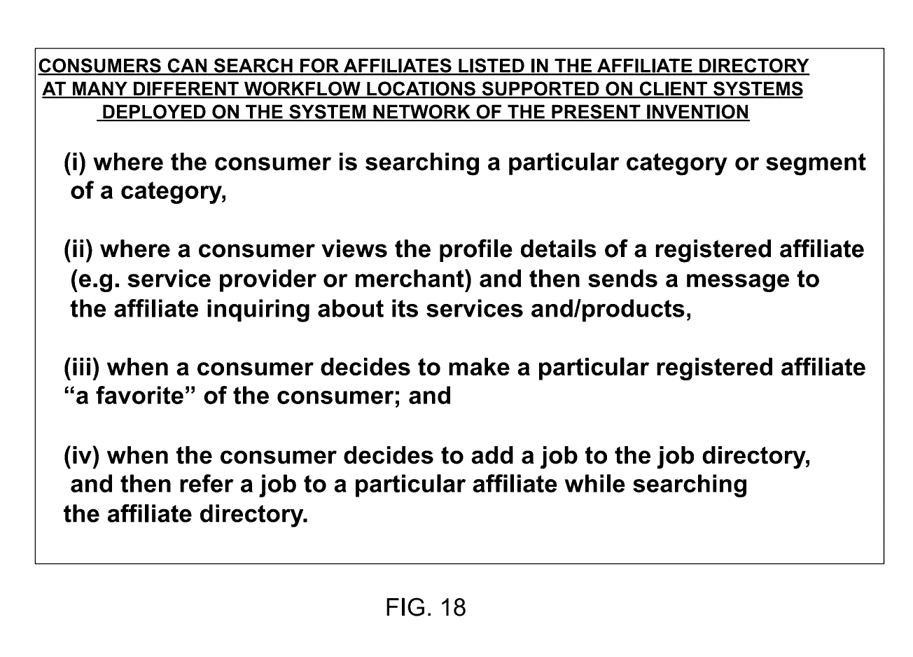

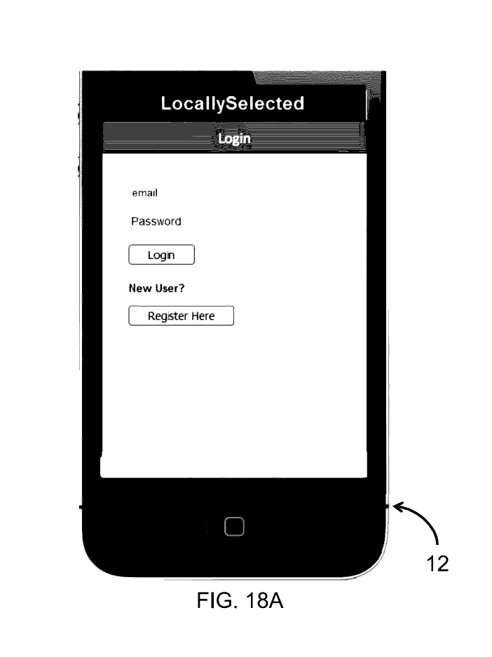

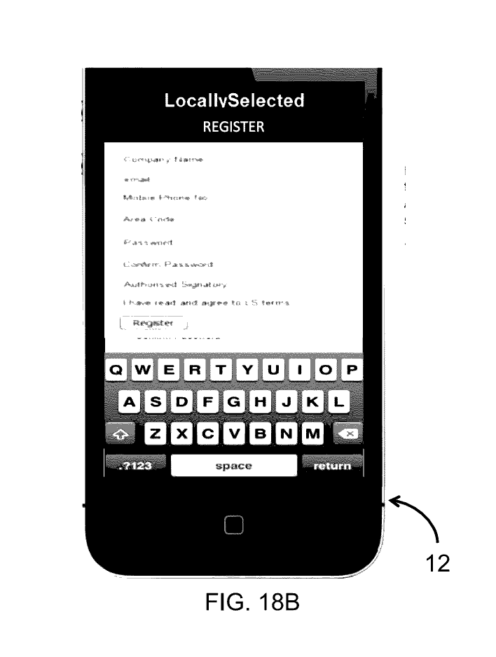

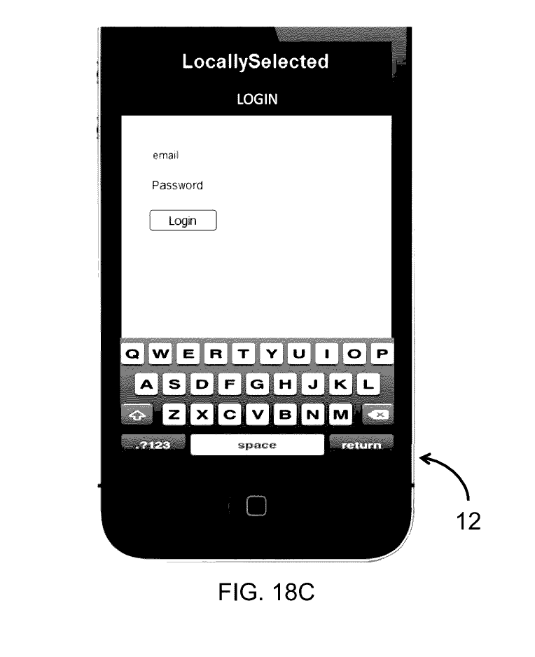

FIG. 18 describes the primary workflow locations where consumers can search for affiliates listed in the affiliate directory illustrated in FIGS. 6A and 6B, including, for example, (i) where the consumer is searching a particular category or segment of a category, (ii) where a consumer views the profile details of a registered affiliate (e.g. service provider or merchant) and then sends a message to the affiliate inquiring about its services and/products, (iii) when a consumer decides to make a particular registered affiliate “a favorite” of the consumer; and (iv) when the consumer decides to add a job to the job directory, and then refer a job to a particular affiliate(s) while searching the affiliate directory.

### Primary GUI Screens for the System Network of the Illustrative Embodiment of the Present Invention

The various services supported by system network of the present invention are supported by a variety of graphical user interfaces (GUIS), shown in FIGS. 18A through 56B. As shown, each GUI screen in the Drawings will be generated and maintained by server-side-driven, client-side-driven and/or client-server-driven processes, supported by object-oriented modules of the system application layer of the system network of the present invention. Also, each GUI screen may contain numerous unique, recognizable icons which, when selected, trigger server-side-driven, client-side-driven and/or client-server-driven processes and the generation and display of new or transformed GUI screens on client systems 12, to provide the system users with the services/functionalities associated with selected icons and supporting modules. The details of these modules, graphical icons (i.e. also referred to as “interface objects”) and corresponding services will be described in greater detail hereinafter.

As shown, the system network has been designed for several different kinds of user roles including, for example: (i) individual consumers who can homeowners, renters, college students, children and anyone who needs consumer services and/or products; (ii) affiliates (including service providers, merchants, manufacturers et al); and (iii) administrators of the system network, and depending on which role for which the user requests registration, the system network will request different sets of registration information, including name of user, address, contact information, information about the user etc. Once the user has successfully registered with the system network, the system network will automatically serve a native client GUI, or an HTML5 GUI, adapted for the registered user.

### Specification of Registration and Login Processes on the System Network of the Present Invention

FIG. 18A shows a graphical user interface (GUI) screen generated by the login module of the system network and displayed on the display screen of a mobile client system on the system network of the present invention.

FIG. 18B shows a graphical user interface (GUI) screen generated by the registration module of the system network and displayed on the display screen of a mobile client system.

FIG. 18C shows a graphical user interface (GUI) displayed on the display screen of a mobile client system on the system network, and generated by the login module of the system network.

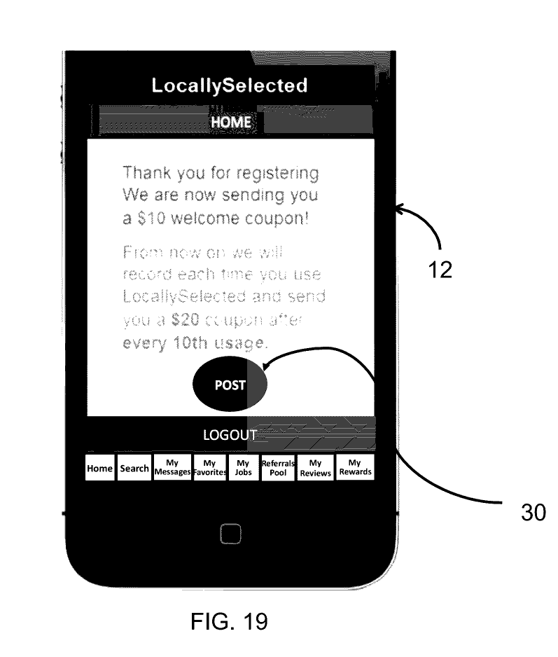

FIG. 19 shows a graphical user interface (GUI) displayed on the display screen of a mobile client system on the system network, and generated by the home module of the system network. As shown in FIG. 19 and other GUI screens disclosed herein, the home module and all other modules relying on this module, generates a GUI screen presenting a footer-based control panel containing a set of interface objects labeled and assigned to the following modules which will be described in greater detail hereinafter: home module; search module; my messages module; my favorites module; my jobs module; referral pool; my reviews module; and my rewards module. Upon selecting any one of these footer-based interface objects, the corresponding module is loaded and activated on the client system of the user on the system network of the present invention.

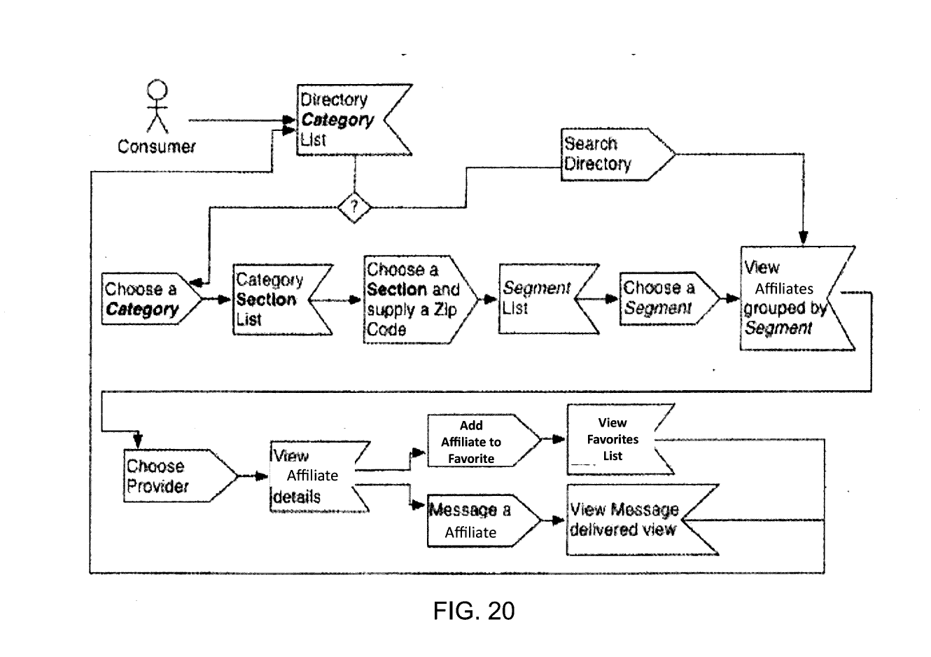

FIG. 20 provides a use case model illustrating a consumer accessing the affiliate directory of the system network, and using the services supported thereby including the search module, the favorites module, and messaging module.

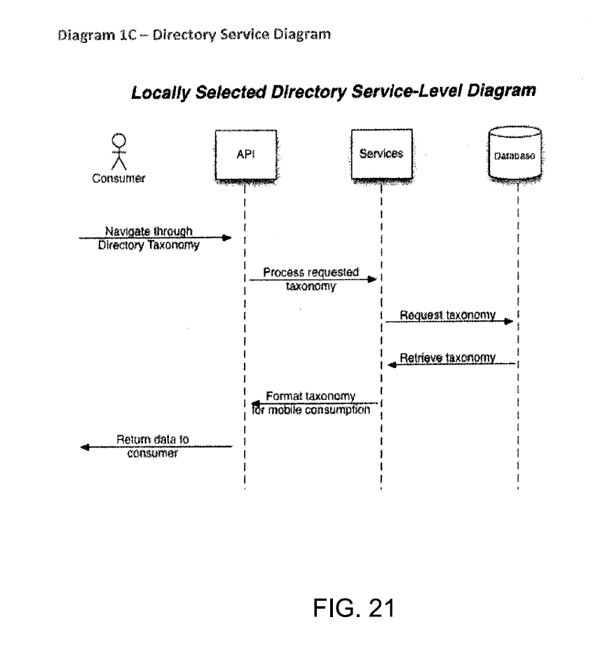

FIG. 21 provides a multi-layer service model for delivering affiliate and other directory services, supported on the system network of the present invention, wherein consumer users and are others are provided with a graphical user interface (GUI) coupled to the application programming interface or API (i.e. control tier) which interfaces with the system database or RDBMS (i.e. database tier) for storing persistent objects and supporting various services, including searching the affiliate directory, provided by the system network of the present invention.

### Affiliate Directory Related Services Supported by the System Network of the Present Invention

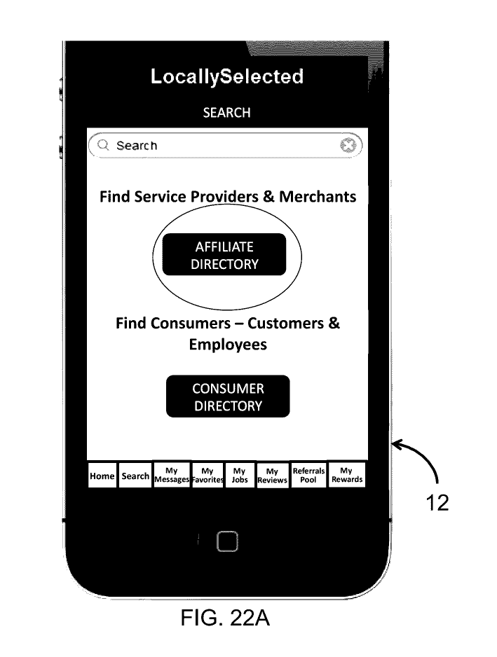

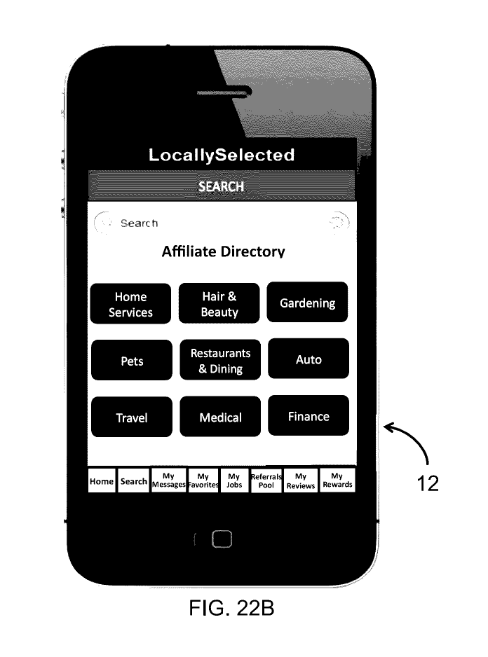

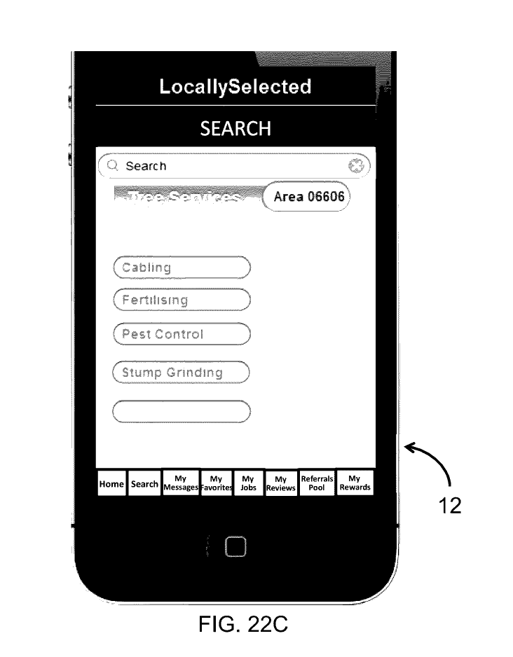

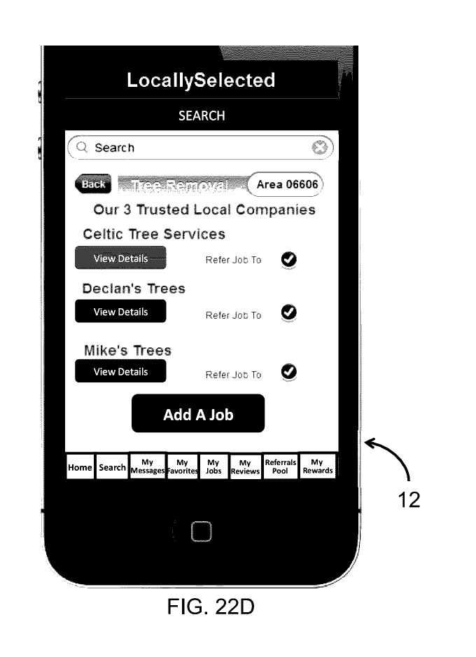

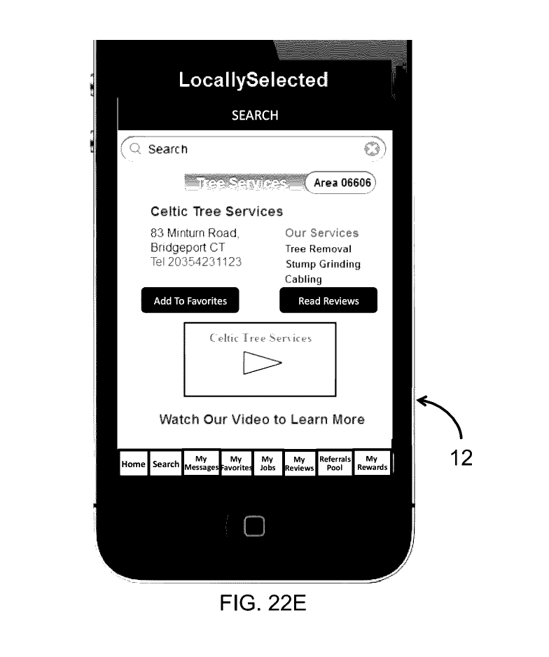

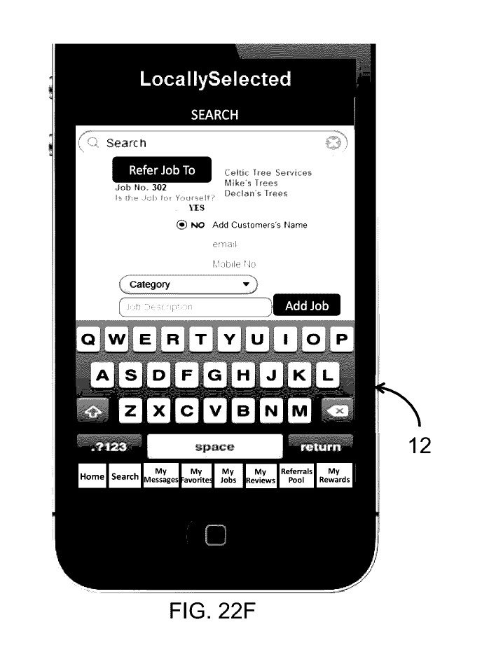

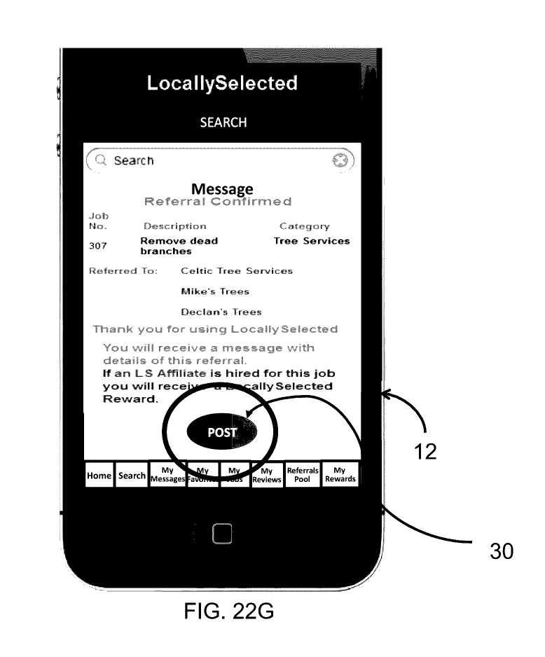

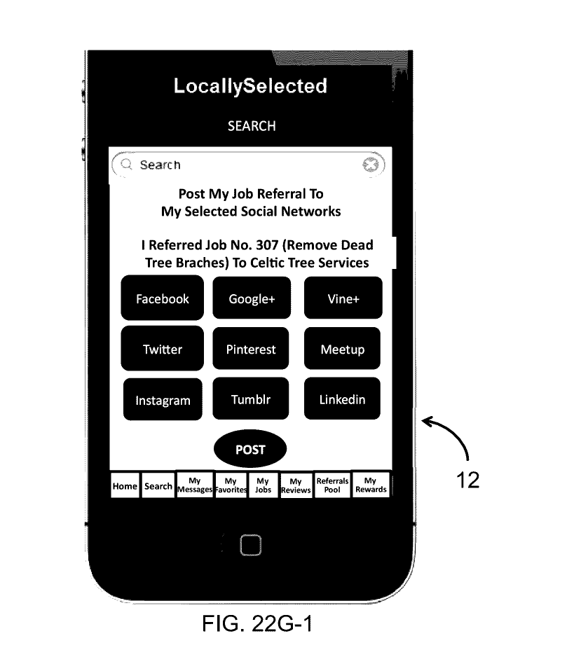

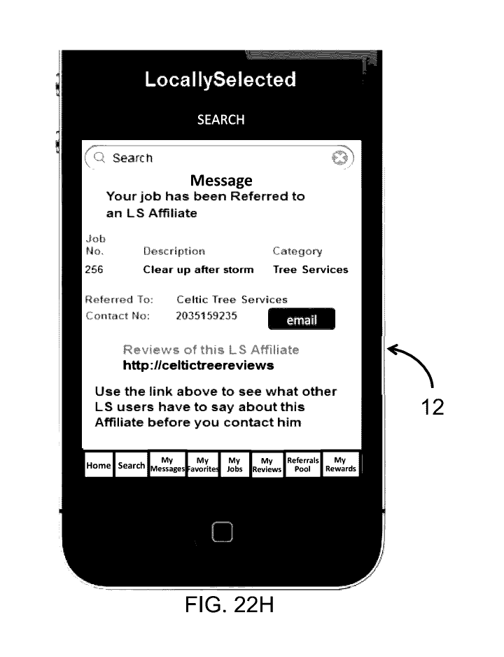

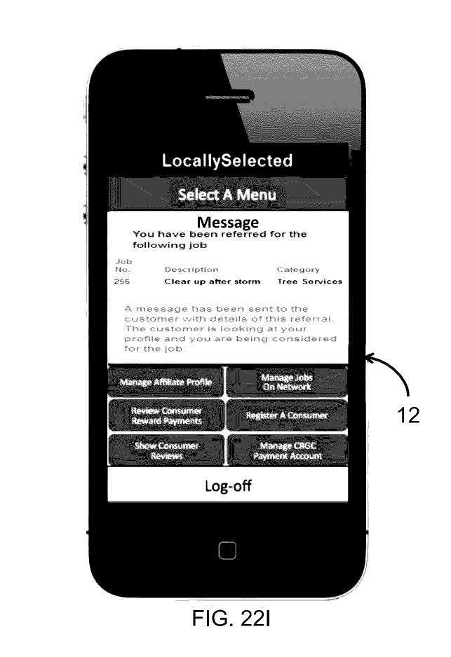

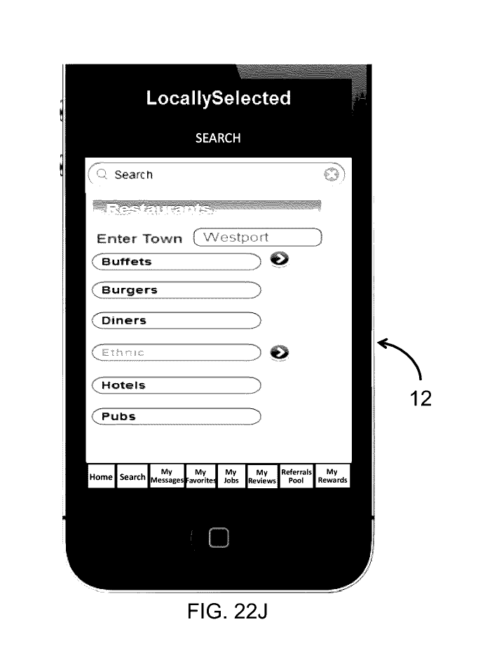

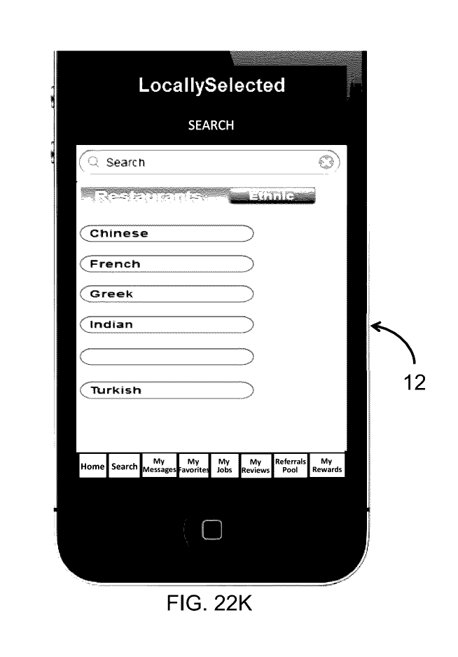

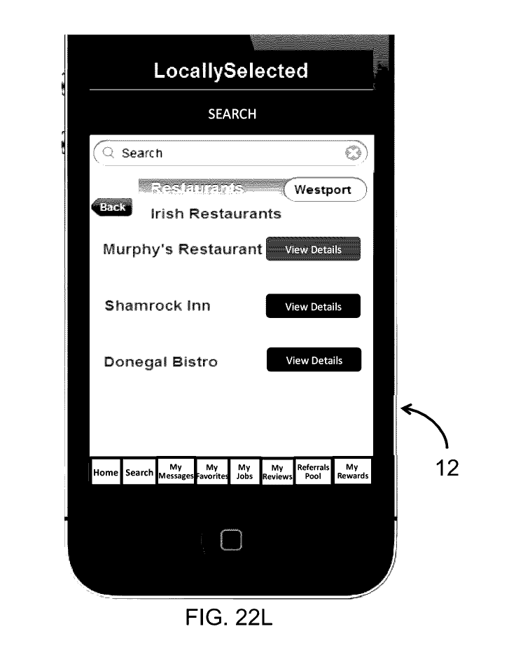

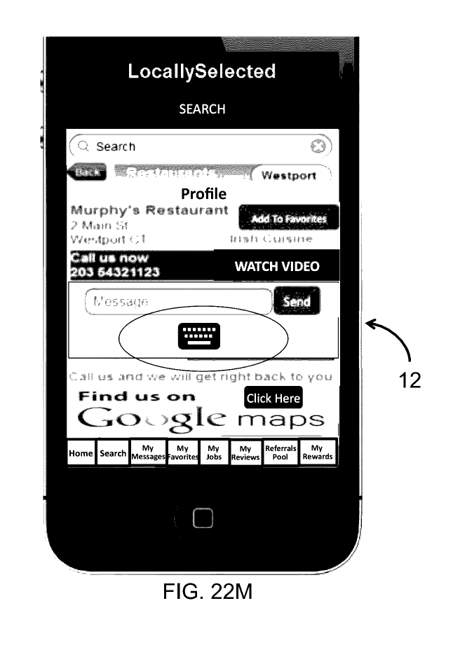

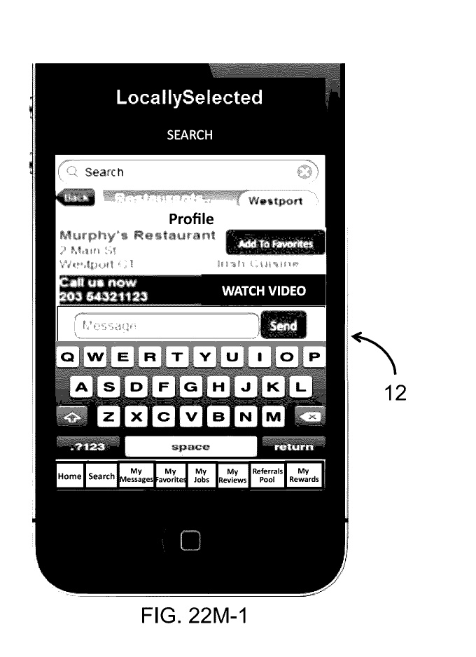

FIG. 22A shows a graphical user interface (GUI) screen generated by the search module of the system network and displayed on the display screen of a mobile client system on the system network, wherein interface objects are displayed for both the affiliate directory and the consumer directory, for access by registered consumers when using the system network of the present invention.

FIG. 22B shows a graphical user interface (GUI) screen generated by the search module of the system network and displayed on the display screen of a mobile client system on the system network, wherein interface objects are displayed for service categories such as, for example, but not limited to home services, hair & beauty, gardening, pets, restaurants & dining, automotive, travel, medical and financial.

FIG. 22C shows a graphical user interface (GUI) screen generated by the search module of the system network and displayed on the display screen of a mobile client system on the system network, wherein the displayed GUI screen indicates that the consumer selected the interface object for home services, and navigated through display screens to display the interface for “tree services” for a specific area code, where subcategories are displayed, specifically, cabling, fertilizing, pest control, stump grinding, and tree removal.

FIG. 22D shows a graphical user interface (GUI) screen generated by the search module of the system network and displayed on the display screen of a mobile client system on the system network, wherein the consumer selects the interface object for a specific service (i.e. subcategory), the system network automatically accesses the system database and serves and displays to the consumer, a predetermined number (e.g. three) service providers (e.g. affiliates) for the selected service in the specified area code, and wherein, the customer can elect to “refer a job” to one, more or all of the listed service providers by selecting the corresponding interface object (e.g. check icon), and also can view the affiliate profile of each service provider by selecting the interface object entitled “View Details”, as shown.

FIG. 22E shows a graphical user interface (GUI) screen generated by the search module of the system network and displayed on the display screen of a mobile client system on the system network, wherein the displayed GUI displays the vendor/service provider profile detail screen, and the consumer has the option of adding the service provider to the consumer's favorites list, as well as read detailed affiliate reviews, supported by the read review module supported on the system network.

FIG. 22F shows a graphical user interface (GUI) screen generated by the search module of the system network and displayed on the display screen of a mobile client system on the system network, wherein the displayed GUI screen displays the “add a job” and “refer job to” display screen, in response to the consumer selecting the interface object for “add a job” shown in FIG. 22D, wherein the system automatically generates a job number for the new job, and if the job is not for the consumer user, then contact details are requested for the person who needs the job performed, and they are provided by the consumer user and the system network will automatically generate a user profile for that customer/system user, and wherein, from the search directory point of consumer contact, neither the job or the referrals will be added to the Referral Pools facility illustrated in FIGS. 15 and 16, but rather, job referrals (i.e. the referral of a consumer's specific job) will be automatically and simultaneously transmitted (at the time of the consumer search inquiry) to a predetermined number (e.g. up to three affiliates) affiliate service providers or merchants selected by the consumer searching the affiliate directory, wherein these referred affiliate service providers will typically pay a fee to the system network administrator for the provision of such affiliate directory listing services on the system network.

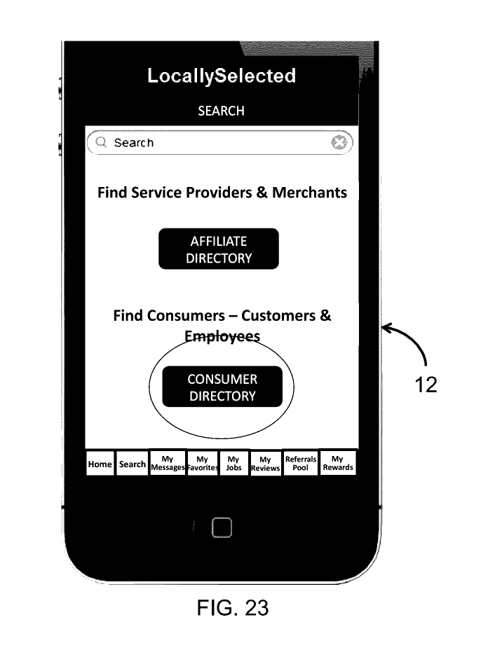

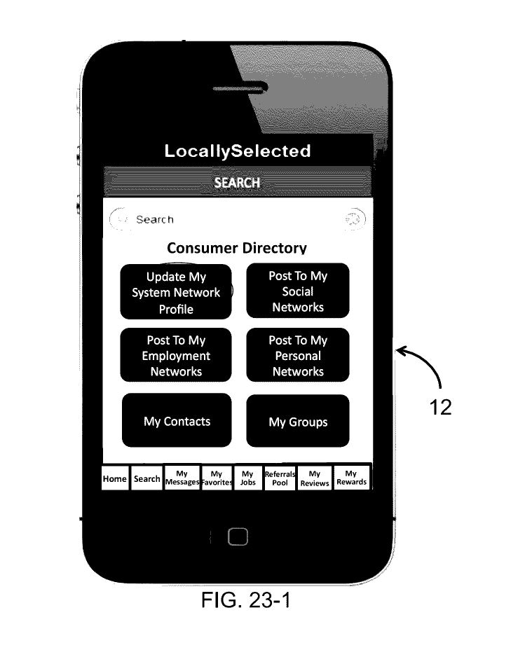

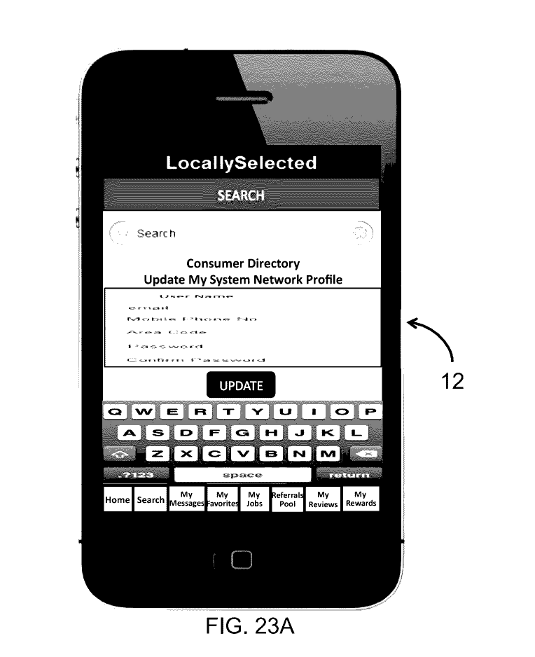

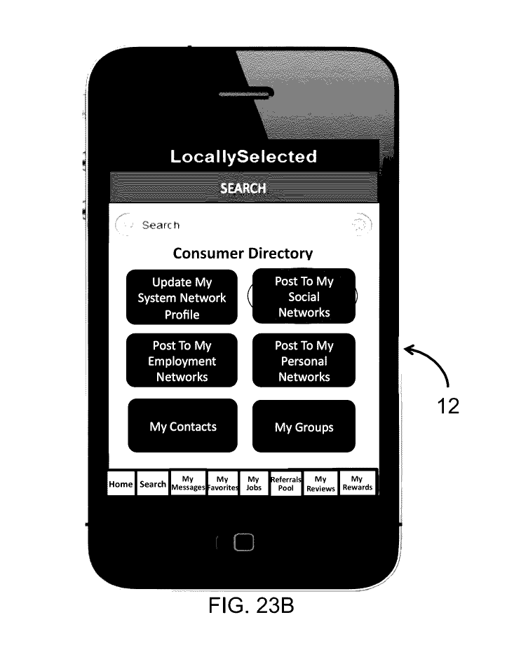

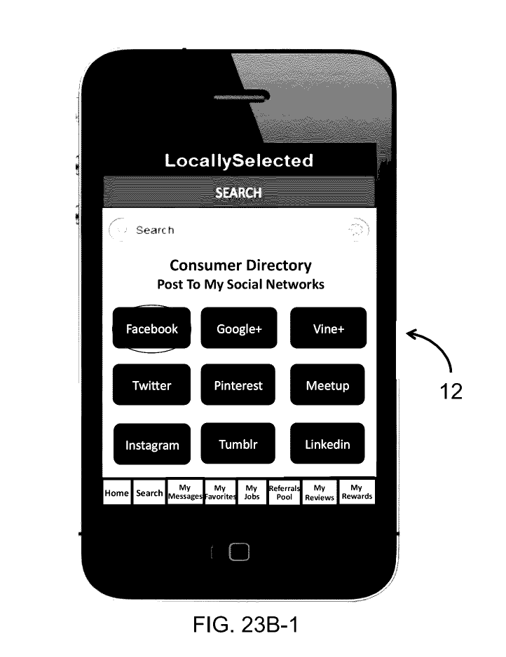

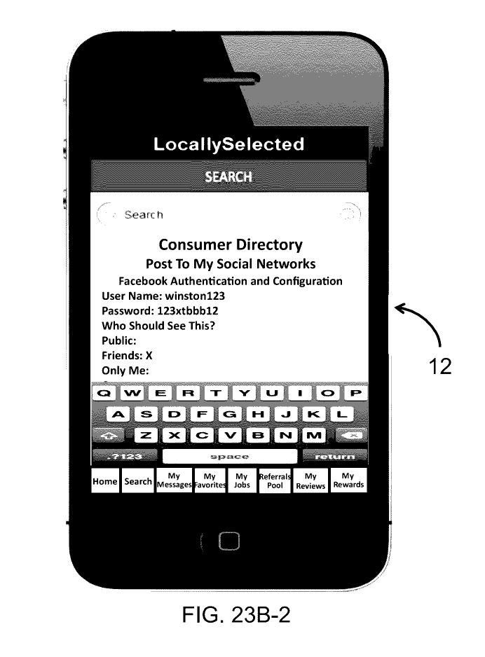

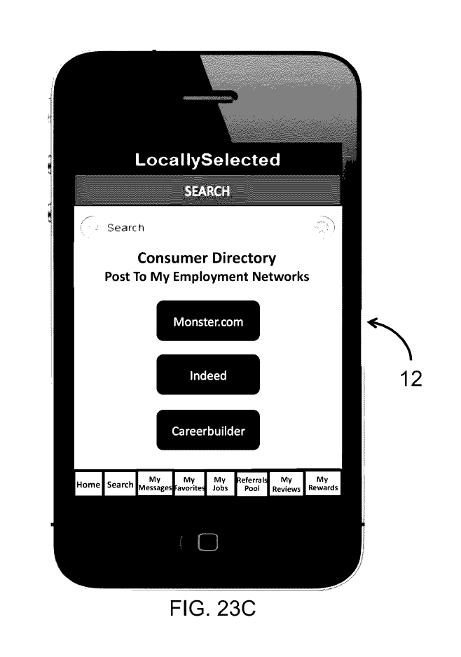

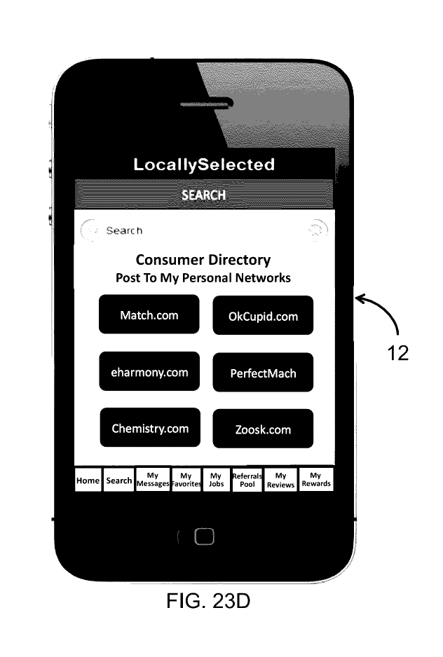

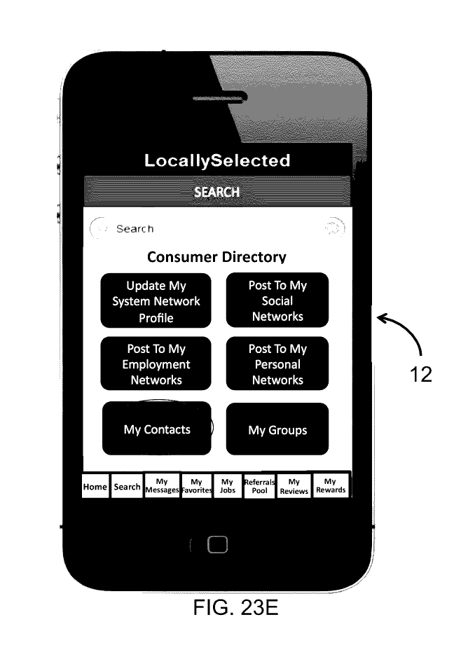

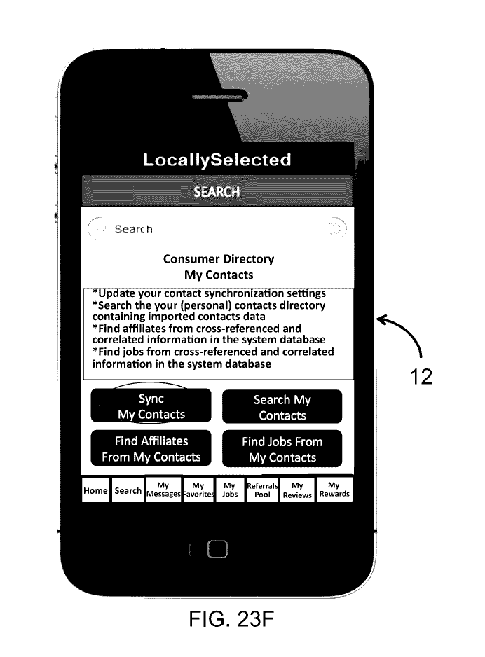

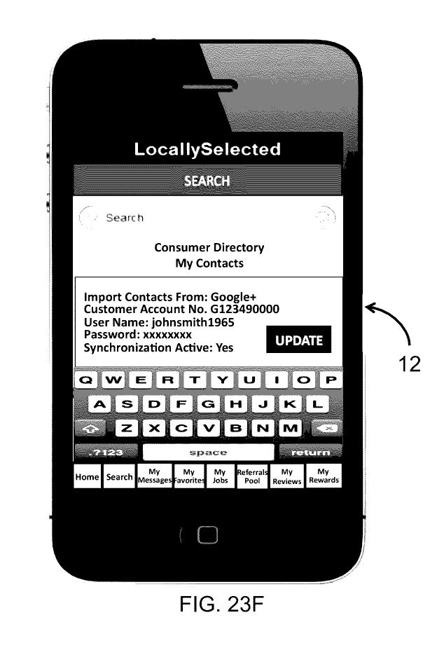

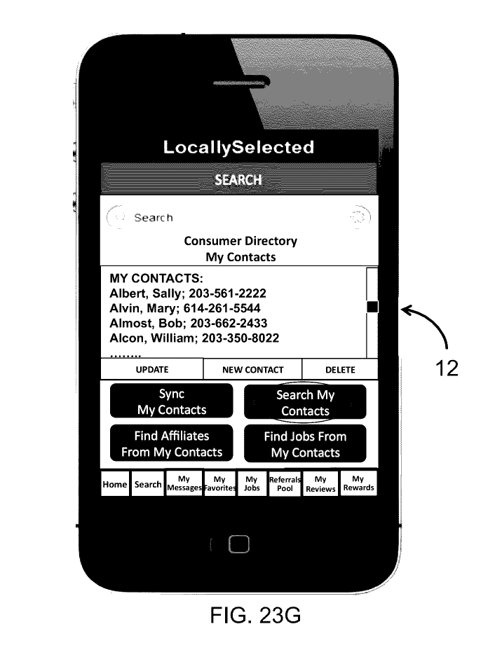

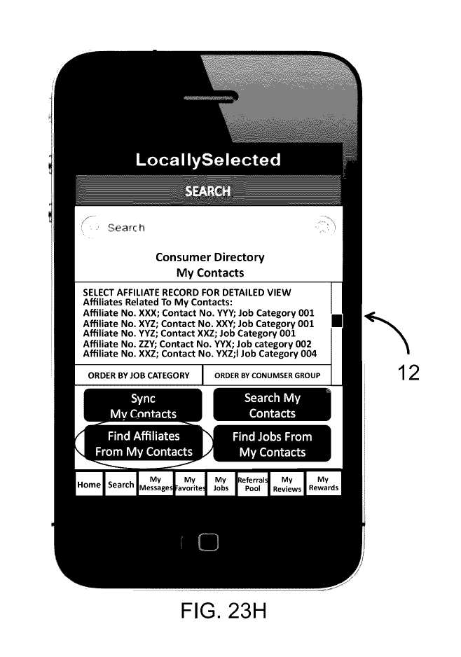

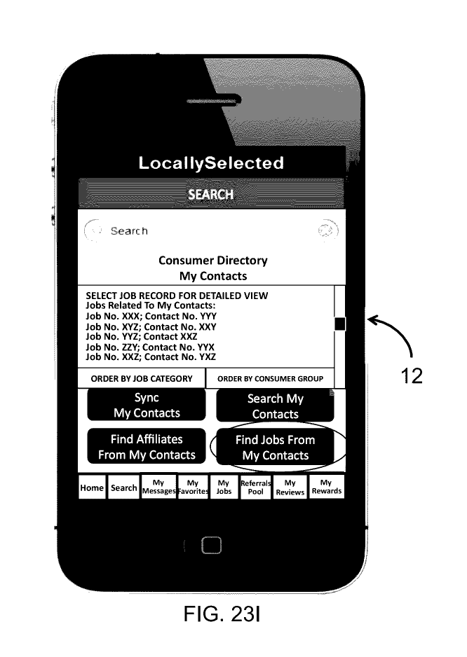

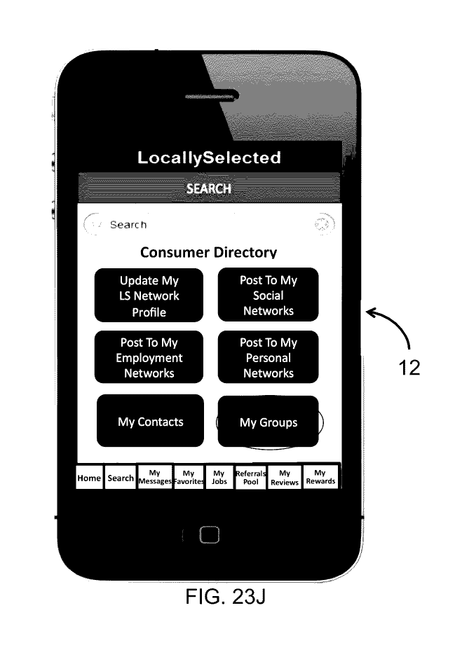

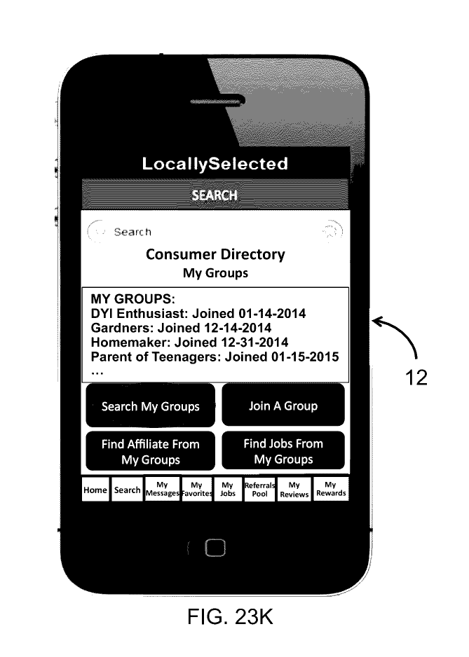

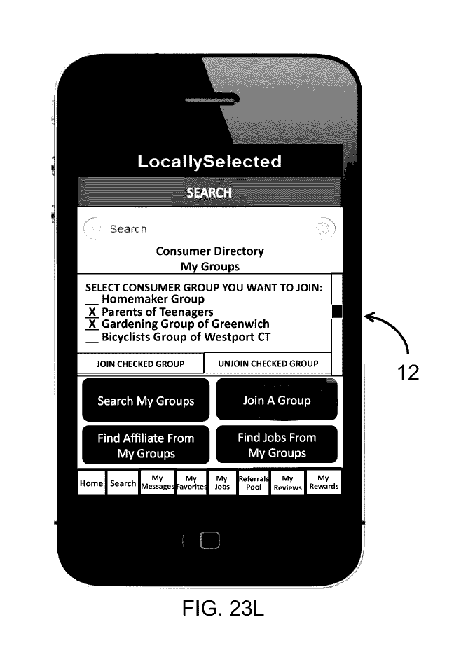

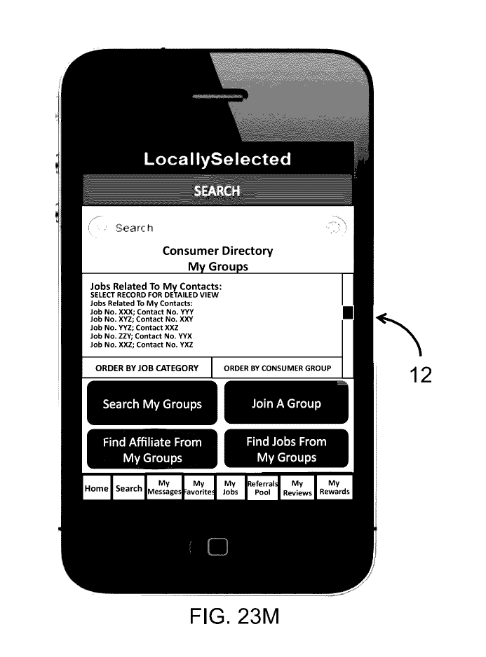

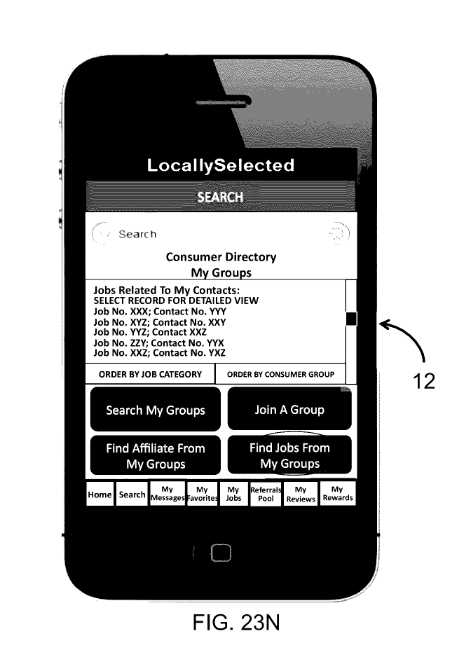

FIG. 22G shows a graphical user interface (GUI) screen generated by the search module of the system network and displayed on the display screen of a mobile client system on the system network, wherein the displayed GUI screen presents a message confirming that the consumer user that added job has been referred to the three selected service providers (e.g. Celtic Tree Service, Mike's Trees and Declan's Trees), and advising the consumer user that they will receive a message about this referral, and that if one of these referred network affiliates is hired for this specific job, then they will receive a predetermined amount of consumer reward gift card (CRGC) credit value paid by the affiliate who has completed the performance of the referred job, and wherein a “post” interface object is displayed on this message screen providing the referring consumer the option to post the essence of this message event to the social, personal and employment network channels of the referring consumer which have been preconfigured and enabled in the GUI screen shown in FIGS. 23B, 23C and 23D.

FIG. 22G-1 shows a graphical user interface (GUI) screen generated by the search module of the system network and displayed on the display screen of a mobile client system on the system network, where in response to selecting the “Post” interface object in FIG. 22G, the displayed GUI screen presents a set of enabled social channels of the referring consumer, as shown, to which the job referral event will be sent upon (i) selecting desired social networks and (ii) then selecting the “post” interface object displayed on the lower portion of the GUI display screen.

FIG. 22H shows a graphical user interface (GUI) screen generated by the search module of the system network and displayed on the display screen of a mobile client system associated with the consumer whose a job has been referred to affiliates selected by the referring consumer using the display screen shown in FIG. 22F, wherein the displayed GUI screen presents a message to the consumer informing that a consumer reward gift card credit will be issue to the consumer in the event that a consumer viewing the referral in the affiliate directory listing hires the affiliate who completes the job.

FIG. 22I shows a graphical user interface (GUI) screen generated by the search module (and supporting modules) of the system network, and displayed on the display screen of a mobile client system associated with each affiliate who has received a job referral by a referring consumer (using the display screen shown in FIG. 22F), wherein the displayed GUI screen presents a message to the consumer informing that the affiliate has been referred the job and is being considered therefor, and that a message has been sent to the consumer requesting job performance, with a link to the affiliate's profile and past job reviews by consumers who have used the affiliate on their jobs in the specified category.

FIG. 22J shows a graphical user interface (GUI) screen generated by the search module of the system network and displayed on the display screen of a mobile client system on the system network, where in response to the consumer user selecting the corresponding interface object in the GUI display screen shown in FIG. 22B, the restaurant category screen is displayed and the consumer enters the town “Westport” and selects “Ethnic”.

FIG. 22K shows a graphical user interface (GUI) screen generated by the search module of the system network and displayed on the display screen of a mobile client system on the system network, wherein “Irish” subcategory screen is selected;

FIG. 22L shows a graphical user interface (GUI) screen generated by the search module of the system network and displayed on the display screen of a mobile client system on the system network, wherein the system network displays three restaurants to the consumer located in the chosen town for the chosen “ethnic/restaurant” category, and where the “view details” interface objects are displayed near each restaurant selection so that the consumer can easily view the affiliate profile for each restaurant selection.

FIG. 22M shows a graphical user interface (GUI) screen generated by the search module of the system network and displayed on the display screen of a mobile client system on the system network, wherein the system network displays the affiliate profile for the restaurant “Murphy's Restaurant” selected from the display screen shown in FIG. 22L, and wherein (i) “add to favorites” interface object is provided at the top of the affiliate profile screen, (ii) an embedded video player for watching a video advertisement on Murphy's restaurant is located in the middle of the display screen, and (iii) Google maps directions interface object is provided at the bottom of the display screen.

FIG. 22M-1 shows a graphical user interface (GUI) screen generated by the search module of the system network and displayed on the display screen of a mobile client system on the system network, wherein the system network displays the affiliate profile for the restaurant “Murphy's Restaurant” selected from the display screen shown in FIG. 22L, and wherein the GUI-based keyboard is displayed for character data entry into the messaging screen supported by the messaging module of the system network.

### Consumer Directory Related Services Supported by the System Network of the Present Invention

FIG. 23 shows a graphical user interface (GUI) screen generated by the search module of the system network and displayed on the display screen of a mobile client system on the system network. As shown, interface objects are displayed for both the affiliate directory and the consumer directory, for access by registered consumers when using the system network of the present invention, and wherein the consumer selects the “consumer directory” interface object to generate the GUI screen shown in FIG. 23-1.

FIG. 23-1 shows a graphical user interface (GUI) screen generated by the search module and consumer directory module of the system network and displayed on the display screen of a mobile client system on the system network. When the consumer user selects the consumer directory interface object from the GUI screen shown in FIG. 22A, the system network displays the interface objects for the following (i) update my system network profile, (ii) post to my social networks, (iii) post to my employment network, and (iv) post my personal networks.

FIG. 23A shows a graphical user interface (GUI) screen generated by the search module and consumer directory module of the system network and displayed on the display screen of a mobile client system on the system network. When the consumer user selects the update my system network profile interface object from the GUI screen shown in FIG. 23, the system network displays the interface objects for updating the user's consumer profile on the system network.

FIG. 23B shows a graphical user interface (GUI) screen generated by the search module and consumer directory module of the system network and displayed on the display screen of a mobile client system on the system network. When the consumer user selects the post my social networks object from the GUI screen shown in FIG. 22A, the system network displays the interface objects for configuring and authenticating the consumer social networks for the posting of messages and others events generated on the system network of the present invention.

FIG. 23B-1 and FIG. 23B-2 show a graphical user interface (GUI) screens generated by the search module and the consumer directory module of the system network and displayed on the display screen of a mobile client system on the system network. When the consumer user selects the post to my social networks interface object from the GUI screen shown in FIG. 23, the system network displays the interface objects for updating the user's configuration and authentication settings for his or her social networks (e.g. Facebook, Google+, Vine, Twitter, Pinterest, Meetup, Instagram, Tumblr, and LinkedIn, etc.) registered on the system network.

FIG. 23C shows a graphical user interface (GUI) screen generated by the search module of the system network and displayed on the display screen of a mobile client system on the system network, When the consumer/user selects the post to my employment networks interface object from the GUI screen shown in FIG. 23, the system network displays the interface objects for updating the user's configuration and authentication settings for his or her employment networks (e.g. monster.com, indeed.com, careerbuilder.com, etc.) registered on the system network.

FIG. 23D shows a graphical user interface (GUI) displayed on the display screen of a mobile client system on the system network, and generated by the search module and consumer directory module of the system network, when the consumer user selects the post to my personal networks interface object from the GUI screen shown in FIG. 23, wherein the system network displays the interface objects for updating the user's configuration and authentication settings for his or her personal networks (e.g. match.com, eharmony.com, chemistry.com, okcupid.com, perfectmatch, zoosk.com, etc.) registered on the system network.

FIGS. 23E and 23F is a series of graphical user interfaces (GUI) screen generated by the search module and the consumer directory module of the system network and displayed on the display screen of a mobile client system on the system network, as shown in FIG. 23. When the consumer user selects the my contacts interface object from the GUI screen shown in FIG. 23, and the system network displays, in FIG. 23F, the interface objects for: (i) updating the user's contact synchronization settings; (ii) searching the my (personal) contacts directory maintained by system network using imported contacts data (e.g. from iPhone, CRM systems such as Salesforce, Apple iCloud, Google+, or other information service); (iii) finding affiliates from cross-referenced and correlated information stored in the consumer's my contacts directory and the other data structures illustrated in FIGS. 6A and 6B relating to the jobs listing, the affiliate directory, the jobs referral pools and the like); and (iv) finding jobs from cross-referenced and correlated information stored in the consumer's my contacts directory and the other data structures illustrated in FIGS. 6A and 6B relating to the jobs listing, the affiliate directory, the jobs referral pools and the like.

FIG. 23G shows a graphical user interface (GUI) screen generated by the search module and the consumer directory module of the system network and displayed on the display screen of a mobile client system on the system network. When the consumer user selects the synch my contacts interface object from the GUI screen shown in FIG. 23G, and the system network displays the GUI screen shown in FIG. 23G allowing the consumer to update contact synchronization settings.

FIG. 23H shows a graphical user interface (GUI) screen generated by the search module and the consumer directory module of the system network and displayed on the display screen of a mobile client system on the system network. When the consumer user selects the find affiliates from my contacts interface object from the GUI screen shown in FIG. 23H, and the system network displays the GUI screen shown in FIG. 23H presenting an list of automatically retrieved and presented affiliates who are listed in a job category and have been used by the consume, or one or more of the consumer's personal contacts, determined using the programmed data processing apparatus and logic illustrated in FIGS. 6A, 6B, and 16.

FIG. 23I shows a graphical user interface (GUI) screen generated by the search module and the consumer directory module of the system network and displayed on the display screen of a mobile client system on the system network. When the consumer user selects the find jobs from my contacts interface object from the GUI screen shown in FIG. 23HI, and the system network displays the GUI screen shown in FIG. 23I presenting an list of automatically retrieved and presented jobs which have been served by affiliates for the consumer performing the search, or consumers who are listed in the consumer's contacts, determined using the programmed data processing apparatus and logic illustrated in FIGS. 6A, 6B, and 16.

FIG. 23J shows a graphical user interface (GUI) shown in FIG. 23, wherein the consumer user selects the my groups interface object from the GUI screen shown to automatically display the GUI screen shown in FIG. 23K, presenting interface objects for (i) searching my groups, (ii) join a (consumer-based) group (e.g. DYI enthusiasts group, gardeners group, etc), (iii) finding affiliates from my groups, and (iv) finding jobs from my groups.

FIG. 23K shows a graphical user interface (GUI) screen generated by the search module and the consumer directory module of the system network and displayed on the display screen of a mobile client system on the system network. When the consumer user selects the search my groups interface object from the GUI screen shown in FIG. 23K, and the system network displays the GUI screen shown in FIG. 23K presenting the names of all of the consumer groups which the consumer has joined, and the dates of joining the same.

FIG. 23L shows a graphical user interface (GUI) screen generated by the search module and the consumer directory module of the system network and displayed on the display screen of a mobile client system on the system network, wherein when the consumer user selects join a group interface object from the GUI screen shown in FIG. 23K, and the system network displays the GUI screen shown in FIG. 23L presenting the names of all of the consumer groups which the consumer (i) can join by simply checking the group and then selecting join the checked group interface object, and likewise, (ii) can un-join by simply un-checking the group and then then-join group interface object.

FIG. 23M shows a graphical user interface (GUI) screen generated by the search module and the consumer directory module of the system network and displayed on the display screen of a mobile client system on the system network, wherein when the consumer user selects the find affiliates from interface object from the GUI screen shown in FIG. 23M, and the system network displays the GUI screen shown in FIG. 23M presenting the names of all affiliates who are listed in a job category and have been used by the consumer or one or more of the consumer's contacts, determined using the programmed data processing apparatus and logic illustrated in FIGS. 6A, 6B, and 16.

FIG. 23N shows a graphical user interface (GUI) screen generated by the search module and the consumer directory module of the system network and displayed on the display screen of a mobile client system on the system network. When the consumer user selects the find jobs from interface object from the GUI screen shown in FIG. 23M, and the system network displays the GUI screen shown in FIG. 23M presenting the names of all jobs which have been served by affiliates for the consumer during the search, or consumers who are listed in the consumer's contacts, determined using the programmed data processing apparatus and logic illustrated in FIGS. 6A, 6B, and 16.

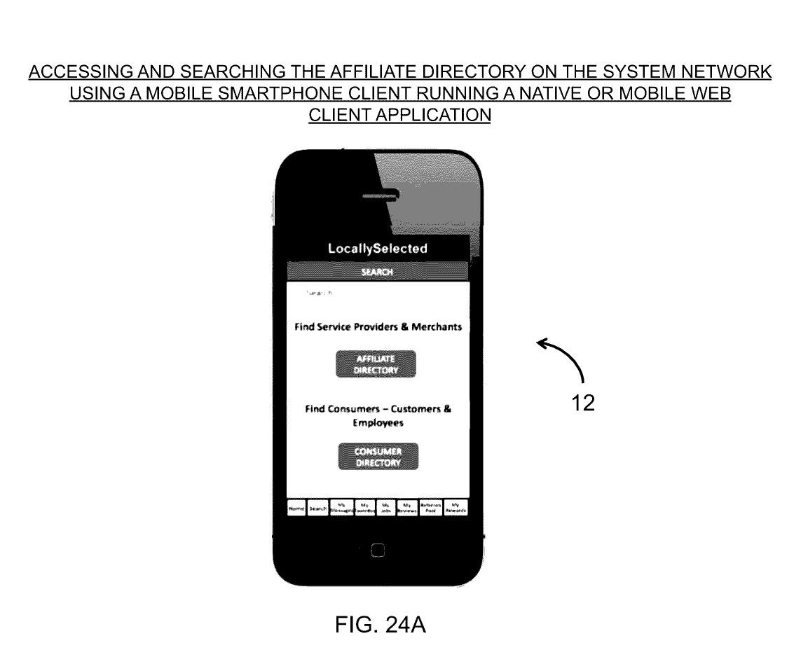

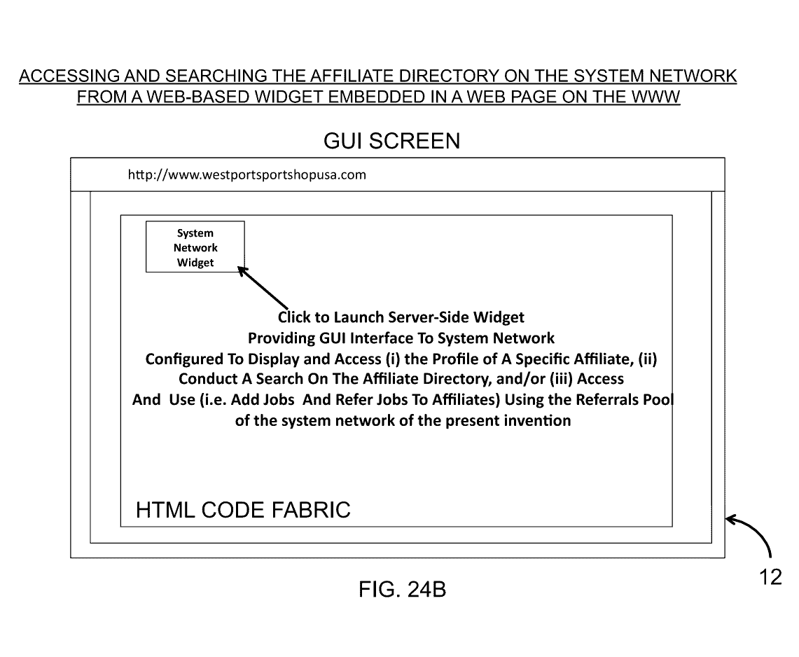

FIG. 24A shows a graphical user interface (GUI) screen generated by the search module of the system network and displayed on the display screen of a mobile client system on the system network. As shown, the displayed GUI screen of FIG. 23 illustrates that such a client system, running a native or mobile client web client application, can be used to access and search the affiliate directory on the system network of the present invention.

FIG. 24B shows a schematic representation of a desktop-size or tablet-size GUI screen, wherein a wide suite of consumer and affiliate services can be accessed and delivered over the system network, from a web-based GUI-generating widget embedded in a web page on the WWW being browsed by a client system. Upon selecting the server-side or client-side widget (e.g. Applet), the user is provided a GUI interface to system network configured to display and access (i) the profile of a specific affiliate, (ii) conduct a search on the affiliate directory, and/or (iii) access and use (i.e. the Add Jobs And Refer Jobs To Affiliates functions) using the Referral Pools facility of the system network of the present invention.

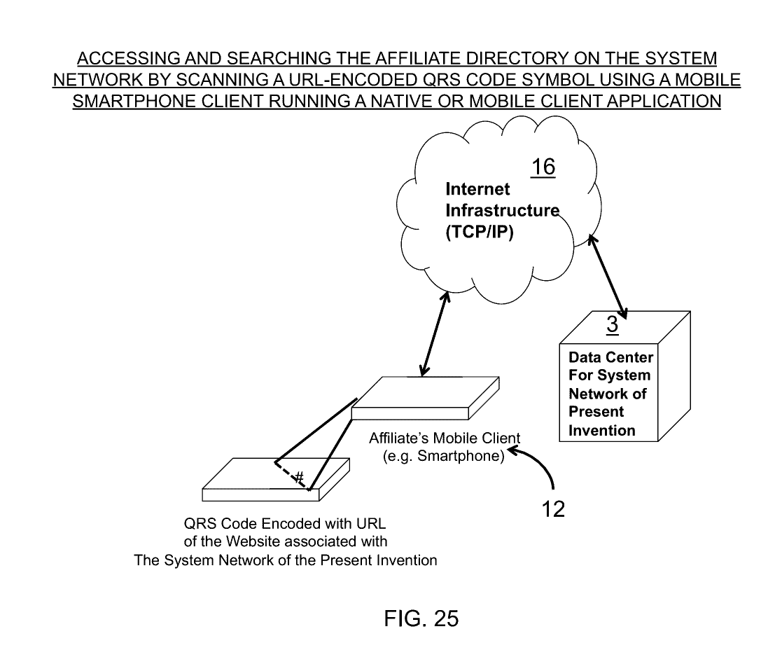

FIG. 25 illustrates that a wide suite of consumer and affiliate services can be accessed and delivered over the system network of the present invention by scanning URL-encoded QRS code symbols using a mobile smartphone client system, running a native or mobile client application, and establishing a network connection and session with servers on the system network.

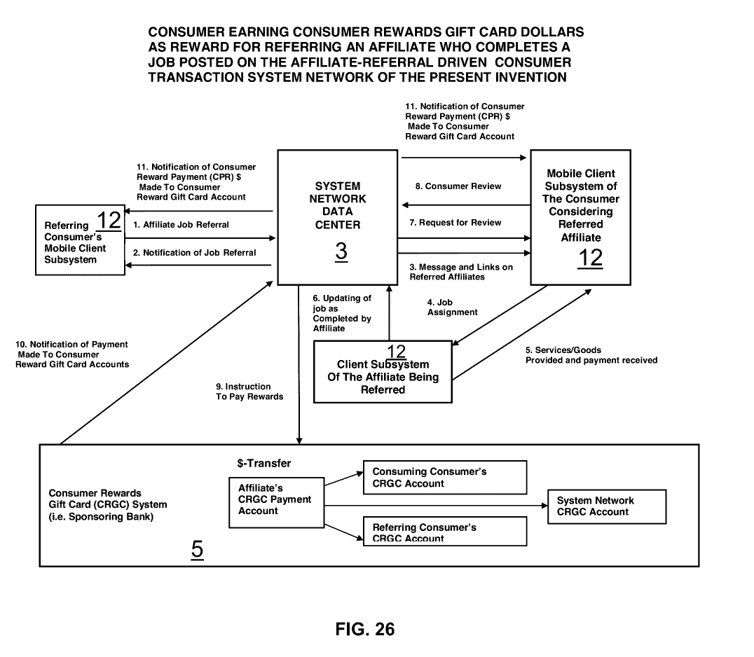

FIG. 26 shows a schematic representation illustrating a primary process supported on the system network of the present invention, wherein a consumer earns consumer reward gift card (CRGC) dollars as a reward for referring an affiliate who completes a job posted on the affiliate-referral driven consumer transaction rewarding system network of the present invention. In the illustrative embodiment, the process comprising steps of: (a) the mobile client system of the referring consumer sends an affiliate job referral to the data center of the system network; (b) the data center of the system network sends a notification of job referral back to the referring consumer's mobile client system, as confirmation; (c) the data center of the system network sends a message and links on the referred affiliate(s) to the mobile client system of the consumer considering a referred affiliate to perform a service and/or from which to purchase goods; (d) the mobile client system of the consumer considering the referred affiliates sends a job assignment to the client system of the affiliate to who was referred, so they know they have been asked to perform the specified job; (e) the affiliate selected for the specified job performs the job services and/or provides specified goods or services, and the client system of the affiliate sends a message to the mobile client system of the consumer indicating that services have been rendered and/or goods provided and payment made by the consumer for the services/goods; (f) the data center of the system network sends a request for a consumer review to the mobile client system of the consumer whose job has been completed by the referred affiliate; (g) the mobile client system of the consumer whose referred job has been performed completely (and payment made by one of several methods) composes/writes a consumer review on the affiliate service provider/merchant who completed the specified job, and this consumer review is then sent from the mobile client system to the data center of the system network; (h) the data center of the system network sends instructions to the consumer rewards gift card payment system causing credit (money) in the affiliates CRGC payment account to be transferred to the CRGC account of the consumer referring the affiliate, the CRGC account of the consumer whose job has been performed by the affiliate, and the system network administrator's CRGC or like account; and (i) the CRGC payment system sending a notification to the data center of the system network that payment has been transferred (made) to the consumer reward gift card (CRGC) accounts of the consumers and system network administrator, (j) the data center of the system network sending a notification to the mobile client system of the affiliate service provider advising that a CRGC payment has been made to the consumer referring the affiliate to the completed job transaction, and the consumer whose referred job has been completed by the affiliate and reviewed by the consumer.

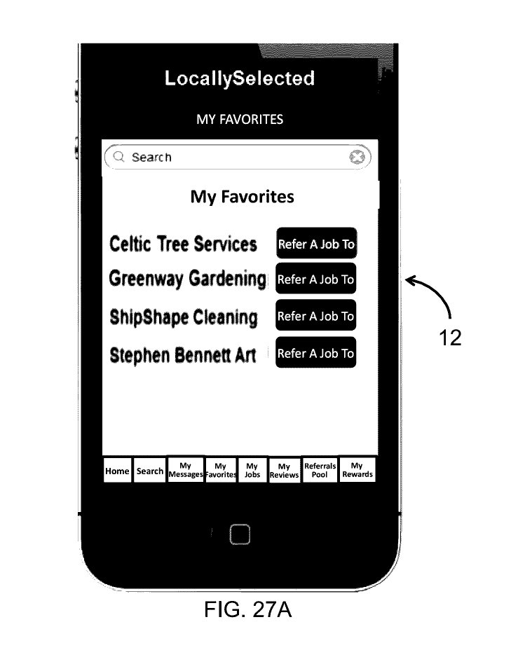

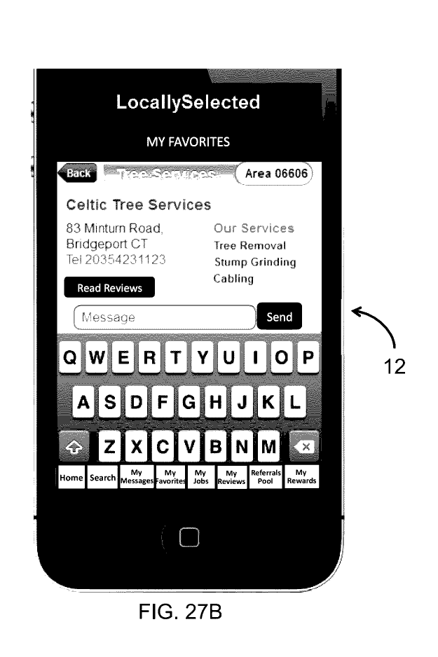

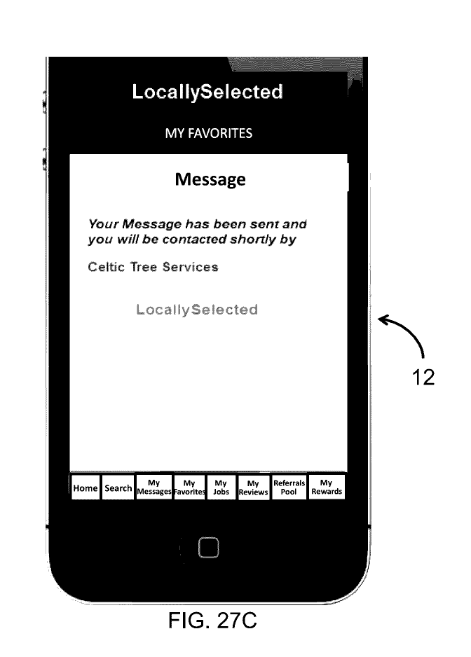

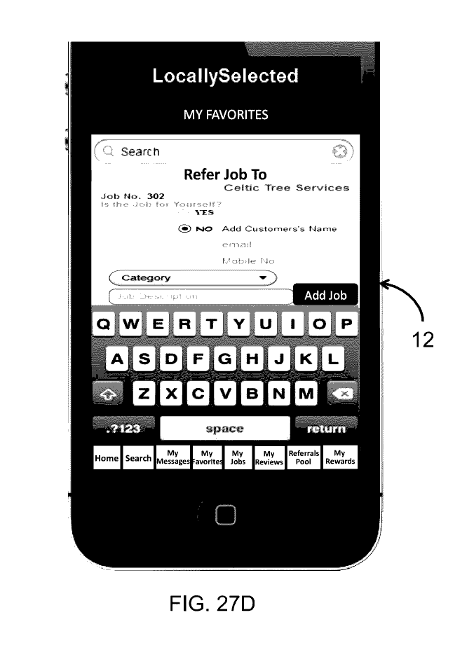

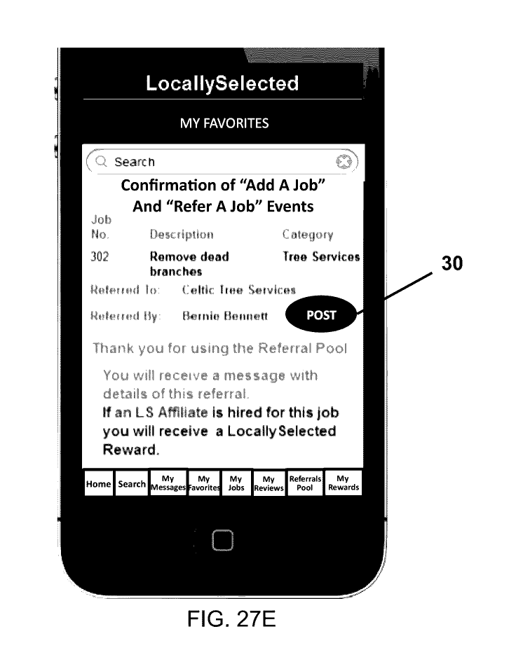

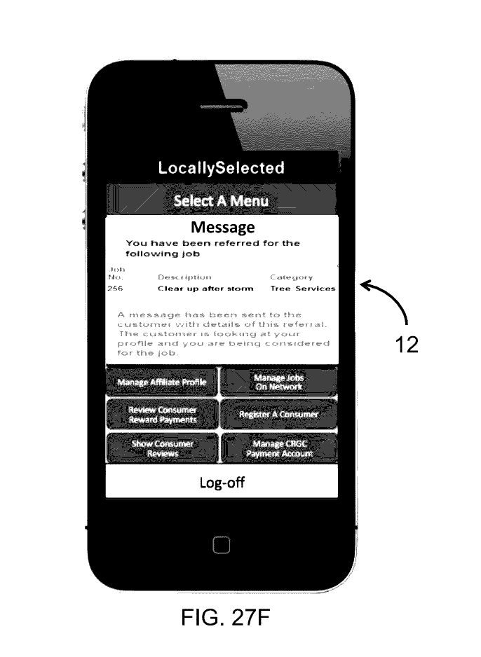

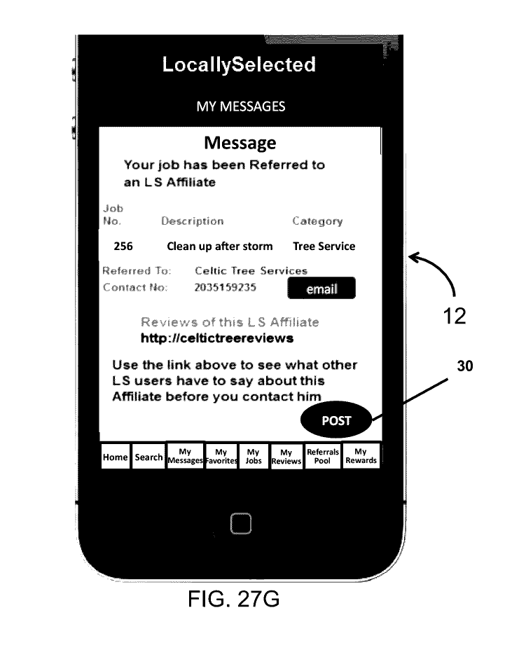

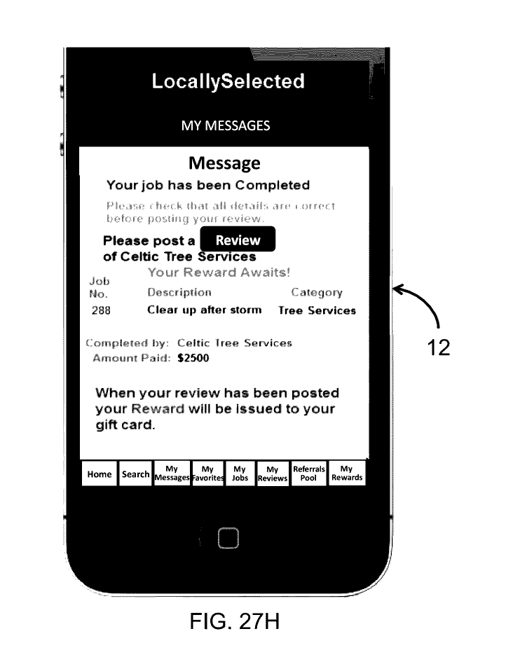

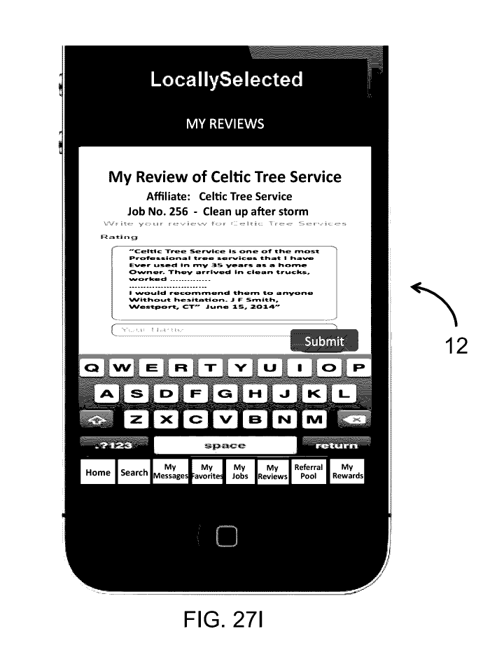

FIG. 27A shows a graphical user interface (GUI) screen generated by the my favorites module of the system network and displayed on the display screen of a mobile client system on the system network. In this figure, the displayed GUI screen shows the my favorites list of the consumer user comprising a list of service providers and/or merchants and vendors who have been added from the search module by selecting the “add favorites” interface object, and where the consumer can refer a job to any of the listed affiliates by selecting the “refer a job to” interface object (i.e. button) which has been selected for “Celtic Tree Service” in the example shown in FIG. 27A.

FIG. 27B shows a graphical user interface (GUI) screen generated by the my favorites module of the system network and displayed on the display screen of a mobile client system on the system network, wherein the displayed GUI screen the vendor/affiliate details screen for the affiliate (e.g. Celtic Tree Service. The read reviews interface object is shown an available for selection to display the reviews of the affiliate by its past customers, and the integrating messaging module is shown for use by the consumer to send messages to affiliates, using a virtual keyboard supported by an interface object for entry of message information content;

FIG. 27C shows a graphical user interface (GUI) screen generated by the my favorites module of the system network and displayed on the display screen of a mobile client system on the system network, presents a message in response to the message sent from the GUI screen shown in FIG. 27B, confirming that the consumer's message to the affiliate service provider has been transmitted through the system network to the destination affiliate.

FIG. 27D shows a graphical user interface (GUI) screen generated by the my favorites module of the system network and displayed on the display screen of a mobile client system on the system network associated with a consumer, wherein the displayed GUI screen presents the “add a job” and “refer job to” interface objects display screen, in response to the consumer selecting the interface object for “add a job” shown in FIG. 27A. In the illustrative embodiment, the system network automatically generates a job number for the new job, and if the job is not for the consumer user, then contact details are requested for the person who needs the job performed, and they are provided by the consumer user and the system network will automatically generate a user profile for that customer/system user. The job and referrals will be added to the Referral Pools structure illustrated in FIGS. 15 and 16 and be available for referral by a predetermined number (e.g. two) other consumer/users. Upon successful completion of the job, the affiliate service provider will update the job status on the system network to indicate that consumer reward credits should be paid by the affiliate's CRGC payment account to the CRGC accounts of (i) the consumer/user who added the job to the job list which eventually was added to the Referral pool structure during the job referring operation, and (ii) the consumer who referred the job (which may be a person or entity different from the entity whose job was added and needed to be performed/completed).

FIG. 27E shows a graphical user interface (GUI) screen generated by the my favorites module of the system network and displayed on the display screen of a mobile client system on the system network associated with the consumer whose job needs to be performed. The displayed GUI screen presents a message in response to the operations performed using the GUI screen shown in FIG. 27D, confirming that “Add A Job” and “Refer A Job” events have occurred using the GUI screen shown in FIG. 27D, and containing details regarding the job referral made using the Referral Pools feature and functionality supported on the system network of the present invention. Notably, this GUI screen includes embedded interface object 30 that can post the underlying webpage or web object to actively configured social networks, personal networks, employment networks response to the consumer selecting this interface object. Setting up such social, personal and employment network posting channels is achieved using the consumer directory module and supporting modules described with reference to FIGS. 23 through 23D.

FIG. 27F shows a graphical user interface (GUI) screen generated by the messaging module of the system network and displayed on the display screen of a mobile client system on the system network associated with the affiliate who has received the job referral. The displayed GUI screen presents a message in response to the operations performed using the GUI screen shown in FIG. 27D, confirming with the affiliate that (i) the affiliate (e.g. Celtic Tree Service) has been referred to a consumer for a specific job (e.g. Job No. 256—Clean Up After Storm—Tree Services) and (ii) that the consumer who need is seeking to have its job performed has received a link to the referred affiliate profile and reviews and is being considered for the specified job by the consumer.

FIG. 27G shows a graphical user interface (GUI) screen generated by the my messages module of the system network and displayed on the display screen of a mobile client system on the system network associated with the consumer whose job has been referred to one or more affiliate service providers. The displayed GUI screen presents a message in response to the operations performed using the GUI screen shown in FIG. 27D, confirming with the consumer that (i) the consumer's job has been referred to a particular affiliate service provider (e.g. Celtic Tree Service) and (ii) the consumer can consider the reviews and profile of the referred affiliate at the link (URL) provided in the message body.

FIG. 27H is a graphical user interface (GUI) screen generated by the my messages module of the system network and displayed on the display screen of a mobile client system on the system network associated with the consumer whose job has been completed an affiliate service provider. The displayed GUI screen presents a message confirming with the consumer that (i) the consumer's job has been completed by a particular affiliate service provider (e.g. Celtic Tree Service) and (ii) after the consumer writes and posts a review on the affiliate who completed the job, the consumer and job referrer will be paid consumer reward gift card (CRGC) credit from the CRGC Payment Account of the affiliate service provider/merchant who completed the job.

FIG. 27I shows a graphical user interface (GUI) screen generated by the my reviews module of the system network and displayed on the display screen of a mobile client system on the system network associated with the consumer whose job has been completed an affiliate service provider. The displayed GUI screen shows the review which the consumer wrote for the affiliate who completed the consumer's job, and it is ready for submission to the system database upon selection of the “submit” interface object (i.e. button). Upon submission, the review record will be automatically added to the affiliate directory, the jobs listing, and the consumer directory, illustrated in FIGS. 6A and 6B, a schematic representation of these three data structures fully implemented and supported within the RDBMS of the system network.

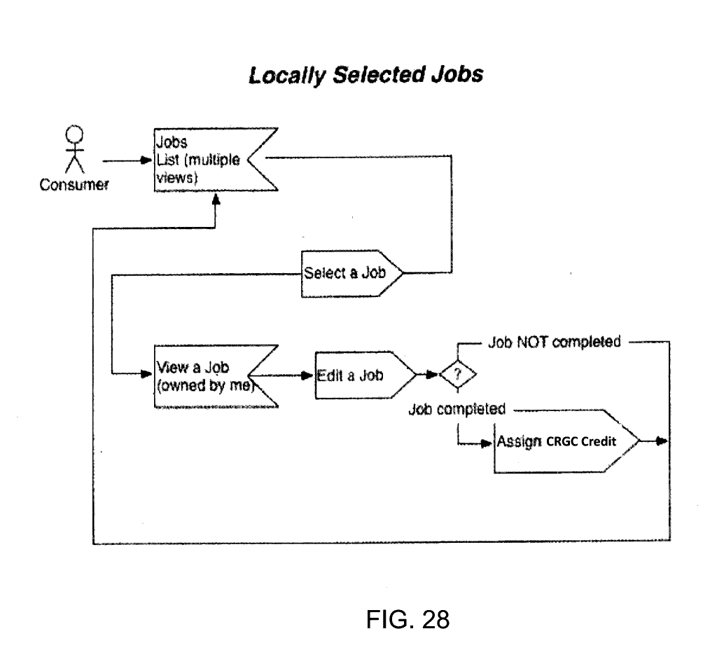

FIG. 28 shows a schematic representation of a use case model illustrating a consumer accessing the jobs directory of the system network illustrated in FIGS. 6A and 6B, and using the services supported thereby.

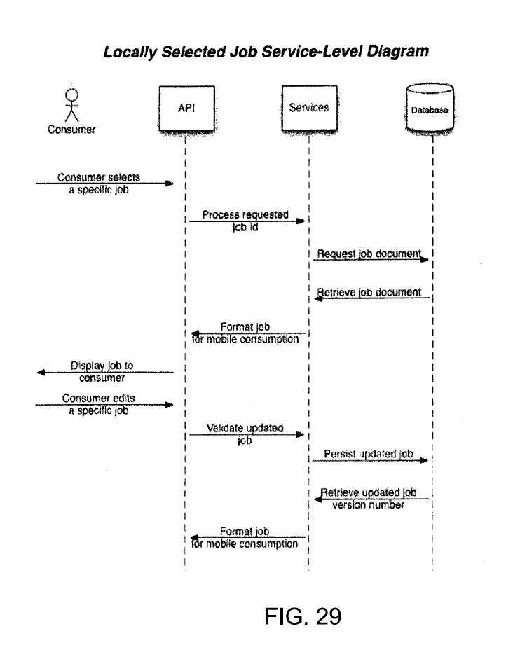

FIG. 29 shows schematic representation of a multi-layer service model for delivering job listing services, supported on the system network of the present invention. The consumer users and are others are provided with a graphical user interface (GUI) coupled to the application programming interface or API (i.e. control-tier) which interfaces with the system database or RDBMS (i.e. database tier) for storing persistent objects and supporting various services provided by the system network of the present invention.

### Structure and Apparatus for Managing Job-Affiliate Referrals Records in the Affiliate-Referral Driven Consumer-Transaction Rewarding System Network of the Present Invention

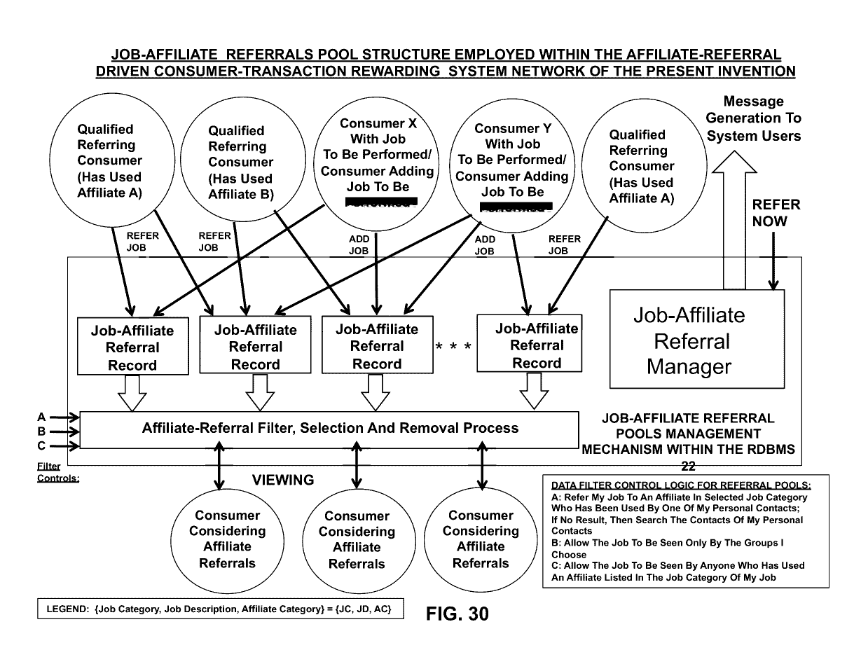

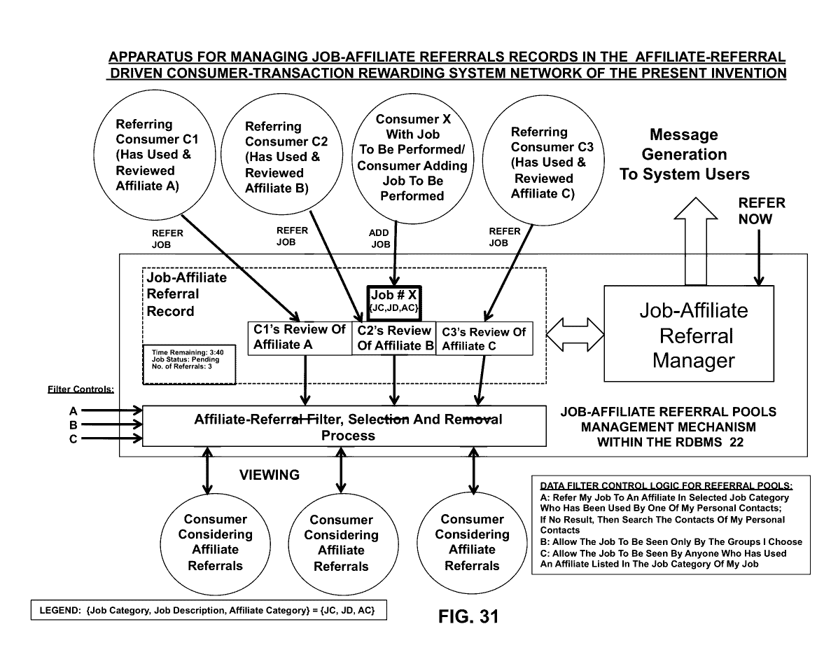

FIG. 30 shows a schematic representation of the job-affiliate referral pools structure employed within the affiliate-referral driven consumer-transaction rewarding system network of the present invention. FIG. 31 shows a schematic representation of apparatus for managing job-affiliate referrals records in the affiliate-referral driven consumer-transaction rewarding system network of the present invention. The structure and apparatus represented in FIGS. 30 and 31 are similar to the structure and apparatus shown in FIGS. 15 and 16, and described above in detail. It shall be mentioned, once again, however, that in the illustrative embodiment, the data filter control logic for the referral pools is characterized the three rules set forth below, and supplied as data filter control to the job-affiliate referral pools management mechanism within the RDBMS 22, shown in FIGS. 30 and 31: (A) Refer My Job To An Affiliate In Selected Job Category Who Has Been Used By One Of My Personal Contacts; If No Result, Then Search The Contacts Of My Personal Contacts: (B) Allow The Job To Be Seen Only By The Groups I Choose; and (C) Allow The Job To Be Seen By Anyone Who Has Used An Affiliate Listed In The Job Category Of My Job. These rules are practiced in the GUI interfaces set forth in FIGS. 32C, 32L and 32P, for the three Options A, B and C, supported when a user wishes to add a job to the referrals pool supported within the RDBMS 22 on the system network of the present invention.

FIG. 32A shows a graphical user interface (GUI) screen generated by the referral pools module of the system network and displayed on the display screen of a mobile client system on the system network associated with a consumer searching for an affiliate referral within the Referral Pools structure, illustrated in FIGS. 15 and 16, and also FIGS. 6A and 6B. The displayed GUI screen presents the consumer with several options, namely: (i) adding a job to the job listings maintained by the system network; (ii) review the jobs that have been added by the consumer (i.e. jobs added by me); (iii) refer jobs to a particular affiliate service provider based on the consumer's past experiences therewith; and (iv) review jobs that have been referred by the consumer (i.e. jobs referred by me). Only registered consumer/users can add jobs to the referral pools structure, or refer jobs which are already in the referral pools structure. Also, a job is removed from the referral pools upon any of the following events: (i) after three (3) referrals have been made against a particular job; (ii) when a particular job is certified as completed by the assigned referred service provider; and (iii) after the passage of an agreed upon time limit (e.g. 1 year). A message should be send to the consumer user whose job has been completed, prior to the completed job being removed from the referral pools.

The Privacy Aspect of Jobs Added to” the Referral Pools can Range from (I) “Private” when Added Using Option a, “Social” when Added Using Option B, and “Public” when Added Using Option C Illustrated in FIG. 32C

Notably, the Referral Pools structure of the present invention supports the formation and management of many different kinds of “job-affiliate referral pools” data structures within the RDBMS 22 of the system network 1. Each such data structure contains minimally added job records, and many data structures will also comprise added job records linked to affiliate referral records, and their affiliate profiles, and also consumer reviews of affiliate past job performance, as illustrated in FIGS. 6A and 6B, and 15 and 16. Also, each job record will include viewing parameters which shall control who is entitled to see or view any particular job record, and associated data elements (e.g. affiliate records, reviews, etc) when checking the user's (i) “jobs added by me” function (illustrated in FIG. 32T), “refer jobs to” function (illustrated in FIG. 32W), and “jobs referred by me” function (illustrated in FIG. 32V), wherein each such function is accessible in the GUI screen illustrated in FIG. 32A, and related GUI screens generated by the referral pools module and the my jobs module. Such job-viewing parameters, and job-affiliate-referral viewing parameters can be based on job category, a selected group of the user, and other parameters set while adding jobs to the referral pools, as well during searching the affiliates directory.

As indicated in FIG. 32-CC, “jobs added by me” can be sorted and viewed by a user by job category, or by (consumer) group, or by date, or other criteria.

Also, as indicated in FIG. 32V, “jobs referred by me” can be sorted and viewed by a user by job category, or by (consumer) group, or by date, or other criteria.

This category/group-dependent viewing feature of client systems on the system network allows users to determine who should be seeing what jobs, and what job referrals. Therefore, the privacy aspect of “jobs added to” the referral pools can range from (i) “private referral pools” when jobs are added to the referral pools using Option A illustrated in FIG. 32C, (ii) “social referral pools” when jobs are added to the referral pools using Option B illustrated in FIG. 32C, and (iii) “public referral pools” when jobs are added to the referral pools using Option C illustrated in FIG. 32C.

### Specification of the Referral Pools: The “Add a Job” Function—Case A

FIGS. 32B and 32C shows series of graphical user interface (GUI) screens generated by the referral pools module of the system network and displayed on the display screen of a mobile client system on the system network associated with a consumer searching for an affiliate referral within the Referral Pools structure. In response to selecting the “add a job” interface object in the GUI screen of FIG. 32B, the displayed GUI screen states that the consumer would like top add a job, and also either (A) Refer My Job To An Affiliate In This Job Category Who Has Been Used By One Of My Personal Contacts; If No Result, Then Search The Contacts Of My Personal Contacts, (B) Allow The Job To Be Seen Only By The Groups I Choose In Next Screen, or (C) Allow The Job To Be Seen By Anyone Who Has Used An Affiliate Listed In The Job Category Of The Job, which are effectively data filters that operate on the job-affiliate data records associated with the Referral Pools structure schematically represented in FIGS. 15 and 16. Options A, B and C represented in the GUI screen of FIG. 32C correspond to the data logic filter controls specified as A, B and C in FIGS. 15 and 16. Also, in this case, the consumer user selects option (A) from the GUI screen, where the job is to be referred to an affiliate who (i) is listed in the job category of the job, and (ii) has been used by one of the consumer/user's personal contacts.

FIG. 32D-1 and 32D-2 shows a series of graphical user interface (GUI) screens generated by the referral pools module of the system network and displayed on the display screen of a mobile client system on the system network associated with a consumer. In FIG. 32D-1, the user selects Option A (data filter) from the GUI screen of FIG. 32C, because the user wants to consider, for job referral, (i) all affiliates listed in the job category selected in the GUI screen of FIG. 32D-2, and (ii) who have been used by one of the user's personal contacts, as determined by searching through the relational data structures represented in FIGS. 6A and 6B. Also as shown in the GUI screen of FIG. 32D-2, system network's search engine (shown in FIGS. 6A and 6B) returns for display on the client system's GUI screen, a list of affiliates who matched the search criteria set by Option A, with “view details” interface objects for selection and viewing of affiliate profiles from the GUI screen, and also “refer job to” interface objects for selection by the user to cause the system to execute this function upon selecting the “continue” interface object and generating the GUI screen of FIG. 32D-3.

FIG. 32D-3 shows a graphical user interface (GUI) screen generated by the referral pools module of the system network and displayed on the display screen of a mobile client system on the system network associated with a consumer, where upon selecting the continue interface object in FIG. 32D-2, the client system displays a GUI screen presenting an “add a job” interface object. The system network automatically generates a job number for each new job (e.g. Job No. 502 being assigned for the exemplary system user), and if the job is not for the system user, then contact details are requested in specified data fields in the GUI screen for the person/consumer who needs the job performed, and after such information is provided by the consumer user and received by the system network, the system network will automatically generate a user profile for that customer/system user. The new job will be added to the Job Listing and Referral Pools structures illustrated in FIGS. 15 and 16, and 30 and 31, and be available for referral by a predetermined number (e.g. 10) other consumer/users, and wherein upon successful completion of the job, the affiliate service provider will update the job status on the system network to indicate that consumer reward credits should be paid by the affiliate's CRGC payment account to the CRGC accounts of (i) the consumer/user who added the job to the job list which eventually was added to the Referral Pools structure during the job referring operation, and (ii) the consumer who referred the job (which may be a person or entity different from the entity whose job was added and needed to be performed/completed).

FIG. 32E shows a graphical user interface (GUI) screen generated by the referral pools module of the system network and displayed on the display screen of a mobile client system on the system network associated with the a consumer whose jobs need to be performed. The displayed “Refer A Job” GUI displays the search results which comprises all of the affiliates listed in the affiliate directory structure of FIGS. 6A and 6B who satisfy the A-type search criteria: namely, all affiliates who (i) are listed in the job category of the job, and (ii) have been used by one of the consumer/user's personal contacts, wherein this interface object allows the user to select a “qualified” affiliate to be referred to the specified job (i.e. Job No. 502).

FIG. 32F shows a graphical user interface (GUI) screen generated by the affiliate's messaging module on the system network and displayed on the display screen of a mobile client system on the system network associated with the affiliate who has been referred a particular job on the system network. The displayed GUI presents a message confirming that the affiliate has been referred a particular job, and that the referring consumer is reviewing the affiliate's profile and job reviews.

FIG. 32G shows a graphical user interface (GUI) screen generated by the my messages module on the system network and displayed on the display screen of a mobile client system on the system network associated with the consumer who has a particular job to be performed by a registered service provider affiliate with the system network. The displayed GUI presents a message confirming that the consumer's job has been referred to a particular affiliate service provider and providing a link or URL to the affiliate's profile.

FIG. 32H shows a graphical user interface (GUI) screen generated by the my messages module of the system network and displayed on the display screen of a mobile client system on the system network associated with the consumer whose job has been completed an affiliate service provider. The displayed GUI screen presents a message confirming with the consumer that (i) the consumer's job has been completed by a particular affiliate service provider (e.g. Celtic Tree Service), (ii) a particular amount paid, and (iii) after the consumer writes and posts a review on the affiliate who completed the job, the consumer and job referrer will be paid a consumer reward gift card (CRGC) credit from the CRGC Payment Account of the affiliate service provider/merchant who completed the referred job.

FIG. 32I shows a graphical user interface (GUI) screen generated by the my reviews module of the system network and displayed on the display screen of a mobile client system on the system network associated with the consumer whose job has been completed an affiliate service provider. The displayed GUI screen indicates that where the consumer has composed a review of an affiliate who has completed the consumer's job, and that the consumer is ready for submission to the system database upon selection of the “submit” interface object (i.e. button), where upon the consumer posting the consumer review, the review record will be added to the affiliate directory, the jobs listing, and the consumer directory, illustrated in FIG. 6, which is merely a schematic representation of these three data structures which are otherwise implemented in the RDBMS of the system network database.

FIG. 32J shows a graphical user interface (GUI) screen generated by the my reviews module of the system network and displayed on the display screen of a mobile client system on the system network associated with the consumer whose job has been completed an affiliate service provider. The GUI screen confirms that the consumer has posted a review of the affiliate who completed the consumer's job, and submitted the same to the system database.

### Specification of the Referral Pools: The “Add a Job” Function—Case B

FIG. 32K is a graphical user interface (GUI) screen generated by the my referral pools module of the system network and displayed on the display screen of a mobile client system on the system network associated with the consumer who wants to add a job and make some job referrals to affiliate service providers or merchants. The displayed GUI screen displays interface objects for (i) adding a new job to the jobs listing on the system network, which new job may be for the consumer adding the new job, or for another entity with whom the consumer is affiliated in some manner, (ii) reviewing jobs added by me, (iii) referring jobs to an affiliate, and (iv) reviewing jobs referred by me, wherein the consumer user will select option B in Add A Job data filter menu shown in FIG. 32P.

FIG. 32L shows a graphical user interface (GUI) screen generated by the referral pools module of the system network and displayed on the display screen of a mobile client system on the system network associated with a consumer searching for an affiliate referral within the Referral Pools structure. In response to selecting the “add a job” interface object in the GUI screen of FIG. 32K, the displayed GUI screen states that the consumer would like top add a job, and also either (A) Refer My Job To An Affiliate In This Job Category Who Has Been Used By One Of My Personal Contacts; If No Result, Then Search The Contacts Of My Personal Contacts, (B) Allow The Job To Be Seen Only By The Groups I Choose In Next Screen, or (C) Allow The Job To Be Seen By Anyone Who Has Used An Affiliate Listed In The Job Category Of The Job, which are effectively data filters that operate on the job-affiliate data records associated with the Referral Pools structure schematically represented in FIGS. 15 and 16. Options A, B and C represented in the GUI screen of FIG. 32K correspond to the data logic filter controls specified as A, B and C in FIGS. 15 and 16. Also, the consumer user selects option (B) from the GUI screen, where the job is to be viewable in the Referral Pools (i.e. Referral Pools A) to all users who are members of the Groups selected by the user in GUI screen shown in FIG. 32M.

FIG. 32M shows a graphical user interface (GUI) screen generated by the referral pools module of the system network and displayed on the display screen of a mobile client system on the system network associated with a consumer searching for an affiliate referral within the Referral Pools structure. In response to selecting the B data filter option interface object in the GUI screen of FIG. 32L, the system network serves the client system a GUI screen setting forth interface objects that allow the consumer to choose which Groups the consumer wishes to view the job to be added in the referral pools facility supported on the system network of the present invention. The exemplary consumer groups shown in FIG. 32M include groups such as: Do It Yourself (DYI) enthusiasts, gardening, homeowner, parents of teenager, automotive, swimming pools, etc. This GUI screen of FIG. 32M displays any and all groups of which the user is a member, and allows the user to choose the groups of which he is a member on the system network, which will be allowed to view the job the user is adding in the Referral Pools, thereby providing advanced data filtering and viewing functionality to the system network.

FIG. 32N shows a graphical user interface (GUI) screen generated by the referral pools module of the system network and displayed on the display screen of a mobile client system on the system network associated with a consumer, wherein the GUI screen displays an “add a job” interface object. The system network automatically generates a job number for each new job (e.g. Job No. 502 being assigned for the exemplary system user). In the even that the job is not for the system user, then contact details are requested in specified data fields in the GUI screen for the person/consumer who needs the job performed, and after such information is provided by the consumer user and received by the system network, the system network will automatically generate a user profile for that customer/system user. The new job will be added to the Job Listing and Referral Pools structures illustrated in FIGS. 15 and 16, and 30 and 31, and be available for referral by a predetermined number (e.g. two) other consumer/users. Upon successful completion of the job, the affiliate service provider will update the job status on the system network to indicate that consumer reward credits should be paid by the affiliate's CRGC payment account to the CRGC accounts of (i) the consumer/user who added the job to the job list which eventually was added to the Referral Pools structure during the job referring operation, and (ii) the consumer who referred the job (which may be a person or entity different from the entity whose job was added and needed to be performed/completed).

FIG. 32N-1 shows a graphical user interface (GUI) screen generated by the referral pools module of the system network and displayed on the display screen of a mobile client system on the system network associated with a consumer. The GUI screen displays an “jobs added by me” interface object, wherein the user can view all jobs that have been added to the referral pool B, and viewable by any member of the Group with which the added job was tagged or indexed during the add a job operation performed in FIG. 32N. Also the user can view the recently added Job No. 502 presented in the jobs added by me displays space, with all other jobs to which the user is entitled to view on the system network, with the option of sorting and viewing the list of jobs by job category or by consumer group, using pull-down menus shown in FIG. 32N-1.

### Specification of the Referral Pools: The “Add a Job” Function—Case C

FIG. 32O shows a graphical user interface (GUI) screen generated by the my referral pools module of the system network and displayed on the display screen of a mobile client system on the system network associated with the consumer who wants to add a job and make some job referrals to affiliate service providers or merchants. The displayed GUI screen displays interface objects for (i) adding a new job to the jobs listing on the system network, which new job may be for the consumer adding the new job, or for another entity with whom the consumer is affiliated in some manner, (ii) reviewing jobs added by me, (iii) referring jobs to an affiliate, and (iv) reviewing jobs referred by me, wherein the consumer user will select option B in Add A Job data filter menu shown in FIG. 32P.

FIG. 32P shows a graphical user interface (GUI) screen generated by the referral pools module of the system network and displayed on the display screen of a mobile client system on the system network associated with a consumer searching for an affiliate referral within the Referral Pools structure. In response to selecting the “add a job” interface object in the GUI screen of FIG. 32O, the displayed GUI screen states that the consumer would like top add a job, and also either (A) Refer My Job To An Affiliate In This Job Category Who Has Been Used By One Of My Personal Contacts; If No Result, Then Search The Contacts Of My Personal Contacts, (B) Allow The Job To Be Seen Only By The Groups I Choose In Next Screen, or (C) Allow The Job To Be Seen By Anyone Who Has Used An Affiliate Listed In The Job Category Of The Job, which are effectively data filters that operate on the job-affiliate data records associated with the Referral Pools structure schematically represented in FIGS. 15 and 16. Options A, B and C represented in the GUI screen of FIG. 32O correspond to the data logic filter controls specified as A, B and C in FIGS. 15 and 16. Also, in this case C, the consumer user selects Option (C) from the GUI screen, where the job is to be viewable by anyone who has used an affiliate listed in the job category of the job.

FIGS. 32Q, 32R, and 32R-1 shows a series of graphical user interface (GUI) screens generated by the referral pools module of the system network and displayed on the display screen of a mobile client system on the system network associated with a consumer. The GUI screen displays an “add a job” interface object for adding a new job to the referral pools (along with one or more qualified affiliates) and a “pull-down menu” interface object for selecting the Job Category from a job category list maintained by the system administrator. The system network automatically generates a job number for each new job (e.g. Job No. 502 being assigned for the exemplary system user). In the event that the job is not for the system user, then contact details are requested in specified data fields in the GUI screen for the person/consumer who needs the job performed, and after such information is provided by the consumer user and received by the system network, the system network will automatically generate a user profile for that customer/system user, and wherein the new job will be added to the Job Listing and Referral Pools structures illustrated in FIGS. 15 and 16, and 30 and 31, and be available for referral by a predetermined number (e.g. two) other consumer/users. Upon successful completion of the job, the affiliate service provider will update the job status on the system network to indicate that consumer reward credits should be paid by the affiliate's CRGC payment account to the CRGC accounts of (i) the consumer/user who added the job to the job list which eventually was added to the Referral Pools structure during the job referring operation, and (ii) the consumer who referred the job, which may be a person or entity different from the entity whose job was added and needed to be performed/completed.

FIG. 32S shows a graphical user interface (GUI) screen generated by the my referral pools module of the system network and displayed on the display screen of a mobile client system on the system network associated with the consumer who wants to add a job to the referral pools. The displayed GUI screen displays interface objects for entering a description of the job, and the name and email address of the person for whom the job is to be performed if it is not the user, and also the job category which is selected from the pull-down menu in FIG. 32R.

FIG. 32T shows a graphical user interface (GUI) screen generated by the referral pools module of the system network and displayed on the display screen of a mobile client system on the system network associated with a consumer. The GUI screen displays an “jobs added by me” interface object, wherein the user can view all jobs that have been added to the referral pool B, and viewable by any member of the Group with which the added job was tagged or indexed during the add a job operation performed in FIG. 32N. The user can view the recently added Job No. 502 presented in the jobs added by me displays space, with all other jobs to which the user is entitled to view on the system network, with the option of sorting and viewing the list of jobs by job category or by consumer group, using pull-down menus shown in FIG. 32T.

### Specification of the Referral Pools: The “Refer a Job to (an Affiliate)” Function

FIG. 32U shows a graphical user interface (GUI) screen generated by the referral pools module of the system network and displayed on the display screen of a mobile client system on the system network associated with a consumer who wants to “refer a job” to affiliate service providers or merchants. This is achieved by selecting the “refer jobs to” interface object in the GUI screen shown in FIG. 32U, which automatically generated the jobs referred by me GUI screen shown in FIG. 32V, where all jobs viewable by the user (by virtue of job origination, group membership or contacts) are displayed in this GUI screen and available for selection and referring to one or more qualified affiliates using the GUI screen shown in FIG. 32W.

FIG. 32W shows a graphical user interface (GUI) screen generated by the referral pools module of the system network and displayed on the display screen of a mobile client system on the system network associated with the consumer whose jobs need to be referred. The displayed “Refer A Job” GUI of FIG. 32W is configured to harness the search power of the search engine in FIGS. 6A and 6B to conduct an automated search of the users “my contacts” directory, and affiliate directory, and jobs listing, and referral pools, to determine who in the user, and anyone in his or her contact list has used an affiliate listed in the job category, to which the user can consider referring the selected job in referral pools.

FIG. 32X shows a graphical user interface (GUI) screen generated by the message module of the system network and displayed on the display screen of a mobile client system on the system network associated with the affiliate who has been referred to a particular job. The displayed GUI presents a message confirming that the affiliate has been referred a particular job, and that the referring consumer is reviewing the affiliate's profile and job reviews.

FIG. 32Y shows a graphical user interface (GUI) screen generated by the my messages module on the system network and displayed on the display screen of a mobile client system on the system network associated with the consumer who has a particular job to be performed by a registered service provider affiliate with the system network. The displayed GUI presents a message confirming that the consumer's job has been referred to a particular affiliate service provider and providing a link or URL to the affiliate's profile.

FIG. 32Z shows a graphical user interface (GUI) screen generated by the my messages module of the system network and displayed on the display screen of a mobile client system on the system network associated with the consumer whose job has been completed an affiliate service provider. The displayed GUI screen presents a message confirming with the consumer that (i) the consumer's job has been completed by a particular affiliate service provider (e.g. Celtic Tree Service), (ii) a particular amount paid, and (iii) after the consumer writes and posts a review on the affiliate who completed the job, the consumer and job referrer will be paid a consumer reward gift card (CRGC) credit from the CRGC Payment Account of the affiliate service provider/merchant who completed the referred job.

FIG. 32-AA shows a graphical user interface (GUI) screen generated by the my reviews module of the system network and displayed on the display screen of a mobile client system on the system network associated with the consumer whose job has been completed an affiliate service provider. The displayed GUI screen indicates that where the consumer has composed a review of an affiliate who has completed the consumer's job, and that the consumer is ready for submission to the system database upon selection of the “submit” interface object (i.e. button), where upon the consumer posting the consumer review, the review record will be added to the affiliate directory, the jobs listing, and the consumer directory, illustrated in FIGS. 6A and 6B, which is merely a schematic representation of these three data structures which are otherwise implemented in the data tables and data-joins according to various schemas involved the RDBMS of the system network database.

FIG. 32-BB shows a graphical user interface (GUI) screen generated by the my reviews module of the system network and displayed on the display screen of a mobile client system on the system network associated with the consumer whose job has been completed an affiliate service provider. The GUI screen confirms that the consumer has posted a review of the affiliate who completed the consumer's job, and submitted the same to the system database.

### Specification of the Referral Pools: The “Jobs Added by Me” Function

FIG. 32-DD shows a graphical user interface (GUI) screen generated by the referral pools module of the system network and displayed on the display screen of a mobile client system on the system network associated with the consumer who wants to add a job and seek some referrals for an affiliate service provider. The displayed “jobs added by me” GUI screen presents a list of jobs added by the user (i.e. jobs added by me), indicating, for each listed job; (i) a date of job entry into the system network; (ii) a job number assigned to each job by the system network; (iii) job category (e.g. roofing, painting, tree service etc); (iv) status of job (e.g. completed/done, pending, in-progress, not yet started); (v) whether or not consumer reward has been consumer reward issued. As shown, interface objects are provide so that the list of jobs added by the user can be sorted and viewed by job category, consumer group, as well as date. This function informs each user what jobs they have added and which can be referred to affiliates on the system network.

### Specification of the Jobs Referral Pools: The “Jobs Referred by Me” Function

FIG. 32-CC shows a graphical user interface (GUI) generated by the my referral pools module of the system network and displayed on the display screen of a mobile client system on the system network associated with the consumer who has made some previous job referrals on the system network referrals. The displayed “jobs referred by me” GUI screen presents a list of jobs that the user has referred to affiliates over the past year or so. Each job referred listed comprises the following information items: (i) a date of job entry into the system network; (ii) a job number assigned to each job by the system network; (iii) the name of the affiliate to which the job was referred; (iv) status of the job (e.g. completed/done, pending, in-progress, not yet started); and (v) whether or not consumer reward has been issued for each listed job referral. As shown, interface objects are provided so that this list of job-affiliate referrals made by the user can be sorted and viewed by job category, consumer group, as well as date. This function informs each user what jobs they have referred and on which they can earn consumer reward gift card (CRGC) credit from affiliates on the system network, in the event a referral is used and a job transaction is completed and reviewed.

### Specification of the My Jobs Service Suite of the Present Invention

FIG. 33 shows a graphical user interface (GUI) screen generated by the my jobs module of the system network and displayed on the display screen of a mobile client system on the system network associated with a consumer interested in managing all of the jobs that he or she had added and referred to the system network, via searching the affiliate directory, within my favorites, and while using the referral pools facility. The displayed GUI screen presents the consumer with the same functions supported in the referral pools module/facility, namely: (i) adding a job to the job listings maintained by the system network; (ii) review the jobs that have been added by the consumer (i.e. jobs added by me); (iii) refer jobs to a particular affiliate service provider based on the consumer's past experiences therewith; and (iv) review jobs that have been referred by the consumer (i.e. jobs referred by me). Only registered consumer/users can add jobs to the referral pools structure, or refer jobs which are already in the referral pools structure. Also a job is removed from the referral pools upon any of the following events, (i) after three (3) referrals have been made against a particular job, (ii) when a particular job is certified as completed by the assigned referred service provider, and (iii) after the passage of an agreed upon time limit (e.g. 1 year), and wherein a message should be send to the consumer user whose job has been completed, prior to the completed job being removed from the referral pools. The My Jobs Service Suite supports the same functions provided in the Referral Pools Suite/Facility and therefore these functions do not need to be described again.

### How Consumers can Earn Consumer Reward Gift Card (CRGC) Credits on the System Network of the Present Invention

FIG. 34A describes several ways in which consumers can earn consumer reward gift card (CRGC) credits on the system network, specifically: (i) by a consumer x adding a job to the system network and/or requesting service by a network affiliate; (ii) by a consumer y purchasing a product/service from an affiliate on the system network, and then writing and posting a product/service review on the system network; and (iii) by a consumer z referring an affiliate to a job, upon which a consumer transaction is completed and reviewed, and where consumer z has actually used the affiliate being referred.

As a general rule, when a consumer refers an affiliate for a job which is listed in the Referral Pools, the referring consumer has no control over which reviews of the affiliate will be linked to the referral that is ultimately presented to the consumer seeking a referral from the referral pools facility on the system network of the present invention. The review written by the referring consumer is never included in the reviews attached to the referral. The most recent 10 reviews, not including the reviews posted by the referring consumer, are used. This is to prevent the referrer from influencing the process for monetary gain and encouraging the consumer to write accurate reviews.

In other words, in the referral pools service of the present invention, the referring consumer can and does prepare “the referral envelope” containing the most recent reviews by others for a particular affiliate which the referring consumer is referring, but the referring consumer cannot add its own “affiliate review” within the referral envelope—the consumer referrer functions as the referral massager but not the message.

### Managing a Registered User's Consumer Rewards Gift Card (CRGC) Account on the System Network of the Present Invention

FIG. 34B describes a primary suite of services supported on the system network relating to managing a registered user's consumer rewards gift card (CRGC) account including (i) consumers managing their consumer reward gift credit card on the system network, (ii) reviewing balances, making donations, (iii) adding credit to consumer reward gift card account, (iv) using PayPal financial institution linked to the consumer's credit card or debit card account, (v) transferring reward credit to spouse or family member who has a consumer reward card.

### Using Consumer Rewards Gift Card (CRGC) Credit to Pay for Purchases and Transactions on the System Network of the Present Invention

FIG. 34C describes a primary suite of services supported on the system network relating to using rewards credit to pay for purchases and transactions, by way of any of the following techniques: (i) using earned rewards credit to pay for such services/products from any affiliate on the system network; (ii) swiping ones consumer rewards gift card (CRGC) magstripe-encoded card and paying for services using credit stored in its corresponding CRGC account; and (iii) using a mobile client app to generate and display a QRS code which is read by the affiliate's mobile QRS reader, and then using ones CRGC account linked thereto to pay for products and/or services from affiliated service providers and/or merchants.

FIG. 35 describes a work flow process that can be used when paying for services/goods purchased from affiliate service providers and/or merchants registered with the system network, using ones consumer reward gift card (CRGC) account maintained on the system network. According to this process, the consumer (i) reviews the balance on its CRCG account; (ii) generates a barcode on the screen of its mobile client system (e.g. iPhone); (iii) requests the affiliated service provider to read the barcode and connect to the system network and request for credit-based payment for goods and/or services from the consumer's CRGC account; and (iv transfers the required funds from the CRGC account to pay for the purchase transaction and generates a receipt and the like to document the payment transaction.

FIG. 36 shows a multi-layer service model for the barcode-driven consumer reward credit based payment service that is supported on the system network of the present invention, wherein consumer users are provided with a graphical user interface (GUI) coupled to the application programming interface or API (i.e. control tier) which interfaces with the system database or RDBMS (i.e. database tier) for storing persistent objects and supporting various services provided by the system network of the present invention. This way, when paying for goods and/or services being purchased from an affiliate provider on the system network, the consumer can use his or her mobile client system to display a QRS barcode on the GUI screen thereof, so that the affiliate can use its client-based based barcode reader to read the consumer's QRS barcode and initiate a payment session with the sponsoring financial institution and use credit stored in the consumer's CRGC account to pay for goods and/or services being purchased from the affiliate service provider.

Method of Supporting a Consumer Purchase Transaction Between a Consumer and an Affiliate on the System Network, and Making Payment for the Purchase Using Credit Value Available within the Consumer's Consumer Rewards Gift Card (CRGC) Account

FIG. 37 describes the primary steps involved in carrying out the method of supporting a consumer purchase transaction between a consumer and an affiliate on the system network, and making payment for the purchase using credit value available within the consumer's consumer rewards gift card (CRGC) account. In the illustrative embodiment, the method involves the steps: (a) consumer purchases products or services at a store or space (e.g. restaurant) of an affiliate service provider/merchant, registered on the system network, and the affiliate generates and displays a sales transaction invoice at the point of sale or purchase, in the form of a QRS code on a display screen; (b) the affiliate service provider uses the affiliate's mobile client system to scan a QRS bar code displayed on the consumer client machine identifying its consumer reward gift card (CRGC) account for payment; (c) the affiliate's mobile client system displays a proposed payment transaction screen for the consumer transaction, requesting the consumer's approval to make payment from the identified CRGC account; (d) upon the consumer providing approval for payment, the system network processes the payment and sends notification messages to the consumer and the affiliate service provider, which updates the system database, while payment processing is carried out transparently; and (e) the consumer receives the payment confirmation on its mobile client system, and confirms the consumer transaction on the network and its associated payment transaction using the mobile client system.

Using Available Consumer Rewards Gift Card (CRGC) Credit Value to Pay for a Purchase of Goods and/or Services Over the Affiliate-Referral Driven Consumer-Transaction Rewarding System Network of the Present Invention

FIG. 38 is a schematic representation of the system network of the present invention supporting the process, whereby a consumer uses available consumer rewards gift card (CRGC) credit value to pay for a purchase of goods and/or services over the affiliate-referral driven consumer-transaction rewarding system network of the present invention. In the illustrative embodiment, the process comprises the steps of: (a) sending messages and links on referred affiliates from the data center of the system network to the mobile client system of the consumer making purchases from affiliates on the system network; (b) sending a purchase request from the mobile client system of the consumer making the purchase from affiliate on the system network; (c) sending a message and instructions for payment from the mobile client system of the consumer making purchase from the affiliate on the system network; (d) transfer of credit (i.e. funds) between the CRGC account of the consumer and the CRGC payment account of the affiliate service provider/merchant to make a payment for goods and/or services being purchased by the consumer from the affiliate; (e) notification of payment made within the sponsoring bank, sent from the consumer rewards gift card system; (f) notification of payment transfer within the sponsoring bank, sent from the consumer rewards gift card (CRGC) system to the data center of the system network; (g) the transfer of purchased goods and/or services from the client suite of the affiliate selling goods and/or services to the consumer; (h) sending a message of the completed purchase transaction from the client system of the affiliate to the data center of the system network; (i) preparing and sending a consumer review of the completed purchase transaction involving the affiliate, from the mobile client system of the consumer who purchased the goods and/or services, to the data center of the system network; and (j) loading the consumer review to the jobs listing structure, the affiliate directory structure, and the consumer directory structure schematically depicted in FIGS. 6A and 6B.

### Specification of the Rewards Module Supported on the System Network of the Present Invention

FIG. 39A shows a graphical user interface (GUI) screen generated by the my rewards module of the system network and displayed on the display screen of a mobile client system on the system network associated with the consumer who wants to manage their consumer reward credits. The displayed GUI screen presents interfaces objects, supported by sub modules, for the following purposes: (i) paying for services and/or goods with consumer reward gift card (CRGC) credit available on the system network; (ii) adding credit to consumer reward gift card (CRGC) account; (iii) donating money (to charities and non-profits) using consumer reward gift card credit; and (iv) consumer reward gift card credit, and wherein the consumer has selected and enabled the “pay with consumer rewards gift card (CRGC)” function to pay for goods and/or services with CRGC credit earned and maintained on the system network causing the “Display My QRS Code” interface object to be displayed to the consumer.

FIG. 39B shows a graphical user interface (GUI) screen generated by the my rewards module of the system network and displayed on the display screen of a mobile client system on the system network associated with the consumer who wants to manage their consumer reward credits. In response to selecting the “Display My QRS Code” interface object from the GUI screen shown in FIG. 39A, the GUI screen presents (i) the four function-enabling interface objects shown in FIG. 39A, and also (ii) the consumer's encoded QRS Code to be scanned by the client system of an affiliate to whom the consumer wishes to transfer a payment from its CRGC account to the affiliate's CRGC payment account, illustrated in FIG. 38.

FIG. 39C shows a graphical user interface (GUI) screen generated by the my rewards module of the system network and displayed on the display screen of a mobile client system on the system network associated with the consumer who wants to manage their consumer reward credits, where in response to scanning the QRS Code” interface object from the GUI screen shown in FIG. 39A, the client system of the affiliate scanning the QRS Code operably connects through the system network with the CRGC payment system, establishes a payment transaction session therewith, and once ready to enable a transfer of CRGC credit from the consumer's CRGC account to the affiliate's CRGC payment account, the payment servers send an encrypted message to the consumer's client system, enabling the “pay now” interface object display on the display GUI screen shown in FIG. 38C, inviting the consume to select it and select, approve and authorize the payment to execute during the session.

FIG. 39D shows a graphical user interface (GUI) screen generated by the my rewards module of the system network and displayed on the display screen of a mobile client system on the system network associated with the consumer who wants to manage their consumer reward credits, where in response to the consumer selecting the “pay now” interface object presented in the GUI screen shown in FIG. 39C, the payment transaction is executed, credit transfers occur as illustrated in FIG. 38, and the payment system sends a notification to the data center of the system network therewith that payment has been made, and the system network then notifies the consumer's client system and displays the “Review Payment Receipt” message illustrated in FIG. 39D.

FIG. 40 shows a schematic representation of work flow process that can be used in making payments to charities and non-profit organizations, registered with the system network using ones consumer reward gift card (CRGC) account maintained on the system network. The consumer (i) reviews the balance on its CRCG account, (ii) generates a barcode on the screen of its mobile client system (e.g. iPhone) and requests to donate CRGC credit to a selected charity or non-profit organization from the consumer's CRGC account, and (iii) transfer the required funds from the CRGC account to pay for donation and generate receipts and the like to document the donation transaction.

FIGS. 41A, 41B, 41C and 41D show a series of graphical user interface (GUI) screens generated by the my rewards module of the system network and displayed on the display screen of a mobile client system on the system network associated with the consumer who wants to donate some of their consumer reward credits (i.e. money) to a charity or non-profit organization registered on the system network and having their own CRCG account, as illustrated in FIG. 1B. After reviewing available balances in FIGS. 41A and 41B, and selecting the “donate” interface object in FIG. 41C, the donation transaction is executed. Upon execution of the transaction, the consumer selected amount of CRGC credit donation is transferred from the consumer's CRGC account to the charitable or non-profit organization's CRGC account, illustrated in FIG. 1B, and in response thereto, a donation receipt is displayed on the consumer's GUI screen as shown in FIG. 41D, to complete this donation transaction, with appropriate records being subsequently generated and transferred to the IRS and other governmental agencies in accordance with prescribed law and regulations.

FIG. 42 shows a schematic representation of work flow process that can be used in add credit value one's consumer reward gift card (CRGC) account maintained on the system network. The consumer (i) reviews the balance on its CRCG account, (ii) requests to add credit to a CRGC account via the GUI screen of its mobile client system (e.g. iPhone), (iii) selects a bank from which to transfer monetary credit value to the consumer's CRGC account, and (iv) transfers the required funds from the selected bank to the CRGC account to add credit to the CRGC account and maintain some predetermined balance limit, and generate receipts and the like to document the credit transfer transaction.

FIGS. 43A, 43B, and 43C shows series of graphical user interface (GUI) screens generated by the my rewards module of the system network and displayed on the display screen of a mobile client system on the system network associated with the consumer who wants to add monetary credit from an external bank to their consumer reward gift card (CRGC) account maintained on the system network, as illustrated in FIG. 1B. After reviewing available balances in FIG. 43A and selecting the “send” interface object in FIG. 43B, the credit transfer transaction is executed, whereupon the consumer specified CRGC credit amount is transferred from the consumer's selected bank to his or her CRGC account, illustrated in FIG. 1B. In response thereto, a transfer receipt is displayed on the consumer's GUI screen as shown in FIG. 43C, to complete this transaction, with appropriate records being subsequently generated and transferred to the proper governmental agencies in accordance with prescribed law and regulations.

FIG. 44 shows a schematic representation of work flow process that can be used in transfer credit value from one's consumer reward gift card (CRGC) account to another CRGC account maintained on the system network. The consumer (i) reviews the balance on its CRCG account, (ii) requests to transfer credit from the consumer's CRGC account to another's CRGC account, via the GUI screen of its mobile client system (e.g. iPhone), and (ii) transfers the required credit from the CRGC account to the other selected CRGC account, and generate receipts and the like to document the credit transfer transaction.

FIGS. 45A, 45B, and 45C shows series of graphical user interface (GUI) screens generated by the my rewards module of the system network and displayed on the display screen of a mobile client system on the system network associated with the consumer who wants to transfer credit from their consumer reward gift card (CRGC) account to another's CRGC account maintained on the system network, as illustrated in FIG. 1B. After reviewing available balances in FIG. 45A and selecting the “send” interface object in FIG. 45B, the credit transfer transaction is executed, whereupon the consumer specified CRGC credit amount is transferred from the consumer's selected bank to his or her CRGC account, illustrated in FIG. 1B. In response thereto, a transfer receipt is displayed on the consumer's GUI screen as shown in FIG. 45C, to complete this transaction, with appropriate records being subsequently generated and transferred to the proper governmental agencies in accordance with prescribed law and regulations.

FIG. 46 shows a map of affiliate services supported on the client system affiliates (e.g. service providers, vendors and merchants) comprising: (i) affiliates registering with the system network, and receiving an affiliate consumer reward payment account with a user name and password credentials; (ii) affiliates managing their consumer reward gift card (CRGC) payment accounts on the system network including affiliate services such as affiliates adding a bank account(s) to the CRCG payment system to fund their CRGC payment accounts maintained by the sponsoring financial institution within the CRGC payment system, affiliates configuring settings relating to their CRGC payment accounts, monitoring consumer reward credit being automatically (or manually) issued to consumers (i.e. affiliate customers) on the system network; (iii) affiliates managing their affiliate profiles and points of access supported on the system network, including affiliate services such as managing affiliate profiles on the system network, and downloading and installing “a search and display affiliate profile and services” widget on social network channels, personal network channels, employment network channels; and (iv) managing the referral pool supported on the system network of the present invention including affiliate services such as viewing the number of jobs posted for service and performance, as well as the allowing affiliates to view the number of referred jobs that have been completed by the affiliate in specific service categories, and allowing affiliates to view the referred and assigned jobs are currently being performed or schedule to be performed by the affiliate on the system network.

FIG. 47A shows a graphical user interface (GUI) screen generated by the affiliate login module of the system network and displayed on the display screen of a mobile client system on the system network associated with an affiliate (or one of its principals or employees wants to needs to manage the affiliate's profile, consumer reward gift card payment account, or other services on the system network. The displayed GUI screen presents an interface object (i.e. Affiliate Login) which, when selected, initiates the login process on the system network.

FIG. 47B shows a graphical user interface (GUI) screen generated by the affiliate login module of the system network and displayed on the display screen of a mobile client system on the system network associated with an affiliate, wherein the displayed GUI screen presents interface objects for logging into the system network, or alternatively, registering with the system network if the user is not registered and does not have a user account on the system network.

FIG. 47C shows a graphical user interface (GUI) screen generated by the affiliate registration module of the system network and displayed on the display screen of a mobile client system on the system network associated with an affiliate. The displayed GUI screen presents interface objects for registering with the system network.

FIG. 47D shows a graphical user interface (GUI) screen generated by the affiliate registration module of the system network and displayed on the display screen of a mobile client system on the system network associated with an affiliate. The displayed GUI screen presents a confirmation that the user has successfully registered with the system network.

FIG. 47E shows a graphical user interface (GUI) screen generated by the home (select a menu) module of the system network and displayed on the display screen of a mobile client system on the system network associated with an affiliate, wherein the displayed GUI screen presents the six primary service modules supported on the affiliate side of the system network, namely (i) manage affiliate profile, (ii) review consumer reward payments, (iii) manage jobs on network, (iv) register a consumer (i.e. customer), and (vi) manage consumer reward gift card (CRGC) payment account using any client system deployed on the system network of the present invention.

FIG. 48A shows a graphical user interface (GUI) screen generated by the home (select a menu) module of the system network and displayed on the display screen of a mobile client system on the system network associated with an affiliate. The displayed GUI screen presents the six primary service modules supported on the affiliate side of the system network, and the consumer selects the “manage affiliate profile” module.

FIG. 48B shows a graphical user interface (GUI) screen generated by the manage affiliate profile module of the system network and displayed on the display screen of a mobile client system on the system network associated with an affiliate. The displayed GUI screen presents the affiliate profile information management screen which allows the affiliate to update profile information as required, via virtual keyboard which is enabled upon touching the screen, as illustrated in FIG. 48C, and when information has been changed, selecting the “save update profile” interface object (e.g. button) automatically saves the information updates to persistent memory in the database system of the system network.

FIG. 48C shows a graphical user interface (GUI) screen generated by the manage affiliate profile module of the system network and displayed on the display screen of a mobile client system on the system network associated with an affiliate, wherein a virtual keyboard is enabled upon touching the screen, for entering profile information updates.

FIG. 49A shows a graphical user interface (GUI) screen generated by the home (select a menu) module of the system network and displayed on the display screen of a mobile client system on the system network associated with an affiliate. The displayed GUI screen presents the six primary service modules supported on the affiliate side of the system network, and the consumer selects the “manage jobs on network” module.

FIG. 49B shows a graphical user interface (GUI) screen generated by the manage jobs on network module of the system network and displayed on the display screen of a mobile client system on the system network associated with an affiliate. The “update a job” interface object is selected to present the GUI screen shown in FIG. 49C.

FIG. 49C shows a graphical user interface (GUI) screen generated by the manage jobs on network module of the system network and displayed on the display screen of a mobile client system on the system network associated with an affiliate. The displayed GUI screen presents the Update A Job screen which allows the affiliate to update job information as required, via a virtual keyboard shown which is enabled upon touching the screen, and when information has been changed, selecting the “submit update” interface object (e.g. button) automatically saves the information updates to persistent memory in the database system of the system network.

FIG. 49D shows a graphical user interface (GUI) screen generated by the manage jobs on network module of the system network and displayed on the display screen of a mobile client system on the system network associated with an affiliate. The displayed GUI screen presents the confirmation message sent to the affiliate for completing the referred job, and notifying the same that the system network will automatically issue consumer rewards credit to the referring consumer, the consumer who posted the job to the referral pool, and the system administrator.

FIG. 49E shows a graphical user interface (GUI) screen generated by the manage jobs on network module of the system network and displayed on the display screen of a mobile client system on the system network associated with an affiliate. The affiliate selected an add a new job GUI screen, so that the affiliate can add a job for a consumer who did not contact him through the system network, where upon adding the job, the system automatically generates a job number for the added job. In the event that the job is for a new user, then contact details for the person are added by the affiliate and the system network will generate a new user/consumer profile for that customer, and then the system will send a message requiring the new user to (i) download client application software (for native client system software application enablement on the client system) or a URL for access to the web-based responsive-design website providing a web-based interface and services to the web-enabled client system used by the new system user, and (ii) activate its new consumer reward gift card (CRGC) account with the CRGC payment system within the system network of the present invention. Thereafter, the affiliate adds all of the customer and job related information required including job amount so that the correct consumer reward can be calculated and issued by the system network (i.e. CRGC payment system) to the customer upon completion of the job.

FIG. 49F shows a graphical user interface (GUI) screen generated by the manage jobs on network module of the system network and displayed on the display screen of a mobile client system on the system network associated with an affiliate. The displayed GUI screen presents the confirmation message confirming that the new job has been successfully added to the system network for the customer/consumer.

FIG. 50A shows a graphical user interface (GUI) screen generated by the home (select a menu) module of the system network and displayed on the display screen of a mobile client system on the system network associated with an affiliate. The displayed GUI screen presents the six primary service modules supported on the affiliate side of the system network, and the consumer selects the “review consumer rewards” module.

FIG. 50B shows a graphical user interface (GUI) screens generated by the review consumer rewards module of the system network and displayed on the display screen of a mobile client system on the system network associated with an affiliate. The “review recent consumer reward payments” interface object is selected to present a list of consumer reward gift card credits (e.g. measured in $) which have been recently issued (e.g. over the past 30 days) by the affiliate.

FIG. 50C shows a graphical user interface (GUI) screens generated by the review consumer rewards module of the system network and displayed on the display screen of a mobile client system on the system network associated with an affiliate. The “review all consumer reward payments” interface object is selected to present a list of all consumer reward gift card credits (e.g. measured in $) which have been issued by the affiliate from the first date of the CRGC payment account opening to the present moment.

FIG. 51A shows a graphical user interface (GUI) screens generated by the home (select a menu) module of the system network and displayed on the display screen of a mobile client system on the system network associated with an affiliate. The displayed GUI screen presents the six primary service modules supported on the affiliate side of the system network, and the consumer selects the “register consumers” module.

FIGS. 51B-1 and 51B-1 shows a series of graphical user interface (GUI) screens generated by the register consumers module of the system network and displayed on the display screen of a mobile client system on the system network associated with an affiliate. The “register consumers” interface object is selected to present an interface for entering consumer profile information minimally required to register a new consumer to the system network, using either (i) the integrated bar code scanner which scans the new consumer's ID barcode on an ID card (e.g. driver's license or other card) to capture the user's name, address and other available information as shown in FIGS. 51B-1, and (ii) a virtual keyboard for manually key-entering profile information into the form, and thereafter using GUI screen shown in FIG. 51B-3, the affiliate selects the “submit” interface object to store the user profile information in persistent memory storage devices on the system network, and complete user registration.

FIG. 52A shows a graphical user interface (GUI) screens generated by the home (select a menu) module of the system network and displayed on the display screen of a mobile client system on the system network associated with an affiliate, wherein the displayed GUI screen presents the six primary service modules supported on the affiliate side of the system network, and the consumer selects the “show consumer reviews” module.

FIG. 52B shows a graphical user interface (GUI) screen generated by the show consumer reviews module of the system network and displayed on the display screen of a mobile client system on the system network associated with an affiliate. The review “recent consumer reviews” interface object is selected to present a list of consumer reviews of affiliates which have been recently posted (e.g. over the past 30 days) by particular consumers regarding the quality and manner in which jobs were performed by the affiliate.

FIG. 52C shows a graphical user interface (GUI) screen generated by the show consumer reviews module of the system network and displayed on the display screen of a mobile client system on the system network associated with an affiliate. The “affiliate review” (i.e. consumer review of an affiliate) is presented on the GUI screen, showing the name, address and contact information of the affiliate and typically a written review of the affiliate's performance in carrying out the specified job, with words of recommendation or condemnation provided.

FIG. 53A shows a graphical user interface (GUI) screens generated by the home (select a menu) module of the system network and displayed on the display screen of a mobile client system on the system network associated with an affiliate. The displayed GUI screen presents the six primary service modules supported on the affiliate side of the system network, and the consumer selects the “manage CRGC payment account” module.

FIG. 53B shows a graphical user interface (GUI) screen generated by the manage CRGC payment account module of the system network and displayed on the display screen of a mobile client system on the system network associated with an affiliate. The review affiliate's consumer reward gift card (CRGC) credit balance interface object is selected to present affiliate details regarding the balance of CRGC payment credit available in the affiliate's CRGC payment account within the CRGC payment system on the system network.

FIG. 53C shows a graphical user interface (GUI) screen generated by the manage CRGC payment account module of the system network and displayed on the display screen of a mobile client system on the system network associated with an affiliate. A configuration of “affiliate settings on network” interface object is presented on the GUI screen, showing the affiliate configuration settings including affiliate ID No., Affiliate Name, Affiliate Contact, Affiliate bank account information, bank routing number, bank account number, set auto limit amount (determining how much money needs to be transferred to maintain a specific predetermined credit limit in the affiliate's CRGC payment amount account.

Specification Of The Affiliate Contacts Module Supported On The System Network Of The Present Invention

FIG. 54A shows a graphical user interface (GUI) screen generated by the select a menu module (i.e. affiliate home module) of the system network and displayed on the display screen of a mobile client system on the system network associated with an affiliate. The “affiliate contacts module” interface object is being selected from the GUI screen, so that affiliate contacts and group management functions can be performed in GUI screens shown in FIGS. 54B and 54C.

FIG. 54B shows a graphical user interface (GUI) screen generated by the affiliate contact module of the system network and displayed on the display screen of a mobile client system on the system network associated with an affiliate. The interface objects for the manage affiliate contacts module and the manage affiliate groups are displayed, and wherein the manage affiliate contacts module is selected for affiliate contact management purposes (e.g. import and sync contacts with the affiliate's CRM system such as PeopleSoft, review affiliate contacts, add a new affiliate contact, etc).

FIG. 54C shows a graphical user interface (GUI) screen generated by the affiliate contacts module of the system network and displayed on the display screen of a mobile client system on the system network associated with an affiliate. The interface object for the manage affiliate contacts module is selected causing the sync affiliate contacts module, the review affiliate contacts module and the add new affiliate contact module to be displayed, and wherein the sync affiliate contacts module is selected for importing contact files from and synchronizing contact files within the affiliate's contacts directory on the system network, with contact files maintained within the affiliate's enterprise-level CRM system).

FIG. 54D shows a graphical user interface (GUI) screen generated by the affiliate contacts module of the system network and displayed on the display screen of a mobile client system on the system network associated with an affiliate. The interface object for the manage affiliate contacts module is selected causing the sync affiliate contacts module, the review affiliate contacts module and the add new affiliate contact module to be displayed, and wherein the review affiliate contacts module is selected for reviewing affiliate contacts.

FIG. 54E shows a graphical user interface (GUI) screen generated by the affiliate contacts module of the system network and displayed on the display screen of a mobile client system on the system network associated with an affiliate. The interface object for the manage affiliate contacts module is selected causing the sync affiliate contacts module, the review affiliate contacts module and the add new affiliate contact module to be displayed, and wherein the add a new affiliate contact module is selected for adding a new affiliate contact.

### Specification of the Manage Affiliate Groups Module Supported on the System Network of the Present Invention

FIG. 54F shows a graphical user interface (GUI) screen generated by the affiliate contacts module of the system network and displayed on the display screen of a mobile client system on the system network associated with an affiliate. The interface objects for the manage affiliate contacts module and the manage affiliate groups are displayed, and wherein the manage affiliate groups module is selected for affiliate groups management purposes (e.g. review current affiliate groups created and supported on the system network, and adding a new affiliate group).

FIG. 54G shows a graphical user interface (GUI) screen generated by the affiliate contacts module of the system network and displayed on the display screen of a mobile client system on the system network associated with an affiliate. The interface object for the review affiliate groups module has been selected, causing a list of affiliate groups to be displayed to which the user belong, along with a menu of tools allowing the user to edit the affiliate groups, save them, and even delete them as desired by the affiliate user.

FIG. 54H shows a graphical user interface (GUI) screen generated by the affiliate contacts module of the system network and displayed on the display screen of a mobile client system on the system network associated with an affiliate. The interface object for the create new affiliate groups module has been selected, causing a new affiliate group form to be displayed, along with a menu of tools allowing the user to create a new group of affiliates from the user's contacts, and thereafter the save the new affiliate group, and even delete the new group before it is saved, as might be desired by the affiliate user.

### Specification of the Affiliate Messaging Module Supported on the System Network of the Present Invention

FIG. 55A shows a graphical user interface (GUI) screen generated by the select a menu module (i.e. affiliate home module) of the system network and displayed on the display screen of a mobile client system on the system network associated with an affiliate. The “affiliate messaging module” interface object is being selected from the GUI screen, so that affiliate messaging functions can be performed in GUI screens shown in FIGS. 55B through 55E.

FIG. 55B shows a graphical user interface (GUI) screen generated by the affiliate messaging module of the system network and displayed on the display screen of a mobile client system on the system network associated with an affiliate, wherein interface objects for the review affiliate messages module and the send new message are displayed.

FIG. 55C shows a graphical user interface (GUI) screen generated by the affiliate messaging module of the system network and displayed on the display screen of a mobile client system on the system network associated with an affiliate. The interface object for the review affiliate messages module is selected causing a list of incoming messages to be reviewed by the user by selecting the message to be reviewed in the display space provided in the GUI screen.

FIG. 55D shows a graphical user interface (GUI) screen generated by the affiliate messaging module of the system network and displayed on the display screen of a mobile client system on the system network associated with an affiliate. The interface object for the new affiliate message module is selected causing a new message interface to be displayed allowing the user affiliate to create a new message for a single contact, using a on-screen virtual keyboard, along with a set of tools allowing the user to select from his or her list of contacts, list of affiliate groups, save the message, and send the message.

FIG. 54E shows a graphical user interface (GUI) screen generated by the affiliate messaging module of the system network and displayed on the display screen of a mobile client system on the system network associated with an affiliate. The interface object for the new affiliate message module is selected causing a new message interface to be displayed allowing the user affiliate to create a new message for a affiliate selected by the user (e.g. LS B2B GROUP BRIDGEPORT WEST), using a on-screen virtual keyboard, along with a set of tools allowing the user to select from his or her list of contacts, list of affiliate groups, save the message, and send the message.

### Specification of the Logoff Module Supported on the System Network of the Present Invention

FIG. 56A and FIG. 56B shows a series of graphical user interface (GUI) screens generated by the select a menu module (i.e. affiliate home module) of the system network and displayed on the display screen of a mobile client system on the system network associated with an affiliate. The “logoff” interface object is being selected from the GUI screen, so that the client system logs off the system network, and displaying the GUI screen shown in FIG. 56B, ready for logging back into the system network upon selecting the interface object labeled “affiliate login”.

### The Illustrative Embodiments of the System Network of the Present Invention

The entirety of this disclosure (including the written description, figures, claims, abstract, appendices, and/or the like) for the system network and related methods and processes of the present invention shows various embodiments via which the claimed innovations may be practiced. It is to be understood that these embodiments and the features they describe are a representative sample presented to assist in understanding the claimed innovations, and are not exhaustive and/or exclusive. As such, the various embodiments, implementations, examples, and/or the like are deemed non-limiting throughout this disclosure.

Furthermore, alternate undescribed embodiments may be available (e.g., equivalent embodiments). Such alternate embodiments have not been discussed in detail to preserve space and/or reduce repetition. That alternate embodiments have not been discussed in detail is not to be considered a disclaimer of such alternate undescribed embodiments, and no inference should be drawn regarding such alternate undescribed embodiments relative to those discussed in detail in this disclosure. It is to be understood that such alternate undescribed embodiments may be utilized without departing from the spirit and/or scope of the disclosure.

For example, the organizational, logical, physical, functional, topological, and/or the like structures of various embodiments may differ. In another example, the organizational, logical, physical, functional, topological, and/or the like structures of the application server, application server elements, system network data stores, system network components and their subcomponents, capabilities, applications, and/or the like described in various embodiments throughout this disclosure are not limited to a fixed operating order and/or arrangement, instead, all equivalent operating orders and/or arrangements are contemplated by this disclosure.

In yet another example, the application server, application server elements, system network data stores, system network components and their subcomponents, capabilities, applications, and/or the like described in various embodiments throughout this disclosure are not limited to serial execution, instead, any number and/or configuration of threads, processes, instances, services, servers, clients, nodes, and/or the like that execute in parallel, concurrently, simultaneously, synchronously, asynchronously, and/or the like is contemplated by this disclosure. Furthermore, it is to be understood that some of the features described in this disclosure may be mutually contradictory, incompatible, inapplicable, and/or the like, and are not present simultaneously in the same embodiment. Accordingly, the various embodiments, implementations, examples, and/or the like are not to be considered limitations on the disclosure as defined by the claims or limitations on equivalents to the claims.

This disclosure includes innovations not currently claimed. Applicant reserves all rights in such currently unclaimed innovations including the rights to claim such innovations and to file additional provisional applications, nonprovisional applications, continuation applications, continuation-in-part applications, divisional applications, and/or the like. It is to be understood that while some embodiments of the system network discussed in this disclosure have been directed to a platform for referring consumers and providers, the innovations described in this disclosure may be readily applied to a wide variety of other fields and/or applications.

The present invention has been described in great detail with reference to the above illustrative embodiments. It is understood, however, that further modifications will readily occur to those with ordinary skill in the art having had the benefit of reading the present disclosure.

For example, in alternative embodiments of the present invention described hereinabove, the system network is illustrated as being used to promote consumer services and products. However, it is understood that the services and products referred on the system network can be professional as well as industrial, scientific, engineering, manufacturing oriented, allowing the system network to be used across many different industries. Also while text and SMS and email messaging has been described in the illustrative embodiments, it is understood that videoconferencing, video messaging, video messages, and other kind of messages are possible and contemplated by the present invention. Also alternative system configurations are expected and will depend on particular end-user applications and target markets for products and services using the principles and technologies of the present invention.

These and all other such modifications and variations are deemed to be within the scope and spirit of the present invention as defined by the accompanying Claims to Invention.

1. A processor-implemented method to obtain a provider recommendation, comprising:
receiving via a processor a description of a job from a consumer;
determining via the processor a referrer qualified to recommend providers to complete the job;
obtaining via the processor a recommendation of a provider to complete the job from the referrer;
confirming via the processor that the recommended provider completed the job; and
awarding via the processor a voucher to the consumer and a voucher to the referrer.

2. The method of claim 1, wherein the description of the job includes a job category and a job subcategory.

3. The method of claim 1, wherein a referrer who utilized a provider in a job category associated with the job is qualified to recommend providers to complete the job.

4. The method of claim 1, wherein a referrer who utilized a provider in a local area associated with the job is qualified to recommend providers to complete the job.

5. The method of claim 1, wherein the referrer cannot recommend providers which the referrer has not used previously.

6. The method of claim 1, wherein the referrer can only recommend one provider for the job.

7. The method of claim 1, further comprising adjusting account balance of an account associated with the provider based on the values of vouchers awarded to the consumer and the referrer.

8. The method of claim 1, wherein the provider pays for all or at least a portion of the value of a voucher awarded to the consumer for registering.

9. The method of claim 1, wherein the provider pays a periodic membership fee.

10. The method of claim 1, further comprising awarding a frequent user voucher to the consumer after a predetermined number of transactions.

11. The method of claim 10, wherein the value of the frequent user voucher is predetermined.

12. The method of claim 10, wherein the value of the frequent user voucher is based on a percentage of the dollar amount of business associated with the transactions.

13. An Internet-based affiliate-referral driven consumer transaction rewarding system network comprising:
a plurality of communication servers, operably connected to the infrastructure of the Internet, for supporting http and other TCP/IP based communication protocols on the system network;
a plurality of client systems operably connected to the infrastructure of the Internet, and each the client subsystem having a computing platform and a display screen for displaying graphical user interfaces (GUIs) associated with one or more programs executing on the computing platform, and supporting services for system users on the system network;
an information file storage and retrieval system including (i) a relational database management system (RDBMS) for organizing information files stored and managed on the system network, and (ii) information storage devices for storing the information files associated with the information maintained with the object-oriented GUI screens on client systems deployed on system network;
one or more object-oriented application servers operably connected to the infrastructure of the Internet and the RDBMS, for storing and executing modules of object-oriented code, and generating processes having a server-side and a client-side and supporting a graphical user interface (GUI) based environment available on the client-side and displayed on the client systems;
wherein each client subsystem supports the client-side of the processes generated by the one or more modules of object-oriented code executing on the one or object-oriented application servers;
wherein the object-oriented application servers and the modules are configured so that each consumer and network affiliate can register as a system user on the system network, and automatically create and assign a system network user account to the system user upon completing registration on system network; and
wherein the system network user account is stored and maintained within the information storage devices of the distributed information file storage and retrieval system, and thereafter, each system user can receive the many information-based services delivered through the GUI screens displayed on the display screen of each client system deployed on the system network.

14. The Internet-based affiliate-referral driven consumer transaction rewarding system network of claim 13, which further comprises a mechanism, by which affiliate consumer reward gift card (CRGC) payment accounts maintained at the sponsoring financial institution are loaded with financial credit value from the affiliates' financial accounts maintained within computer system networks of affiliate financial institutions, by way of debit/credit card payment networks and/or ACH payment settlement system networks; wherein consumer reward gift card (CRGC) accounts maintained at the sponsoring financial institution are reloaded with credit value from the computer system network of a designated financial institution, so that there is a specified minimum amount of credit value in a consumer's CRGC account, or registered charity or non-profit organization, for making payments for various kinds of purchases on the system network, as well as payments for donations to registered charities and non-profit organizations.

15. The Internet-based affiliate-referral driven consumer transaction rewarding system network of claim 13, wherein at least one said client system comprises: (i) magstripe readers for reading encoded-encoded consumer reward gift cards, (ii) RF-ID tag readers for reading RFID-based tags with consumer identification and CRGC account information for supporting CRGC transactions on the system network; and (iii) mobile barcode reading client computers for reading QRS and other bar codes for enabling payment of consumer transactions using a CRGC Account supported on said system network.

16. The Internet-based affiliate-referral driven consumer transaction rewarding system network of claim 13, wherein primary data structures maintained within the system database include the job listings structure, the affiliate directory structure with affiliate profiles, the consumer directory structure with consumer profiles and reviews, the job referrals structure, and the job referral pools structure.

17. The Internet-based affiliate-referral driven consumer transaction rewarding system network of claim 13, wherein primary data structures maintained within the system database includes (i) a my contacts structure and a my groups structure which are associated with the consumer directory structure, and (ii) a affiliate contacts structure and a affiliate group structure which are associated with the affiliate directory structure.

18. A method of searching a system network with an affiliate database to find affiliates who have been classified in a particular category of services/goods, and wherein each consumer has a consumer reward gift card (CRGC) account, and each affiliate has a consumer reward gift card (CRGC) payment account from which to make reward payments into the CRGC account of consumers who have made job referrals to affiliates who have completed referred jobs which have been reviewed by consumers, said method comprising:
(a) making a query against said affiliate database; and
(b) in response to the search query, receiving (i) a list of registered affiliates that meet the consumer's search criteria, (ii) a business profile for each affiliate business/merchant, and (iii) a list of reviews made by a set of recent consumers registered on said system network.

19. The method of claim 18, which further comprises:
(1) reading the displayed affiliate profiles;
(2) referring a displayed affiliate to a particular job which may be the user's job or someone else's job;
(3) conducting another search query against said affiliate database;
(4) the consumer reviews the displayed reviews, makes a decision on the displayed reviews, and contacts one or more of the listed affiliates via messaging;
(5) a consumer selecting a referred affiliate; and
(6) if and when a transaction is completed, then
(a) the consumer who received services/goods (job) writes and posts a review;
(b) the affiliate providing the services confirms that the job was completed;
(c) thereafter, the affiliate transfers reward credits from the CRGC payment account of the affiliate to (i) the CRGC account of the referring consumer, and (ii) the CRGC account of the served consumer.

20. The method of claim 18, wherein consumer rewards gift card credit (CRGC) is earned and issued over the system network, upon the occurrence of any one of the following events:
(i) when consumer reward gift card (CRGC) credits are issued to job adders on the system network;
(ii) when consumer reward gift card (CRGC) credits are issued to job referrers on the system network; and
(iii) when consumer reward gift card (CRGC) credits are issued to consumer purchasers on the system network.
